(19) United States
(12) Patent Application Publication
(10) Pub. No.: US 2025/0075041 A1
(43) Pub. Date: Mar. 6, 2025

(54) COMPOSITIONS FOR SALTWATER-STABLE HYDROGEL ADHESIVES AND METHODS OF USE THEREOF

(71) Applicants: Jonathan Barnes, St. Louis, MO (US); Yipei Zhang, St. Louis, MO (US); Ruihan Li, St. Louis, MO (US); Tarryn Trick, St. Louis, MO (US); Mark Nosiglia, St. Louis, MO (US); Mark Palmquist, St. Louis, MO (US)

(72) Inventors: Jonathan Barnes, St. Louis, MO (US); Yipei Zhang, St. Louis, MO (US); Ruihan Li, St. Louis, MO (US); Tarryn Trick, St. Louis, MO (US); Mark Nosiglia, St. Louis, MO (US); Mark Palmquist, St. Louis, MO (US)

(73) Assignee: Washington University, St. Louis, MO (US)

(21) Appl. No.: 18/821,712

(22) Filed: Aug. 30, 2024

Related U.S. Application Data
(60) Provisional application No. 63/580,034, filed on Sep. 1, 2023.

(51) Int. Cl. C08J 3/075; C08L 51/02; C09J 151/02

(52) U.S. Cl. CPC C08J 3/075; C08L 51/02; C09J 151/02; C08J 2351/02; C08L 2205/02; C09J 2451/00

(57) ABSTRACT

Compositions of saltwater-stable adhesive hydrogels are provided, as well as methods of use thereof in adhesion, drug delivery, antibiotic delivery, surface coating, and antifouling applications. Disclosed copolymer complexes exhibit reversible ionic strength-based solubility between a soluble complex and an insoluble hydrogel, and include a first polynorbornene (PNB)-based bottlebrush copolymer including a plurality of β-cyclodextrin (β-CD)-terminated oligoethylene glycol sidechains and a second PNB-based bottlebrush copolymer including a plurality of positively charged adamantane (Ad)-terminated oligoviologen sidechains. In some embodiments, the second PNB-based bottlebrush copolymer further includes at least one porphyrin-terminated sidechain and/or has at least one electrostatically loaded, negatively charged therapeutic drug.

### CROSS-REFERENCE TO RELATED APPLICATIONS

This application claims the benefit of priority to U.S. Provisional Application Ser. No. 63/580,034 filed on 1 Sep. 2023, which is incorporated herein by reference in its entirety.

### STATEMENT REGARDING FEDERALLY SPONSORED RESEARCH OR DEVELOPMENT

Not applicable.

### MATERIAL INCORPORATED-BY-REFERENCE

Not applicable.

### FIELD

The present disclosure generally relates to methods and compositions for saltwater stable adhesive compositions.

### BACKGROUND

Shear-thinning hydrogels are a type of dynamic soft material that exhibit a decrease in viscosity when subjected to shear stress, meaning they become thinner and more fluid-like when agitated or injected but become thicker and more solid-like when at rest (a.k.a., self-healing). This property makes them ideal for a variety of applications, including drug delivery, tissue engineering, bioprinting, cosmetics, etc. Although there is already considerable diversity in molecular designs for currently available shear-thinning hydrogels, there are far fewer examples whose properties (stiffness) and performance (adhesive strength) can be changed in response to visible light in a controlled and non-destructive fashion. Also, many adhesives do not stick to a wide range of surfaces in saline environments (e.g., ocean, human body, etc.).

In addition, hydrogel polymers can be utilized as antibacterial polymer coating to prevent biofilm formation. Opportunistic pathogens such as Pseudomonas aeruginosa (P. aeruginosa) and other gram-negative bacteria are a rising public health threat due to their multi-drug resistance and ability to thrive in a range of environments. P. aeruginosa is a main cause of medical device-associated infections, exacerbating hospital admissions and patient morbidity. These characteristics can be attributed in part to the formation of multicellular bacterial communities called biofilms. Biofilms are aggregates of bacteria encased in an extracellular matrix that is typically comprised of extracellular DNA (eDNA), polysaccharides, and proteins. Biofilm formation allows for stronger cell adherence to surfaces, less susceptibility to environmental changes, and stronger tolerance toward antibiotics and the human immune system.

### SUMMARY

Polymer coatings can be designed with adhesive properties and/or with a combination of antifouling and bactericidal properties to prevent bacterial attachment and biofilm formation on various surfaces, including but not limited to surgical equipment and medical devices. The technology disclosed herein provides a synthetic route to the rapidly photocurable and saltwater-stable injectable hydrogels and coatings with versatile adhesive properties. These viscous hydrogels displayed broad adhesive properties across polar and non-polar substrates (i.e., glass, metal, and high-density polyethylene (HDPE)), mimicking that of natural mucous, while control over the hydrogel's mechanical properties (storage/loss moduli) and performance (adhesive strength) was achieved using a low-energy (blue light) photoinduced electron-transfer process. This new hydrogel platform leads to significant improvements in several applications: antifouling/bactericidal coatings for medical device implants to protect a surgery patient from acquired bacterial infections, a new class of modular photodynamic hydrogels that can be cured rapidly to form tough ‘plugs’ for use in wound healing, underwater hull coating platforms, and so on.

Described herein are injectable polymers that remain soluble in regular, deionized water but rapidly gel out of solution after exposure to saltwater. Upon gelation, these hydrogels become very sticky, adhering to many polar and non-polar surface tested (HDPE, stainless steel, glass, wood, platinum, etc.). After heating the sample or irradiating it with visible light, the gel becomes stiffer and more viscous, making it a stronger, tunable adhesive. The gels can be re-dissolved if washed with deionized water. Further development includes addition of secondary polymers that can be physically mixed with the reagent polymers that make the host self-assembled gel, followed by polymerizing the secondary polymer to form a crosslinked material within the host self-assembled gel. Embodiments of this technology prove useful in applications such as, but not limited to antimicrobial coatings for medical devices, antifouling coatings for boats, wound healing, and light-activated adhesives that function in saline environments (e.g., seawater, the human body, etc.).

Therefore, among the various aspects of the present disclosure provides compositions for saltwater-stable adhesive hydrogels as well as methods for making and using the disclosed hydrogel compositions.

In one aspect of the present disclosure, a copolymer complex is provided. The copolymer complex comprises: a first and a second polynorbornene (PNB)-based bottlebrush copolymer. The first PNB-based bottlebrush copolymer comprises: a plurality of oligoethylene glycol sidechains and a plurality of β-cyclodextrin (β-CD)-terminated oligoethylene glycol sidechains. The second PNB-based bottlebrush copolymer comprises: a plurality of oligoethylene glycol sidechains and a plurality of positively charged adamantane (Ad)-terminated oligoviologen sidechains. The copolymer complex is reversibly soluble based on ionic strength, such that: in a low ionic strength aqueous environment, the copolymer complex is soluble and dissolves to form a soluble copolymer complex, and in a high ionic strength aqueous environment, the copolymer complex is insoluble and rapidly precipitates out to form a saltwater-stable adhesive hydrogel.

In some embodiments, each Ad-terminated oligoviologen sidechain comprises at least one positively charged viologen subunit per oligoviologen sidechain. In some embodiments, the hydrogel is further heat-activated, such that the heat-activated hydrogel comprises increased dynamic CD-Ad crosslinking junctions, increased viscosity, and increased stiffness as compared to the hydrogel prior to heat activation. In some embodiments, at least one negatively charged compound is electrostatically loaded onto the plurality of positively charged Ad-terminated oligoviologen sidechains. In some embodiments, the at least one negatively charged compound comprises an antibiotic selected from tazobactam and piperacillin. In some embodiments, the second PNB-based bottlebrush copolymer further comprises a plurality of porphyrin-terminated sidechains. In some embodiments, the hydrogel is further photo-activated, such that the heat-activated hydrogel comprises increased dynamic CD-Ad crosslinking junctions, increased viscosity, and increased stiffness as compared to the hydrogel prior to photo-activation. In some embodiments, each porphyrin-terminated sidechain comprises a zinc-based tetraphenyl porphyrin monomer.

In another aspect of the present disclosure, a method of synthesizing a copolymer complex is provided. The method comprises exposing a copolymer mixture to an aqueous environment to form the copolymer complex. The copolymer mixture comprises: a first and a second polynorbornene (PNB)-based bottlebrush copolymer. The first PNB-based bottlebrush copolymer comprises: a plurality of oligoethylene glycol sidechains and a plurality of β-cyclodextrin (β-CD)-terminated oligoethylene glycol sidechains. The second PNB-based bottlebrush copolymer comprises: a plurality of oligoethylene glycol sidechains and a plurality of positively charged adamantane (Ad)-terminated oligoviologen sidechains. The copolymer complex is reversibly soluble based on ionic strength, such that: in a low ionic strength aqueous environment, the copolymer complex is soluble and dissolves to form a soluble copolymer complex, and in a high ionic strength aqueous environment, the copolymer complex is insoluble and rapidly precipitates out to form a saltwater-stable adhesive hydrogel.

In some embodiments, each Ad-terminated oligoviologen sidechain comprises at least one positively charged viologen subunit per oligoviologen sidechain. In some embodiments, the method further comprises forming the soluble copolymer complex by lowering an ionic strength of the aqueous environment. In some embodiments, the method further comprises forming the saltwater-stable adhesive hydrogel complex by raising an ionic strength of the aqueous environment.

In a further aspect of the present disclosure, a method of coating a surface with an adhesive hydrogel is provided. The method comprises: applying a copolymer complex to a surface and exposing the surface to a high ionic strength aqueous environment such that the copolymer complex on the surface rapidly precipitates out to form the saltwater-stable adhesive hydrogel and coat the surface. The copolymer complex comprises a first and a second polynorbornene (PNB)-based bottlebrush copolymer. The first PNB-based bottlebrush copolymer comprises: a plurality of oligoethylene glycol sidechains and a plurality of β-cyclodextrin (β-CD)-terminated oligoethylene glycol sidechains. The second PNB-based bottlebrush copolymer comprises: a plurality of oligoethylene glycol sidechains and a plurality of positively charged adamantane (Ad)-terminated oligoviologen sidechains. The copolymer complex is reversibly soluble based on ionic strength, such that: in a low ionic strength aqueous environment, the copolymer complex is soluble and dissolves to form a soluble copolymer complex, and in a high ionic strength aqueous environment, the copolymer complex is insoluble and rapidly precipitates out to form a saltwater-stable adhesive hydrogel.

In some embodiments, applying the copolymer complex to the surface comprises: dissolving the first PNB-based bottlebrush copolymer and the second PNB-base bottlebrush copolymer in an organic solvent to form a dissolved copolymer complex; drop casting the dissolved copolymer complex on to the surface; and evaporating the organic solvent from the surface. In some embodiments, each Ad-terminated oligoviologen sidechain comprises at least one positively charged viologen subunit per oligoviologen sidechain. In some embodiments, the surface is selected from high-density polyethylene (HDPE), stainless steel, glass, wood, and platinum. In some embodiments, the high ionic strength aqueous environment comprises a saline solution. In some embodiments, the second PNB-based bottlebrush copolymer further comprises a plurality of zinc-based tetraphenyl porphyrin-terminated sidechains. In some embodiments, the method further comprises activating the hydrogel by at least one of photo-activation and heat activation. In some embodiments, at least one negatively charged compound is electrostatically loaded onto the plurality of positively charged Ad-terminated oligoviologen sidechains. In some embodiments, the at least one negatively charged compound comprises an antibiotic selected from tazobactam and piperacillin.

The main feature that makes the copolymer complexes of the present disclosure unique is the fact that they have oligoviologen sidechains that are positively charged. These viologen-based sidechains are the reason why the mixture of the two polymers is responsive to changes in ionic strength of the solution they are dissolved in. At least one positively charged (dicationic) viologen subunit is present per oligoviologen sidechain (such that each repeating subunit carries at least two positive charges). In some embodiments, each Ad-terminated oligoviologen sidechain includes two dicationic viologen repeating subunits, such that each repeating subunit carries four positive charges. Depending on the embodiment, an increase in the number of viologen subunits beyond two may be required and/or desirable, as it would give more positive charges per oligoviologen sidechain.

In some aspects, one or more negatively charged compounds can be electrostatically loaded onto the second/‘guest’ PNB copolymer as it binds to the positive charges of the aforementioned oligoviologens. A negatively charged compound includes therapeutic drugs (including small-molecules), antibiotics, proteins, and oligonucleotides. A primary distinguishing factor for the copolymer system disclosed herein is that specific sidechain groups have been combined to induce crosslinking, while the positively charged oligoviologen sidechain groups give the copolymer complex its saltwater responsivity as well as the ability to respond to light via a novel photoredox mechanism discussed in greater detail herein below.

The copolymer complexes described herein can be synthesized with or without porphyrin-terminated sidechains. When present, porphyrin-terminated sidechains carry out light-responsive activation of the hydrogel form of the copolymer complex such that dynamic CD-Ad crosslinking junctions, viscosity, and stiffness is increased in light/photo-activated complexes as compared to the complex prior to light/photo-activation. In exemplary aspects, porphyrin-terminated sidechains include tetraphenyl porphyrin-terminated sidechains and can further include zinc-based porphyrins. Other metals may be used Many types of porphyrin structures can bind several types of metals. The present disclosure contemplates porphyrin-based derivatives that are metalated with a range of metals, as known in the art. This would cover all When absent, the copolymer complex is heat activatable, that is, enhanced adhesive and mechanical properties (crosslinking junctions, viscosity, stiffness, etc) result from exposing the hydrogel form of the copolymer complex to heat. All copolymers complexes described herein, either with or without porphyrin groups, exhibit saltwater responsiveness, strong adhesion, and injectability.

The copolymer complexes of the present disclosure are reversibly soluble depending on ionic strength of the surrounding solution. A copolymer complex of the present disclosure is present as a soluble copolymer complex in low ionic strength aqueous solutions, while the same copolymer complex is present as a hydrogel in high ionic strength aqueous solutions. In other words, the soluble copolymer complex dissolves into solution while the hydrogel copolymer complex is insoluble and precipitates out of solution (in exemplary embodiments, precipitation is rapid). The hydrogels of the present disclosure are adhesive to a wide variety of surfaces and are saltwater-stable. This process/relationship is fully reversible—the hydrogel can be redissolved to form the soluble copolymer complex upon lowering of the ionic strength of the solution, and the soluble copolymer complex can be rapidly precipitated to form the hydrogel by raising the ionic strength of the solution.

The ionic strength of the solution can be raised/increased and lowered/decreased by changing the salt concentration of the solution. Any salt known in the art to induce gelling may be used to increase ionic strength, including those salts known for “salting out” of proteins. The gelling/precipitation of the copolymer complexes of the present disclosure to form hydrogels is not dependent on the concentration of copolymer in the pre-gel solution or soluble copolymer complex. A low ionic strength aqueous solution can comprise a solution of zero/no ionic strength, i.e., deionized water. Solutions having ionic strengths of zero or greater that do not induce gelling/precipitation of the hydrogel form of the copolymer complex are considered to have low ionic strength for purposes of the present disclosure. Similarly, solutions having ionic strengths that do induce gelling and rapid precipitation of the copolymer complex are considered to have high ionic strength for purposes of the present disclosure. Depending on the embodiment, different salts/saline solutions may impart different thresholds of ionic strength for inducing gelation/precipitation. As nonlimiting examples, salts/saline solutions can include NaCl, KCl, phosphate buffered saline (PBS).

In methods of the present disclosure, the copolymer complex can be applied to a surface (including but not limited to high-density polyethylene (HDPE), stainless steel, glass, wood, and platinum) and serves as an adhesive coating for the surface once exposed to a high ionic strength solution to induce formation of the hydrogel form of the complex. Depending on the embodiment, drop cast saltwater-stable films can also be synthesized using the copolymer mixture dissolved in organic solvent(s), the resultant film is then saltwater stable and remains adhered to the original surface. As an example, the copolymer complex is initially synthesized by mixing the first and second (i.e., ‘host’ and ‘guest’) PNB-based bottlebrush copolymers in an organic solvent (including but not limited to methanol-based solutions), such that the copolymer complex dissolves into the organic solvent as a soluble copolymer complex. Low ionic strength conditions of the organic solvent enable solubility of the copolymer complex. This soluble copolymer complex is subsequently drop cast onto the surface, and followed by evaporation of the methanol which forms a film of the residual copolymer complex on the surface. Once this film-coated surface is dipped or submerged into a saltwater solution, the copolymer complex transitions to its hydrogel form and the surface becomes coated in the hydrogel owing to its adhesive properties. The hydrogel then remains stable and attached to the surface under static conditions (e.g., even if/when the surface is removed from the saltwater solution).

Other objects and features will be in part apparent and in part pointed out hereinafter.

### DESCRIPTION OF THE DRAWINGS

Those of skill in the art will understand that the drawings described herein are for illustrative purposes only. The drawings are not intended to limit the scope of the present teachings in any way.

FIG. 1(A-C): FIG. 1A is a graphical representation of the self-assembly of natural and synthetic hydrogels comprising bottlebrush polymers. Mucin proteins crosslinked by disulfide linkages (square/rectangular blocks). Oligosaccharide side chains are appended to the polypeptide backbone give a bottlebrush-like architecture, which aids hydrogel network formation. FIG. 1B is a schematic of dynamic host-guest molecular recognition between β-cyclodextrin (β-CD, host; cup-like shape) and adamantane (Ad, guest; cube-like shape). In H₂O, the equilibrium affinity constant (Kₐ) is on the order of 10⁴⁻⁵ M⁻¹. FIG. 1C is a schematic of the self-assembly of natural and synthetic hydrogels. Ring-opening metathesis polymerization (ROMP) of norbornene-based functional monomers in DMF yielded a set of bottlebrush supramolecular copolymers that, after dialysis, self-assembled 1:1 in saltwater (but not deionized H₂O) to afford a photo-responsive mucomimetic hydrogel with broad adhesive properties. Note: For copolymers A_{x, Pn} and Bₓ, the x and n values are summarized in Table 1 with detailed information on monomer units.

FIG. 2(A-B): FIG. 2A is a set of images comparing saltwater-induced gelation of copolymer mixtures A_{3, P1}+B₃, C_{1, P1}+B₃, C_{2, P1}+B₃ and D_{P1}+B₃ which were injected* separately into 10 mL deionized H₂O and 100 mM NaCl solutions at 50 mg·mL⁻¹. Screenshots are chosen from timepoints: before injection, during injection, immediately after injection and a while after injection. FIG. 2B is a graphical representation of statistical copolymers (A_{3, P1}) poly(2V⁴⁺Ad₃₀-TEG₉₀-ZnTPP)ₛₜₐₜ, (B₃) poly(CD₃₀-TEG₉₀)ₛₜₐₜ, (C_{1, P1}) poly(HexylAd₃₀-TEG₉₀-ZnTPP)ₛₜₐₜ, (C_{2, P1}) poly(TEGAd₃₀-TEG₉₀-ZnTPP)ₛₜₐₜ, and (D_{P1}) poly(2V⁴⁺Me₃₀-TEG₉₀-ZnTPP)ₛₜₐₜ. 18 G needle gauge was used for A_{3, P1}+B₃ and D_{P1}+B₃, while 16 G needle gauge was used for C_{1, P1}+B₃ and C_{2, P1}+B₃. Additionally, C_{2, P1}+B₃ were maintained at 4° C. in solution until injected.

FIG. 3(A-C): FIG. 3A is a schematic diagram illustrating the mechanism of water loss in response to rheological properties. FIG. 3B is a graph of rheology strain sweep experiments at 25° C. at a frequency of 1 rad·s⁻¹. FIG. 3C is a graph of rheology frequency sweep experiments at 25° C. at 1% strain. The hydrogels were prepared in an aqueous 100 mM NaCl solution at a concentration of 50 mg·mL⁻¹. All hydrogel samples were tested in triplicate pre- and post-heating. Hydrogel samples tested immediately after mixing are labeled as ‘Pre-heat’. Then, each hydrogel sample was heated to 80° C. and held at this temperature for 10 min, followed by cooling the sample back to 25° C., where it was held for an additional 10 min and tested again. This latter state was labeled as ‘Post-heat’.

FIG. 4(A-B): FIG. 4A is a set of images of copolymer mixtures, A_{3, P1}+B₃, applied to different surfaces (glass, metal, HDPE, Ham) in aqueous 100 mM NaCl solutions. All samples tested were prepared at a concentration of 30 mg·mL⁻¹. FIG. 4B is a representative graph of lap-shear adhesion tests of A_{3, P1}+B₃ hydrogels on different surfaces including glass, metal, high density polyethylene (HDPE), and ham after 24 h air dry. All samples tested were prepared at a concentration of 30 mg·mL⁻¹.

FIG. 5(A-F): FIG. 5A is a schematic of the chemical structures of hydrogel network components and corresponding proposed self-assembled structures after reduction of the oligoviologen subunits via the integrated zinc-tetraphenyl porphyrin (ZnTPP) photoredox catalyst and sacrificial reductant (TEOA, triethanolamine). FIG. 5B is a set of images of photoreduction process before irradiation (left), after irradiation (middle), and after rheological assessment (right). FIG. 5C is a graph of oscillatory shear rheology strain sweep data for three hydrogels (50 mg·mL⁻¹) at 25° C. and 1.0 rad·s⁻¹. Hydrogels were tested without light irradiation, 30 min blue light irradiation, and 60 min blue light irradiation. All hydrogels tested for rheology were prepared in an aqueous 3 mM TEOA/100 mM NaCl solution. FIG. 5D is a graph of oscillatory shear rheology strain sweep data for one hydrogel (50 mg·mL⁻¹) at 25° C. and 1.0 rad·s⁻¹. The hydrogel was tested in sequence without light irradiation, ten 15 min of blue light irradiation, and 30 min of blue light irradiation. All hydrogels tested for rheology were prepared in an aqueous 3 mM TEOA/100 mM NaCl solution. FIG. 5E is an illustration of the experimental setup and photoreduction process for lap-shear adhesion tests. FIG. 5F is a graph of lap-shear adhesion stress (kPa) vs extension (mm) for A_{3, P1}+B₃ hydrogels (30 mg·mL⁻¹) on glass with 3 h air dry (without light, bottom three spectra) and 3 h blue light irradiation (upper three spectra). All hydrogels tested for rheology were prepared in an aqueous 3 mM TEOA/100 mM NaCl solution.

FIG. 6 is an illustration of a chemical reaction resulting in Ad-Hexyl-OH (1). 1-Bromoadamantane (2.15 g, 10 mmol, 1 equiv.) and 1,6-Hexanediol (23.6 g, 200 mmol, 20 equiv.) were added into a round bottom flask. The reaction mixture was heated to 150° C. and refluxed for 18 h. After completion of the reaction, the crude mixture was dissolved in CH₂Cl₂ (150 mL), washed with 1 M HCl (30 mL) three times, and then washed with brine solution (30 mL). The organic layer was dried over Na₂SO₄ and concentrated. The compound was further purified by flash column chromatography (silica gel, 100:1 CH₂Cl₂:MeOH) to yield the desired compound 1 as a colorless oil (2.02 g, 80% yield). ¹H NMR (500 MHz, CDCl₃): δ_{H} 3.62 (t, J=6.6 Hz, 2H); 3.38 (t, J=6.7 Hz, 2H); 2.12 (s, 3H); 1.73 (d, J=2.8 Hz, 5H); 1.66-1.48 (m, 12H); 1.40-1.32 (m, 4H). ¹³C NMR (125 MHz, CDCl₃): δ_{C} 71.89, 63.05, 59.77, 41.73, 36.66, 32.86, 30.79, 30.64, 26.20, 25.73. MALDI-TOF: theoretical mass of C₁₆H₂₈O₂, 252.21; found: 275.39 for [M+Na]⁺.

FIG. 7 is an illustration of a chemical reaction resulting in Ad-Hexyl-Oms (2). Compound 1 (2.02 g, 8 mmol, 1 equiv.) and Et₃N (1.22 g, 1.7 mL, 12 mmol, 1.5 equiv.) were dissolved in CH₂Cl₂ (30 mL) and cooled to 0° C. Methanesulfonyl chloride (MsCl, 1.15 g, 0.8 mL, 10 mmol, 1.25 equiv.) was then added to the solution. The reaction mixture was stirred at room temperature for 12 h. Next, the reaction mixture was washed with 1 M HCl, saturated NaHCO₃ solution and brine (30 mL each). The compound was further purified by flash column chromatography (silica gel, pure CH₂Cl₂) to yield the desired compound 2 as a colorless oil (2.13 g, 80% yield). ¹H NMR (500 MHz, CDCl₃): δ_{H} 4.22 (t, J=6.6 Hz, 2H); 3.39 (t, J=6.6 Hz, 2H); 3.00 (s, 3H); 2.13 (s, 3H); 1.78-1.71 (m, 8H); 1.67-1.49 (m, 8H); 1.45-1.34 (m, 4H). ¹³C NMR (125 MHz, CDCl₃): δ_{C} 71.90, 70.24, 59.59, 41.78, 37.54, 36.68, 30.67, 30.64, 29.25, 25.91, 25.47. MALDI-TOF: theoretical mass of C₁₇H₃₀O₄S, 330.19; found: 353.23 for [M+Na]⁺.

FIG. 8 is an illustration of a chemical reaction resulting in Nb-Ethyl-OH (3). Cis-5-Norbornene-exo-2,3-dicarboxylic acid (10.01 g, 60.98 mmol, 1 equiv.), ethanolamine (5.55 g, 5.50 mL, 91.09 mmol, 1.5 equiv.), and Et₃N (1.23 g, 1.70 mL, 12.20 mmol, 0.2 equiv.) were dissolved in 150 mL of toluene and heated to reflux at 130° C. with a Dean Stark trap for 24 h. The organic solvent was removed, the crude material was redissolved in CH₂Cl₂, washed with 1 M HCl (2×50 mL) and with brine (50 mL). The organic layer was collected, dried by Na₂SO₄, and concentrated by rotary evaporation to yield the desired product 3 as a white solid (9.85 g, 78% yield). ¹H NMR (500 MHz, CDCl₃): δ_{H} 6.29 (t, J=1.8 Hz, 2H); 3.79-3.76 (m, 2H); 3.72-3.69 (m, 2H); 3.30-3.27 (m, 2H); 2.72 (d, J=1.3 Hz, 2H); 2.03 (s, 1H); 1.54-1.50 (m, 1H); 1.35 (d, J=9.9 Hz, 1H). ¹³C NMR (125 MHz, CDCl₃): δ_{C} 178.88, 137.97, 60.71, 48.05, 45.44, 42.94, 41.51.

FIG. 9 is an illustration of a chemical reaction resulting in NB-Ethyl-Oms (4). Compound 3 (5.54 g, 26.74 mmol, 1 equiv.) and Et₃N (4.07 g, 5.60 mL, 40.17 mmol, 1.5 equiv.) were dissolved in 85 mL of CH₂Cl₂. The solution was allowed to cool to 0° C. MsCl (4.74 g, 3.20 mL, 40.63 mmol, 1.5 equiv.) was slowly added to the cooled reaction mixture. The resulting solution was slowly warmed to room temperature and stirred for 12 h. After completion, the reaction mixture was washed in a separatory funnel with 1 M CH₃COOH (3×100 mL), saturated NaHCO₃ (2×100 mL), and brine (2×100 mL). The organic layers were collected, dried with Na₂SO₄, and concentrated by rotary evaporation. The product was purified by flash column chromatography (silica gel, 0-3% MeOH in CH₂Cl₂) to yield the desired compound 4 as a pale-yellow solid (5.92 g, 78% yield). ¹H NMR (500 MHz, CDCl₃): δ_{H} 6.28 (t, J=1.7 Hz, 2H); 4.38 (t, J=5.3 Hz, 2H); 3.82 (t, J=5.3 Hz, 2H); 3.28-3.25 (m, 2H); 3.00 (s, 3H); 2.72 (d, J=1.1 Hz, 2H); 2.02 (s, 1H); 1.54-1.50 (m, 1H); 1.27 (d, J=9.9 Hz, 1H). ¹³C NMR (125 MHz, CDCl₃): δ_{C} 177.83, 137.89, 65.02, 48.02, 45.29, 42.92, 38.00, 37.82. MALDI-TOF: theoretical mass of C₁₂H₁₅NO₅S, 285.07; found: 286.08 for [M+H]⁺, 308.07 for [M+Na]⁺.

FIG. 10 is an illustration of a chemical reaction resulting in Nb-1V·1PF₆ (5). Compound 4 (1.00 g, 3.50 mmol, 1 equiv.), 4,4′-bipyridine (10.95 g, 70.12 mmol, 20 equiv.), and KPF₆ (3.23 g, 17.54 mmol, 5 equiv.) were dissolved in 30 mL of toluene in a high-pressure flask equipped with a stir bar. The flask was heated at 120° C. for 16 h. After completion, the reaction mixture was allowed to cool to room temperature and concentrated by rotary evaporation. The crude product was redissolved in MeCN and transferred into 50 mL centrifuge tubes (˜5 mL per tube) and diluted to 45 mL with Et₂O. The tubes were centrifuged at 4500 rpm for 20 min. The supernatant was decanted away, the solid was re-dissolved in a minimal amount of MeCN and diluted to 45 mL with Et₂O. The previous two steps were repeated three times. The resulting product was converted to 5 by dissolving in H₂O followed by the addition of excess KPF₆. The product precipitate was collected by centrifugation. The supernatant was decanted away and the solid was re-washed with H₂O by centrifugation three times before drying under vacuum to yield the desired product 5 as a pale brown solid (1.61 g, 94% yield). ¹H NMR (500 MHz, (CD₃)₂SO): δ_{H} 9.28 (d, J=6.9 Hz, 2H); 8.88 (dd, J=4.5, 1.7 Hz, 2H); 8.64 (d, J=6.9 Hz, 2H); 8.06 (dd, J=4.5, 1.7 Hz, 2H); 6.28 (t, J=1.7 Hz, 2H); 4.82-4.77 (m, 2H); 4.05-4.01 (m, 2H); 3.03 (s, 2H); 2.67 (s, 2H); 1.35 (d, J=9.8 Hz, 1H); 1.15 (d, J=9.7 Hz, 1H). ¹³C NMR (125 MHz, (CD₃)₂SO): δ_{C} 177.41, 152.73, 151.07, 145.95, 140.53, 137.61, 125.16, 121.86, 58.62, 47.39, 44.39, 42.66, 38.79. MALDI-TOF: theoretical mass of C₂₁H₂₀F₆N₃O₂P, 346.16 for [M-PF₆]⁺; found: 346.21 for [M-PF₆]⁺.

FIG. 11 is an illustration of a chemical reaction resulting in Nb-1V·2PF₆ (6). Compound 5 (0.60 g, 1.23 mmol, 1 equiv.), dibromohexane (9.04 g, 5.70 mL, 37.05 mmol, 30 equiv.), and KPF₆ (1.15 g, 6.24 mmol, 5 equiv.) were dissolved in 20 mL of dry MeCN in a high-pressure flask equipped with a stir bar. The flask was heated at 80° C. and the reaction ran for 16 h. After completion, the reaction mixture was allowed to cool to room temperature. The crude product was transferred into 50 mL centrifuge tubes (˜5 mL per tube) and diluted to 45 mL with Et₂O. The tubes were centrifuged at 4500 rpm for 20 min. The supernatant was decanted away and the solid was re-dissolved in a minimal amount of MeCN and diluted to 45 mL with Et₂O. The previous two steps were repeated three times. The resulting product was converted to 6 by dissolving in H₂O followed by the addition of excess KPF₆. The product precipitate was collected by centrifugation. The supernatant was decanted and the solid was re-washed with H₂O by centrifugation three times before drying under vacuum to yield the desired product 6 as a pale brown solid (0.45 g, 46% yield). ¹H NMR (500 MHz, (CD₃)₂SO): δ_{H} 9.44 (d, J=6.8 Hz, 2H); 9.38 (d, J=6.8 Hz, 2H); 8.79 (dd, J=9.2, 6.9 Hz, 4H); 6.28 (s, 2H); 4.89-4.83 (m, 2H); 4.68 (t, J=7.4 Hz, 2H); 4.08-4.04 (m, 2H); 3.54 (t, J=6.7 Hz, 2H); 3.03 (s, 2H); 2.66 (s, 2H); 1.99 (dt, J=15.1, 7.6 Hz, 2H); 1.81 (dd, J=14.4, 7.0 Hz, 2H); 1.45 (dt, J=14.6, 7.2 Hz, 2H); 1.39-1.31 (m, 3H); 1.16 (d, J=9.7 Hz, 1H). ¹³C NMR (125 MHz, (CD₃)₂SO): δ_{C} 177.42, 148.96, 148.16, 146.50, 145.84, 137.63, 126.58, 126.34, 60.88, 59.23, 47.41, 44.38, 42.69, 38.83, 34.99, 31.89, 30.53, 26.90, 24.51. MALDI-TOF: theoretical mass of C₂₇H₃₂BrF₁₂N₃O₂P₂, 509.17 for [M-2PF₆]·⁺; found: 509.33 for [M-2PF₆]·⁺.

FIG. 12 is an illustration of a chemical reaction resulting in Nb-2V·3PF₆ (7). Compound 6 (0.53 g, 0.67 mmol, 1 equiv.), 4,4′-bipyridine (3.13 g, 20.03 mmol, 30 equiv.), and KPF₆ (0.62 g, 3.33 mmol, 5 equiv.) were dissolved in 20 mL of MeCN in a high-pressure flask equipped with a stir bar. The flask was heated at 80° C. and the reaction ran for 16 h. After completion, the reaction mixture was allowed to cool to room temperature. The crude product was transferred into 50 mL centrifuge tubes (˜5 mL per tube) and diluted to 45 mL with Et₂O. The tubes were centrifuged at 4500 rpm for 20 min. The supernatant was decanted away and the solid was re-dissolved in a minimal amount of MeCN and diluted to 45 mL with Et₂O. The previous two steps were repeated three times. The resulting product was converted to 7 by dissolving in H₂O followed by the addition of excess KPF₆. The product precipitate was collected by centrifugation. The supernatant was decanted and the solid was re-washed with H₂O by centrifugation three times before drying under vacuum to yield the desired product 7 as a brown solid (0.43 g, 68% yield). ¹H NMR (500 MHz, (CD₃)₂SO): δ_{H} 9.46 (t, J=6.1 Hz, 2H); 9.36 (d, J=7.0 Hz, 2H); 9.21 (d, J=7.0 Hz, 2H); 8.89 (dd, J=4.5, 1.7 Hz, 2H); 8.83-8.77 (m, 4H); 8.64 (d, J=6.9 Hz, 2H); 8.04 (dd, J=4.5, 1.7 Hz, 2H); 6.30-6.27 (m, 2H); 4.89-4.84 (m, 2H); 4.65 (dt, J=23.1, 7.4 Hz, 4H); 4.09-4.04 (m, 2H); 3.02 (s, 2H); 2.67 (t, J=3.6 Hz, 2H); 1.98 (d, J=6.7 Hz, 4H); 1.37 (dd, J=12.4, 8.7 Hz, 5H); 1.16 (d, J=9.7 Hz, 1H). ¹³C NMR (125 MHz, (CD₃)₂SO): δ_{C} 177.45, 152.39, 150.99, 148.92, 148.22, 146.52, 145.82, 145.27, 140.87, 137.63, 126.57, 126.34, 125.40, 121.91, 60.84, 60.32, 59.26, 47.42, 44.39, 42.70, 38.85, 30.48, 30.41, 24.91. MALDI-TOF: theoretical mass of C₃₇H₄₀F₁₈N₅O₂P₃, 731.28 for [M-2PF₆]·⁺; found: 731.65 for[M-2PF₆]·⁺.

FIG. 13 is an illustration of a chemical reaction resulting in Nb-2V-Ad·4PF₆ (8). Compound 7 (376.3 mg, 0.37 mmol, 1 equiv.) and 2 (365.2 mg, 1.1 mmol, 3 equiv.) were dissolved in 3 mL solvent (2 mL MeCN+1 mL DMF) in a tube equipped with a stir bar. The tube was heated at 130° C. and the reaction ran for 16 h. After completion, the reaction mixture was allowed to cool to room temperature. The crude product was then dissolved in 5 mL MeCN, transferred into a 50 mL centrifuge tube, and diluted to 45 mL with Et₂O. The tube was centrifuged at 4500 rpm for 20 min. The supernatant was decanted away and the solid was re-dissolved in a minimal amount of MeCN and diluted to 45 mL with Et₂O. The previous two steps were repeated three times. The resulting product was converted to 8 by dissolving in H₂O followed by the addition of excess KPF₆. The product precipitate was collected by centrifugation. The supernatant was decanted and the solid was re-washed with H₂O by centrifugation three times before drying under vacuum to yield the desired product 8 as a brown solid (400 mg, 85% yield). ¹H NMR (500 MHz, (CD₃)₂SO): δ_{H} 9.45 (d, J=6.1 Hz, 2H); 9.40-9.33 (m, 6H); 8.84-8.73 (m, 8H); 6.28 (s, 2H); 4.87 (s, 2H); 4.68 (s, 6H); 4.06 (s, 2H); 3.03 (s, 2H); 2.67 (s, 2H); 2.07 (s, 3H); 2.00 (s, 6H); 1.64 (s, 6H); 1.56 (dd, J=27.4, 12.0 Hz, 7H); 1.37 (d, J=30.6 Hz, 12H); 1.17 (d, J=9.5 Hz, 1H). ¹³C NMR 6c 177.42, 148.88, 148.66, 148.51, 148.21, 146.51, 145.73, 137.62, 126.54, 126.32, 70.93, 60.98, 60.80, 59.25, 58.68, 47.40, 44.38, 42.68, 41.20, 40.11, 39.94, 39.78, 39.61, 38.85, 35.95, 30.73, 30.51, 29.89, 29.82, 25.32, 25.28, 24.97. MALDI-TOF: theoretical mass of C₅₃H₆₇F₂₄N₅O₃P₄, 966.50 for [M-3PF₆]⁺; found: 967.10 for [M-3PF₆]⁺.

FIG. 14 is an illustration of a chemical reaction resulting in Nb-2V-Ad·4Cl (9). Compound 8 (50 mg, 0.036 mmol, 1 equiv.) was dissolved in 1 mL MeCN in a centrifuge tube. Tetrabutylammonium chloride (TBACl, 240 mg, 0.864 mmol, 24 equiv.) was dissolved in a minimal amount of MeCN and added dropwise to the centrifuge tube. The product precipitate was collected by centrifugation. The supernatant was decanted and the solid was re-washed with MeCN by centrifugation five times before drying under vacuum to yield the desired product 9 as a brown solid. ¹H NMR (500 MHz, D₂O): δ_{H} 9.23 (d, J=6.1 Hz, 2H), 9.15 (d, J=5.0 Hz, 6H), 8.62-8.55 (m, 8H), 6.34 (s, 2H), 4.98 (s, 2H), 4.24 (s, 2H), 3.18 (s, 2H), 2.87 (s, 2H), 2.11 (m, 9H), 1.71 (s, 6H), 1.61 (d, J=11.9 Hz, 4H), 1.54 (d, J=14.3 Hz, 12H), 1.40 (s, 4H), 1.14 (d, J=10.0 Hz, 1H). ¹³C NMR (125 MHz, D₂O): δ_{C} 180.76, 150.99, 149.93, 149.83, 149.68, 146.01, 145.45, 137.64, 127.11, 127.01, 126.89, 126.85, 74.07, 62.17, 61.96, 61.93, 59.55, 59.50, 47.85, 44.88, 42.26, 40.62, 39.12, 35.58, 30.41, 30.39, 30.34, 30.22, 28.97, 24.86, 24.68. Compound 9 from the counter anion exchange process is not used for any polymerizations, it is only used as a reference monomer peak while running analytical GPC using H₂O as mobile phase.

FIG. 15 is an illustration of a chemical reaction resulting in Nb-2V-Me·4PF₆ (10). Compound 7 (600 mg, 0.59 mmol, 1 equiv.) and iodomethane (83.56 mg, 0.32 mL, 5.9 mmol, 10 equiv.) were dissolved in 15 mL of MeCN in a high-pressure flask equipped with a stir bar. The flask was heated at 80° C. and the reaction ran for 16 h. After completion, the reaction mixture was allowed to cool to room temperature. The crude product was transferred into 50 mL centrifuge tubes (˜5 mL per tube) and diluted to 45 mL with Et₂O. The tubes were centrifuged at 4500 rpm for 20 min. The supernatant was decanted away and the solid was re-dissolved in a minimal amount of MeCN and diluted to 45 mL with Et₂O. The previous two steps were repeated three times. The resulting product was converted to 10 by dissolving in H₂O followed by the addition of excess KPF₆. The product precipitate was collected by centrifugation. The supernatant was decanted and the solid was re-washed with H₂O by centrifugation three times before drying under vacuum to yield the desired product 10 as a yellow solid (548 mg, 90% yield). ¹H NMR (500 MHz, (CD₃)₂SO): δ_{H} 9.45 (d, J=6.7 Hz, 2H); 9.36 (t, J=6.3 Hz, 4H); 9.28 (d, J=6.6 Hz, 2H); 8.83-8.72 (m, 8H); 6.28 (s, 2H); 4.86 (s, 2H); 4.68 (s, 4H); 4.44 (s, 3H); 4.06 (s, 2H); 3.02 (s, 2H); 2.67 (s, 2H); 2.00 (s, 4H); 1.42-1.33 (m, 5H); 1.17 (d, J=9.8 Hz, 1H). ¹³C NMR (125 MHz, (CD₃)₂SO): δ_{C} 177.49, 148.96, 148.69, 148.28, 148.20, 146.65, 146.53, 145.83, 145.75, 137.66, 126.61, 126.55, 126.38, 126.10, 60.83, 59.29, 48.10, 47.44, 44.42, 42.72, 39.94, 39.78, 38.88, 30.53, 24.97. MALDI-TOF: theoretical mass of C₃₈H₄₃F₂₄N₅O₂P₄, 746.31 for [M-3PF₆]⁺; found: 746.75 for [M-3PF₆]⁺.

FIG. 16 is an illustration of a chemical reaction resulting in Nb-2V-Me·4Cl (11). Compound 10 (50 mg, 0.042 mmol, 1 equiv.) was dissolved in 1 mL MeCN in a centrifuge tube. TBACl (280 mg, 1.008 mmol, 24 equiv.) was dissolved in a minimal amount of MeCN and added dropwise to the centrifuge tube. The product precipitate was collected by centrifugation. The supernatant was decanted and the solid was re-washed with MeCN by centrifugation five times before drying under vacuum to yield the desired product 11 as a brown solid. ¹H NMR (500 MHz, D₂O): δ_{H} 9.23 (d, J=6.8 Hz, 2H), 9.15-9.12 (m, 4H), 9.07 (d, J=6.4 Hz, 2H), 8.61-8.52 (m, 8H), 6.34 (s, 2H), 4.95 (m, 2H), 4.52 (s, 3H), 4.26-4.22 (m, 2H), 3.18 (s, 2H), 2.87 (s, 2H), 2.13 (s, 4H), 1.53 (s, 5H), 1.14 (d, J=10.1 Hz, 1H). ¹³C NMR (125 MHz, D₂O): δ_{C} 180.77, 151.03, 150.06, 149.75, 149.68, 146.26, 146.00, 145.46, 145.36, 137.66, 127.15, 127.04, 126.95, 126.61, 61.97, 61.90, 59.49, 48.31, 47.86, 44.89, 42.29, 39.12, 30.36, 24.82. Compound 11 from the counter anion exchange process is not used for any polymerizations, it is only used as a reference monomer peak while running analytical GPC using H₂O as mobile phase.

FIG. 17 is an illustration of a chemical reaction resulting in Nb-Gly (12). Cis-5-Norbornene-exo-2,3-dicarboxylic anhydride (5.288 g, 0.032 mol, 1 equiv.) and glycine (2.418 g, 0.032 mmol, 1 equiv.) were added to a 14/20 neck, 50 mL round-bottom flask and heated to 160° C. for 30 min (melt). After completion, the crude reaction mixture was allowed to cool to room temperature to yield the desired compound 12 as a white solid without further purification (7.12 g, quantitative). ¹H NMR (500 MHz, CDCl₃): δ_{H} 6.30 (s, 2H); 4.27 (s, 2H); 3.31 (s, 2H); 2.76 (s, 2H); 1.60 (d, J=10.0 Hz, 1H); 1.50 (d, J=9.9 Hz, 1H). ¹³C NMR (125 MHz, CDCl₃): δ_{C} 177.38, 171.95, 138.11, 48.16, 45.55, 42.97, 39.27.

FIG. 18 is an illustration of a chemical reaction resulting in Nb—NHS (13). A mixture of dicyclohexylcarbodiimide (DCC, 8.11 g, 39.31 mmol, 1.3 equiv.) and 12 (6.689 g, 30.24 mmol, 1 equiv.) was dissolved in CH₂Cl₂ (anhydrous, 105 mL) and stirred at room temperature for 15 min until a precipitate formed. N-hydroxysuccinimide (NHS, 6.96 g, 60.48 mmol, 2 equiv.) was added to the precipitated solution and stirred at room temperature for 12 h. After filtration of DCU, the crude product was recrystallized with adequate amount of hot EtOAc to dissolve and cooled down in fridge to yield the product 13 as a white solid (8.18 g, 85% yield). ¹H NMR (500 MHz, CDCl₃): δ_{H} 6.30 (t, J=1.8 Hz, 2H); 4.57 (s, 2H); 3.39-3.26 (m, 2H); 2.83 (s, 4H); 2.78 (d, J=1.1 Hz, 2H); 1.61 (s, 2H); 1.56 (d, J=10.0 Hz, 1H), 1.51 (d, J=10.1 Hz, 1H). ¹³C NMR (125 MHz, CDCl₃): δ_{C} 176.46, 168.26, 163.26, 138.12, 48.16, 45.62, 43.00, 37.27, 25.67.

FIG. 19 is an illustration of a chemical reaction resulting in CD-Ots (14). A solution of NaOH (2.12 g, 52.9 mmol, 3 equiv.) in H₂O (8 mL) was added dropwise to a solution of purified β-cyclodextrin (β-CD, 20.0 g, 17.62 mmol, 1 equiv.) in H₂O (110 mL) and stirred for 1 h. A solution p-toluenesulfonyl chloride (TsCl, 3.70 g, 19.4 mmol, 1.1 equiv.) in MeCN (15 mL) was added dropwise and the reaction was stirred at room temperature for 3 h. After completion, the unwanted precipitate was filtered, and the pH of the filtrate was adjusted to 7 using 1 M HCl to yield a white solid. Hot H₂O (200 mL) was added and the resulting solution was stirred at 90° C. until the white solid dissolved, and the solution was cooled to 0-4° C. overnight. The resulting solid was collected by filtration and washed with cold H₂O to yield the desired compound 14 as a white solid (3.18 g, 14% yield). ¹H NMR (500 MHz, (CD₃)₂SO): δ_{H} 7.75 (d, J=8.3 Hz, 2H); 7.43 (d, J=8.3 Hz, 2H); 5.84-5.61 (m, 14H); 4.87-4.74 (m, 7H); 4.60-4.11 (m, 9H); 3.78-3.52 (m, 25H); 3.52-3.16 (m, 14H, overlap with H₂O), 2.42 (s, 3H). ¹³C NMR (125 MHz, (CD₃)₂SO): δ_{C} 144.65, 133.29, 129.90, 128.06, 79.91, 38.82, 36.85, 33.55, 27.97, 21.79. ESI-MS: theoretical mass of C₄₉H₇₆O₃₇S, 1288.38; found, 1289.38 for [M+H]⁺, 1311.36 for [M+Na]⁺, 667.18 for [M+2Na]²⁺.

FIG. 20 is an illustration of a chemical reaction resulting in CD-NH₂ (15). Compound 14 (1.00 g, 0.78 mmol, 1 equiv.) and ethylenediamine (excess, 9.00 g, 10 mL, 150 mmol, ˜100 equiv.) were dissolved in DMF (anhydrous, 10 mL) and heated to 80° C. for 16 h. After completion, the organic solvent and excess ethylenediamine were removed by rotary evaporator. The crude material was re-dissolved in a minimal amount of DMF, and added dropwise to Me₂CO (500 mL), The solid was filtered and washed with cold Me₂CO to yield the desired compound 15 as a white powder (0.82 g, 90% yield). ¹H NMR (500 MHz, D₂O): δ_{H} 5.04 (s, 7H); 3.97-3.79 (m, 28H); 3.65-3.50 (m, 14H); 2.87-2.67 (m, 4H). ¹³C NMR (125 MHz, (CD₃)₂SO): δ_{C} 101.94, 81.53, 73.05, 72.41, 72.03, 60.99, 59.95. ESI-MS: theoretical mass of C₄₄H₇₆N₂O₃₄, 1176.43; found, 1177.43 for [M+H]⁺, 589.21 for [M+2H]²⁺.

FIG. 21 is an illustration of a chemical reaction resulting in Nb-CD (16). Compound 13 (100 mg, 0.314 mmol, 1.05 equiv.) and 15 (352 mg, 0.299 mmol, 1 equiv.) were dissolved in DMF (anhydrous, 15 mL). Et₃N (0.045 g, 0.06 mL, 0.448 mmol, 1.5 equiv.) was added slowly and the resulting solution was stirred at room temperature for 72 h. After completion, the organic solvent and excess Et₃N were removed by rotary evaporator. The crude material was re-dissolved in a minimal amount of DMF and precipitated by the addition of Me₂CO. The solution and precipitate were transferred to a 50 mL centrifuge tube and was centrifuged at 4500 rpm and −10° C. for 45 min. The Me₂CO was carefully decanted away from the precipitate, the precipitate was re-dissolved in DMF and diluted to 50 mL with Me₂CO, and the mixture was centrifuged at 4500 rpm and −10° C. for 45 min. The previous two steps were repeated two more times to yield the desired compound 16 as a white powder (265 mg, 64% yield). ¹H NMR (500 MHz, (CD₃)₂SO): δ_{H} 8.11 (s, 1H); 6.31 (s, 2H); 5.84-5.69 (m, 14H); 4.88-4.79 (m, 7H); 4.45 (s, 6H); 3.97 (s, 2H); 3.71-3.26 (m, 42H, overlap with H₂O); 3.11 (s, 2H); 2.70 (s, 2H); 1.76 (d, J=9.2 Hz, 1H); 1.30 (d, J=9.4 Hz, 1H). ¹³C NMR (125 MHz, (CD₃)₂SO): δ_{C} 177.15, 177.10, 165.78, 137.80, 101.97, 83.18, 81.55, 73.06, 72.44, 72.01, 59.90, 48.47, 47.36, 44.67, 44.65, 42.48. ESI-MS: theoretical mass of C₅₅H₈₅N₃O₃₇, 1379.49; found, 1380.49 for [M+H]⁺, 701.74 for [M+Na+H]²⁺.

FIG. 22 is an illustration of a chemical reaction resulting in Nb-DCI (17). cis-5-Norbornene-exo-2,3-dicarboxylic anhydride (4.00 g, 24.40 mmol, 1 equiv.) and urea (2.932 g, 48.80 mmol, 2 equiv.) were added to a 14/20 neck, 25 mL round-bottom flask and heated to 140° C. for 4 h (melt). After completion of the reaction, H₂O (10 mL) was added, and the solution was heated until a homogeneous solution formed. The resulting solution was allowed to cool to room temperature and crystals were collected via filtration and washed several times with H₂O to yield the desired product 17 as a white, crystalline solid (3.40 g, 85% yield). ¹H NMR (500 MHz, CDCl₃): δ_{H} 6.28 (t, J=1.7 Hz, 2H); 3.29 (m, 2H); 2.74 (m, 2H); 1.57 (d, J=9.9 Hz, 1H); 1.46 (d, J=10.0 Hz, 1H). ¹³C NMR (125 MHz, CDCl₃): δ_{C} 178.26, 137.90, 49.32, 45.31, 43.06.

FIG. 23 is an illustration of a chemical reaction resulting in TEG-Ots (18). Tetraethylene glycol (39.375 g, 202.73 mmol, 4 equiv.) and Et₃N (10.157 g, 14 mL, 100.38 mmol, 2 equiv.) were dissolved in CH₂Cl₂ (250 mL) and cooled to 0° C. A solution of TsCl (9.00 g, 47.20 mmol, 1 equiv.) in CH₂Cl₂ (50 mL) was added. The resulting solution was stirred overnight. Then, the reaction mixture was washed with saturated K₂CO₃ solution, brine, and 1M HCl (125 mL each). The organic layer was dried over Na₂SO₄ and concentrated. The compound was further purified by flash column chromatography (silica gel, 100:1 CH₂Cl₂:MeOH) to yield the desired compound 18 as a colorless oil (10.88 g, 60% yield). ¹H NMR (500 MHz, CDCl₃): δ_{H} 7.78 (d, J=8.5 Hz, 2H); 7.33 (d, J=8.5 Hz, 2H); 4.16-4.13 (m, 2H); 3.71-3.57 (m, 14H); 2.52 (s, 1H); 2.43 (s, 3H). ¹³C NMR (125 MHz, CDCl₃): δ_{C} 144.93, 133.00, 129.92, 128.06, 72.55, 70.81, 70.73, 70.54, 70.39, 69.35, 68.78, 21.75. MALDI-TOF: theoretical mass of C₁₅H₂₄O₇S, 348.12; found: 349.19 for [M+H]⁺.

FIG. 24 is an illustration of a chemical reaction resulting in Nb-TEG (19). Compound 17 (3.01 g, 18.44 mmol, 1.1 equiv.) and Cs₂CO₃ (7.30 g, 83.09 mmol, 5 equiv.) were dissolved in DMF (anhydrous, 60 mL) and the solution was stirred at room temperature for 1 h. A solution of 18 (5.84 g, 16.76 mmol, 1 equiv.) in DMF (anhydrous, 20 mL) was added and stirred at room temperature for an additional 24 h. After completion, the reaction mixture was filtered and the DMF was removed. The crude was re-dissolved in CH₂Cl₂ (100 mL), washed with H₂O (30 mL), and dried over Na₂SO₄. The compound was further purified by flash column chromatography (silica gel, 100:1 CH₂Cl₂:MeOH) to yield the desired product 19 as a colorless oil (4.14 g, 72% yield). ¹H NMR (500 MHz, CDCl₃): δ_{H} 6.28-6.25 (m, 2H); 3.72-3.55 (m, 16H); 3.25 (s, 2H); 2.67 (s, 2H); 2.52 (s, 1H); 1.47 (d, J=10.0 Hz, 1H); 1.34 (d, J=10.0 Hz, 1H). ¹³C NMR (125 MHz, CDCl₃): δ_{C} 178.20, 137.93, 72.63, 70.76, 70.65, 70.45, 69.97, 67.07, 61.86, 47.93, 45.36, 42.84, 37.86. MALDI-TOF: theoretical mass of C₁₇H₂₅NO₆, 339.17; found: 340.35 for [M+H]⁺, 362.22 for [M+Na]⁺.

FIG. 25 is an illustration of a chemical reaction resulting in Nb-TEG-Ots (20). Compound 19 (720 mg, 2.12 mmol, 1 equiv.) and Et₃N (430 mg, 0.6 mL, 4.24 mmol, 2 equiv.) were dissolved in CH₂Cl₂ (15 mL) and cooled to 0° C. A solution of TsCl (809.8 mg, 4.24 mmol, 2 equiv.) in CH₂Cl₂ (10 mL) was added, and the resulting solution was stirred overnight. Then, the reaction mixture was washed with H₂O and brine (10 mL each), and the organic layer was dried over Na₂SO₄ and concentrated. The compound was further purified by flash column chromatography (silica gel, 100:1 CH₂Cl₂:MeOH) to yield the desired compound 20 as a colorless oil (1.03 g, 96% yield). ¹H NMR (500 MHz, CDCl₃): δ_{H} 7.78 (d, J=8.1 Hz, 2H); 7.33 (d, J=7.9 Hz, 2H); 6.27 (s, 2H); 4.16-4.12 (m, 2H); 3.69-3.51 (m, 14H); 3.25 (s, 2H); 2.66 (s, 2H); 2.44 (s, 3H); 1.46 (d, J=9.9 Hz, 1H); 1.34 (d, J=9.8 Hz, 1H). ¹³C NMR (125 MHz, CDCl₃): δ_{C} 178.11, 144.89, 137.94, 133.14, 129.93, 128.09, 70.84, 70.70, 70.66, 69.98, 69.35, 68.80, 67.03, 47.94, 45.39, 42.83, 37.85, 21.76. MALDI-TOF: theoretical mass of C₂₄H₃₁NO₈S, 493.18; found: 494.30 for [M+H]⁺, 516.30 for [M+Na]⁺.

FIG. 26 is an illustration of a chemical reaction resulting in TPP-OH (21). Benzaldehyde (8.60 g, 81 mmol, 3 equiv.) and 4-hydroxybenzaldehyde (3.30 g, 27 mmol, 1 equiv.) were dissolved in propionic acid (180 mL). This solution was heated to reflux at 140° C. for 30 min. Pyrrole (7.25 g, 108 mmol, 4 equiv.) was added dropwise to the solution under N₂. The reaction mixture was refluxed for 4 h and then allowed to cool to room temperature. Then, about half the volume of the reaction mixture was removed under reduced pressure and MeOH (250 mL) was added into the concentrated solution. The dark blue solution was stored overnight at 4° C. After filtration, the purple precipitate was collected and washed with cold MeOH. Crude product was dried under vacuum and subsequently purified by column chromatography using Hexanes:CH₂Cl₂ (1:1→0:1) as the eluent to yield the desired product 21 as a purple solid (0.85 g, 5% yield). ¹H NMR (500 MHz, CD₂Cl₂): δ_{H} 8.86 (m, 8H); 8.22 (m, 6H); 8.08 (m, 2H); 7.77 (m, 9H); 7.20 (m, 2H); −2.78 (s, 2H). ¹³C NMR (125 MHz, CD₂Cl₂): δ_{C} 155.54, 142.33, 142.31, 135.85, 134.87, 134.70, 127.84, 126.82, 120.23, 120.15, 113.82. MALDI-TOF: theoretical mass of C₄₄H₃₀N₄O, 630.24; found: 631.53 for [M+H]⁺.

FIG. 27 is an illustration of a chemical reaction resulting in Nb-TEG-ZnTPP (22). Compound 21 (0.334 g, 0.53 mmol, 1 equiv.), 20 (0.392 g, 0.8 mmol, 1.5 equiv.), and K₂CO₃ (0.732 g, 5.3 mmol, 10 equiv.) were dissolved in 15 mL dry DMF and refluxed at 70° C. under N₂ for 12 h. The mixture was then filtered, and the solvent was removed by rotary evaporation to give a purple residue, which was dissolved in CHCl₃ (50 mL) and washed with brine (3×50 mL) and then H₂O (2×50 mL). The combined organic phases were dried over anhydrous Na₂SO₄, filtered, concentrated by rotary evaporation, and purified by column chromatography using EtOAc as the eluent. The product collected from the previous column (0.2638 g, 0.28 mmol, 1 equiv.) and Zn(OAc)₂ (0.6146 g, 2.8 mmol, 10 equiv.) were dissolved in a (7:3) CHCl₃:MeOH mixture (15 mL) and stirred overnight in the dark. The reaction mixture was diluted with CHCl₃ (50 mL) and washed with H₂O (3×50 mL). The combined organic phases were dried over anhydrous Na₂SO₄, concentrated by rotary evaporation to yield the desired product 22 as a purple solid (418 mg, 78% yield). ¹H NMR (500 MHz, CD₂Cl₂): δ_{H} 9.00-8.93 (m, 8H); 8.22 (m, 6H); 8.11 (m, 2H); 7.77 (m, 8H); 7.27 (m, 2H); 6.20 (m, 2H); 4.30 (m, 2H); 3.87 (m, 2H); 3.65-3.45 (m, 12H); 3.02 (s, 2H); 2.42 (s, 2H); 1.36 (d, J=10 Hz, 2H); 1.18 (d, J=10 Hz, 2H). ¹³C NMR (125 MHz, CD₂Cl₂): δ_{C} 177.76, 158.64, 150.63, 150.27, 150.20, 142.91, 137.78, 135.51, 135.31, 134.52, 132.06, 131.93, 131.89, 127.53, 126.63, 121.11, 112.80, 70.78, 70.59, 70.45, 69.97, 69.86, 67.86, 66.78, 47.65, 45.24, 42.56, 37.71. MALDI-TOF: theoretical mass of C₆₁H₅₁N₅O₆Zn, 1013.31; found, 1013.19 for [M]⁺.

FIG. 28 is an illustration of a chemical reaction resulting in Nb-Hexyl-Ad (23). Compound 1 (0.227 g, 0.9 mmol, 1 equiv.) and compound 12 (0.4 g, 1.8 mmol, 2 equiv.) were dissolved in dry CH₂Cl₂ (10 mL) and cooled to 0° C. Then, EDC·HCl (0.5176 g, 2.7 mmol, 3 equiv.) and DMAP (0.0033 g, 0.27 mmol, 0.2 equiv.) were added into the solution, which was stirred overnight at room temperature for 12 h. After completion, the reaction mixture was washed with H₂O and brine (10 mL each), and the organic layer was dried over Na₂SO₄ and concentrated. The compound was further purified by flash column chromatography (silica gel, 100:1 CH₂Cl₂:MeOH) to yield the desired compound 23 as a white solid (0.302 g, 74% yield). ¹H NMR (500 MHz, CDCl₃): δ_{H} 6.31 (s, 2H); 4.22 (s, 2H); 4.13 (t, J=6.7 Hz, 2H); 3.38 (t, J=6.6 Hz, 2H); 3.32 (s, 2H); 2.75 (s, 2H); 2.14 (s, 3H); 1.74 (d, J=2.4 Hz, 6H); 1.66-1.57 (m, 9H); 1.52 (dd, J=10.2, 8.5 Hz, 3H); 1.37-1.33 (m, 4H). ¹³C NMR (125 MHz, CDCl₃): δ_{C} 177.28, 167.08, 138.13, 71.85, 66.17, 59.66, 48.16, 45.59, 43.01, 41.76, 39.59, 36.69, 30.70, 30.66, 28.58, 26.03, 25.79. MALDI-TOF: theoretical mass of C₂₇H₃₇NO₅, 455.27; found: 478.11 for [M+Na]⁺.

FIG. 29 is an illustration of a chemical reaction resulting in Nb-Me (24). Compound 17 (0.2 g, 1.23 mmol, 1 equiv.) and Cs₂CO₃ (0.802 g, 2.46 mmol, 2 equiv.) were dissolved in DMF and stirred for 30 min. Iodomethane (0.524 g, 0.23 mL, 3.69 mmol, 3 equiv.) was added and the resulting mixture was heated to 80° C. for 24 h. After completion of the reaction, the resulting unwanted precipitate was filtered, and the organic solvent was removed. The residual organic material was re-dissolved in CH₂Cl₂, washed with H₂O, and dried over Na₂SO₄ to yield the desired compound 24 as a white solid (198 mg, 91% yield). ¹H NMR (500 MHz, CDCl₃): δ_{H} 6.27-6.25 (m, 2H); 3.26-3.24 (m, 2H); 2.95 (s, 3H); 2.68 (s, 2H); 1.52-1.48 (m, 1H); 1.21-1.16 (m, 1H). ¹³C NMR (125 MHz, CDCl₃): δ_{C} 178.26, 137.86, 48.07, 45.25, 43.03, 24.73. ESI-MS: theoretical mass of C₁₀H₁₁NO₂, 177.08; found: 178.09 for [M+H]⁺.

FIG. 30 is an illustration of a chemical reaction resulting in Ad-TEG-OH (25). 1-Bromoadamantane (2.00 g, 9.3 mmol, 1 equiv.), tetraethylene glycol (45 g, 40 mL, excess equiv.), and Et₃N (2.18 g, 3.88 mL, 27.9 mmol, 3 equiv.) were added into a round bottom flask. The reaction mixture was heated to 150° C. and refluxed for 18 h. After completion of the reaction, the crude mixture was dissolved in CH₂Cl₂ (100 mL), washed with 1 M HCl (30 mL) two times, and then washed with brine solution (30 mL). The organic layer was dried over Na₂SO₄ and concentrated to yield the desired compound 25 as a dark brown oil (2.96 g, 96% yield). ¹H NMR (500 MHz, CDCl₃): δ_{H} 3.72 (s, 2H); 3.66 (m, 8H); 3.61-3.56 (m, 6H); 2.80 (s, 1H); 2.13 (s, 3H); 1.74 (s, 6H); 1.60 (q, J=12.2, 6H). ¹³C NMR (125 MHz, CDCl₃): δ_{C} 72.58, 72.31, 71.24, 70.59, 70.55, 70.52, 70.29, 61.68, 61.67, 59.22, 45.35, 41.40, 36.41, 36.06, 30.46. ESI-MS: theoretical mass of C₁₈H₃₂O₅, 328.22; found: 329.0 for [M+H]⁺, 350.9 for [M+Na]⁺, 175.7 for [M+Na]²⁺.

FIG. 31 is an illustration of a chemical reaction resulting in Nb-TEG-Ad (26). Compound 25 (0.256 g, 0.78 mmol, 1 equiv.) and compound 12 (0.345 g, 1.56 mmol, 2 equiv.) were dissolved in dry CH₂Cl₂ (10 mL) and cooled to 0° C. Then, EDC·HCl (0.449 g, 2.34 mmol, 3 equiv.) and DMAP (0.0286 g, 0.234 mmol, 0.3 equiv.) were added into the solution, which was stirred overnight at room temperature for 12 h. After completion, the reaction mixture was concentrated by rotary evaporation, and then further purified by flash column chromatography (silica gel, 100:1 CH₂Cl₂:MeOH) to yield the desired compound 26 as a pale-yellow oil (0.364 g, 88% yield). ¹H NMR (500 MHz, CDCl₃): δ_{H} 6.30 (t, J=1.7 Hz, 2H), 4.29 (dd, J=5.5, 4.0 Hz, 2H), 4.26 (s, 2H), 3.69 (dd, J=5.5, 4.0 Hz, 2H), 3.67-3.63 (m, 8H), 3.58 (dd, J=6.2, 3.5 Hz, 4H), 3.33-3.30 (m, 2H), 2.75 (d, J=0.9 Hz, 2H), 2.13 (s, 3H), 1.73 (d, J=2.8 Hz, 6H), 1.60 (q, J=12.2 Hz, 7H), 1.52 (dd, J=8.7, 1.3 Hz, 1H). ¹³C NMR (125 MHz, CDCl₃): δ_{C} 177.08, 166.94, 137.97, 72.23, 71.26, 70.65, 70.63, 70.58, 70.55, 68.76, 64.90, 59.23, 48.00, 45.42, 42.85, 41.46, 39.40, 36.44, 30.48. ESI-MS: theoretical mass of C₂₉H₄₁NO₈, 531.28; found: 554.3 for [M+Na]⁺.

FIG. 32 is an illustration of a chemical reaction (top) and a table (bottom) of units for statistical copolymer A (poly(2V⁴⁺Ad₃₀-TEG₉₀-ZnTPP). A solution of modified G3 was freshly prepared in DMF. G3 (0.0595 mL, 0.86 mg, 1.19 μmol, 1 equiv.) was added to a solution of 8 (50.1 mg, 35.7 μmol, 30 equiv.), 19 (36.4 mg, 107.2 μmol, 90 equiv.), and 22 (1.21 mg, 1.19 μmol, 1 equiv.) in 1.370 mL DMF to give G3:8 ratio of 1:30 and a 0.025 M concentration of 8. The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL H2O to remove the excess EVE and DMF. The dialysis continued for 12 h with H₂O and was then switched to 500 mL saturated NaCl solution to do counter anion exchange from PF6− to Cl− for 6 h. After that, the solution in the beaker was switched back to 500 mL H2O, followed by changing the H2O every 12 h for a total of two more times. After dialysis, copolymer A3, P1 was lyophilized for 24 h to yield a purple solid (62.7 mg, 87% yield). The table summarizes the ratio of monomers incorporated into each specific copolymer.

FIG. 33 is an illustration of a chemical reaction (top) and a table (bottom) of units for statistical copolymer B (poly(CD₃₀-TEG₉₀)). A solution of modified Grubbs 3rd generation catalyst (G3) was freshly prepared in DMF. G3 (0.0479 mL, 0.69 mg, 0.96 μmol, 1 equiv.) was added to a solution of 16 (39.7 mg, 28.8 μmol, 30 equiv.) and 19 (29.3 mg, 86.3 μmol, 90 equiv.) in 1.103 mL DMF to give G3:16 ratio of 1:30 (the concentration of 16 in solution was 0.025 M). The resulting solution was stirred for 12 h at room temperature. After the polymerization went to completion, the reaction was quenched by addition of ethyl vinyl ether (EVE). Then, the reaction mixture was transferred to dialysis tubing (RC dialysis tubing, 1 kDa molecular weight cut-off, 38 mm flat-width), and was placed in a beaker with 500 mL H₂O to remove the excess EVE and DMF. The dialysis continued for 24 h and the H₂O was changed every 12 h. After dialysis, copolymer B₃ was lyophilized for 24 h to yield a pale-yellow solid (51.5 mg, 75% yield). The table summarizes the ratio of monomers incorporated into each specific copolymer.

FIG. 34 is an illustration of a chemical reaction for the statistical copolymer C1, _{P1}: poly(HexylAd₃₀-TEG₉₀-ZnTPP)ₛₜₐₜ. A solution of modified G3 was freshly prepared in DMF. G3 (0.0956 mL, 1.39 mg, 1.91 μmol, 1 equiv.) was added to a solution of 23 (26.1 mg, 57.3 μmol, 30 equiv.), 19 (58.4 mg, 172 μmol, 90 equiv.), and 22 (1.94 mg, 1.91 μmol, 1 equiv.) in 2.199 mL DMF to give G3:23 ratio of 1:30 and a 0.025 M concentration of 23. The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL H₂O to remove the excess EVE and DMF. The dialysis continued for 24 h and the H₂O was changed every 12 h. After dialysis, copolymer C_{1, P1} was lyophilized for 24 h to yield a pale-purple solid (79.5 mg, 90% yield).

FIG. 35 is an illustration of a chemical reaction for the statistical copolymer C_{2, P1}: poly(TEGAd₃₀-TEG₉₀-ZnTPP)ₛₜₐₜ. G3 (0.0797 mL, 1.15 mg, 1.59 μmol, 1 equiv.) was added to a solution of 26 (25.4 mg, 47.8 μmol, 30 equiv.), 19 (48.7 mg, 143 μmol, 90 equiv.), and 22 (1.62 mg, 1.59 μmol, 1 equiv.) in 1.833 mL DMF to give G3:26 ratio of 1:30 and a 0.025 M concentration of 26. The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL H₂O to remove the excess EVE and DMF. The dialysis continued for 24 h at 4° C. and the H₂O was changed every 12 h. After dialysis, copolymer C_{2, P1} was lyophilized for 24 h to yield a pale-purple solid (58.8 mg, 80% yield).

FIG. 36 is an illustration of a chemical reaction for the statistical copolymer D_{P1}: poly(2V⁴⁺Me₃₀-TEG₉₀-ZnTPP)ₛₜₐₜ. G3 (0.0711 mL, 1.03 mg, 1.42 μmol, 1 equiv.) was added to a solution of 10 (50.4 mg, 42.7 μmol, 30 equiv.), 19 (43.4 mg, 128.0 μmol, 90 equiv.), and 22 (1.44 mg, 1.42 μmol, 1 equiv.) in 1.635 mL DMF to give G3:10 ratio of 1:30 and a 0.025 M concentration of 10. The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL H₂O to remove the excess EVE and DMF. The dialysis continued for 12 h with H₂O and was then switched to 500 mL saturated NaCl solution to do counter anion exchange from PF₆⁻ to Cl⁻ for 6 h. After that, the solution in the beaker was switched back to 500 mL H₂O, followed by changing the H₂O every 12 h for a total of two more times. After dialysis, copolymer D_{P1} was lyophilized for 24 h to yield a purple solid (68.9 mg, 90% yield).

FIG. 37 is an illustration of a chemical reaction for the statistical copolymer E_{P1}: poly(TEG₁₂₀-ZnTPP)ₛₜₐₜ. G3 (0.0669 mL, 0.97 mg, 1.34 μmol, 1 equiv.) was added to a solution of 19 (54.5 mg, 160.6 μmol, 120 equiv.) and 22 (1.36 mg, 1.34 μmol, 1 equiv.) in 3.15 mL DMF to give G3:19 ratio of 1:120 and a 0.05 M concentration of 22. The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL H₂O to remove the excess EVE and DMF. The dialysis was continued for 24 h and the H₂O was changed every 12 h. After dialysis, copolymer E_{P1} was dried under vacuum to yield as a purple solid (43.3 mg, 76% yield).

FIG. 38 is an illustration of a chemical reaction for the statistical copolymer F_{P1}: poly(Me₁₂₀-ZnTPP)ₛₜₐₜ. G3 (0.119 mL, 1.72 mg, 2.37 μmol, 1 equiv.) was added to a solution of 24 (50.5 mg, 285.0 μmol, 120 equiv.) and 22 (2.41 mg, 2.37 μmol, 1 equiv.) in 5.58 mL DMF to give G3:24 ratio of 1:120 and a 0.05 M concentration of 24. The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL CH₂Cl₂ to remove the excess EVE and DMF. The dialysis continued for 24 h and the CH₂Cl₂ was changed every 12 h. After dialysis, copolymer F_{P1} was dried under vacuum to yield as a dark brown solid (45.6 mg, 83% yield).

FIG. 39 is a graph of nuclear magnetic resonance (¹H NMR) (500 MHz, 25° C., (CD₃)₂SO) spectrum for compound 8 (FIG. 13).

FIG. 40 is a graph of ¹H NMR (500 MHz, 25° C., (CD₃)₂SO) spectrum for compound 10 (FIG. 15).

FIG. 41 is a graph of ¹H NMR (500 MHz, 25° C., (CD₃)₂SO) spectrum for compound 16 (FIG. 21).

FIG. 42 is a graph of ¹H NMR (500 MHz, 25° C., (CD₃)₂SO) spectrum for compound 19 (FIG. 24).

FIG. 43 is a graph of ¹H NMR (500 MHz, 25° C., (CD₃)₂SO) spectrum for compound 22 (FIG. 27).

FIG. 44 is a graph of ¹H NMR (500 MHz, 25° C., (CD₃)₂SO) spectrum for compound 23 (FIG. 28).

FIG. 45 is a graph of ¹H NMR (500 MHz, 25° C., (CD₃)₂SO) spectrum for compound 26 (FIG. 31).

FIG. 46 is a graph of ¹H NMR (500 MHz, 25° C., (CD₃)₂SO) spectra of 19, 8, 22 and statistical copolymer A_{1, P1}. The rectangular box highlights the full conversion to polymer by disappearance of monomer olefin peaks.

FIG. 47 is a graph of ¹H NMR (500 MHz, 25° C., (CD₃)₂SO) spectra of 19, 8, 22 and statistical copolymer A_{2, P1}. The rectangular box highlights the full conversion to polymer by disappearance of monomer olefin peaks.

FIG. 48 is a graph of ¹H NMR (500 MHz, 25° C., (CD₃)₂SO) spectra of 19, 8 and statistical copolymer A_{3, P0}. The rectangular box highlights the full conversion to polymer by disappearance of monomer olefin peaks.

FIG. 49 is a graph of ¹H NMR (500 MHz, 25° C., (CD₃)₂SO) spectra of 19, 8, 22 and statistical copolymer A_{3, P1}. The rectangular box highlights the full conversion to polymer by disappearance of monomer olefin peaks.

FIG. 50 is a graph of ¹H NMR (500 MHz, 25° C., (CD₃)₂SO) spectra of 19, 8, 22 and statistical copolymer A_{3, P2}. The rectangular box highlights the full conversion to polymer by disappearance of monomer olefin peaks.

FIG. 51 is a graph of ¹H NMR (500 MHz, 25° C., (CD₃)₂SO) spectra of 19, 8, 22 and statistical copolymer A_{3, P4}. The rectangular box highlights the full conversion to polymer by disappearance of monomer olefin peaks.

FIG. 52 is a graph of ¹H NMR (500 MHz, 25° C., (CD₃)₂SO) spectra of 19, 8, 22 and statistical copolymer A_{4, P1}. The rectangular box highlights the full conversion to polymer by disappearance of monomer olefin peaks.

FIG. 53 is a graph of ¹H NMR (500 MHz, 25° C., (CD₃)₂SO) spectra of 19, 8, 22 and statistical copolymer A_{5, P1}. The rectangular box highlights the full conversion to polymer by disappearance of monomer olefin peaks.

FIG. 54 is a graph of ¹H NMR (500 MHz, 25° C., (CD₃)₂SO) spectra of 19, 16 and statistical copolymer B₁. The rectangular box highlights the full conversion to polymer by disappearance of monomer olefin peaks.

FIG. 55 is a graph of ¹H NMR (500 MHz, 25° C., (CD₃)₂SO) spectra of 19, 16 and statistical copolymer B₂. The rectangular box highlights the full conversion to polymer by disappearance of monomer olefin peaks.

FIG. 56 is a graph of ¹H NMR (500 MHz, 25° C., (CD₃)₂SO) spectra of 19, 16 and statistical copolymer B₃. The rectangular box highlights the full conversion to polymer by disappearance of monomer olefin peaks.

FIG. 57 is a graph of ¹H NMR (500 MHz, 25° C., (CD₃)₂SO) spectra of 19, 16 and statistical copolymer B₄. The rectangular box highlights the full conversion to polymer by disappearance of monomer olefin peaks.

FIG. 58 is a graph of 1H NMR (500 MHz, 25° C., (CD₃)₂SO) spectra of 19, 16 and statistical copolymer B₅. The rectangular box highlights almost full conversion to polymer by disappearance of monomer olefin peaks. Two runs of polymerizations were laid together to show the small amount of remaining monomers were slightly different for each run.

FIG. 59 is a graph of 1H NMR (500 MHz, 25° C., (CD₃)₂SO) spectra of 19, 16 and statistical copolymer B₆. The rectangular box highlights not full conversion to polymer by remaining monomer olefin peaks.

FIG. 60 is a graph of 1H NMR (500 MHz, 25° C., (CD₃)₂SO) spectra of 19, 16 and statistical copolymer B₇. The rectangular box highlights not full conversion to polymer by remaining monomer olefin peaks.

FIG. 61 is a graph of 1H NMR (500 MHz, 25° C., (CD₃)₂SO) spectra of 19, 16 and statistical copolymer B₈. The rectangular box highlights not full conversion to polymer by remaining monomer olefin peaks.

FIG. 62 is a graph of 1H NMR (500 MHz, 25° C., (CD₃)₂SO) spectra of statistical copolymers B. the rectangular box highlights the comparison of conversion to polymer between different statistical copolymers B.

FIG. 63 is a graph of 1H NMR (500 MHz, 25° C., (CD₃)₂SO) spectra of 19, 23, 22 and statistical copolymer C_{1, P1}. The rectangular box highlights the full conversion to polymer by disappearance of monomer olefin peaks.

FIG. 64 is a graph of 1H NMR (500 MHz, 25° C., (CD₃)₂SO) spectra of 19, 26, 22 and statistical copolymer C_{2, P1}. The rectangular box highlights the full conversion to polymer by disappearance of monomer olefin peaks.

FIG. 65 is a graph of 1H NMR (500 MHz, 25° C., (CD₃)₂SO) spectra of 19, 10, 22 and statistical copolymer DP₁. The rectangular box highlights the full conversion to polymer by disappearance of monomer olefin peaks.

FIG. 66 is a graph of 1H NMR (500 MHz, 25° C., (CD₃)₂SO) spectra of 19, 22 and statistical copolymer EP₁. The rectangular box highlights the full conversion to polymer by disappearance of monomer olefin peaks.

FIG. 67 is a graph of ¹H NMR (500 MHz, 25° C., (CD₃)₂SO) spectra of 24, 22 and statistical copolymer FP₁. The rectangular box highlights the full conversion to polymer by disappearance of monomer olefin peaks.

FIG. 68 is a graph of DOSY NMR (D₂O, 25° C.) of statistical copolymer A_{3, P1}.

FIG. 69 is a graph of DOSY NMR (D₂O, 25° C.) of statistical copolymer B₃.

FIG. 70 is a graph of DOSY NMR (D₂O, 25° C.) of statistical copolymer complex A_{3, P1}+B₃.

FIG. 71 is a set of graphs of isothermal titration calorimetry (ITC) of β-CD and solution 8 in H₂O (left) and 100 mM NaCl solution (right). Titrations were made in 5 μL aliquots with 25 total injections and at a stirring speed of 480 rpm. The concentration of the β-CD and 8 solutions were 0.5 and 20 mM, respectively. The solutions were prepared in either pure H₂O or 100 mM NaCl solution. All titrations were carried out at 25° C.

FIG. 72(A-D): FIG. 72A is a graph of gel permeation chromatography (GPC) traces of 19, 9 and statistical copolymer A_{1, P1}. PSS NOVEMA MAX Lux analytical 100 Å columns were used in tandem and H₂O mobile phase (0.025 M Na₂SO₄) running at 23° C. with 1.0 mL·min⁻¹ flow rate. FIG. 72B is a graph of GPC traces of 19, 9 and statistical copolymer A_{2, P1}. PSS NOVEMA MAX Lux analytical 100 Å columns were used in tandem and H₂O mobile phase (0.025 M Na₂SO₄) running at 23° C. with 1.0 mL·min⁻¹ flow rate. FIG. 72C is a graph of GPC traces of 19, 9 and statistical copolymer A_{3, P0}. PSS NOVEMA MAX Lux analytical 100 Å columns were used in tandem and H₂O mobile phase (0.025 M Na₂SO₄) running at 23° C. with 1.0 mL·min⁻¹ flow rate. FIG. 72D is a graph of GPC traces of 19, 9 and statistical copolymer A_{3, P1}. PSS NOVEMA MAX Lux analytical 100 Å columns were used in tandem and H₂O mobile phase (0.025 M Na₂SO₄) running at 23° C. with 1.0 mL·min⁻¹ flow rate.

FIG. 73(A-D): FIG. 73A is a graph of GPC traces of 19, 9 and statistical copolymer A_{3, P2}. FIG. 73B is a graph of GPC traces of 19, 9 and statistical copolymer A_{3, P4}. FIG. 73C is a graph of GPC traces of 19, 9 and statistical copolymer A_{4, P1}. FIG. 73D is a graph of GPC traces of 19, 9 and statistical copolymer A_{5, P1.}

FIG. 74 is a graph of GPC traces of statistical copolymers A_{1, P1}, A_{2, P1}, A_{3, P1}, A_{4, P1}, and A_{5, P1} (similar components with different units of monomers incorporated and increasing molecular weight theoretically).

FIG. 75 is a graph of GPC traces of statistical copolymers A_{3, P0}, A_{3, P1}, A_{3, P2}, and A_{3, P4} (copolymers with similar molecular weight theoretically but with different amounts of porphyrin incorporated per chain).

FIG. 76(A-E): FIG. 76A is a graph of GPC traces of 19, 16, and statistical copolymer B₁. FIG. 76B is a graph of GPC traces of 19, 16, and statistical copolymer B₂. FIG. 76C is a graph of GPC traces of 19, 16, and statistical copolymer B₃. FIG. 76D is a graph of GPC traces of 19, 16, and statistical copolymer B₄. FIG. 76E is a graph of GPC traces of 19, 16, and statistical copolymer B₅.

FIG. 77 is a graph of GPC traces of statistical copolymers B₁, B₂, B₃, B₄, and B₅ (similar components with different units of monomers incorporated and increasing molecular weight theoretically).

FIG. 78(A-C): FIG. 78A is a graph of GPC traces of 19 and statistical copolymer C_{1, P1}. FIG. 78B is a graph of GPC traces of 19, 11 and statistical copolymer D_{P1}. FIG. 78C is a graph of GPC traces of 19 and statistical copolymer E_{P1}.

FIG. 79 is a set of images illustrating the solubility for statistical copolymer C_{2, P1} at 4° C. (left), room temperature (RT, middle), and at 40° C. (right).

FIG. 80 is a graph of GPC traces of statistical copolymers C_{1, P1} and C_{2, P1}. Data was collected for C_{2, P1} by using two Shodex GPC KD-806M columns in sequence in DMF mobile phase (0.025 M LiBr) running at 60° C. at 1.0 mL·min⁻¹. Data was collected again for statistical copolymer C_{1, P1} on this column (DMF mobile phase) as a reference since C_{1, P1} and C_{2, P1} have similar molecular weight theoretically.

FIG. 81(A-D): FIG. 81A is a plot of the differential refractive index (dRI) vs concentration (0.1, 0.3, 0.5, 0.7, 0.9 mg/mL) of the statistical copolymer A_{3, P1} in a buffer (0.025 M Na₂SO₄ in H₂O). The samples were directly injected into the Optilab (U)T-rEX detector using a syringe pump (flow rate 0.33 mL·min⁻¹). The dRI signal was measured for each injection, and the slope of the dRI-concentration describes the dn/dc value of the polymer. FIG. 81B is a plot of dRI vs concentration (0.1, 0.3, 0.5, 0.7, 0.9 mg/mL) of the statistical copolymer B₃, in a buffer (0.025 M Na₂SO₄ in H₂O). FIG. 81C is a plot of dRI vs concentration (0.1, 0.3, 0.5, 0.7, 0.9 mg/mL) of the statistical copolymer C_{1, P1} in a buffer (0.025 M Na₂SO₄ in H₂O). FIG. 81D is a plot of dRI vs concentration (0.1, 0.3, 0.5, 0.7, 0.9 mg/mL) of the statistical copolymer D_{P1} in a buffer (0.025 M Na₂SO₄ in H₂O).

FIG. 82 is a plot of dRI vs concentration (0.1, 0.3, 0.5, 0.7, 0.9 mg/mL) of statistical copolymer C_{2, P1.}

FIG. 83 is a table of molecular weight and dispersity data for the different statistical copolymers (A_{3,P1}, B₃, C_{1,P1}, and D_{P1}) and determined using the GPC traces and dn/dc values.

FIG. 84 is a graph of UV-vis absorbance of the supernatant from copolymer mixture A_{3, P1}+B₃ at different time points. A pre-mixed solution of 15 mg A_{3, P1}+B₃ in 0.5 mL H₂O and a pre-mixed solution of 15 mg C_{1, P1}+B₃ in 0.5 mL H₂O were added to 100 mM NaCl solution (100 mL) separately. After the full injection of copolymer mixture into the bottle, 1 mL aliquots of the supernatant were taken to test the UV-vis absorbance at different time points. The detection by UV-vis spectroscopy is based on the absorbance of the porphyrin molecule (430 nm) integrated in the copolymer complex.

FIG. 85 is a graph of UV-vis absorbance of the supernatant from copolymer mixture C_{1, P1}+B₃ at different time points. Copolymer complex C_{1, P1}+B₃ will be partially dissolved in solution (with the peak showing up at 430 nm), followed by gradual precipitation (with the peak disappearing at 430 nm) but has some degradation, as evidenced by the emergence of an absorbance peak occurring at 634 nm.

FIG. 86 is a graph of UV-vis absorbance at 430 nm and 634 nm of the supernatant from copolymer mixture A_{3, P1}+B₃ and C_{1, P1}+B₃ at different time points.

FIG. 87(A-C): FIG. 87A is a set of representative images of H₂O droplets on metal (left), glass (middle), and HDPE (right). FIG. 87B is a set of representative images of copolymer A_{3, P1} on metal (left), glass (middle), and HDPE (right). FIG. 87C is a set of representative images of copolymer B₃ on metal (left), glass (middle), and HDPE (right).

FIG. 88(A-B): FIG. 88A is a set of representations images of copolymer mixture A_{3, P1}+B₃ on metal (left), glass (middle), and HDPE (right). FIG. 88B is a set of representations images of copolymer C_{1, P1} on metal (left), glass (middle), and HDPE (right).

FIG. 89 is a table summarizing the average contact angle values of H₂O and the copolymers of FIG. 87 and FIG. 88 on different surfaces (metal, glass, and HDPE).

FIG. 90(A-C): FIG. 90A is representative image of the copolymer complex A_{3, P1}+B₃ mixed at 25 mg/mL in different concentrations of NaCl solutions. FIG. 90B is representative image of the copolymer complex A_{3, P1}+B₃ mixed at 25 mg/mL in different concentrations of LiCl solutions. FIG. 90C is representative image of the copolymer complex A_{3, P1}+B₃ mixed at 25 mg/mL in different concentrations of KCl solutions.

FIG. 91 is a table summarizing different copolymer complex of A (1^{st} column) hydrogels and B (2nd column) hydrogels tested for rheology (3^{rd} column).

FIG. 92 is a schematic of a chemical reaction scheme showing host-guest complex using A_{3, P1}+B₃.

FIG. 93(A-F): FIG. 93A is a graph of oscillatory strain rheology of copolymer A_{3, P1}+B₃ in PBS at 25 mg/mL at 15° C. FIG. 93B is a graph of oscillatory strain rheology of copolymer A_{3, P1}+B₃ in PBS at 25 mg/mL at 25° C. FIG. 93C is a graph of oscillatory strain rheology of copolymer A_{3, P1}+B₃ in PBS at 50 mg/mL at 15° C. FIG. 93D is a graph of oscillatory strain rheology of copolymer A_{3, P1}+B₃ in PBS at 50 mg/mL at 25° C. FIG. 93E is a graph of oscillatory strain rheology of copolymer A_{3, P1}+B₃ in PBS at 75 mg/mL at 15° C. FIG. 93F is a graph of oscillatory strain rheology of copolymer A_{3, P1}+B₃ in PBS at 75 mg/mL at 25° C. FIG. 94(A-F):

FIG. 94(A-F): FIG. 94A is a graph of angular frequency rheology of A_{3, P1}+B₃ in PBS at 25 mg/mL at 15° C. FIG. 94B is a graph of angular frequency rheology of A_{3, P1}+B₃ in PBS at 25 mg/mL at 25° C. FIG. 94C is a graph of angular frequency rheology of A_{3, P1}+B₃ in PBS at 50 mg/mL at 15° C. FIG. 94D is a graph of angular frequency rheology of A_{3, P1}+B₃ in PBS at 50 mg/mL at 25° C. FIG. 94E is a graph of angular frequency rheology of A_{3, P1}+B₃ in PBS at 75 mg/mL at 15° C. FIG. 94F is a graph of angular frequency rheology of A_{3, P1}+B₃ in PBS at 75 mg/mL at 25° C.

FIG. 95(A-F): FIG. 95A is a graph of oscillatory strain rheology of A_{3, P1}+B₃ at 50 mg/mL in 50 mM NaCl at 15° C. (performed at 1 rad/s). FIG. 95B is a graph of oscillatory strain rheology of A_{3, P1}+B₃ at 50 mg/mL in 50 mM NaCl at 25° C. (performed at 1 rad/s). FIG. 95C is a graph of oscillatory strain rheology of A_{3, P1}+B₃ at 50 mg/mL in 100 mM NaCl at 15° C. (performed at 1 rad/s). FIG. 95D is a graph of oscillatory strain rheology of A_{3, P1}+B₃ at 50 mg/mL in 100 mM NaCl at 25° C. (performed at 1 rad/s). FIG. 95E is a graph of oscillatory strain rheology of A_{3, P1}+B₃ at 50 mg/mL in 200 mM NaCl at 15° C. (performed at 1 rad/s). FIG. 95F is a graph of oscillatory strain rheology of A_{3, P1}+B₃ at 50 mg/mL in 200 mM NaCl at 25° C. (performed at 1 rad/s).

FIG. 96(A-F): FIG. 96A is a graph of angular frequency rheology of A_{3, P1}+B₃ at 50 mg/mL in 50 mM NaCl at 15° C. (preformed at 1% strain). FIG. 96B is a graph of angular frequency rheology of A_{3, P1}+B₃ at 50 mg/mL in 50 mM NaCl at 25° C. (preformed at 1% strain). FIG. 96C is a graph of angular frequency rheology of A_{3, P1}+B₃ at 50 mg/mL in 100 mM NaCl at 15° C. (preformed at 1% strain). FIG. 96D is a graph of angular frequency rheology of A_{3, P1}+B₃ at 50 mg/mL in 100 mM NaCl at 25° C. (preformed at 1% strain). FIG. 96E is a graph of angular frequency rheology of A_{3, P1}+B₃ at 50 mg/mL in 200 mM NaCl at 15° C. (preformed at 1% strain). FIG. 96F is a graph of angular frequency rheology of A_{3, P1}+B₃ at 50 mg/mL in 200 mM NaCl at 25° C. (preformed at 1% strain).

FIG. 97(A-F): FIG. 97A is a graph of oscillatory strain rheology (run 1) preformed at 1 rad/s of A_{1, P1}+B₁ at 50 mg/mL in 100 mM NaCl at 25° C. FIG. 97B is a graph of angular frequency (run 1) preformed at 1% strain of A_{1, P1}+B₁ at 50 mg/mL in 100 mM NaCl at 25° C. FIG. 97C is a graph of oscillatory strain rheology (run 2) preformed at 1 rad/s of A_{1, P1}+B₁ at 50 mg/mL in 100 mM NaCl at 25° C. FIG. 97D is a graph of angular frequency (run 2) preformed at 1% strain of A_{1, P1}+B₁ at 50 mg/mL in 100 mM NaCl at 25° C. FIG. 97E is a graph of oscillatory strain rheology (run 3) preformed at 1 rad/s of A_{1, P1}+B₁ at 50 mg/mL in 100 mM NaCl at 25° C. FIG. 97F is a graph of angular frequency (run 3) preformed at 1% strain of A_{1, P1}+B₁ at 50 mg/mL in 100 mM NaCl at 25° C.

FIG. 98(A-F): FIG. 98A is a graph of oscillatory strain rheology (run 1) preformed at 1 rad/s of A_{2, P1}+B₂ at 50 mg/mL in 100 mM NaCl at 25° C. FIG. 98B is a graph of angular frequency (run 1) preformed at 1% strain of A_{2, P1}+B₂ at 50 mg/mL in 100 mM NaCl at 25° C. FIG. 98C is a graph of oscillatory strain rheology (run 2) preformed at 1 rad/s of A_{2, P1}+B₂ at 50 mg/mL in 100 mM NaCl at 25° C. FIG. 98D is a graph of angular frequency (run 2) preformed at 1% strain of A_{2, P1}+B₂ at 50 mg/mL in 100 mM NaCl at 25° C. FIG. 98E is a graph of oscillatory strain rheology (run 3) preformed at 1 rad/s of A_{2, P1}+B₂ at 50 mg/mL in 100 mM NaCl at 25° C. FIG. 98F is a graph of angular frequency (run 3) preformed at 1% strain of A_{2, P1}+B₂ at 50 mg/mL in 100 mM NaCl at 25° C.

FIG. 99(A-F): FIG. 99A is a graph of oscillatory strain rheology (run 1) preformed at 1 rad/s of A_{3, P0}+B₃ at 50 mg/mL in 100 mM NaCl at 25° C. FIG. 99B is a graph of angular frequency (run 1) preformed at 1% strain of A_{3, P0}+B₃ at 50 mg/mL in 100 mM NaCl at 25° C. FIG. 99C is a graph of oscillatory strain rheology (run 2) preformed at 1 rad/s of A_{3, P0}+B₃ at 50 mg/mL in 100 mM NaCl at 25° C. FIG. 99D is a graph of angular frequency (run 2) preformed at 1% strain of A_{3, P0}+B₃ at 50 mg/mL in 100 mM NaCl at 25° C. FIG. 99E is a graph of oscillatory strain rheology (run 3) preformed at 1 rad/s of A_{3, P0}+B₃ at 50 mg/mL in 100 mM NaCl at 25° C. FIG. 99F is a graph of angular frequency (run 3) preformed at 1% strain of A_{3, P0}+B₃ at 50 mg/mL in 100 mM NaCl at 25° C.

FIG. 100(A-F): FIG. 100A is a graph of oscillatory strain rheology (run 1) preformed at 1 rad/s of A_{3, P1}+B₃ at 50 mg/mL in 100 mM NaCl at 25° C. FIG. 100B is a graph of angular frequency (run 1) preformed at 1% strain of A_{3, P1}+B₃ at 50 mg/mL in 100 mM NaCl at 25° C. FIG. 100C is a graph of oscillatory strain rheology (run 2) preformed at 1 rad/s of A_{3, P1}+B₃ at 50 mg/mL in 100 mM NaCl at 25° C. FIG. 100D is a graph of angular frequency (run 2) preformed at 1% strain of A_{3, P1}+B₃ at 50 mg/mL in 100 mM NaCl at 25° C. FIG. 100E is a graph of oscillatory strain rheology (run 3) preformed at 1 rad/s of A_{3, P1}+B₃ at 50 mg/mL in 100 mM NaCl at 25° C. FIG. 100F is a graph of angular frequency (run 3) preformed at 1% strain of A_{3, P1}+B₃ at 50 mg/mL in 100 mM NaCl at 25° C.

FIG. 101(A-F): FIG. 101A is a graph of oscillatory strain rheology (run 1) preformed at 1 rad/s of A_{3, P2}+B₃ at 50 mg/mL in 100 mM NaCl at 25° C. FIG. 101B is a graph of angular frequency (run 1) preformed at 1% strain of A_{3, P2}+B₃ at 50 mg/mL in 100 mM NaCl at 25° C. FIG. 101C is a graph of oscillatory strain rheology (run 2) preformed at 1 rad/s of A_{3, P2}+B₃ at 50 mg/mL in 100 mM NaCl at 25° C. FIG. 101D is a graph of angular frequency (run 2) preformed at 1% strain of A_{3, P2}+B₃ at 50 mg/mL in 100 mM NaCl at 25° C. FIG. 101E is a graph of oscillatory strain rheology (run 3) preformed at 1 rad/s of A_{3, P2}+B₃ at 50 mg/mL in 100 mM NaCl at 25° C. FIG. 101F is a graph of angular frequency (run 3) preformed at 1% strain of A_{3, P4}+B₃ at 50 mg/mL in 100 mM NaCl at 25° C.

FIG. 102(A-F): FIG. 102A is a graph of oscillatory strain rheology (run 1) preformed at 1 rad/s of A_{3, P4}+B₃ at 50 mg/mL in 100 mM NaCl at 25° C. FIG. 102B is a graph of angular frequency (run 1) preformed at 1% strain of A_{3, P4}+B₃ at 50 mg/mL in 100 mM NaCl at 25° C. FIG. 102C is a graph of oscillatory strain rheology (run 2) preformed at 1 rad/s of A_{3, P4}+B₃ at 50 mg/mL in 100 mM NaCl at 25° C. FIG. 102D is a graph of angular frequency (run 2) preformed at 1% strain of A_{3, P4}+B₃ at 50 mg/mL in 100 mM NaCl at 25° C. FIG. 102E is a graph of oscillatory strain rheology (run 3) preformed at 1 rad/s of A_{3, P4}+B₃ at 50 mg/mL in 100 mM NaCl at 25° C. FIG. 102F is a graph of angular frequency (run 3) preformed at 1% strain of A_{3, P4}+B₃ at 50 mg/mL in 100 mM NaCl at 25° C.

FIG. 103(A-F): FIG. 103A is a graph of oscillatory strain rheology (run 1) preformed at 1 rad/s of A_{4, P1}+B₄ at 50 mg/mL in 100 mM NaCl at 25° C. FIG. 103B is a graph of angular frequency (run 1) preformed at 1% strain of A_{4, P1}+B₄ at 50 mg/mL in 100 mM NaCl at 25° C. FIG. 103C is a graph of oscillatory strain rheology (run 2) preformed at 1 rad/s of A_{4, P1}+B₄ at 50 mg/mL in 100 mM NaCl at 25° C. FIG. 103D is a graph of angular frequency (run 2) preformed at 1% strain of A_{4, P1}+B₄ at 50 mg/mL in 100 mM NaCl at 25° C. FIG. 103E is a graph of oscillatory strain rheology (run 3) preformed at 1 rad/s of A_{4, P1}+B₄ at 50 mg/mL in 100 mM NaCl at 25° C. FIG. 103F is a graph of angular frequency (run 3) preformed at 1% strain of A_{4, P1}+B₄ at 50 mg/mL in 100 mM NaCl at 25° C.

FIG. 104(A-F): FIG. 104A is a graph of oscillatory strain rheology (run 1) preformed at 1 rad/s of A_{5, P1}+B₅ at 50 mg/mL in 100 mM NaCl at 25° C. FIG. 104B is a graph of angular frequency (run 1) preformed at 1% strain of A_{5, P1}+B₅ at 50 mg/mL in 100 mM NaCl at 25° C. FIG. 104C is a graph of oscillatory strain rheology (run 2) preformed at 1 rad/s of A_{5, P1}+B₅ at 50 mg/mL in 100 mM NaCl at 25° C. FIG. 104D is a graph of angular frequency (run 2) preformed at 1% strain of A_{5, P1}+B₅ at 50 mg/mL in 100 mM NaCl at 25° C. FIG. 104E is a graph of oscillatory strain rheology (run 3) preformed at 1 rad/s of A_{5, P1}+B₅ at 50 mg/mL in 100 mM NaCl at 25° C. FIG. 104F is a graph of angular frequency (run 3) preformed at 1% strain of A_{5, P1}+B₅ at 50 mg/mL in 100 mM NaCl at 25° C.

FIG. 105(A-F): FIG. 105A is a graph of angular frequency (run 1) preformed at 1% strain of A_{3, P1}+B₃ at 50 mg/mL in 100 mM NaCl at 25° C. FIG. 105B is a graph of oscillatory strain rheology (run 1) preformed at 1 rad/s of A_{3, P1}+B₃ at 50 mg/mL in 100 mM NaCl at 25° C. FIG. 105C is a graph of angular frequency (run 2) preformed at 1% strain of A_{3, P1}+B₃ at 50 mg/mL in 100 mM NaCl at 25° C. FIG. 105D is a graph of oscillatory strain rheology (run 2) preformed at 1 rad/s of A_{3, P1}+B₃ at 50 mg/mL in 100 mM NaCl at 25° C.

FIG. 105E is a graph of angular frequency (run 3) preformed at 1% strain of A_{3, P1}+B₃ at 50 mg/mL in 100 mM NaCl at 25° C. FIG. 105F is a graph of oscillatory strain rheology (run 3) preformed at 1 rad/s of A_{3, P1}+B₃ at 50 mg/mL in 100 mM NaCl at 25° C. FIG. 106(A-E):

FIG. 106(A-E): FIG. 106A is a graph of oscillatory strain rheology (performed at 1 rad/s) at 50 mg/mL in 100 mM NaCl at 25° C. A_{1, P1}+B₁ hydrogels. FIG. 106B is a graph of oscillatory strain rheology (performed at 1 rad/s) at 50 mg/mL in 100 mM NaCl at 25° C. A_{2, P1}+B₂ hydrogels. FIG. 106C is a graph of oscillatory strain rheology (performed at 1 rad/s) at 50 mg/mL in 100 mM NaCl at 25° C. A_{2, P1}+B₂ hydrogels. FIG. 106D is a graph of oscillatory strain rheology (performed at 1 rad/s) at 50 mg/mL in 100 mM NaCl at 25° C. A_{4, P1}+B₄ hydrogels. FIG. 106E is a graph of oscillatory strain rheology (performed at 1 rad/s) at 50 mg/mL in 100 mM NaCl at 25° C. A_{5, P1}+B₅ hydrogels.

FIG. 107 is a table summarizing storage and loss moduli for different A_{n, P1}+Bₙ (n=1, 2, 3, 4 and 5) hydrogels.

FIG. 108(A-D): FIG. 108A is a graph of oscillatory strain rheology (performed at 1 rad/s) at 50 mg/mL in 100 mM NaCl at 25° C. A_{3, P0}+B₃ hydrogels. FIG. 108B is a graph of oscillatory strain rheology (performed at 1 rad/s) at 50 mg/mL in 100 mM NaCl at 25° C. A_{3, P1}+B_{3 2} hydrogels. FIG. 108C is a graph of oscillatory strain rheology (performed at 1 rad/s) at 50 mg/mL in 100 mM NaCl at 25° C. A_{3, P2}+B₃ hydrogels. FIG. 108D is a graph of oscillatory strain rheology (performed at 1 rad/s) at 50 mg/mL in 100 mM NaCl at 25° C. A_{3, P4}+B₃ hydrogels.

FIG. 109 is a table summarizing storage and loss moduli for different A_{3, Pn}+B₃ (n=0, 1, 2 and 4) hydrogels, where different units of porphyrin were incorporated per chain.

FIG. 110 is a set of images of the C_{1, P1}+B₃ for rheology tests showing the hydrogel as prepared on stage (left), before the test covering the gap (middle), and after the test (right).

FIG. 111(A-F): FIG. 111A is a graph of oscillatory strain rheology (run 1) preformed at 1 rad/s of C_{1, P1}+B₃ at 50 mg/mL in 100 mM NaCl at 25° C. FIG. 111B is a graph of angular frequency (run 1) preformed at 1% strain of C_{1, P1}+B₃ at 50 mg/mL in 100 mM NaCl at 25° C. FIG. 111C is a graph of oscillatory strain rheology (run 2) preformed at 1 rad/s of C_{1, P1}+B₃ at 50 mg/mL in 100 mM NaCl at 25° C. FIG. 111D is a graph of angular frequency (run 2) preformed at 1% strain of C_{1, P1}+B₃ at 50 mg/mL in 100 mM NaCl at 25° C. FIG. 111E is a graph of oscillatory strain rheology (run 3) preformed at 1 rad/s of C_{1, P1}+B₃ at 50 mg/mL in 100 mM NaCl at 25° C. FIG. 111F is a graph of angular frequency (run 3) preformed at 1% strain of C_{1, P1}+B₃ at 50 mg/mL in 100 mM NaCl at 25° C.

FIG. 112(A-G): FIG. 112A is a set of images of the C_{2, P1}+B₃ for rheology tests showing the hydrogel as prepared on stage (left), before the test covering the gap (middle), and after the test (right). FIG. 112B is a graph of oscillatory strain rheology (run 1) preformed at 1 rad/s of C_{2, P1}+B₃ at 50 mg/mL in 100 mM NaCl at 25° C. FIG. 112C is a graph of angular frequency (run 1) preformed at 1% strain of C_{2, P1}+B₃ at 50 mg/mL in 100 mM NaCl at 25° C. FIG. 112D is a graph of oscillatory strain rheology (run 2) preformed at 1 rad/s of C_{2, P1}+B₃ at 50 mg/mL in 100 mM NaCl at 25° C. FIG. 112E is a graph of angular frequency (run 2) preformed at 1% strain of C_{2, P1}+B₃ at 50 mg/mL in 100 mM NaCl at 25° C. FIG. 112F is a graph of oscillatory strain rheology (run 3) preformed at 1 rad/s of C_{2, P1}+B₃ at 50 mg/mL in 100 mM NaCl at 25° C. FIG. 112G is a graph of angular frequency (run 3) preformed at 1% strain of C_{2, P1}+B₃ at 50 mg/mL in 100 mM NaCl at 25° C.

FIG. 113(A-C): FIG. 113A is a graph of oscillatory strain rheology (performed at 1 rad/s) at 50 mg/mL in 100 mM NaCl at 25 β° C. for hydrogels A_{3, P1}+B₃. FIG. 113B is a graph of oscillatory strain rheology (performed at 1 rad/s) at 50 mg/mL in 100 mM NaCl at 25 β° C. for hydrogels C_{3, P1}+B₃. FIG. 113C is a graph of oscillatory strain rheology (performed at 1 rad/s) at 50 mg/mL in 100 mM NaCl at 25 β° C. for hydrogels C_{2, P1}+B₃.

FIG. 114 is a table summarizing storage and loss moduli for A_{3, P1}+B₃, C_{1, P1}+B₃, and C_{2, P1}+B₃ hydrogels.

FIG. 115 is a schematic of the photoreduction process.

FIG. 116(A-C): FIG. 116A is a set of images of the photoreduction testing process for the same A_{3, P1}+B₃ hydrogel. The images illustrate (from left to right) i) the test without irradiation, ii) the blue light irradiation process, iii) the test after 15 min irradiation, and iv) the test after an additional 15 min irradiation. FIG. 116B is a graph of angular frequency rheology (performed at 1% strain) of the A_{3, P1}+B₃ hydrogel under different conditions (pre-light, blue light 15 min, and blue light 30 min). FIG. 116C is a graph of oscillatory strain (performed at 1 rad/s) of the A_{3, P1}+B₃ hydrogel under different conditions (pre-light, blue light 15 min, and blue light 30 min).

FIG. 117(A-C): FIG. 117A a set of images of the photoreduction testing process for different A_{3, P1}+B₃ hydrogels. The images illustrate the hydrogel i) before irradiation, ii) during the blue light irradiation process, iii) after irradiation, and iv) after the test. FIG. 117B is a graph of angular frequency rheology (performed at 1% strain) of the A_{3, P1}+B₃ hydrogel under different conditions (pre-light, blue light 15 min, and blue light 30 min). FIG. 117C is a graph of oscillatory strain (performed at 1 rad/s) of the A_{3, P1}+B₃ hydrogel under different conditions (pre-light, blue light 15 min, and blue light 30 min).

FIG. 118 is a set of scanning electron microscopy (SEM) images of A_{3, P1}+B₃ in H₂O after air dried overnight at 1000×, 5000×, 10000×, 35000× magnification (from left to right).

FIG. 119 is a set of SEM images of A_{3, P1}+B₃ hydrogel (fresh) in 100 mM NaCl solution after air dried overnight (region 1) at 1000×, 5000×, 10000×, 35000× magnification (from left to right).

FIG. 120 is a set of SEM images of A_{3, P1}+B₃ hydrogel (fresh) in 100 mM NaCl solution after air dried overnight (region 2) at 1000×, 5000×, 10000×, 35000× magnification (from left to right).

FIG. 121 is a set of SEM images of A_{3, P1}+B₃ hydrogel (pre-made) in 100 mM NaCl solution after air dried overnight (region 2) at 1000×, 5000×, 10000×, 35000× magnification (from left to right).

FIG. 122(A-E): FIG. 122A is an image of the dual syringe method used to apply the hydrogel material onto a substrate. One syringe contained an aqueous 100 mM NaCl solution (0.5 mL), and the other syringe contained the copolymer mixture (A_{3, P1}+B₃) aqueous solution (0.5 mL). FIG. 122B is an image of the A_{3, P1}+B₃ hydrogel after being sandwiched between glass substrate and clamped with plastic clamps. FIG. 122C is an image of the A_{3, P1}+B₃ hydrogel after being sandwiched between steel substrate and clamped with plastic clamps. FIG. 122D is an image of the A_{3, P1}+B₃ hydrogel after being sandwiched between HDPE substrate and clamped with plastic clamps. FIG. 122E is an image of the A_{3, P1}+B₃ hydrogel after being sandwiched between ham and held together with a metal weight.

FIG. 123 is a table summarizing the curing protocols for lap-shear adhesion tests.

FIG. 124 is a set of images showing a solubility test of the copolymer A_{3, P1} and C_{1, P1} in H₂O at room temperature (left), after heating at 80° C. for 10 min (middle) and cooled back to room temperature (right).

FIG. 125(A-D): FIG. 125A is a graph of lap-shear adhesion test on glass of an aqueous 100 mM NaCl solution on glass using curing protocols from FIG. 123. FIG. 125B is a graph of lap-shear adhesion test on glass of the statistical copolymer E_{P1} in H₂O using curing protocols from FIG. 123. FIG. 125C is a graph of lap-shear adhesion test on glass of the statistical copolymer E_{P1} in aqueous 100 mM NaCl solution using curing protocols from FIG. 123. FIG. 125D is a graph of lap-shear adhesion test on glass of the statistical copolymer F_{P1} in CH₂Cl₂ using curing protocols from FIG. 123.

FIG. 126(A-D): FIG. 126A is a graph of lap-shear adhesion test on glass of A_{3, P1}+B₃ hydrogels in aqueous 100 mM NaCl solution using curing protocols from FIG. 123. FIG. 126B is a graph of lap-shear adhesion test on glass of A_{3, P1}+B₃ copolymer mixture in 90% CH₃OH and 10% H₂O using curing protocols from FIG. 123. FIG. 126C is a graph of lap-shear adhesion test on glass of A_{3, P1}+B₃ hydrogels in 100 mM NaCl in 90% CH₃OH and 10% H₂O using curing protocols from FIG. 123. FIG. 126D is a graph of lap-shear adhesion test on glass of three replicates of A_{3, P1}+B₃ hydrogels in aqueous 100 mM NaCl solution with curing protocol 1 (FIG. 123).

FIG. 127(A-B): FIG. 127A is a graph of lap-shear adhesion test on glass of C_{1, P1}+B₃ emulsion in H₂O using curing protocols from FIG. 123. FIG. 127B is a graph of lap-shear adhesion test on glass of C_{1, P1}+B₃ emulsion in aqueous 100 mM NaCl solution using curing protocols from FIG. 123.

FIG. 128(A-B): FIG. 128A is a graph of lap-shear adhesion test of A_{3, P1}+B₃ hydrogels in aqueous 100 mM NaCl solution on metal using pneumatic grips. Curing protocols from FIG. 123 were used. FIG. 128B is a graph of lap-shear adhesion test of A_{3, P1}+B₃ hydrogels in aqueous 100 mM NaCl solution on metal using wedge grips. Curing protocols from FIG. 123 were used.

FIG. 129(A-B): FIG. 129A is a graph of lap-shear adhesion test of A_{3, P1}+B₃ hydrogels in 100 mM NaCl in 90% CH₃OH and 10% H₂O on metal using pneumatic grips. Curing protocols from FIG. 123 were used. FIG. 129B is a graph of lap-shear adhesion test of A_{3, P1}+B₃ hydrogels in 100 mM NaCl in 90% CH₃OH and 10% H₂O on metal using wedge grips. Curing protocols from FIG. 123 were used.

FIG. 130(A-B): FIG. 130A is a graph of lap-shear adhesion test of C_{1, P1}+B₃ emulsion in aqueous 100 mM NaCl solution on metal using pneumatic grips. Curing protocols from FIG. 123 were used. FIG. 130B is a graph of lap-shear adhesion test of C_{1, P1}+B₃ emulsion in aqueous 100 mM NaCl solution on metal using wedge grips. Curing protocols from FIG. 123 were used.

FIG. 131 is a graph of lap-shear adhesion test of A_{3, P1}+B₃ hydrogels in aqueous 100 mM NaCl solution on HDPE, tested in triplicate and using curing protocols from FIG. 123.

FIG. 132 is a graph of lap-shear adhesion test of A_{3, P1}+B₃ hydrogels in 100 mM NaCl in 90% CH₃OH and 10% H₂O on HDPE, tested in triplicate and using curing protocols from FIG. 123.

FIG. 133 is a graph of lap-shear adhesion test of C_{1, P1}+B₃ emulsion in aqueous 100 mM NaCl solution on HDPE, tested in triplicate and using curing protocols from FIG. 123.

FIG. 134 is a graph of lap-shear adhesion test A_{3, P1}+B₃ hydrogels in aqueous 100 mM NaCl solution on ham, tested in triplicate and using curing protocols 1 from FIG. 123.

FIG. 135(A-B): FIG. 135A is a set of images of the experimental set up for the blue light irradiation process. FIG. 135B is a graph of lap-shear adhesion test of A_{3, P1}+B₃ hydrogels on glass with no light (bottom three spectra) and blue light (top three spectra) for 3 h.

FIG. 136 is a schematic illustration of antifouling and bactericidal polymer coatings against bacterial adhesion and biofilm formation (top). Illustrations of the self-assembled polymer network before (bottom, left) and after antibiotic loading is also shown (bottom, right).

FIG. 137 is a schematic illustrating ring-opening metathesis polymerization (ROMP) of norbornene-based functional monomers in DMF yielded a set of bottlebrush supramolecular copolymers A and B. After dialysis, a 1:1 mixture of A:B in 90% MeOH and 10% H₂O afforded a self-assembled polymer coating. Bactericidal properties were achieved after counter anion exchange with tazobactam and piperacillin anions.

FIG. 138(A-C): FIG. 138A is a set of representative confocal microscopy images of control (top) and polymer coated (A+B, bottom) glass coverslip at 20 min (left), 48 h (middle), and 96 h (left). FIG. 138B is a graph of the polymer film (A+B) thickness on a glass coverslip at different timepoints. FIG. 138C is a graph of the polymer film (A+B) height on a glass coverslip for control (darker shade/black) and polymer coated (lighter shade/grey) at different timepoints.

FIG. 139(A-E): FIG. 139A is a set of representative confocal microscopy images showing the biofilm height of no polymer film (control, left), polymer film (A+B, middle), and antibiotic-loaded polymer film (Aₜ+Aₚ+B, right) at 48 h. FIG. 139B is a graph of the thickness of polymer film (A+B) and antibiotic-loaded polymer film (Aₜ+Aₚ+B) at 0 h and 48 h. FIG. 139C is a graph of the biofilm height at 48 h for no polymer film, polymer film (A+B), and antibiotic-loaded polymer film (Aₜ+Aₚ+B). FIG. 139D is a graph of CFUs at 0, 24, and 48 h for no polymer film, polymer film (A+B), and antibiotic-loaded polymer film (Aₜ+Aₚ+B) with PAO1 ΔwspF Tn7 Gm::P(A1/04/03)::GFP (indicated as “PAO1 ΔwspF”). FIG. 139E is a graph of CFUs at 0, 24, and 48 h for no polymer film, polymer film (A+B), and antibiotic-loaded polymer film (Aₜ+Aₚ+B) with PAO1 ΔwspF ΔpelF Δpsl ΔalgD Tn7 Gm::P(A1/04/03)::GFP (indicated as “PAO1 ΔwspF ΔEPS”).

FIG. 140(A-E): FIG. 140A is a graphical representation of the release of antibiotics via counter anion exchange for antibiotic-loaded polymer film (Aₜ+Aₚ+B). FIG. 140B is a graph of antibiotic release at 0 h, 0-0.5 h, and 0.5-1 h of a solution with antibiotic-loaded polymer film (Aₜ+Aₚ+B). FIG. 140C is a graph of antibiotic release at 1-1.5 h, 1.5-2 h, 2-2.5 h and 2.5-3 h of a solution with antibiotic-loaded polymer film (Aₜ+Aₚ+B). FIG. 140D is a graph of antibiotic release at 3-4 h and 4-5 h of a solution with antibiotic-loaded polymer film (Aₜ+Aₚ+B). FIG. 140E is a graph of antibiotic release at 5-6 h, 6-8 h, and 8-10 h of a solution with antibiotic-loaded polymer film (Aₜ+Aₚ+B).

FIG. 141 is a graph of ¹H NMR (500 MHz, 25° C., (CD₃)₂SO) spectrum for compound 8.

FIG. 142 is a graph of ¹H NMR (500 MHz, 25° C., (CD₃)₂SO) spectrum for compound 16.

FIG. 143 is a graph of ¹H NMR (500 MHz, 25° C., (CD₃)₂SO) spectrum for compound 19.

FIG. 144 is a graph of ¹H NMR (500 MHz, 25° C., (CD₃)₂SO) spectrum for compound 22.

FIG. 145 is a graph of ¹H NMR (500 MHz, 25° C., (CD₃)₂SO) spectra of 19, 8, and statistical copolymer A₀. The rectangular box highlights the full conversion to polymer by disappearance of monomer olefin peaks.

FIG. 146 is a graph of ¹H NMR (500 MHz, 25° C., (CD₃)₂SO) spectra of 19, 8, 22, and statistical copolymer A. The rectangular box highlights the full conversion to polymer by disappearance of monomer olefin peaks.

FIG. 147 is a graph of ¹H NMR (500 MHz, 25° C., (CD₃)₂SO) spectra of 19, 16, and statistical copolymer B. the rectangular box highlights the full conversion to polymer by disappearance of monomer olefin peaks.

FIG. 148 is a graph of ¹H NMR (500 MHz, 25° C., (CD₃)₂SO) spectrum of tazobactam loaded statistical copolymer Aₜ. Each charged viologen side chain contained four positive charges and should bind to four tazobactam anions if fully loaded, when correlated with NMR integration, proton resonances a and b should be 8, and resonances c, d, e should be 4, 4, 12, respectively. By the integration shown above, copolymer A₁ is about 60% loaded with tazobactam anion.

FIG. 149 is a graph of ¹H NMR (500 MHz, 25° C., (CD₃)₂SO) spectrum of piperacillin loaded statistical copolymer Aₚ. Each charged viologen side chain contained four positive charges and should bind to four piperacillin anions if fully loaded, when correlated with NMR integration, proton resonances a and b should be 8, and resonances c, d, e should be 4, 4, 4, respectively. By the integration shown above, copolymer Aₚ is about 45% loaded with piperacillin anion.

FIG. 150(A-C): FIG. 150A is a graph of GPC traces of 19, 9, and statistical copolymer A₀. FIG. 150B is a graph of GPC traces of 19, 9, and statistical copolymer A. FIG. 150C is a graph of GPC traces of 19, 16, and statistical copolymer B.

FIG. 151(A-H): FIG. 151A is an image of polymer film of a glass slide. FIG. 151B is a graph of profilometry, wherein a glass slide is coated with a polymer film. FIG. 151C is a graph of profilometry, wherein a glass slide is coated with a polymer film, dried for 1 day, is submerged in 100 mM NaCl solution until day 4. FIG. 151D is a graph of profilometry, wherein a glass slide is coated with a polymer film, dried for 1 day, is submerged in 100 mM NaCl solution until day 11. FIG. 151E is a graph of profilometry, wherein a glass slide is coated with a polymer film, dried for 1 day, is submerged in 100 mM NaCl solution until day 18. FIG. 151F is a graph of profilometry, wherein a glass slide is coated with a polymer film, dried for 1 day, is submerged in 100 mM NaCl solution until day 25. FIG. 151G is a graph of profilometry, wherein a glass slide is coated with a polymer film, dried for 1 day, is submerged in 100 mM NaCl solution until day 53. FIG. 151H is a graph of profilometry, wherein a glass slide is coated with a polymer film, dried for 1 day, is submerged in 100 mM NaCl solution until day 81.

FIG. 152 is a table summarizing the profilometry data for the three replicates of FIG. 151.

FIG. 153 is a graph summarizing the profilometry data for the three replicates of FIG. 151.

FIG. 154 is a set of SEM images of A+B in 90% CH₃OH and 10% H₂O after being air dried overnight. SEM images were taken at 1000×, 5000×, 10000, and 35000× magnification.

FIG. 155 a set of SEM images of Aₜ+Aₚ+B in 90% CH₃OH and 10% H₂O after being air dried overnight. SEM images were taken at 1000×, 5000×, 10000, and 35000× magnification.

FIG. 156(A-B): FIG. 156A is a graph of spectroscopic analysis of polymer film coating at fluorescence emission from 510 nm to 840 nm using an excitation of 488 nm.

FIG. 156B is a graph of spectroscopic analysis of polymer film coating at absorbance measurements from 300 to 850 nm.

FIG. 157 is a schematic for the flow cell set up. Polymer film (A+B) coated coverslips were prepared for flow cell experiments. PAO1 ΔwspF Tn7 Gm::P(A1/04/03)::GFP was struck out onto Luria Broth (LB) agar plates. The flow cell was connected, and the initial rate was set at 40 mL·h⁻¹ for 20 minutes. After 20 minutes, the flow rate was reduced to 10 mL·h⁻¹ and imaged using an upright Nikon confocal laser scanning microscope. At 48 h and 96 h, the flow cells were imaged again. On each day of imaging, three stills and three z-stack images were taken of the middle portion of the flow cells.

FIG. 158 is a set of confocal images of a flow cell experiment at 20 min (topo) and 96 h (bottom) using glass coverslips coated with polymer film A₀+B (no porphyrin included).

FIG. 159 is a set of representative z-stack images of glass coverslips without polymer coating (control) in flow cell experiments. Images were taken at 20 min (top), 48 h (middle), and 96 hours (bottom).

FIG. 160 is a set of representative z-stack images of polymer-coated glass coverslips in flow cell experiments. Images were taken at 20 min (top), 48 h (middle), and 96 hours (bottom).

FIG. 161 is a table summarizing the thickness of polymer film (A+B) on glass coverslip on at 20 min, 48 h, and 96 h.

FIG. 162 is a table summarizing the bacteria growth on glass coverslip without polymer coating at 20 min, 48 h, and 96 h.

FIG. 163 is a table summarizing bacteria growth on glass coverslip with polymer coating (A+B) at 20 min, 48 h, and 96 h.

FIG. 164 is a set of images of wells with no polymer coating (lane “a”), wells coated with polymer film (A+B) (lane “b”), and wells coated with antibiotic-loaded polymer film (Aₜ+Aₚ+B) (lane “c”). Images were taken from three replicates at 0 h, 24 h, 48 h, and after buffer wash.

FIG. 165 is a set of confocal microscopy images (replicate 1) of polymer film (A+B) and antibiotic-loaded polymer film (Aₜ+Aₚ+B) at 0 h; bacteria growth of no polymer film, polymer film (A+B) and antibiotic-loaded polymer film (Aₜ+Aₚ+B) at 48 h.

FIG. 166 is a set of confocal microscopy images (replicate 2) of polymer film (A+B) and antibiotic-loaded polymer film (Aₜ+Aₚ+B) at 0 h; bacteria growth of no polymer film, polymer film (A+B) and antibiotic-loaded polymer film (Aₜ+Aₚ+B) at 48 h.

FIG. 167 is a set of confocal microscopy images (replicate 3) of polymer film (A+B) and antibiotic-loaded polymer film (Aₜ+Aₚ+B) at 0 h; bacteria growth of no polymer film, polymer film (A+B) and antibiotic-loaded polymer film (Aₜ+Aₚ+B) at 48 h.

FIG. 168 is a table summarizing the thickness of polymer film (A+B) in well plates at 0 h and 48 h, from FIG. 164.

FIG. 169 is a table summarizing the thickness of antibiotic-loaded polymer film (Aₜ+Aₚ+B) in well plates at 0 h and 48 h, from FIG. 164.

FIG. 170 is a table summarizing bacteria growth (PAO1 ΔwspF) at 48 h for no polymer film, polymer film (A+B) and antibiotic-loaded polymer film (Aₜ+Aₚ+B) in well plates, from FIG. 164.

FIG. 171 is a table summarizing bacteria growth (PAO1 ΔwspF ΔEPS) at 48 h for no polymer film, polymer film (A+B) and antibiotic-loaded polymer film (Aₜ+Aₚ+B) in well plates, from FIG. 164.

FIG. 172 is a set of graphs of CFUs from three biological replicates of PAO ΔwspF 1 (top) and PAO1 ΔwspF ΔEPS (bottom) at 0 h, 24 h, and 48 h for no polymer film (left-most column for each time point), polymer film (A+B, middle column for each time point), and antibiotic-loaded polymer film (Aₜ+Aₚ+B, right-most column for each time point).

FIG. 173 is a set of confocal microscopy images of control experiments in the well plate:polymer film (A+B) with bacteria in PBS, polymer film (A+B) without bacteria in TSB, no polymer film with bacteria in PBS, and no polymer film with bacteria in TSB.

FIG. 174 is a graph of optical density (OD) at 600 nm measuring the release of antibiotics at 0 h, 0-4 h, 4-8 h, 8-12 h, 12-24 h, and 24-48 h from an antibiotic-loaded polymer film (Aₜ+Aₚ+B).

FIG. 175 is a graph of OD at 600 nm of three replicates measuring the release of antibiotics at 0 h, 0-0.5 h, and 0.5-1 h from an antibiotic-loaded polymer film (Aₜ+Aₚ+B).

FIG. 176 is a graph of OD at 600 nm of three replicates measuring the release of antibiotics at 1-1.5 h, 1.5-2 h, and 2-2.5 h from an antibiotic-loaded polymer film (Aₜ+Aₚ+B).

FIG. 177 is a graph of OD at 600 nm of three replicates measuring the release of antibiotics at 2.5-3 h, 3-4 h, and 4-5 h from an antibiotic-loaded polymer film (Aₜ+Aₚ+B).

FIG. 178 is a graph of OD at 600 nm of three replicates measuring the release of antibiotics at 5-6 h, 6-8 h, and 8-10 h from an antibiotic-loaded polymer film (Aₜ+Aₚ+B).

FIG. 179 is a graph of OD at 600 nm of three replicates measuring the release of antibiotics at 10-12 h, 12-24 h, and 24-48 h from an antibiotic-loaded polymer film (Aₜ+Aₚ+B).

### DETAILED DESCRIPTION

As disclosed herein, a synthetic protocol has developed for the fabrication of rapidly photocurable and saltwater-stable injectable hydrogels and coatings with versatile adhesive properties. Self-assembled hydrogels were prepared by mixing two polynorbornene (PNB)-based bottlebrush copolymers, each of which were synthesized through ring-opening metathesis polymerization (ROMP) of functional norbornene (Nb)-based monomers terminated by β-cyclodextrin (β-CD) and adamantane (Ad) groups, respectively. Formation of host-guest inclusion complexes between the ‘host’ β-CD and ‘guest’ Ad groups in H₂O resulted in soluble polymer networks that only gelled once the copolymer mixture was exposed to a high ionic strength solution. The lack of gelation in deionized H₂O resulted from the Ad group being tethered to a PNB backbone via polar oligoviologen dimer linkers bearing four positive charges per repeat subunit. Only upon introduction to a saline environment did the network rapidly precipitate to form a viscous stimuli-responsive hydrogel. This unique gelation mechanism is akin to the “salting out” of proteins and was not dependent on the concentration of polymer in the pre-gel solution. Moreover, a zinc-based tetraphenyl porphyrin photocatalyst was introduced as a side chain in the ‘guest’ copolymer containing Ad groups. The appended porphyrin's function was two-fold: i) to tune the loss modulus (G″) and therefore tan δ (G″/G′) of the hydrogel; and ii) to serve as a photocatalyst capable of transferring an electron to the electron-deficient oligoviologen side chains upon absorption of visible light, the latter of which resulted in contraction and stiffening of the self-assembled network by way of a viologen-based radical molecular recognition mechanism. A library of structural analogues was synthesized, and the corresponding viscous hydrogels (G″>G′) were fabricated and tested on polar and non-polar surfaces (i.e., glass, metal, and HDPE) to evaluate their broad adhesive properties pre/post-heat-curing and in response to blue light. Notably, heat activation and photo-activation of the hydrogels ‘switched on’ elastic (G′>G″) and shear-thinning properties and increased its adhesive strength, as H₂O was removed from the hydrogel either through direct evaporation or through the photo-induced contraction mechanism, respectively.

Considering the high affinity of the hydrogels for so many substrates (e.g., apart from tissue embodiments), including HDPE, antifouling properties were investigated on the basis of the polymer architecture. The unique gelation mechanism of the hydrogels only in saltwater and the versatile adhesive properties of the gels provided a way to form stable polymer coatings onto a surface (e.g., glass, metal, and HDPE) under buffered conditions (e.g., PBS, blood plasma, growth media). Furthermore, as the polymer has incorporated the polar viologen subunits as side chains, in some embodiments the chloride (Cl−) counter anions can be exchanged to other negatively charged cargos/compounds, such as antibiotics (e.g., piperacillin and tazobactam). A negatively charged compound includes therapeutic drugs (including small-molecules), antibiotics, proteins, and oligonucleotides. This will improve the bactericidal properties of the soft material considerably and lead to controlled release of antibiotics over extended durations (e.g., weeks or months). The antifouling/bactericidal coatings for medical device implants can protect a surgery patient from acquired bacterial infections (e.g., biofilm infections) during the first critical recovery days and weeks before the coatings naturally degrade.

Additionally, hydrogels with such broad adhesive properties serve as a platform to combine with other materials for different applications. For example, polyethylene glycol diacrylate (PEG-DA) crosslinkers over a range of PEG molecular weights can be introduced into the viscous hydrogel network to initiate a second-step covalent crosslinking. By mixing them in deionized H₂O first and then adding saltwater to induce gelation would ensure that PEG-DA is physically mixed into the non-covalent network.

With the porphyrin photocatalyst already present in the network, a photoinduced controlled radical polymerization with PEG-DA will yield a covalent polymer network within the non-covalent network, which will stiffen and improve the elastic properties of the hydrogel, effectively serving as a rapidly photocured yet still adhesive ‘plug’. The possibility of the soft hydrogel biomaterials to be photocured using visible or near-IR light in minutes (if not seconds), can be used to the applications such as wound healing as the hydrogel platform with PEG-DA is able to form a tough adhesive ‘plug’ that is stable in saline conditions while under pressure from fluid flow. Besides the medical applications, this hydrogel platform with adhesive properties in saltwater can also be used together with some other painting materials, such as polydimethylsiloxane (PDMS) for hull coating, which may provide a new method to apply the coatings underwater.

Lastly, this dynamic photoredox-responsive hydrogel platform will also be useful in applications such as in therapeutic delivery and regenerative medicine.

### Chemical Agent

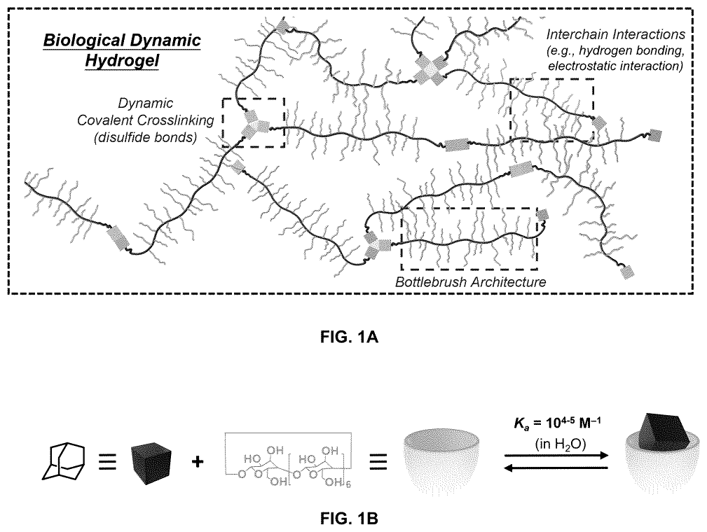

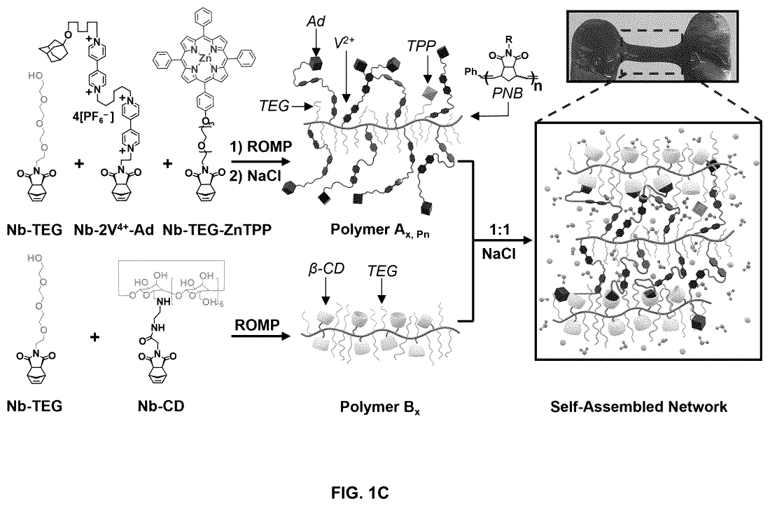

Examples of saltwater-stable copolymer complexes and their copolymer precursors are described herein, including pharmaceutically acceptable salts thereof. See FIGS. 1-179.

The formulas, analogs, and R groups can be optionally substituted or functionalized with one or more groups independently selected from the group consisting of hydroxyl; C₁₋₁₀alkyl hydroxyl; amine; C₁₋₁₀carboxylic acid; C₁₋₁₀carboxyl; straight chain or branched C₁₋₁₀alkyl, optionally containing unsaturation; a C₂₋₁₀cycloalkyl optionally containing unsaturation or one oxygen or nitrogen atom; straight chain or branched C₁₋₁₀alkyl amine; heterocyclyl; heterocyclic amine; and aryl comprising a phenyl; heteroaryl containing from 1 to 4 N, O, or S atoms; unsubstituted phenyl ring; substituted phenyl ring; unsubstituted heterocyclyl; and substituted heterocyclyl, wherein the unsubstituted phenyl ring or substituted phenyl ring can be optionally substituted with one or more groups independently selected from the group consisting of hydroxyl; C₁₋₁₀alkyl hydroxyl; amine; C₁₋₁₀carboxyl; C₁₋₁₀carboxylic acid; C₁₋₁₀carboxyl; straight chain or branched C₁₋₁₀alkyl, optionally containing unsaturation; straight chain or branched C₁₋₁₀alkyl amine, optionally containing unsaturation; a C₂₋₁₀cycloalkyl optionally containing unsaturation or one oxygen or nitrogen atom; straight chain or branched C₁₋₁₀alkyl amine; heterocyclyl; heterocyclic amine; aryl comprising a phenyl; and heteroaryl containing from 1 to 4 N, O, or S atoms; and the unsubstituted heterocyclyl or substituted heterocyclyl can be optionally substituted with one or more groups independently selected from the group consisting of hydroxyl; C₁₋₁₀alkyl hydroxyl; amine; C₁₋₁₀carboxylic acid; C₁₋₁₀carboxyl; straight chain or branched C₁₋₁₀alkyl, optionally containing unsaturation; straight chain or branched C₁₋₁₀alkyl amine, optionally containing unsaturation; a C₂₋₁₀cycloalkyl optionally containing unsaturation or one oxygen or nitrogen atom; heterocyclyl; straight chain or branched C₁₋₁₀alkyl amine; heterocyclic amine; and aryl comprising a phenyl; and heteroaryl containing from 1 to 4 N, O, or S atoms. Any of the above can be further optionally substituted.

The term “imine” or “imino”, as used herein, unless otherwise indicated, can include a functional group or chemical compound containing a carbon-nitrogen double bond. The expression “imino compound”, as used herein, unless otherwise indicated, refers to a compound that includes an “imine” or an “imino” group as defined herein. The “imine” or “imino” group can be optionally substituted.

The term “hydroxyl”, as used herein, unless otherwise indicated, can include —OH. The “hydroxyl” can be optionally substituted.

The terms “halogen” and “halo”, as used herein, unless otherwise indicated, include a chlorine, chloro, Cl; fluorine, fluoro, F; bromine, bromo, Br; or iodine, iodo, or I.

The term “acetamide”, as used herein, is an organic compound with the formula CH₃CONH₂. The “acetamide” can be optionally substituted.

The term “aryl”, as used herein, unless otherwise indicated, include a carbocyclic aromatic group. Examples of aryl groups include, but are not limited to, phenyl, benzyl, naphthyl, or anthracenyl. The “aryl” can be optionally substituted.

The terms “amine” and “amino”, as used herein, unless otherwise indicated, include a functional group that contains a nitrogen atom with a lone pair of electrons and wherein one or more hydrogen atoms have been replaced by a substituent such as, but not limited to, an alkyl group or an aryl group. The “amine” or “amino” group can be optionally substituted.

The term “alkyl”, as used herein, unless otherwise indicated, can include saturated monovalent hydrocarbon radicals having straight or branched moieties, such as but not limited to, methyl, ethyl, propyl, butyl, pentyl, hexyl, octyl groups, etc. Representative straight-chain lower alkyl groups include, but are not limited to, -methyl, -ethyl, -n-propyl, -n-butyl, -n-pentyl, -n-hexyl, -n-heptyl and -n-octyl; while branched lower alkyl groups include, but are not limited to, -isopropyl, -sec-butyl, -isobutyl, -tert-butyl, -isopentyl, 2-methylbutyl, 2-methylpentyl, 3-methylpentyl, 2,2-dimethylbutyl, 2,3-dimethylbutyl, 2,2-dimethylpentyl, 2,3-dimethylpentyl, 3,3-dimethylpentyl, 2,3,4-trimethylpentyl, 3-methylhexyl, 2,2-dimethylhexyl, 2,4-dimethylhexyl, 2,5-dimethylhexyl, 3,5-dimethylhexyl, 2,4-dimethylpentyl, 2-methylheptyl, 3-methylheptyl, unsaturated C₁₋₁₀ alkyls include, but are not limited to, -vinyl, -allyl, -1-butenyl, -2-butenyl, -isobutylenyl, -1-pentenyl, -2-pentenyl, -3-methyl-1-butenyl, -2-methyl-2-butenyl, -2,3-dimethyl-2-butenyl, 1-hexyl, 2-hexyl, 3-hexyl, -acetylenyl, -propynyl, -1-butynyl, -2-butynyl, -1-pentynyl, -2-pentynyl, or -3-methyl-1 butynyl. An alkyl can be saturated, partially saturated, or unsaturated. The “alkyl” can be optionally substituted.

The term “carboxyl”, as used herein, unless otherwise indicated, can include a functional group consisting of a carbon atom double bonded to an oxygen atom and single bonded to a hydroxyl group (—COOH). The “carboxyl” can be optionally substituted.

The term “carbonyl”, as used herein, unless otherwise indicated, can include a functional group consisting of a carbon atom double-bonded to an oxygen atom (C═O). The “carbonyl” can be optionally substituted.

The term “alkenyl”, as used herein, unless otherwise indicated, can include alkyl moieties having at least one carbon-carbon double bond wherein alkyl is as defined above and including E and Z isomers of said alkenyl moiety. An alkenyl can be partially saturated or unsaturated. The “alkenyl” can be optionally substituted.

The term “alkynyl”, as used herein, unless otherwise indicated, can include alkyl moieties having at least one carbon-carbon triple bond wherein alkyl is as defined above.

An alkynyl can be partially saturated or unsaturated. The “alkynyl” can be optionally substituted.

The term “acyl”, as used herein, unless otherwise indicated, can include a functional group derived from an aliphatic carboxylic acid, by removal of the hydroxyl (—OH) group. The “acyl” can be optionally substituted.

The term “alkoxyl”, as used herein, unless otherwise indicated, can include O-alkyl groups wherein alkyl is as defined above and O represents oxygen. Representative alkoxyl groups include, but are not limited to, —O-methyl, —O-ethyl, —O-n-propyl, —O-n-butyl, —O-n-pentyl, —O-n-hexyl, —O-n-heptyl, —O-n-octyl, —O-isopropyl, —O-sec-butyl, —O-isobutyl, —O-tert-butyl, —O-isopentyl, —O-2-methylbutyl, —O-2-methylpentyl, —O-3-methylpentyl, —O-2,2-dimethylbutyl, —O-2,3-dimethylbutyl, —O-2,2-dimethylpentyl, —O-2,3-dimethylpentyl, —O-3,3-dimethylpentyl, —O-2,3,4-trimethylpentyl, —O-3-methylhexyl, —O-2,2-dimethylhexyl, —O-2,4-dimethylhexyl, —O-2,5-dimethylhexyl, —O-3,5-dimethylhexyl, —O-2,4dimethylpentyl, —O-2-methylheptyl, —O-3-methylheptyl, —O-vinyl, —O-allyl, —O-1-butenyl, —O-2-butenyl, —O-isobutylenyl, —O-1-pentenyl, —O-2-pentenyl, —O-3-methyl-1-butenyl, —O-2-methyl-2-butenyl, —O-2,3-dimethyl-2-butenyl, —O-1-hexyl, —O-2-hexyl, —O-3-hexyl, —O-acetylenyl, —O-propynyl, —O-1-butynyl, —O-2-butynyl, —O-1-pentynyl, —O-2-pentynyl and —O-3-methyl-1-butynyl, —O-cyclopropyl, —O-cyclobutyl, —O-cyclopentyl, —O-cyclohexyl, —O-cycloheptyl, —O-cyclooctyl, —O-cyclononyl and —O-cyclodecyl, —O—CH₂-cyclopropyl, —O—CH₂-cyclobutyl, —O—CH₂-cyclopentyl, —O—CH₂-cyclohexyl, —O—CH₂-cycloheptyl, —O—CH₂-cyclooctyl, —O—CH₂-cyclononyl, —O—CH₂-cyclodecyl, —O—(CH₂)₂-cyclopropyl, —O—(CH₂)₂-cyclobutyl, —O—(CH₂)₂-cyclopentyl, —O—(CH₂)₂-cyclohexyl, —O—(CH₂)₂-cycloheptyl, —O—(CH₂)₂-cyclooctyl, —O—(CH₂)₂-cyclononyl, or —O—(CH₂)₂-cyclodecyl. An alkoxyl can be saturated, partially saturated, or unsaturated. The “alkoxyl” can be optionally substituted.

The term “cycloalkyl”, as used herein, unless otherwise indicated, can include an aromatic, a non-aromatic, saturated, partially saturated, or unsaturated, monocyclic or fused, spiro or unfused bicyclic or tricyclic hydrocarbon referred to herein containing a total of from 1 to 10 carbon atoms (e.g., 1 or 2 carbon atoms if there are other heteroatoms in the ring), preferably 3 to 8 ring carbon atoms. Examples of cycloalkyls include, but are not limited to, C₃₋₁₀ cycloalkyl groups include, but are not limited to, -cyclopropyl, -cyclobutyl, -cyclopentyl, -cyclopentadienyl, -cyclohexyl, -cyclohexenyl, -1,3-cyclohexadienyl, -1,4-cyclohexadienyl, -cycloheptyl, -1,3-cycloheptadienyl, -1,3,5-cycloheptatrienyl, -cyclooctyl, and -cyclooctadienyl. The term “cycloalkyl” also can include -lower alkyl-cycloalkyl, wherein lower alkyl and cycloalkyl are as defined herein. Examples of -lower alkyl-cycloalkyl groups include, but are not limited to, —CH₂-cyclopropyl, —CH₂-cyclobutyl, —CH₂-cyclopentyl, —CH₂-cyclopentadienyl, —CH₂-cyclohexyl, —CH₂-cycloheptyl, or —CH₂-cyclooctyl. The “cycloalkyl” can be optionally substituted. A “cycloheteroalkyl”, as used herein, unless otherwise indicated, can include any of the above with a carbon substituted with a heteroatom (e.g., O, S, N).

The term “heterocyclic” or “heteroaryl”, as used herein, unless otherwise indicated, can include an aromatic or non-aromatic cycloalkyl in which one to four of the ring carbon atoms are independently replaced with a heteroatom from the group consisting of O, S, and N. Representative examples of a heterocycle include, but are not limited to, benzofuranyl, benzothiophene, indolyl, benzopyrazolyl, coumarinyl, isoquinolinyl, pyrrolyl, pyrrolidinyl, thiophenyl, furanyl, thiazolyl, imidazolyl, pyrazolyl, triazolyl, quinolinyl, pyrimidinyl, pyridinyl, pyridonyl, pyrazinyl, pyridazinyl, isothiazolyl, isoxazolyl, (1,4)-dioxane, (1,3)-dioxolane, 4,5-dihydro-1H-imidazolyl, or tetrazolyl. Heterocycles can be substituted or unsubstituted. Heterocycles can also be bonded at any ring atom (i.e., at any carbon atom or heteroatom of the heterocyclic ring). A heterocyclic can be saturated, partially saturated, or unsaturated. The “heterocyclic” can be optionally substituted.

The term “indole”, as used herein, is an aromatic heterocyclic organic compound with formula C₈H₇N. It has a bicyclic structure, consisting of a six-membered benzene ring fused to a five-membered nitrogen-containing pyrrole ring. The “indole” can be optionally substituted.

The term “cyano”, as used herein, unless otherwise indicated, can include a —CN group. The “cyano” can be optionally substituted.

The term “alcohol”, as used herein, unless otherwise indicated, can include a compound in which the hydroxyl functional group (—OH) is bound to a carbon atom. In particular, this carbon center should be saturated, having single bonds to three other atoms. The “alcohol” can be optionally substituted.

The term “solvate” is intended to mean a solvate form of a specified compound that retains the effectiveness of such compound. Examples of solvates include compounds of the invention in combination with, for example, water, isopropanol, ethanol, methanol, dimethylsulfoxide (DMSO), ethyl acetate, acetic acid, or ethanolamine.

The term “mmol”, as used herein, is intended to mean millimole. The term “equiv”, as used herein, is intended to mean equivalent. The term “mL”, as used herein, is intended to mean milliliter. The term “g”, as used herein, is intended to mean gram. The term “kg”, as used herein, is intended to mean kilogram. The term “μg”, as used herein, is intended to mean micrograms. The term “h”, as used herein, is intended to mean hour. The term “min”, as used herein, is intended to mean minute. The term “M”, as used herein, is intended to mean molar. The term “μL”, as used herein, is intended to mean microliter. The term “μM”, as used herein, is intended to mean micromolar. The term “nM”, as used herein, is intended to mean nanomolar. The term “N”, as used herein, is intended to mean normal. The term “amu”, as used herein, is intended to mean atomic mass unit. The term “° C.”, as used herein, is intended to mean degree Celsius. The term “wt/wt”, as used herein, is intended to mean weight/weight. The term “v/v”, as used herein, is intended to mean volume/volume. The term “MS”, as used herein, is intended to mean mass spectroscopy. The term “HPLC”, as used herein, is intended to mean high performance liquid chromatograph. The term “RT”, as used herein, is intended to mean room temperature. The term “e.g.,”, as used herein, is intended to mean example. The term “N/A”, as used herein, is intended to mean not tested.

As used herein, the expression “pharmaceutically acceptable salt” refers to pharmaceutically acceptable organic or inorganic salts of a compound of the invention. Preferred salts include, but are not limited, to sulfate, citrate, acetate, oxalate, chloride, bromide, iodide, nitrate, bisulfate, phosphate, acid phosphate, isonicotinate, lactate, salicylate, acid citrate, tartrate, oleate, tannate, pantothenate, bitartrate, ascorbate, succinate, maleate, gentisinate, fumarate, gluconate, glucaronate, saccharate, formate, benzoate, glutamate, methanesulfonate, ethanesulfonate, benzenesulfonate, p-toluenesulfonate, or pamoate (i.e., 1,1′-methylene-bis-(2-hydroxy-3-naphthoate)) salts. A pharmaceutically acceptable salt may involve the inclusion of another molecule such as an acetate ion, a succinate ion, or another counterion. The counterion may be any organic or inorganic moiety that stabilizes the charge on the parent compound. Furthermore, a pharmaceutically acceptable salt may have more than one charged atom in its structure. In instances where multiple charged atoms are part of the pharmaceutically acceptable salt, the pharmaceutically acceptable salt can have multiple counterions. Hence, a pharmaceutically acceptable salt can have one or more charged atoms and/or one or more counterion. As used herein, the expression “pharmaceutically acceptable solvate” refers to an association of one or more solvent molecules and a compound of the invention. Examples of solvents that form pharmaceutically acceptable solvates include, but are not limited to, water, isopropanol, ethanol, methanol, DMSO, ethyl acetate, acetic acid, and ethanolamine. As used herein, the expression “pharmaceutically acceptable hydrate” refers to a compound of the invention, or a salt thereof, that further can include a stoichiometric or non-stoichiometric amount of water bound by non-covalent intermolecular forces.

### Formulation

The agents and compositions described herein can be formulated by any conventional manner using one or more pharmaceutically acceptable carriers or excipients as described in, for example, Remington's Pharmaceutical Sciences (A. R. Gennaro, Ed.), 21st edition, ISBN: 0781746736 (2005), incorporated herein by reference in its entirety. Such formulations will contain a therapeutically effective amount of a biologically active agent described herein, which can be in purified form, together with a suitable amount of carrier so as to provide the form for proper administration to the subject.

The term “formulation” refers to preparing a drug in a form suitable for administration to a subject, such as a human. Thus, a “formulation” can include pharmaceutically acceptable excipients, including diluents or carriers.

The term “pharmaceutically acceptable” as used herein can describe substances or components that do not cause unacceptable losses of pharmacological activity or unacceptable adverse side effects. Examples of pharmaceutically acceptable ingredients can be those having monographs in United States Pharmacopeia (USP 29) and National Formulary (NF 24), United States Pharmacopeial Convention, Inc, Rockville, Maryland, 2005 (“USP/NF”), or a more recent edition, and the components listed in the continuously updated Inactive Ingredient Search online database of the FDA. Other useful components that are not described in the USP/NF, etc., may also be used.

The term “pharmaceutically acceptable excipient,” as used herein, can include any and all solvents, dispersion media, coatings, antibacterial and antifungal agents, isotonic, or absorption delaying agents. The use of such media and agents for pharmaceutically active substances is well known in the art (see generally Remington's Pharmaceutical Sciences (A. R. Gennaro, Ed.), 21st edition, ISBN: 0781746736 (2005)). Except insofar as any conventional media or agent is incompatible with an active ingredient, its use in the therapeutic compositions is contemplated. Supplementary active ingredients can also be incorporated into the compositions.

A “stable” formulation or composition can refer to a composition having sufficient stability to allow storage at a convenient temperature, such as between about 0° C. and about 60° C., for a commercially reasonable period of time, such as at least about one day, at least about one week, at least about one month, at least about three months, at least about six months, at least about one year, or at least about two years.

The formulation should suit the mode of administration. The agents of use with the current disclosure can be formulated by known methods for administration to a subject using several routes which include, but are not limited to, parenteral, pulmonary, oral, topical, intradermal, intratumoral, intranasal, inhalation (e.g., in an aerosol), implanted, intramuscular, intraperitoneal, intravenous, intrathecal, intracranial, intracerebroventricular, subcutaneous, intranasal, epidural, intrathecal, ophthalmic, transdermal, buccal, and rectal. The individual agents may also be administered in combination with one or more additional agents or together with other biologically active or biologically inert agents. Such biologically active or inert agents may be in fluid or mechanical communication with the agent(s) or attached to the agent(s) by ionic, covalent, Van der Waals, hydrophobic, hydrophilic, or other physical forces.

Controlled-release (or sustained-release) preparations may be formulated to extend the activity of the agent(s) and reduce dosage frequency. Controlled-release preparations can also be used to affect the time of onset of action or other characteristics, such as blood levels of the agent, and consequently, affect the occurrence of side effects. Controlled-release preparations may be designed to initially release an amount of an agent(s) that produces the desired therapeutic effect, and gradually and continually release other amounts of the agent to maintain the level of therapeutic effect over an extended period of time. In order to maintain a near-constant level of an agent in the body, the agent can be released from the dosage form at a rate that will replace the amount of agent being metabolized or excreted from the body. The controlled-release of an agent may be stimulated by various inducers, e.g., change in pH, change in temperature, enzymes, water, or other physiological conditions or molecules.

Agents or compositions described herein can also be used in combination with other therapeutic modalities, as described further below. Thus, in addition to the therapies described herein, one may also provide to the subject other therapies known to be efficacious for treatment of the disease, disorder, or condition.

### Therapeutic Methods

Also provided is a process of treating, preventing, or reversing bacterial infection in a subject in need of administration of a therapeutically effective amount of a saltwater-stable adhesive hydrogel composition, so as to prevent or treat bacterial infection after injury and/or surgery. In exemplary embodiments, administration of the composition comprises applying the composition to a wound, to an area proximal to the wound, and/or to a wound dressing.

Methods described herein are generally performed on a subject in need thereof. A subject in need of the therapeutic methods described herein can be a subject having, diagnosed with, suspected of having, or at risk for developing bacterial infection including biofilm infection. A determination of the need for treatment will typically be assessed by a history, physical exam, or diagnostic tests consistent with the disease or condition at issue. Diagnosis of the various conditions treatable by the methods described herein is within the skill of the art. The subject can be an animal subject, including a mammal, such as horses, cows, dogs, cats, sheep, pigs, mice, rats, monkeys, hamsters, guinea pigs, and humans or chickens. For example, the subject can be a human subject.

Generally, a safe and effective amount of the composition is, for example, an amount that would cause the desired therapeutic effect in a subject while minimizing undesired side effects. In various embodiments, an effective amount of the composition described herein can substantially inhibit bacterial infection including biofilm infection, slow the progress of bacterial infection including biofilm infection, or limit the development of bacterial infection including biofilm infection.

According to the methods described herein, administration can be parenteral, pulmonary, oral, topical, intradermal, intramuscular, intraperitoneal, intravenous, intratumoral, intrathecal, intracranial, intracerebroventricular, subcutaneous, intranasal, epidural, ophthalmic, buccal, or rectal administration.

When used in the treatments described herein, a therapeutically effective amount the composition can be employed in pure form or, where such forms exist, in pharmaceutically acceptable salt form and with or without a pharmaceutically acceptable excipient. For example, the compounds of the present disclosure can be administered, at a reasonable benefit/risk ratio applicable to any medical treatment, in a sufficient amount to prevent or treat bacterial infection including biofilm infection.

The amount of a composition described herein that can be combined with a pharmaceutically acceptable carrier to produce a single dosage form will vary depending upon the subject or host treated and the particular mode of administration. It will be appreciated by those skilled in the art that the unit content of agent contained in an individual dose of each dosage form need not in itself constitute a therapeutically effective amount, as the necessary therapeutically effective amount could be reached by administration of a number of individual doses.

Toxicity and therapeutic efficacy of compositions described herein can be determined by standard pharmaceutical procedures in cell cultures or experimental animals for determining the LD₅₀ (the dose lethal to 50% of the population) and the ED₅₀, (the dose therapeutically effective in 50% of the population). The dose ratio between toxic and therapeutic effects is the therapeutic index that can be expressed as the ratio LD₅₀/ED₅₀, where larger therapeutic indices are generally understood in the art to be optimal.

The specific therapeutically effective dose level for any particular subject will depend upon a variety of factors including the disorder being treated and the severity of the disorder; the activity of the specific compound employed; the specific composition employed; the age, body weight, general health, sex and diet of the subject; the time of administration; the route of administration; the rate of excretion of the composition employed; the duration of the treatment; drugs used in combination or coincidental with the specific compound employed; and like factors well known in the medical arts (see e.g., Koda-Kimble et al. (2004) Applied Therapeutics: The Clinical Use of Drugs, Lippincott Williams & Wilkins, ISBN 0781748453; Winter (2003) Basic Clinical Pharmacokinetics, 4^{th} ed., Lippincott Williams & Wilkins, ISBN 0781741475; Sharqel (2004) Applied Biopharmaceutics & Pharmacokinetics, McGraw-Hill/Appleton & Lange, ISBN 0071375503). For example, it is well within the skill of the art to start doses of the composition at levels lower than those required to achieve the desired therapeutic effect and to gradually increase the dosage until the desired effect is achieved. If desired, the effective daily dose may be divided into multiple doses for purposes of administration. Consequently, single dose compositions may contain such amounts or submultiples thereof to make up the daily dose. It will be understood, however, that the total daily usage of the compounds and compositions of the present disclosure will be decided by an attending physician within the scope of sound medical judgment.

Again, each of the states, diseases, disorders, and conditions, described herein, as well as others, can benefit from compositions and methods described herein. Generally, treating a state, disease, disorder, or condition includes reversing or delaying the appearance of clinical symptoms in a mammal that may be afflicted with or predisposed to the state, disease, disorder, or condition but does not yet experience or display clinical or subclinical symptoms thereof. Treating can also include inhibiting the state, disease, disorder, or condition, e.g., arresting or reducing the development of the disease or at least one clinical or subclinical symptom thereof. Furthermore, treating can include relieving the disease, e.g., causing regression of the state, disease, disorder, or condition or at least one of its clinical or subclinical symptoms. A benefit to a subject to be treated can be either statistically significant or at least perceptible to the subject or a physician.

Administration of the composition can occur as a single event or over a time course of treatment. For example, the composition can be administered daily, weekly, bi-weekly, or monthly. For treatment of acute conditions, the time course of treatment will usually be at least several days. Certain conditions could extend treatment from several days to several weeks. For example, treatment could extend over one week, two weeks, or three weeks. For more chronic conditions, treatment could extend from several weeks to several months or even a year or more.

Treatment in accord with the methods described herein can be performed prior to or before, concurrent with, or after conventional treatment modalities for bacterial infection including biofilm infection.

A composition as disclosed herein can be administered simultaneously or sequentially with another agent, such as an antibiotic, an anti-inflammatory, or another agent. For example, a composition can be administered simultaneously with another agent, such as an antibiotic or an anti-inflammatory. Simultaneous administration can occur through administration of separate compositions, each containing one or more of the composition, an antibiotic, an anti-inflammatory, or another agent. Simultaneous administration can occur through administration of one composition containing two or more of the composition, an antibiotic, an anti-inflammatory, or another agent. The composition can be administered sequentially with an antibiotic, an anti-inflammatory, or another agent. For example, the composition can be administered before or after administration of an antibiotic, an anti-inflammatory, or another agent.

Active compounds are administered at a therapeutically effective dosage sufficient to treat a condition associated with a condition in a patient. For example, the efficacy of a compound can be evaluated in an animal model system that may be predictive of efficacy in treating the disease in a human or another animal, such as the model systems shown in the examples and drawings.

An effective dose range of a therapeutic can be extrapolated from effective doses determined in animal studies for a variety of different animals. In general, a human equivalent dose (HED) in mg/kg can be calculated in accordance with the following formula (see e.g., Reagan-Shaw et al., FASEB J., 22(3):659-661, 2008, which is incorporated herein by reference):

HED (mg/kg)=Animal dose (mg/kg)×(Animal Kₘ/Human Kₘ)

Use of the Kₘ factors in conversion results in more accurate HED values, which are based on body surface area (BSA) rather than only on body mass. Kₘ values for humans and various animals are well known. For example, the Kₘ for an average 60 kg human (with a BSA of 1.6 m²) is 37, whereas a 20 kg child (BSA 0.8 m²) would have a Kₘ of 25. Kₘ values for some relevant animal models are also well known, including: mice Kₘ of 3 (given a weight of 0.02 kg and BSA of 0.007); hamster Kₘ of 5 (given a weight of 0.08 kg and BSA of 0.02); rat Kₘ of 6 (given a weight of 0.15 kg and BSA of 0.025) and monkey Kₘ of 12 (given a weight of 3 kg and BSA of 0.24).

Precise amounts of the therapeutic composition depend on the judgment of the practitioner and are peculiar to each individual. Nonetheless, a calculated HED dose provides a general guide. Other factors affecting the dose include the physical and clinical state of the patient, the route of administration, the intended goal of treatment, and the potency, stability, and toxicity of the particular therapeutic formulation.

The actual dosage amount of a compound of the present disclosure or composition comprising a compound of the present disclosure administered to a subject may be determined by physical and physiological factors such as type of animal treated, age, sex, body weight, severity of condition, the type of disease being treated, previous or concurrent therapeutic interventions, idiopathy of the subject and on the route of administration. These factors may be determined by a skilled artisan. The practitioner responsible for administration will typically determine the concentration of active ingredient(s) in a composition and appropriate dose(s) for the individual subject. The dosage may be adjusted by the individual physician in the event of any complication.

In some embodiments, the composition may be administered in an amount from about 1 mg/kg to about 100 mg/kg, or about 1 mg/kg to about 50 mg/kg, or about 1 mg/kg to about 25 mg/kg, or about 1 mg/kg to about 15 mg/kg, or about 1 mg/kg to about 10 mg/kg, or about 1 mg/kg to about 5 mg/kg, or about 3 mg/kg. In other embodiments, the composition may be administered in a range of about 1 mg/kg to about 200 mg/kg, or about 50 mg/kg to about 200 mg/kg, or about 50 mg/kg to about 100 mg/kg, or about 75 mg/kg to about 100 mg/kg, or about 100 mg/kg.

The effective amount may be less than 1 mg/kg/day, less than 500 mg/kg/day, less than 250 mg/kg/day, less than 100 mg/kg/day, less than 50 mg/kg/day, less than 25 mg/kg/day or less than 10 mg/kg/day. It may alternatively be in the range of 1 mg/kg/day to 200 mg/kg/day.

In other non-limiting examples, a dose may also comprise from about 1 micro-gram/kg/body weight, about 5 microgram/kg/body weight, about 10 microgram/kg/body weight, about 50 microgram/kg/body weight, about 100 microgram/kg/body weight, about 200 microgram/kg/body weight, about 350 microgram/kg/body weight, about 500 microgram/kg/body weight, about 1 milligram/kg/body weight, about 5 milligram/kg/body weight, about 10 milligram/kg/body weight, about 50 milligram/kg/body weight, about 100 milligram/kg/body weight, about 200 milligram/kg/body weight, about 350 milligram/kg/body weight, about 500 milligram/kg/body weight, to about 1000 mg/kg/body weight or more per administration, and any range derivable therein. In non-limiting examples of a derivable range from the numbers listed herein, a range of about 5 mg/kg/body weight to about 100 mg/kg/body weight, about 5 microgram/kg/body weight to about 500 milligram/kg/body weight, etc., can be administered, based on the numbers described above.

### Administration

Agents and compositions described herein can be administered according to methods described herein in a variety of means known to the art. The agents and composition can be used therapeutically either as exogenous materials or as endogenous materials. Exogenous agents are those produced or manufactured outside of the body and administered to the body. Endogenous agents are those produced or manufactured inside the body by some type of device (biologic or other) for delivery within or to other organs in the body.

As discussed above, administration can be parenteral, pulmonary, oral, topical, intradermal, intratumoral, intranasal, inhalation (e.g., in an aerosol), implanted, intramuscular, intraperitoneal, intravenous, intrathecal, intracranial, intracerebroventricular, subcutaneous, intranasal, epidural, intrathecal, ophthalmic, transdermal, buccal, and rectal.

Agents and compositions described herein can be administered in a variety of methods well known in the arts. Administration can include, for example, methods involving oral ingestion, direct injection (e.g., systemic or stereotactic), implantation of cells engineered to secrete the factor of interest, drug-releasing biomaterials, polymer matrices, gels, permeable membranes, osmotic systems, multilayer coatings, microparticles, implantable matrix devices, mini-osmotic pumps, implantable pumps, injectable gels and hydrogels, liposomes, micelles (e.g., up to 30 μm), nanospheres (e.g., less than 1 μm), microspheres (e.g., 1-100 μm), reservoir devices, a combination of any of the above, or other suitable delivery vehicles to provide the desired release profile in varying proportions. Other methods of controlled-release delivery of agents or compositions will be known to the skilled artisan and are within the scope of the present disclosure.

Delivery systems may include, for example, an infusion pump which may be used to administer the agent or composition in a manner similar to that used for delivering insulin or chemotherapy to specific organs or tumors. Typically, using such a system, an agent or composition can be administered in combination with a biodegradable, biocompatible polymeric implant that releases the agent over a controlled period of time at a selected site. Examples of polymeric materials include polyanhydrides, polyorthoesters, polyglycolic acid, polylactic acid, polyethylene vinyl acetate, and copolymers and combinations thereof. In addition, a controlled release system can be placed in proximity of a therapeutic target, thus requiring only a fraction of a systemic dosage.

Agents can be encapsulated and administered in a variety of carrier delivery systems. Examples of carrier delivery systems include microspheres, hydrogels, polymeric implants, smart polymeric carriers, and liposomes (see generally, Uchegbu and Schatzlein, eds. (2006) Polymers in Drug Delivery, CRC, ISBN-10: 0849325331). Carrier-based systems for molecular or biomolecular agent delivery can: provide for intracellular delivery; tailor biomolecule/agent release rates; increase the proportion of biomolecule that reaches its site of action; improve the transport of the drug to its site of action; allow colocalized deposition with other agents or excipients; improve the stability of the agent in vivo; prolong the residence time of the agent at its site of action by reducing clearance; decrease the nonspecific delivery of the agent to nontarget tissues; decrease irritation caused by the agent; decrease toxicity due to high initial doses of the agent; alter the immunogenicity of the agent; decrease dosage frequency; improve taste of the product; or improve shelf life of the product.

### Kits

Also provided are kits. Such kits can include an agent or composition described herein and, in certain embodiments, instructions for administration. Such kits can facilitate performance of the methods described herein. When supplied as a kit, the different components of the composition can be packaged in separate containers and admixed immediately before use. Components include, but are not limited to precursor reagents, starting reagents, any additional required or optional reagents, and/or any additional required or optional apparatus/equipment for making and using the compositions described herein. Such packaging of the components separately can, if desired, be presented in a pack or dispenser device which may contain one or more unit dosage forms containing the composition. The pack may, for example, comprise metal or plastic foil such as a blister pack. Such packaging of the components separately can also, in certain instances, permit long-term storage without losing activity of the components.

Kits may also include reagents in separate containers such as, for example, sterile water or saline to be added to a lyophilized active component packaged separately. For example, sealed glass ampules may contain a lyophilized component and in a separate ampule, sterile water, sterile saline each of which has been packaged under a neutral non-reacting gas, such as nitrogen. Ampules may consist of any suitable material, such as glass, organic polymers, such as polycarbonate, polystyrene, ceramic, metal, or any other material typically employed to hold reagents. Other examples of suitable containers include bottles that may be fabricated from similar substances as ampules and envelopes that may consist of foil-lined interiors, such as aluminum or an alloy. Other containers include test tubes, vials, flasks, bottles, syringes, and the like. Containers may have a sterile access port, such as a bottle having a stopper that can be pierced by a hypodermic injection needle. Other containers may have two compartments that are separated by a readily removable membrane that upon removal permits the components to mix. Removable membranes may be glass, plastic, rubber, and the like.

In certain embodiments, kits can be supplied with instructional materials. Instructions may be printed on paper or another substrate, and/or may be supplied as an electronic-readable medium or video. Detailed instructions may not be physically associated with the kit; instead, a user may be directed to an Internet web site specified by the manufacturer or distributor of the kit.

A control sample or a reference sample as described herein can be a sample from a healthy subject or sample, a wild-type subject or sample, or from populations thereof. A reference value can be used in place of a control or reference sample, which was previously obtained from a healthy subject or a group of healthy subjects or a wild-type subject or sample. A control sample or a reference sample can also be a sample with a known amount of a detectable compound or a spiked sample.

Compositions and methods described herein utilizing molecular biology protocols can be according to a variety of standard techniques known to the art (see e.g., Sambrook and Russel (2006) Condensed Protocols from Molecular Cloning: A Laboratory Manual, Cold Spring Harbor Laboratory Press, ISBN-10: 0879697717; Ausubel et al. (2002) Short Protocols in Molecular Biology, 5th ed., Current Protocols, ISBN-10: 0471250929; Sambrook and Russel (2001) Molecular Cloning: A Laboratory Manual, 3d ed., Cold Spring Harbor Laboratory Press, ISBN-10: 0879695773; Elhai, J. and Wolk, C. P. 1988. Methods in Enzymology 167, 747-754; Studier (2005) Protein Expr Purif. 41(1), 207-234; Gellissen, ed. (2005) Production of Recombinant Proteins: Novel Microbial and Eukaryotic Expression Systems, Wiley-VCH, ISBN-10: 3527310363; Baneyx (2004) Protein Expression Technologies, Taylor & Francis, ISBN-10: 0954523253).

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein. The recitation of discrete values is understood to include ranges between each value.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

All publications, patents, patent applications, and other references cited in this application are incorporated herein by reference in their entirety for all purposes to the same extent as if each individual publication, patent, patent application, or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1—Saltwater-Induced Rapid Gelation of Photoredox-Responsive Mucomimetic Hydrogels

Shear-thinning hydrogels represent an important class of injectable soft materials that are often used in a wide range of biomedical applications. Typically, the hydrogel network is formed prior to injection and ‘heals’ once the shearing forces have been removed. However, creation of new shear-thinning materials often requires that factors such as viscosity, injection rate/force, and needle gauge be evaluated to achieve efficient delivery, while simultaneously protecting potentially sensitive cargo (e.g., cells). Here, a new approach to establishing shear-thinning hydrogels is reported where a host-guest crosslinked network initially remains soluble in deionized water but is kinetically trapped as a viscous hydrogel once exposed to a high ionic strength solution. The shear-thinning properties of the viscous hydrogel may then be ‘switched on’ in response to heating or exposure to visible light.

Disclosed herein are hydrogels which consist of polynorbornene-based bottlebrush copolymers with porphyrin- and oligoviologen-containing side chains that are crosslinked through the reversible formation of β-cyclodextrin-adamantane host-guest inclusion complexes. The resultant viscous hydrogels displayed broad adhesive properties across polar and non-polar substrates, mimicking that of natural mucous and thus making it easier to distribute onto a wide range of surfaces. Additional control over the hydrogel's mechanical properties (storage/loss moduli) and performance (adhesion) was achieved post-injection using a low-energy (blue light) photoinduced electron-transfer process. These injectable copolymers and corresponding multimodal viscous hydrogels can serve as versatile biomaterials capable of light-based mechanical manipulation post-injection.

β-cyclodextrin (β-CD) and adamantane (Ad)-functionalized hyaluronic acid (HA) establish dynamic crosslinks and thus soft hydrogels which can be used for the delivery of cells and other biologically relevant molecules. Disclosed herein is the appropriate viscosity and storage/loss moduli for a particular hydrogel composition, as well as the mechanical properties of the material and the physical parameters associated with the injection method to consistent delivery and retention of the shear-thinning hydrogel.

Mucin glycoproteins are an example of a dynamic, stimuli-responsive hydrogel found in nature which serves an important role in the body's defense against dust, debris, and foreign pathogens. Typically, these glycoproteins—whose backbone are made of long peptide chains derived from proline, threonine, and/or serine amino acid residues and can reach molecular weights between 200-500 kDa—are the main component in mucus-based hydrogels that comprise mostly water (93-97% w/v). However, most of the glycoprotein dry mass arises from the N- and O-linked oligosaccharides (made from glucose, galactose, mannose, etc.) that form highly glycosylated sidechains resembling a bottlebrush-like architecture (FIG. 1A, sidechains are represented by the ‘bristles’ of the bottlebrush) that exhibit non-covalent interactions, such as hydrogen bonding and electrostatic repulsion. Moreover, cysteine-rich domains at the termini of these natural bottlebrush polymers lead to dynamic covalent crosslinking through disulfide linkages (FIG. 1A, square/rectangular blocks) which produces an extended biopolymer network. It is precisely these design components that makes mucous-based hydrogels very soft and adaptable to a variety of surfaces. Additionally, the physicochemical properties of mucus-based hydrogels depend on a variety of external factors, including pH, ionic strength, charge, and the number of disulfide crosslinks. One astonishing example of a mucin-derived hydrogel that forms rapidly in a high ionic strength environment has been observed when hagfish respond to a predator by releasing tightly bound protein threads and mucin glycoproteins. This rapid, stimuli-responsive event is facilitated by a high ionic strength environment that is critical to the mechanism of release and formation of protective slime. In contrast, synthetic polyelectrolyte gels typically undergo deswelling in high ionic strength media on account of electrostatic screening that occurs between the polymer-bound charges.

Synthetic stimuli-responsive hydrogels can also be programmed to undergo changes in their structure, properties, and functions in response to external stimuli. These stimuli can be physical: such as changes in temperature or the application of shearing forces or a magnetic field, or chemical: such as a change in pH, or the presence of a redox agent or a reactive biomolecule. Light may also be used to remotely trigger a physical response in hydrogels, such as the photothermal-based precipitation of an embedded thermo-responsive polymer or the isomerization of a photo-responsive building block like azobenzene or spiropyran. It can also be used to elicit a chemical response: such as the disconnection of photolabile covalent bonds or driving a photoredox-based self-assembly process. The prospects of combining bottlebrush architectures and host-guest non-covalent interactions, such as the Ad/β-CD complex (FIG. 1B), with light-responsive functionality into a single hydrogel platform represents a powerful approach to building scalable, adaptive, and bioinspired materials whose injectability is operationally simpler overall and its shear-thinning properties can be controlled spatiotemporally post-injection.

Inspired by the dynamic and versatile bottlebrush architectures of mucous-based hydrogels, described herein is a stimuli-responsive hydrogel that is both saltwater- and photoredox-responsive (i.e., blue light) and which exhibits broad adhesive properties on multiple materials with polar and non-polar surfaces, analogous to natural mucous-based hydrogels. The hydrogel consists of two norbornene (Nb)-based bottlebrush copolymers (A_{x, Pn} and Bₓ) bearing Ad and β-CD groups as side chains (respectively) that self-assemble into soluble host-guest-crosslinked networks upon mixing in H₂O, but which do not form a kinetically trapped viscous hydrogel (FIG. 1C) until the ionic strength of the solution is raised above at least 20 mM NaCl. The lack of gelation in deionized H₂O results from the Ad group being tethered to a polynorbornene (PNB) backbone via polar oligoviologen dimer linkers bearing four positive charges per repeat subunit. This unique gelation mechanism is akin to the “salting out” of proteins and yet was not dependent on the concentration of polymer in the pre-gel solution. The implication of this feature is that the crosslinked network could be readily ejected from the syringe as a soluble aqueous solution prior to rapid gelation in saltwater without having to optimize any parameters associated with the injection method. Moreover, a zinc-based tetraphenyl porphyrin photocatalyst was introduced as a side chain in the ‘guest’ copolymer containing Ad groups so it could serve as a photocatalyst capable of transferring an electron to the electron-deficient oligoviologen side chains upon absorption of visible light, the latter of which resulted in contraction and stiffening of the self-assembled network by way of a viologen-based radical molecular recognition mechanism. A library of structural analogues was synthesized to identify the correct ratio of host-guest pairs as it pertains to gelation, and the corresponding viscous hydrogels (G″>G′) were fabricated and tested on polar and non-polar surfaces to evaluate their broad adhesive properties pre/post-heat-curing and in response to blue light. Notably, heat activation and photo-activation of the mucomimetic hydrogels ‘switched on’ elastic (G′>G″) and shear-thinning properties and increased its adhesive strength, as H₂O was removed from the hydrogel either through direct evaporation or through the photo-induced contraction mechanism, respectively, ultimately leading to an increase in host-guest crosslinking. This fundamentally new approach to mechanical manipulation of these versatile and scalable mucomimetic hydrogels post-injection opens the door to such applications as 3D (bio)printing and manufacturing, 4D tissue culture, therapeutic delivery, and regenerative medicine.

### Results

### Molecular Design of Photoredox-Responsive Viscous Hydrogels

Visible light can be used in a photoredox mechanism to control the network structure and therefore the macroscopic properties (e.g., size, stiffness) of covalently crosslinked hydrogels. This level of control was achieved by introducing a photocatalyst—specifically, a zinc-based tetraphenyl porphyrin (ZnTPP)—into the gel network, which was crosslinked by styrenated oligoviologens. Upon irradiation with blue or red light, the porphyrin transferred an electron to the viologen subunits in the crosslinker via a photoinduced electron transfer (PET) process (i.e., V²⁺ to V·⁺). The corresponding viologen radical cations underwent intra- and intermolecular stacking as the result of radical-radical-based molecular recognition between two unpaired electrons. Moreover, photo-reduction led to a loss of half of the positive charges in the oligoviologen crosslinker, which decreased the electrostatic repulsion and expelled the corresponding counteranions.

A photoredox-responsive hydrogel was designed (FIG. 1C), where the method of crosslinking relied on non-covalent host-guest complexes formed between Ad and β-CD groups as side chains of two separate PNB-based statistical copolymers (Table 1) with the general formula: poly(2V⁴⁺Adₘ-TEG₂₋₄ₘ-ZnTPPₙ)ₛₜₐₜ (A_{x, Pn}) and poly(CDₘ-TEG₂₋₄ₘ)ₛₜₐₜ (Bₓ). On account of the functional-group tolerant nature of Grubbs' catalysts, each copolymer was synthesized using ring-opening metathesis polymerization (ROMP) of Nb-based monomers. Copolymer A_{x, Pn} was designed with polar, dicationic viologen subunits linking the Ad group to the polymerizable Nb group (Nb-2V⁴⁺-Ad) as well as with a photocatalyst-based monomer, Nb-TEG-ZnTPP, where the subscripted n refers to 0, 1, 2, or 4 porphyrin repeat units on average per copolymer chain. Copolymer Bₓ was designed with β-CD and tetraethylene glycol (TEG)-functionalized monomers (Nb-CD and Nb-TEG, respectively) to serve as the ‘host’ copolymer. The Nb-TEG monomer improves the H₂O solubility of copolymer Bₓ, while also functioning as a spacer subunit in between the larger CD macrocycles without negatively impacting the CD's ability to form host-guest complexes. The 30:90 ratio of CD:TEG subunits was selected after extensive screening of reaction conditions and stoichiometries to provide the amount of host macrocycles to form a hydrogel and to maintain the copolymer's solubility in H₂O, respectively. This optimization process began by first determining the maximum number of CD subunits that could be polymerized into copolymer Bₓ, as Nb-CD proved to be more challenging to polymerize than Nb-2V⁴⁺-Ad to make the complimentary copolymer A_{x, Pn}.

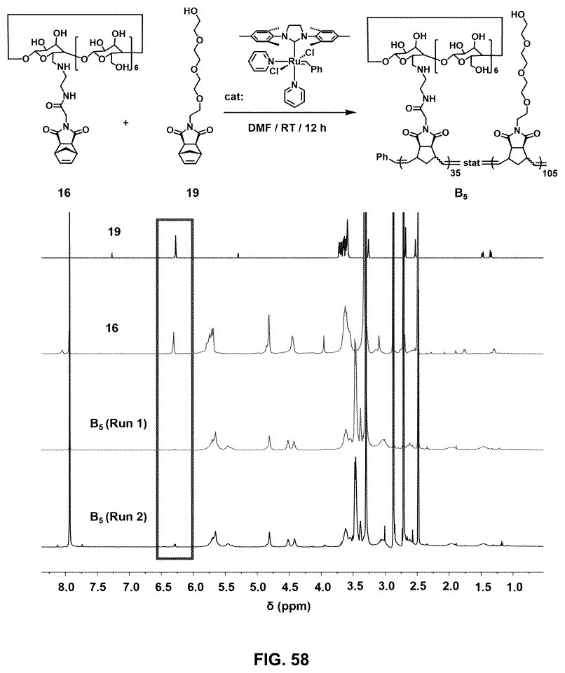

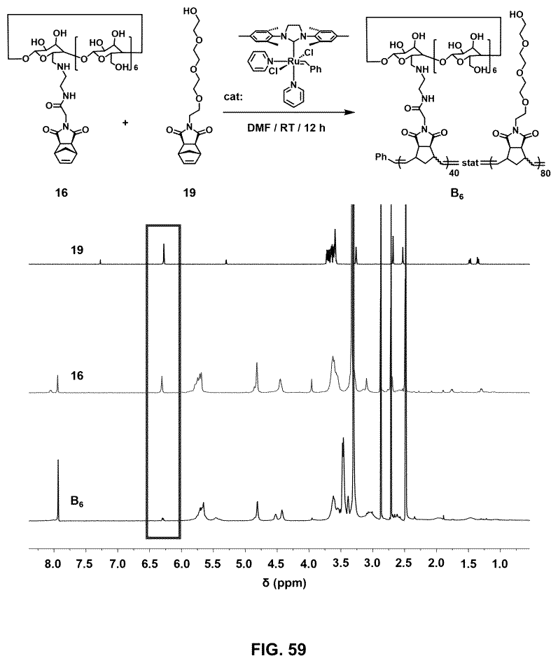

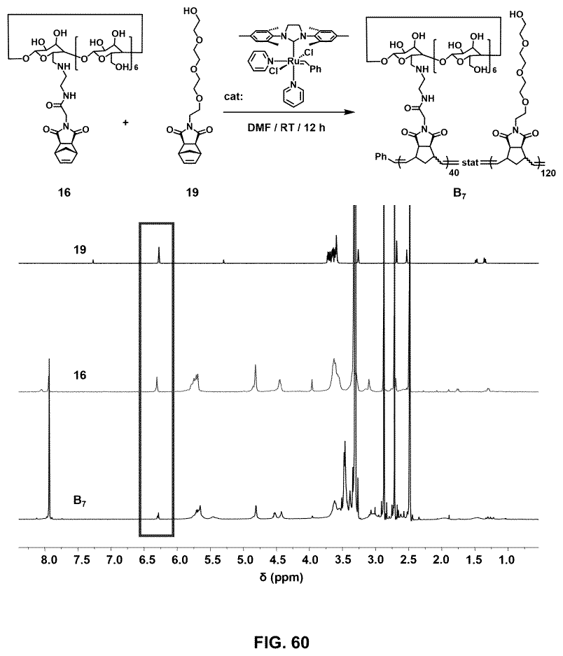

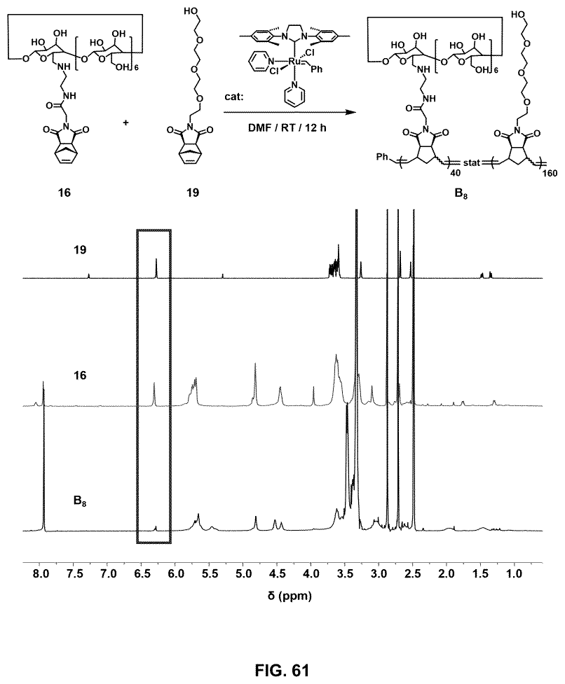

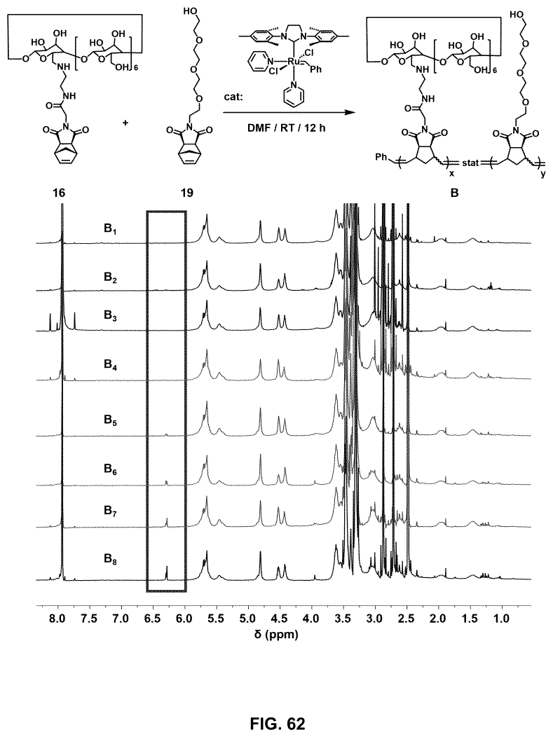

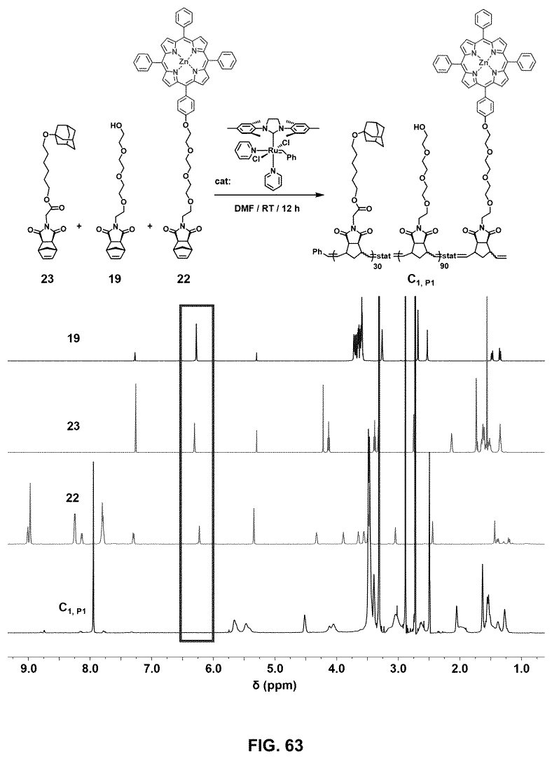

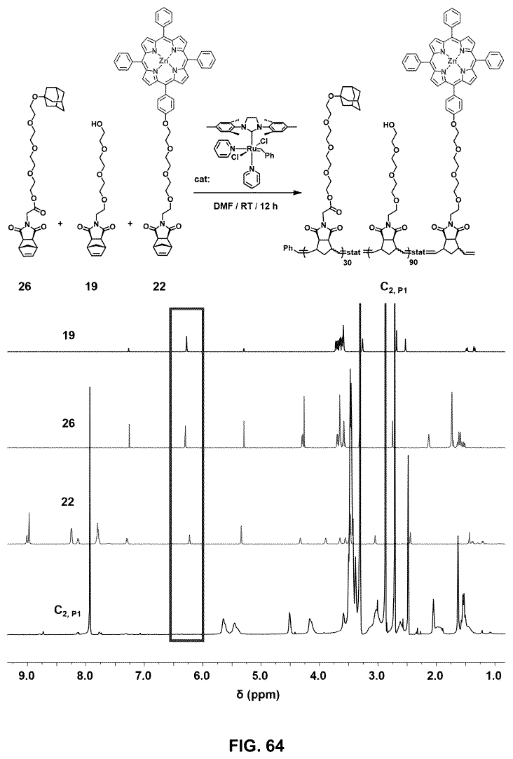

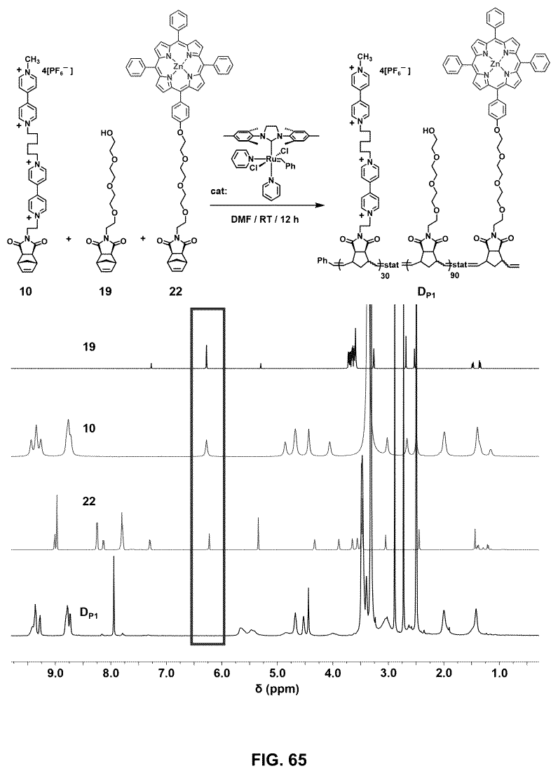

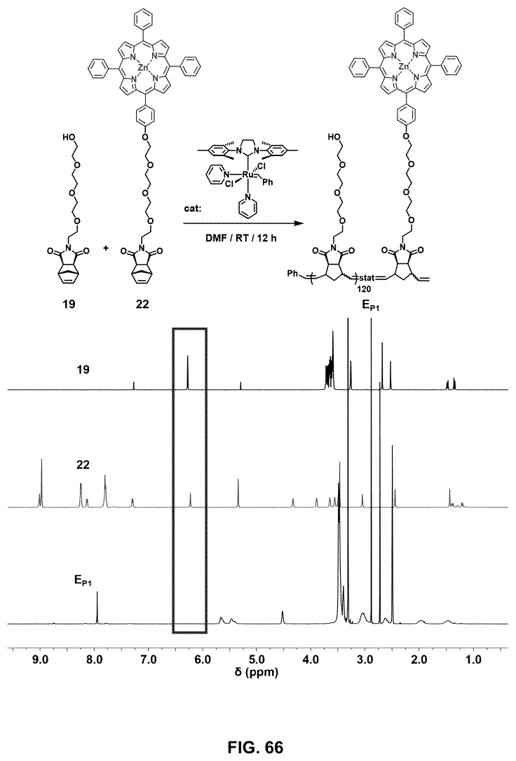

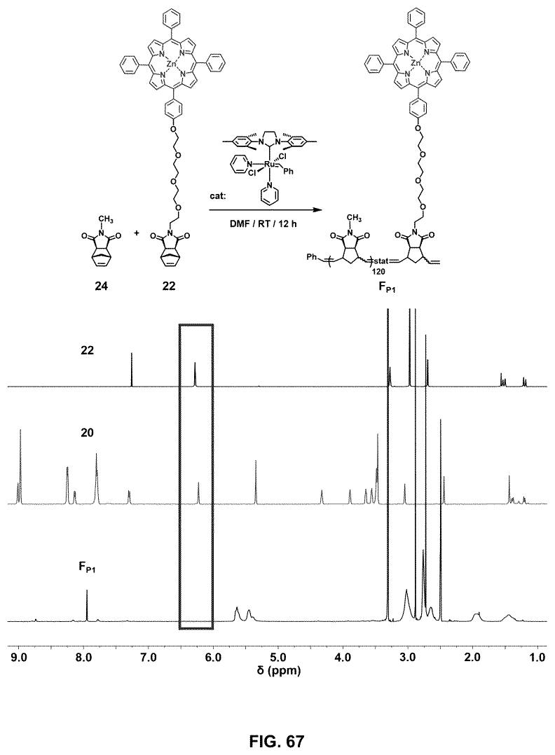

Based on ¹H NMR analyses of aliquots taken from quenched ROMP reactions (FIG. 62), it was clear that 30 CD subunits was the upper bound for the average number of macrocycles that can be incorporated per chain. For example, the olefin proton resonances associated with the Nb-CD monomer remained in the ¹H NMR spectra following attempts to polymerize 35 and 40 CD subunits into copolymers B₅ and B₆-8, respectively, regardless of the amount of TEG present (FIG. 58, FIG. 59, FIG. 60, FIG. 61). Next, the range of TEG:CD ratios was investigated for copolymer Bₓ (Table 1), when only 20 and 30 CD repeat subunits were present (B₁ and B₂-B₄, respectively). Although all these polymerizations went to completion, rheological characterization of the 1:1 mixture of Bₓ with the corresponding A_{x, P1} copolymer in saltwater revealed changes in the storage and loss moduli pre- and post-heating. Specifically, copolymers bearing only 20 CD subunits (B₁) did not gel efficiently, while copolymers bearing 30 CD subunits and four times as many TEG repeat subunits (B₄) could not achieve efficient crosslinking after heat curing, as evidenced by much lower storage/loss moduli (Table 2). The latter result was indicative of steric crowding when too many TEG side chains are present, thus preventing efficient formation of the host-guest inclusion complexes between Ad-CD functional groups. The results of this screening demonstrated that copolymers B₂ and B₃ were the most optimal in terms of the polymerization and gel formation. Copolymer B₃ was selected to move forward with direct comparisons to other control copolymers (C_{x, P1} and Dpi, Tables 1, Table 2) since it maintained good solubility at higher concentrations in H₂O.

TABLE 1
Summary of statistical copolymers synthesized in this investigation.
Note, the C_{1, P1}, C_{2, P1}, and D_{P1} are control copolymers lacking oligoviologen
side chains (C_{1, P1} and C_{2, P1}) or Ad groups (D_{P1}).

| | Monomer Units of Statistical Copolymers | | | | | | | |
|---|---|---|---|---|---|---|---|---|
| Monomer | A_{1, P1} | A_{2, P1} | A_{3, P0} | A_{3, P1} | A_{3, P2} | A_{3, P4} | A_{4, P1} | A_{5, P1} |
| Nb—2V—Ad•4PF₆ (8) | 20 | 30 | 30 | 30 | 30 | 30 | 30 | 35 |
| Nb—TEG (19) | 60 | 60 | 90 | 90 | 90 | 90 | 120 | 105 |
| Nb—TEG—ZnTPP (22) | 1 | 1 | 0 | 1 | 2 | 4 | 1 | 1 |
| Monomer | B₁ | B₂ | B₄ | B₅ | B₅ | C_{1, P1} | C_{2, P1} | D_{P1} |
| Nb—CD (16) | 20 | 30 | 30 | 30 | 35 | — | — | — |
| Nb—Hexyl-Ad (23) | — | — | — | — | — | 30 | — | — |
| Nb—TEG—Ad (26) | — | — | — | — | — | — | 30 | — |
| Nb—2V—Me•4PF₆ (10) | — | — | — | — | — | — | — | 30 |
| Nb—TEG (19) | 60 | 60 | 90 | 120 | 105 | 90 | 90 | 90 |
| Nb—TEG—ZnTPP (22) | — | — | — | — | — | 1 | 1 | 1 |

TABLE 2
Oscillatory shear rheology testing summary for A_{x, P1} + Bₓ hydrogel and
C_{x, P1} + B₃ control materials in aqueous 100 mM NaCl solutions.

| | Pre-heat | | | Post-heat | | |
|---|---|---|---|---|---|---|
| Hydrogel | G′ (kPa) | G″ (kPa) | Tan (d) | G′ (kPa) | G″ (kPa) | Tan (d) |
| A_{1, P1} + B₁ | 0.017 ± 0.005 | 0.114 ± 0.028 | 6.7 | 178 ± 98 | 51 ± 22 | 0.29 |
| A_{2, P1} + B₂ | 0.065 ± 0.016 | 0.308 ± 0.066 | 4.7 | 580 ± 351 | 186 ± 87 | 0.32 |
| A_{3, P1} + B₃ | 0.080 ± 0.050 | 0.390 ± 0.140 | 4.9 | 470 ± 227 | 145 ± 57 | 0.31 |
| A_{4, P1} + B₄ | 0.056 ± 0.004 | 0.249 ± 0.019 | 4.4 | 91 ± 53 | 41 ± 17 | 0.45 |
| A_{5, P1} + B₅ | 0.049 ± 0.018 | 0.201 ± 0.057 | 4.1 | 230 ± 232 | 79 ± 82 | 0.34 |
| C_{1, P1} + B₃ | 0.418 ± 0.107 | 0.718 ± 0.177 | 1.7 | 31 ± 5 | 17 ± 3 | 0.55 |
| C_{2, P1} + B₃ | 0.111 ± 0.015 | 0.529 ± 0.037 | 4.8 | 312 ± 239 | 89 ± 53 | 0.29 |

### Saltwater-Induced Mechanism of Gelation

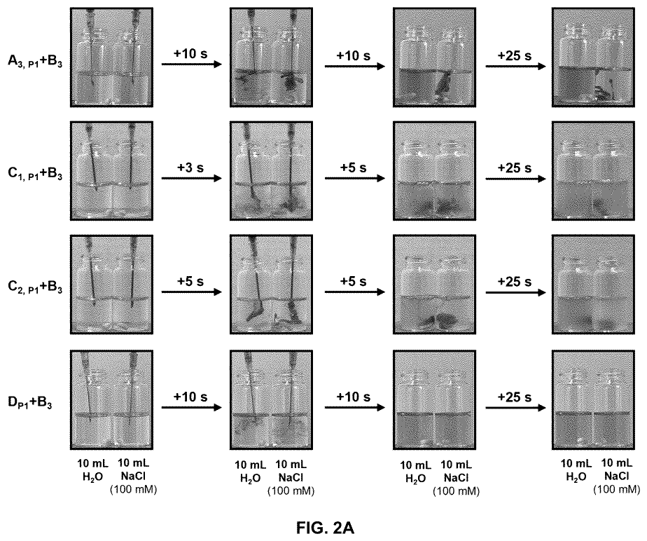

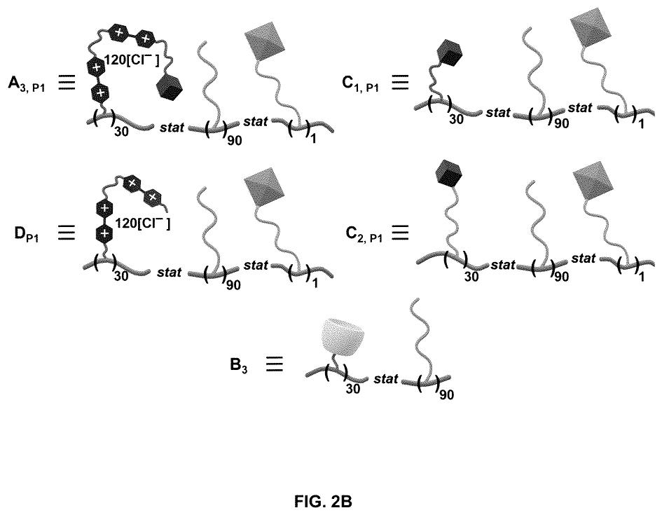

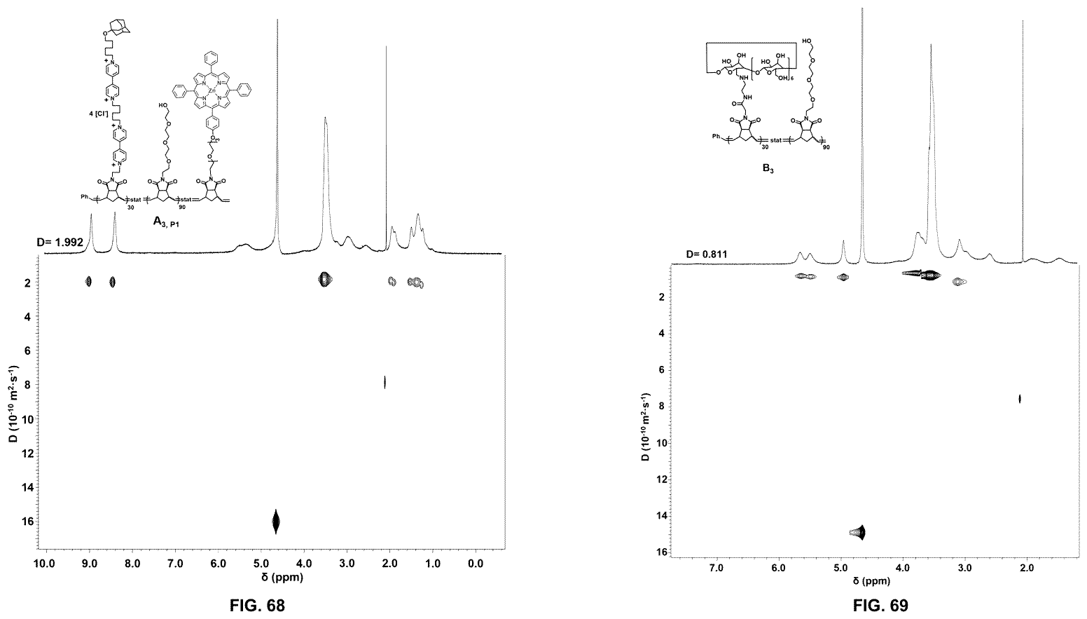

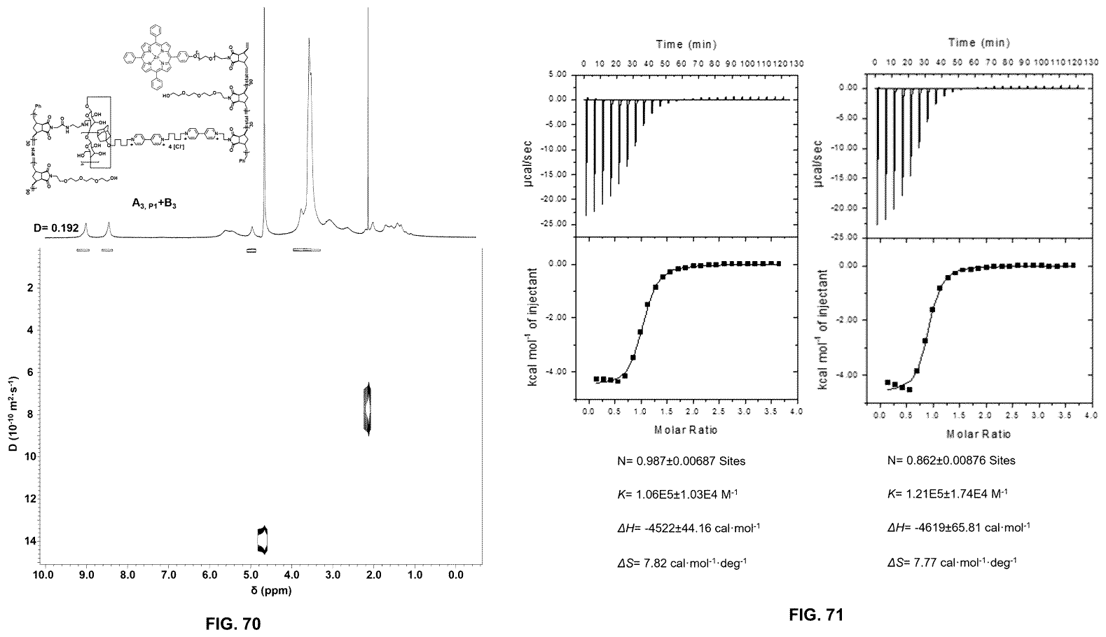

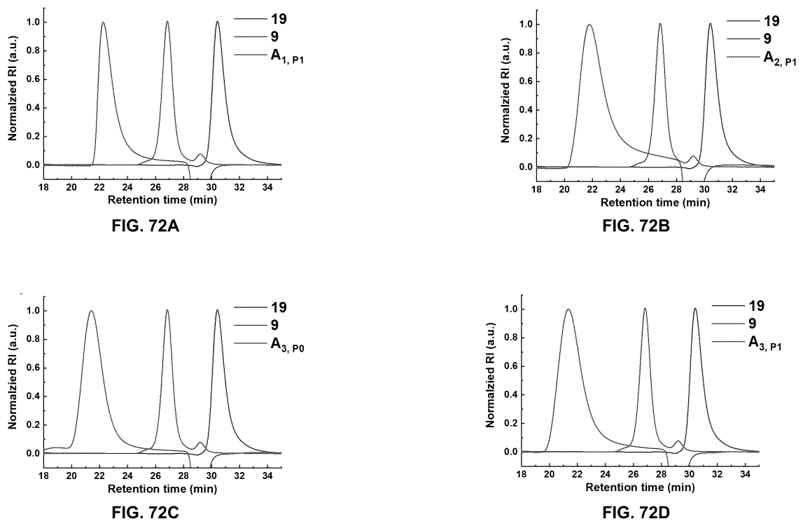

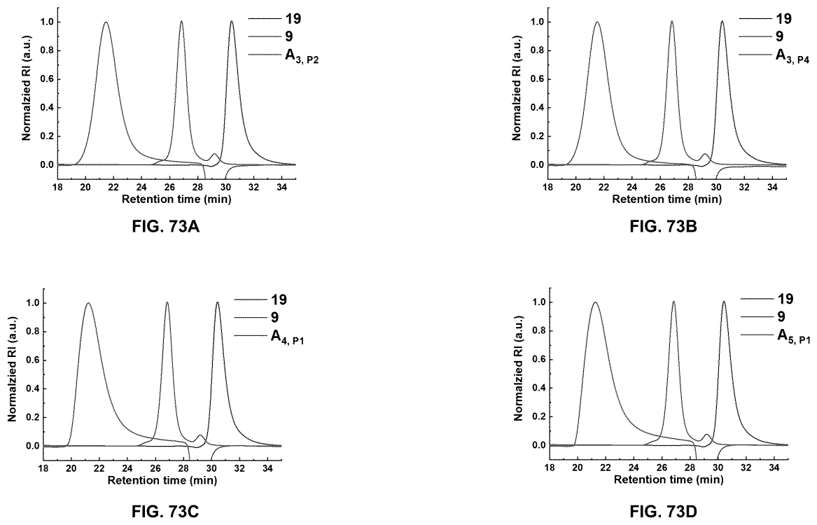

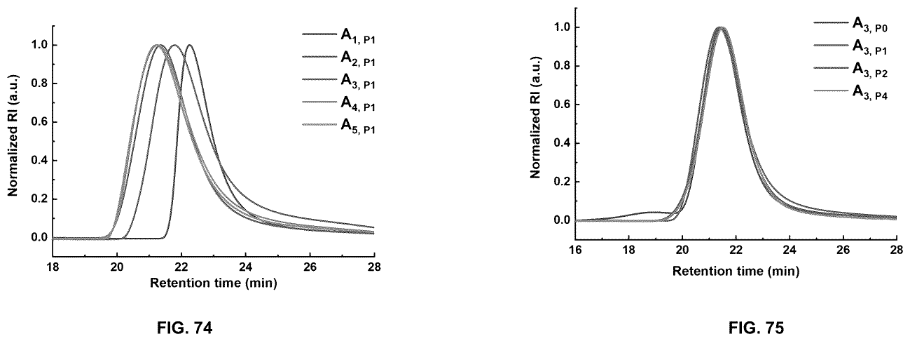

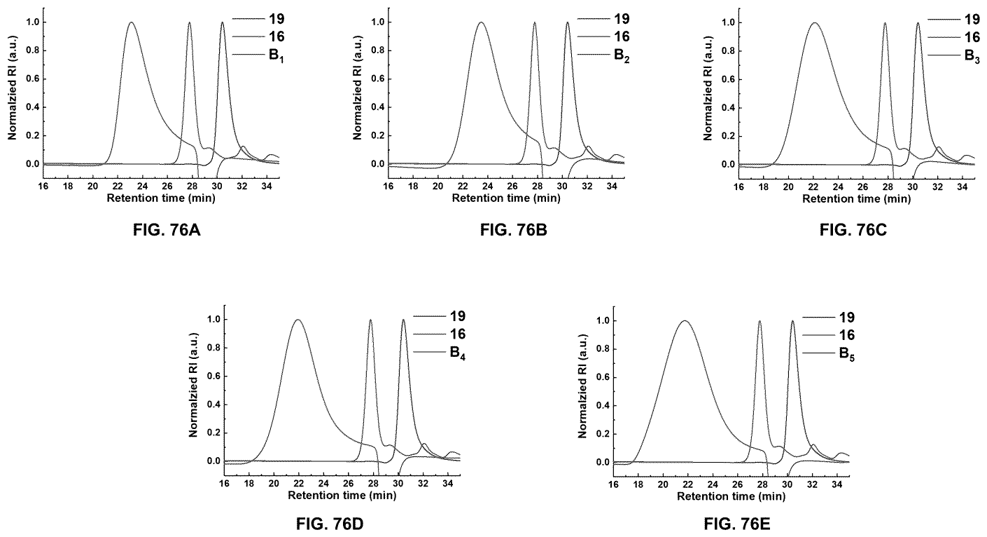

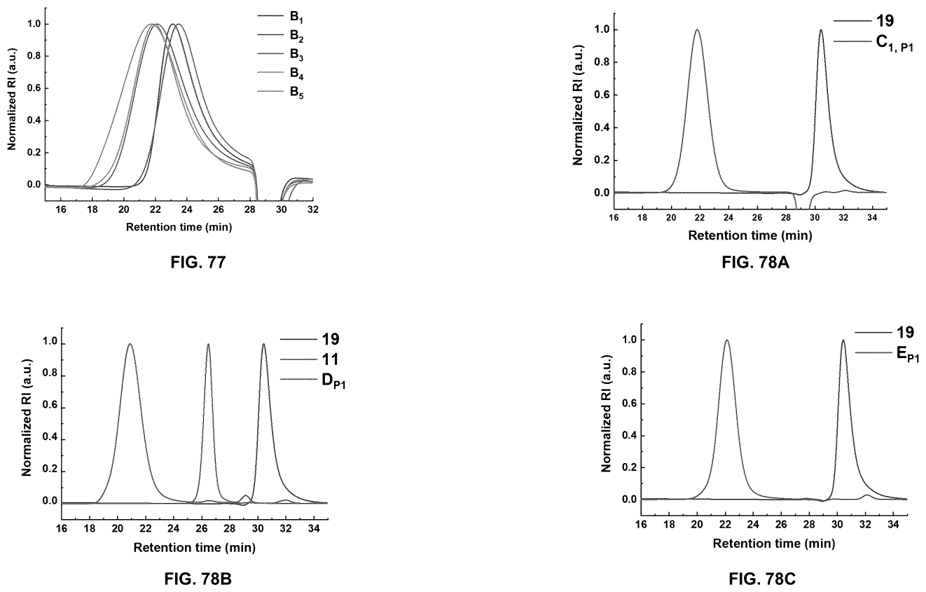

The two-part mechanism of gelation (FIG. 2B) entails the formation of a soluble polymer network upon mixing copolymers A_{3, P1} and B₃ in H₂O at 50 mg·mL⁻¹. At this stage, crosslinking occurs in solution as a function of host-guest complex formation between the Ad/CD side chain groups, as expected. However, no hydrogel formed until the soluble A_{3, P1}+B₃ copolymer network was added via syringe (FIG. 2A) to a saltwater solution containing 100 mM NaCl. Rapid gelation resulted as soon as the A_{3, P1}+B₃ pre-gel solution was injected into saltwater, and the hydrogel adopted a filamentous morphology that adhered to the stainless-steel syringe needle, the glass walls of the vial, and the “non-stick” Teflon stir bar. By comparison, when the A_{3, P1}+B₃ pre-gel solution was injected into deionized H₂O, the copolymer mixture dissolved, but no hydrogel formation was observed. Crosslinking in deionized H₂O without gelation was confirmed by both diffusion-ordered spectroscopy (DOSY, FIG. 68, FIG. 69, FIG. 70) and isothermal titration calorimetry (ITC, FIG. 71). The polar oligoviologen side chains of the ‘guest’ copolymer makes the A_{3, P1}+B₃ network more hydrophilic and therefore more soluble in H₂O. When exposed to a high ionic strength solution, the A_{3, P1}+B₃ network rapidly formed a hydrogel.

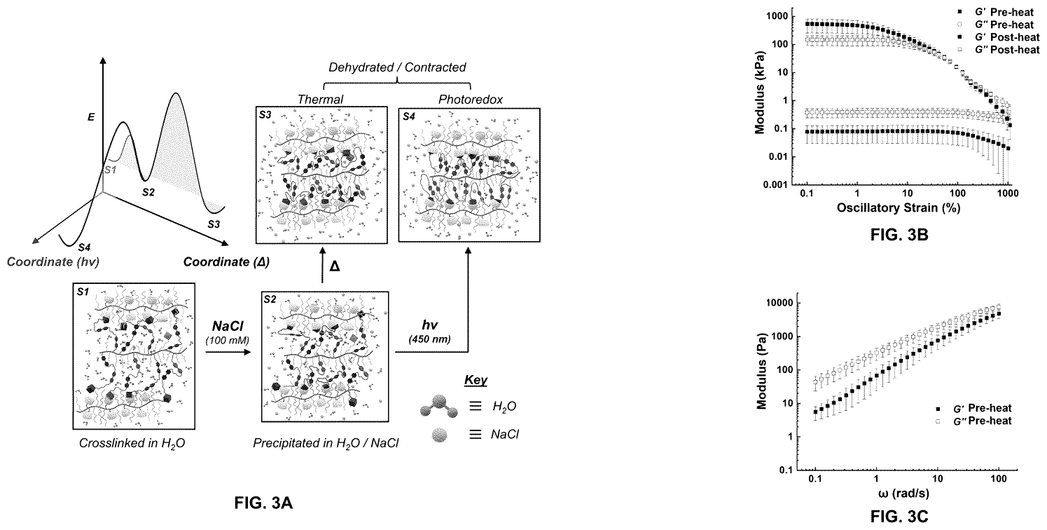

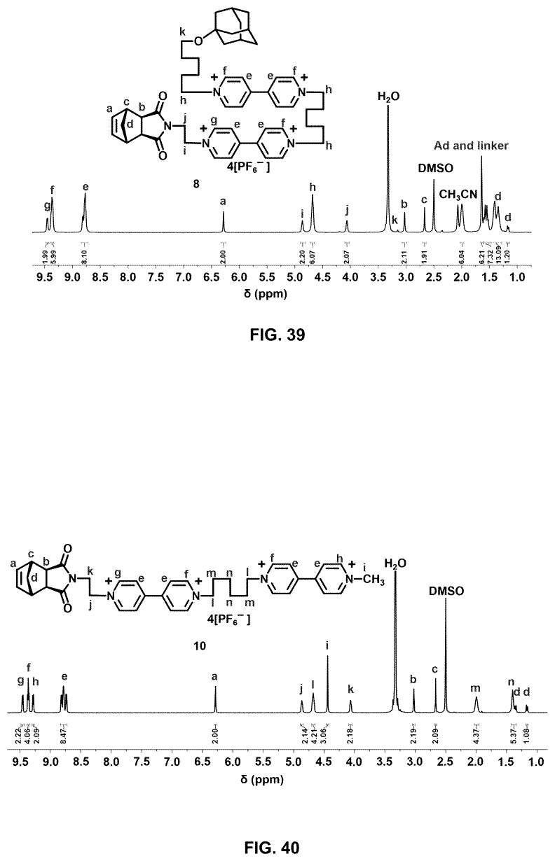

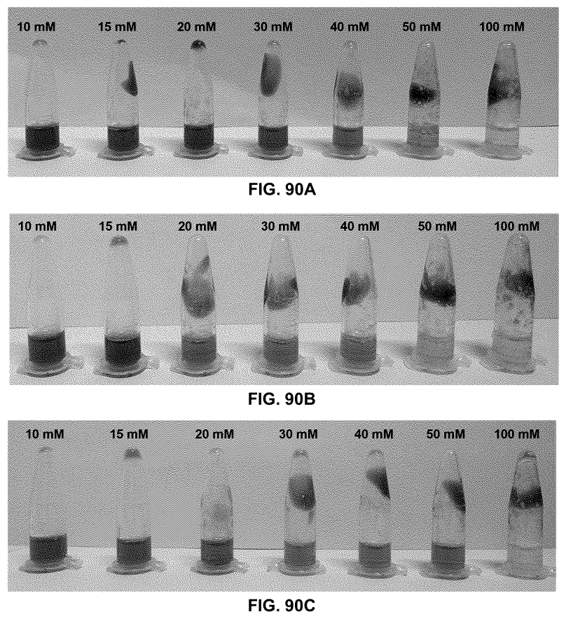

This type of salt-responsive phenomenon has been observed previously for PNB-based copolymers bearing non-viologen cationic side chains. While previous results demonstrated higher ionic strength solutions decreased electrostatic repulsion between the cationic side chains of bottlebrush polymers, resulting in a conformational change from an extended polymer structure to a collapsed and therefore precipitated state, it should be noted that the precipitate in the former case produced an emulsion instead of a hydrogel, whereas the PNBs described herein were crosslinked non-covalently through the formation of host-guest complexes, which allowed the network structure to persist even after being exposed to a high ionic strength solution. Thus, the A_{3, P1}+B₃ pre-gel solution (FIG. 2A, FIG. 3A, FIG. 39) was kinetically trapped as a viscous hydrogel (FIG. 3A, FIG. 40) instead of as a precipitated emulsion that was observed previously. Moreover, the A_{3, P1}+B₃ hydrogels could be converted back to their water-soluble form by removing the saltwater and replacing it with deionized H₂O. This level of reversible gelation is quite distinct from most other host-guest crosslinked and shear-thinning hydrogels reported in the literature. For example, a typical shear-thinning hydrogel will form in deionized H₂O at high enough concentrations as well as in saltwater. When loading a syringe with this material, parameters such as viscosity, composition, concentration, the length and gauge of the needle, and the rate of injection must be determined in advance to ensure proper flow. However, the A_{3, P1}+B₃ polymer mixture reported here remains completely soluble in H₂O and is therefore readily injectable with practically any syringe setup. Conversely, formation of a viscous hydrogel occurs rapidly (i.e., kinetic trapping) upon contact with a high ionic strength solution (e.g., cell culture media, in vivo conditions, etc.). It is important to note that changing the salt from NaCl to LiCl also produced cohesive hydrogels from 50-100 mM (FIG. 90B), whereas with KCl, the solution surrounding the hydrogels appeared more colored at 50 mM (FIG. 90C), meaning more of A_{3, P1} was freed.

To confirm the two-part gelation mechanism, three additional copolymers were synthesized (FIG. 2B): poly(HexylAd₃₀-TEG₉₀-ZnTPP)ₛₜₐₜ (C_{1, P1}), poly(TEGAd₃₀-TEG₉₀-ZnTPP)ₛₜₐₜ (C_{2, P1}), and poly(2V⁴⁺Me₃₀-TEG₉₀-ZnTPP)ₛₜₐₜ (Dpi). Copolymers C_{1, P1} and C_{2, P1} were designed to mimic copolymer A_{3, P1} except the oligoviologen subunits were replaced by a non-polar hexamethylene aliphatic tether and a polar TEG linker, respectively. Copolymer D_{P1} was also designed to mimic A_{3, P1} except the Ad group was replaced by a methyl group. Preparation of the C_{1, P1}+B₃ copolymer mixture in a syringe at 50 mg·mL⁻¹ in deionized H₂O proved cumbersome to load and inject into vials containing deionized H₂O or saltwater given its propensity to immediately form a gelatinous emulsion in the syringe. Even so, care was taken to add the two copolymers C_{1, P1} and B₃ to the syringe with as little mixing as possible (to maintain injectability), followed by injecting the 1:1 mixture into H₂O and saltwater (FIG. 2A, second row) through a 16 G needle (vs the smaller 18 G needle used for A_{3, P1}+B₃). A murky precipitate formed in both solutions, however, the gelation was more pronounced in the 100 mM NaCl solution, as evidenced by the solution becoming less colored and containing a higher concentration of non-gel precipitates. At lower concentrations (i.e., s 30 mg·mL⁻¹), the C_{1, P1}+B₃ mixture could be loaded 1:1 into the syringe without as much initial gelation, making it easier to eject from the syringe into each solution. Even still, the injected solution remained murky with some hydrogel observed at the bottom of the vial.

The issues encountered with the C_{1, P1}+B₃ copolymer mixture led us to pursue a more polar copolymer that would better mimic A_{3, P1}, while still lacking the positive charges associated with the oligoviologen side chains. To this end, copolymer C_{2, P1} was synthesized with polar TEG linkers tethering the Ad groups to the PNB backbone (FIG. 2B). Initial attempts to mix this copolymer 1:1 with B₃ at room temperature also proved difficult because C_{2, P1} precipitated out of H₂O above its lower critical solution temperature (LCST). In fact, C_{2, P1} copolymer solutions had to be cooled to 4° C. (below the LCST) to fully dissolve in either H₂O or saltwater. Thus, to carry out the control experiment, C_{2, P1} and B₃ were kept in separate vials at 4° C. before being loaded into a syringe at a concentration of 50 mg·mL⁻¹ and immediately injected into the vials filled with either H₂O or aqueous 100 mM NaCl. The results from this control experiment (FIG. 2A, third row) demonstrate that upon injection of the C_{2, P1}+B₃ copolymer mixture, uniform hydrogels were formed initially, but quickly became unstable, as evidenced by the clear-to-murky visible transition that occurred after only ˜25 sec. Both of these control experiments demonstrate the necessity for the positively charged oligoviologen side chains, which helped solubilize the A_{3, P1}+B₃ copolymer mixture in H₂O without any hydrogel formation, while also serving as the reason for rapid gelation (or kinetic trapping, FIG. 3A, FIG. 40) upon addition to a saltwater solution.

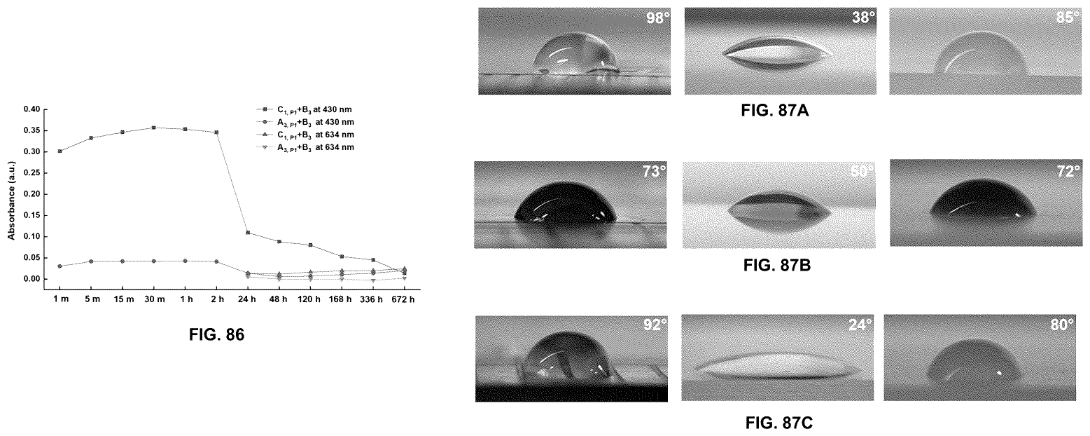

An additional four-week degradation experiment (FIG. 84, FIG. 85, FIG. 86) was carried out using UV-vis absorption spectroscopy to quantify the stability of host-guest-crosslinked products for copolymer mixtures C_{1, P1}+B₃ vs A_{3, P1}+B₃ in solution—both at 30 mg·mL⁻¹ in 100 mL of an aqueous 100 mM NaCl solution. Aliquots were taken intermittently and assessed by UV-vis. Copolymer mixture C_{1, P1}+B₃ in contrast to A_{3, P1}+B₃ demonstrated absorption at 430 nm immediately after injection into the saltwater solution (note, the porphyrin side chain absorbs strongly in the visible region). Conversely, copolymer mixture A_{3, P1}+B₃ demonstrated little to no solution-phase absorption at 430 nm over the entire four-week experiment. The results of this stability study confirmed that A_{3, P1}+B₃ copolymer mixture maintained its heterogeneous hydrogel form over extended durations and the C_{1, P1}+B₃ copolymer mixture took longer for smaller precipitates to aggregate and fall out of solution. Lastly, the gelation mechanism was evaluated in the absence of Ad groups (i.e., D_{P1}+B₃ copolymer mixture), and hence no host-guest interactions were possible. Not surprisingly, both copolymers dissolved (FIG. 2A) in deionized H₂O and in saltwater without hydrogel formation in either case.

### Modulating Rheological Properties as a Function of Host-Guest Crosslinking and Water Content

To further investigate the host-guest crosslinking dynamics in the copolymer network, the A_{3, P1}+B₃ hydrogels were heated from 25 to 80° C. on the rheometer stage, then held there for 10 min, followed by cooling it back to 25° C. and holding for an additional 10 min prior to testing. All the A_{3, P1}+B₃ hydrogels post-heating exhibited (FIG. 3B) shear-thinning properties in response to higher strain as well as a large increase in both G′ and G″. Also, the A_{3, P1}+B₃ hydrogels demonstrated more elastic-like properties (i.e., G′>G″) after heating versus the more viscous behavior (G″>G′) that was observed for hydrogels freshly prepared in saltwater (upper vs lower data traces; FIG. 3B). Moreover, the frequency sweep data for the pre-heated samples (FIG. 3C) shows higher G′ and G″ values at higher angular frequencies, as would be expected for a shear-thinning material, however, no formal crossover point occurs in the frequency range tested during the experiment. The change in behavior pre-/post-heating is directly related to the efficiency by which the CD hosts of copolymer B₃ can form inclusion complexes with the Ad guests of copolymer A_{3, P1}. Because the gelation step occurred rapidly upon addition of copolymers A_{3, P1} and B₃ to saltwater, it appeared that not all the CD and Ad groups were initially able to participate in host-guest-based crosslinking (i.e., kinetically trapped). However, after heating at 80° C. for 10 min, the hydrogels lost some H₂O through evaporation and became even more viscous, which resulted from the formation of more Ad/CD inclusion complexes and thus greater crosslinking. This proposed mechanism (FIG. 3A) is supported by the rheological data shown in FIG. 3B and FIG. 3C, where the pre-heated A_{3, P1}+B₃ hydrogels demonstrated viscous behavior and the post-heated samples exhibited more elastic-like properties. As the percent strain was increased during the rheological characterization experiments, a crossover point occurred where the storage modulus (G′) fell below the loss modulus (G″), clearly indicating shear-thinning properties post-heating.

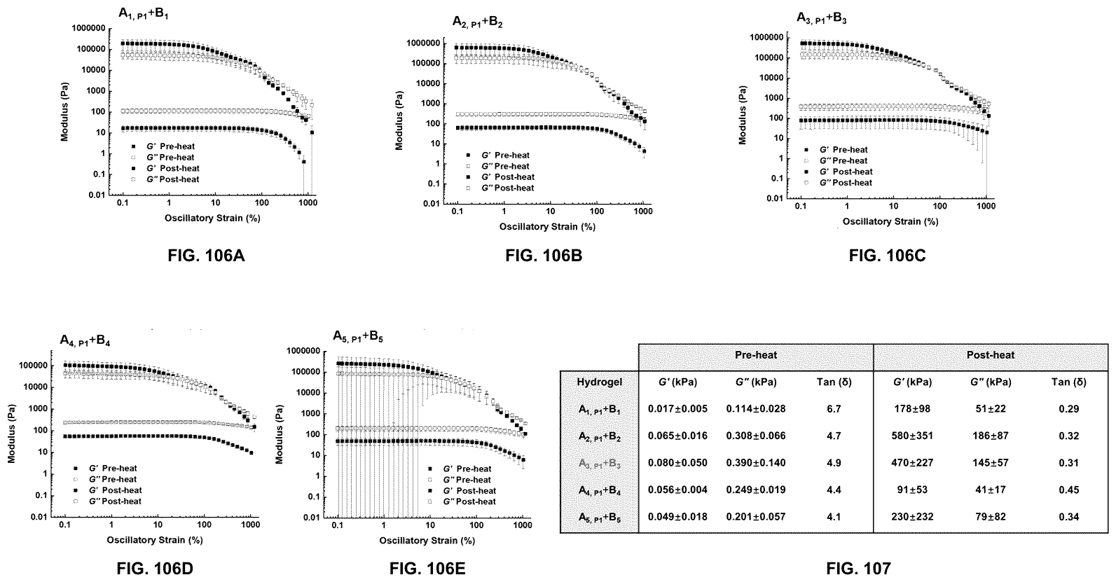

To further support the proposed kinetic trapping mechanism, the rheological properties were evaluated for the series of A_{x, P1}+Bₓ hydrogels (Table 2, FIG. 106A, FIG. 106B, FIG. 106C, FIG. 106D). Because the A_{1, P1}+B₁ copolymer mixture had less host-guest crosslinking before heating—a function of having the fewest (20) available crosslinking sites per copolymer—it exhibited the lowest initial values for G′ and G″ out of all the as-injected hydrogels. Conversely, the A_{4, P1}+B₄ mixture was functionalized with 30 Ad/CD crosslinking sites, yet both copolymers possessed more TEG repeat subunits (120/copolymer) than any other copolymer mixture in the series. These additional TEG side chains would be expected to create a larger steric/kinetic barrier that could offset the increased number of crosslinking host-guest complexes. For the A_{5, P1}+B₅ copolymers, the polymerization did not go to full completion and the standard errors, particularly for the post-heated samples, is large. Both the A_{3, P1}+B₃ and A_{2, P1}+B₂ copolymer mixtures gave the best performance in terms of storage/loss moduli, before and after heating, meaning that a balance between the number of crosslinking sites (30) and number of TEG side chains per copolymer (90 and 60, respectively) was achieved.

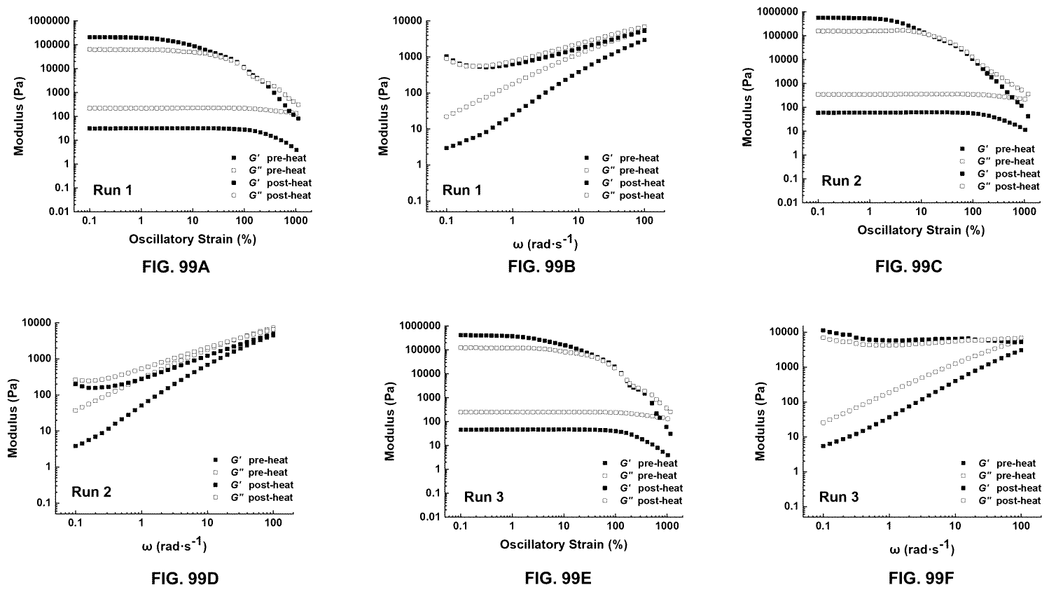

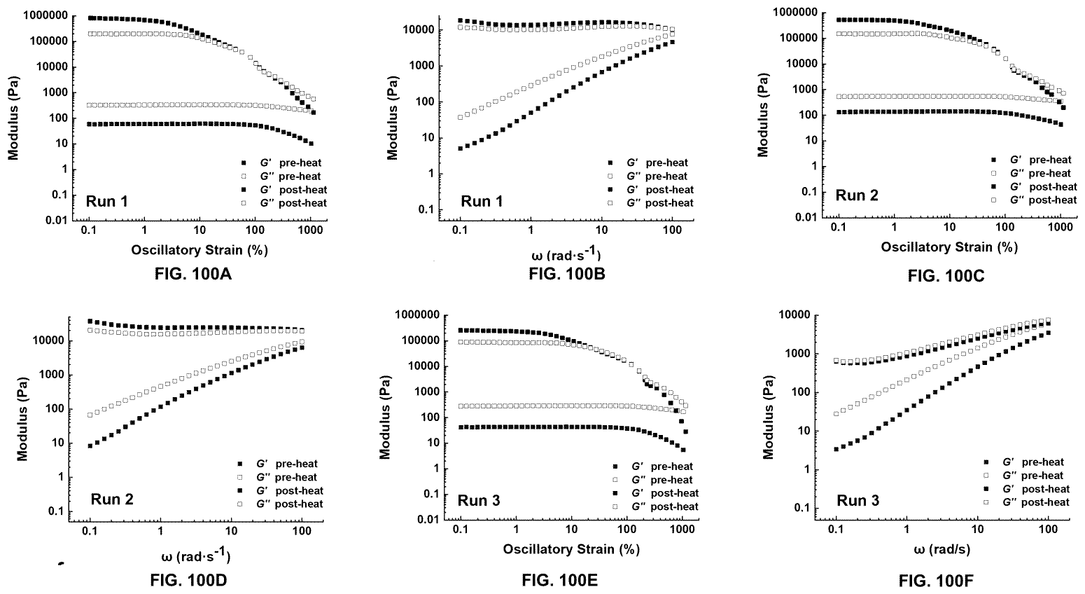

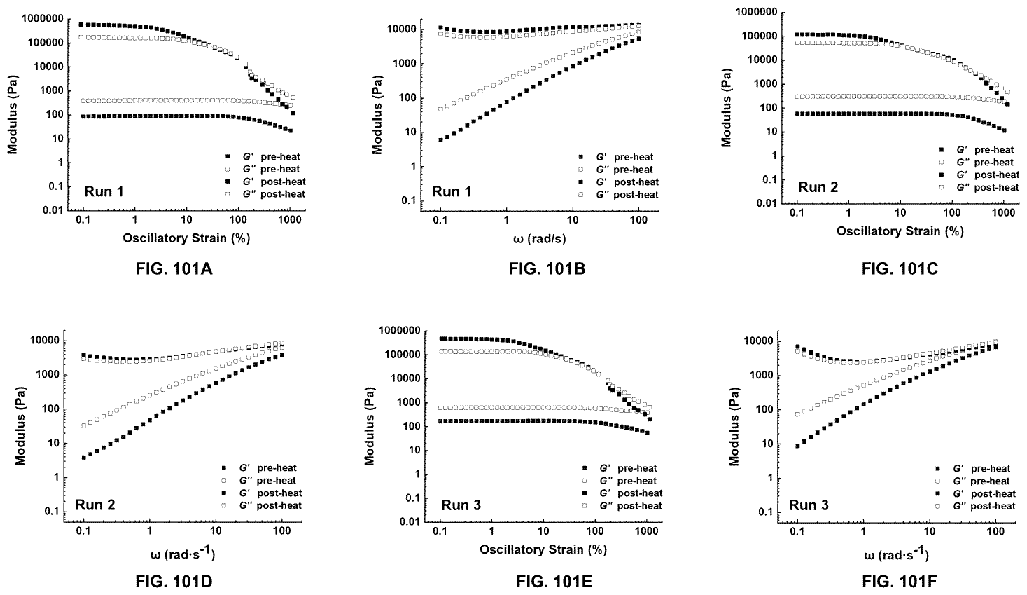

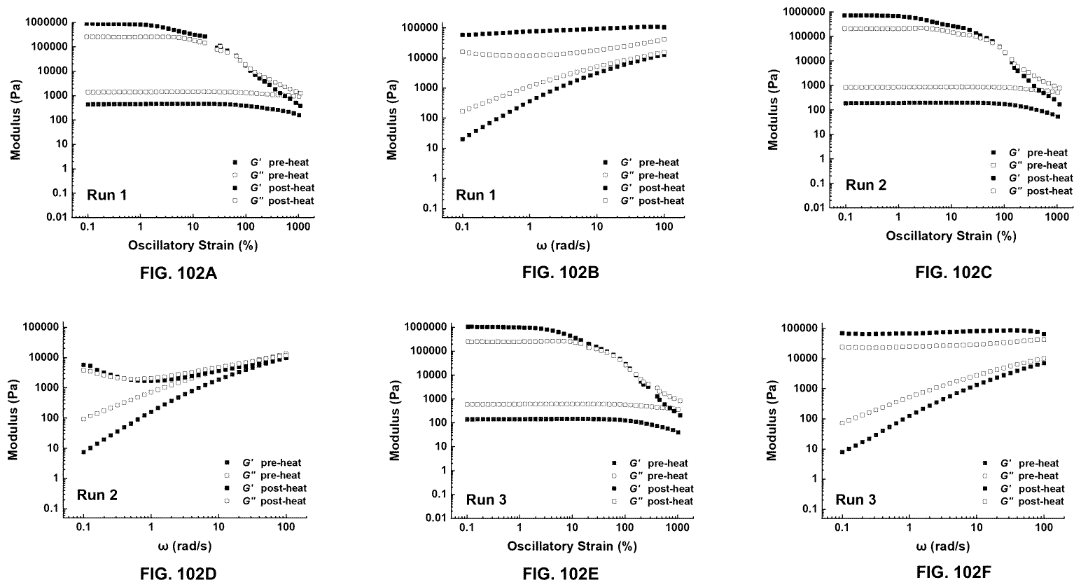

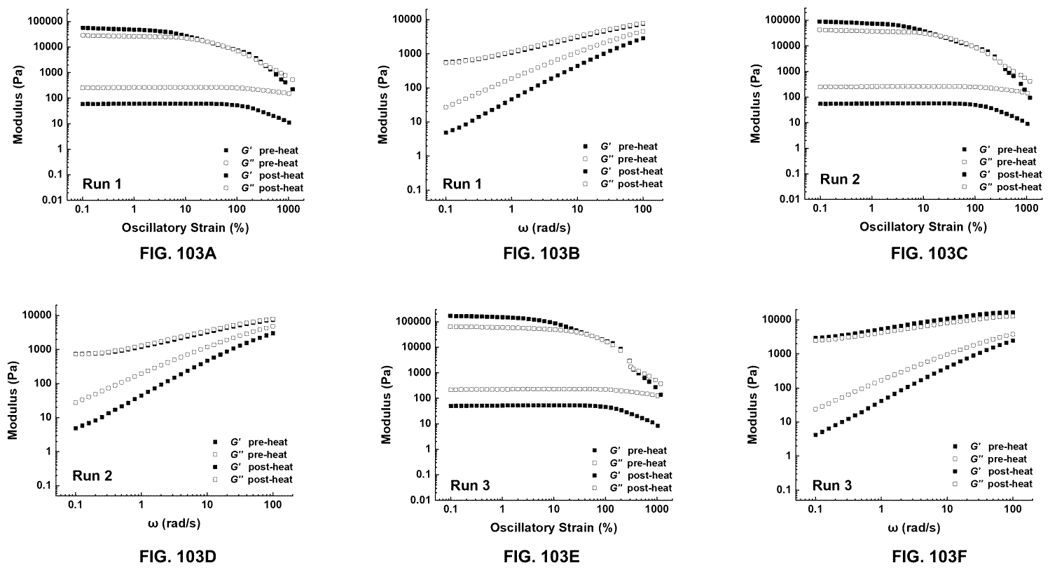

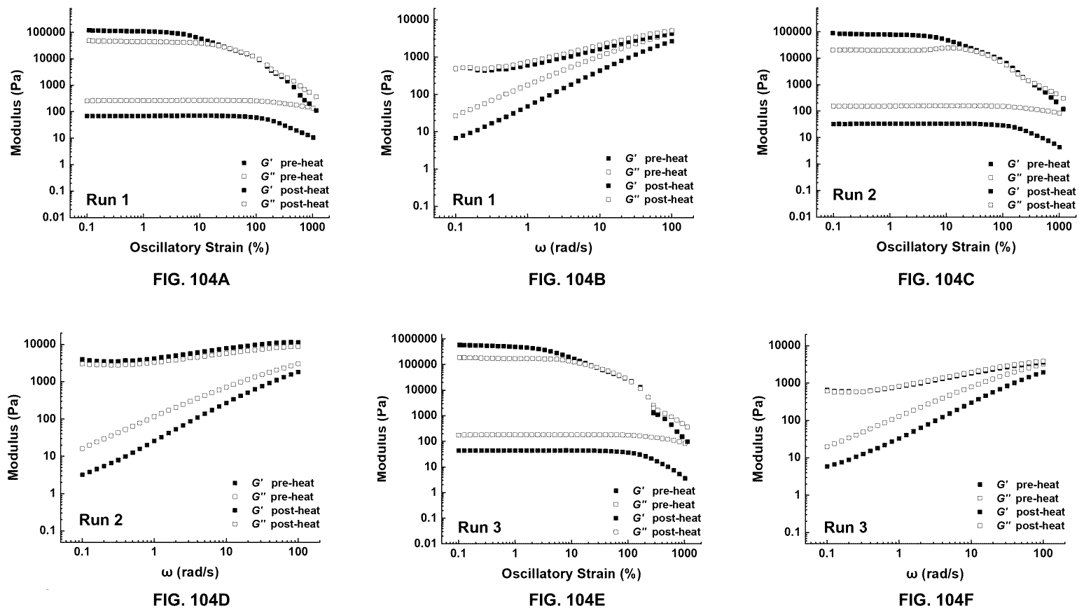

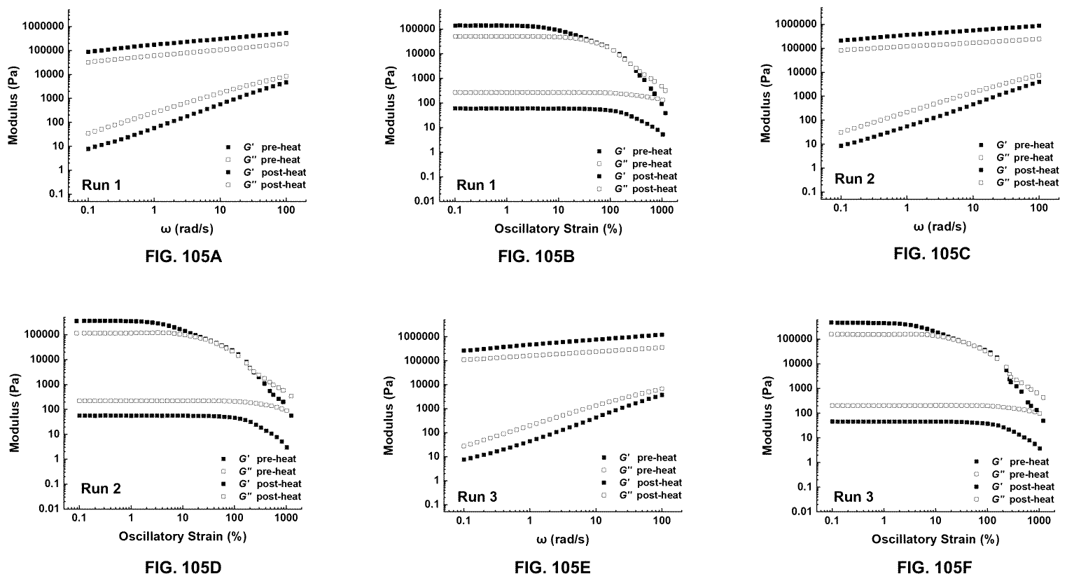

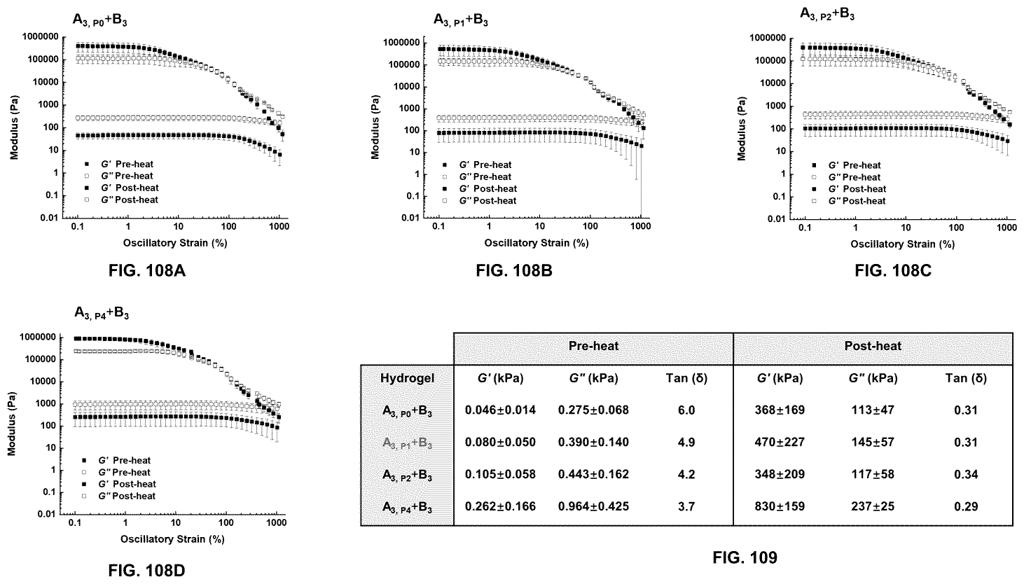

Before investigating their photoredox-based responsiveness (vide infra), the rheological properties of A_{3, Pn}+B₃ hydrogels were evaluated (FIG. 99A-F, FIG. 100A-F, FIG. 101A-F, FIG. 102A-F, FIG. 108A-D) as a function of the average number of porphyrin-based side chains (n=0, 1, 2, or 4) present in copolymer A_{3, Pn}. Physical properties of the hydrogels can be modulated by the number of porphyrin subunits in the network, as it has been shown previously that small-molecule TPPs can self-assemble into stacks in solution, which, in the context of a polymer network, may contribute to additional crosslinking between A_{3, Pn} copolymers. All the A_{3, Pn}+B₃ hydrogels that were investigate exhibited viscous-like properties prior to heating (i.e., G″>G′ when initially mixed in saltwater), even at higher oscillatory strain. However, as more porphyrin side chains were introduced into copolymer A_{3, Pn}, the storage modulus (G′) of the A_{3, Pn}+B₃ hydrogels increased more than the corresponding loss modulus (G′). This change resulted in a decreasing differential between the two moduli and indicates that the porphyrin side chains can participate some in crosslinking through stacking, thus increasing the overall viscosity of the photoredox-responsive hydrogels.

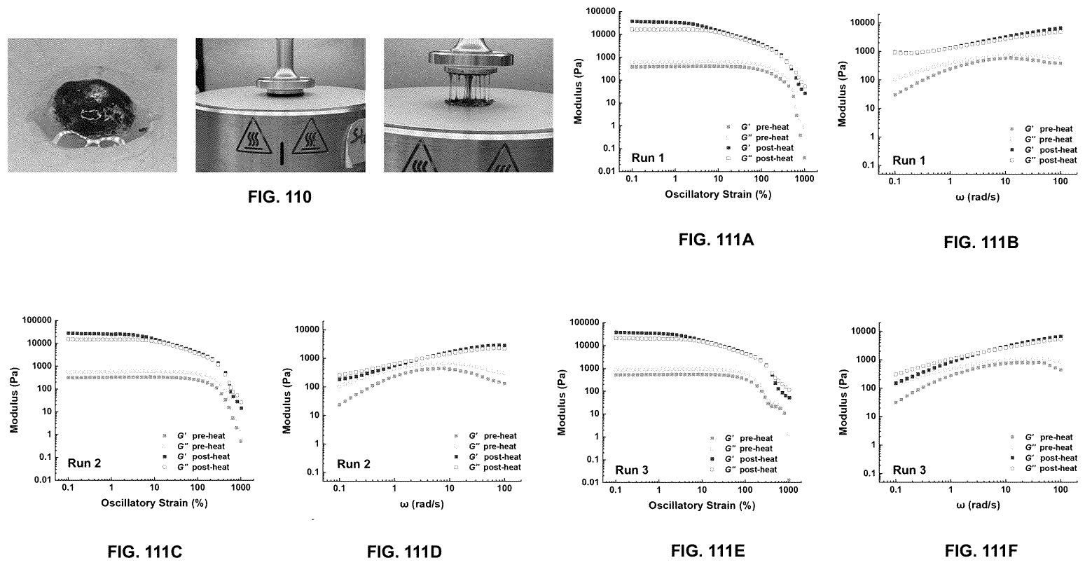

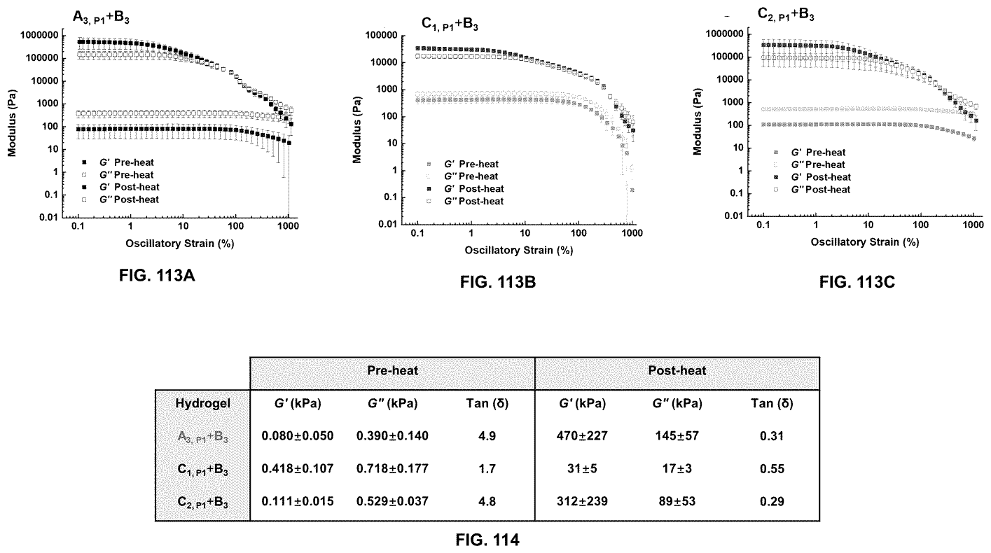

Next, the rheological properties of the control hydrogels, C_{1, P1}+B₃ and C_{2, P1}+B₃, were evaluated. The C_{1, P1}+B₃ hydrogel exhibited the highest G′ and G″ prior to being heated than any of the other gels (Table 2, FIG. 111A, FIG. 111B, FIG. 111C, FIG. 111D, FIG. 111E, FIG. 111F, FIG. 113A, FIG. 113B, FIG. 113C), indicating it was much stiffer in its kinetically trapped state. Moreover, as it was found to be much stiffer, the strain sweep experiment prior to heating displayed a drop at higher strain values. After heating, the C_{1, P1}+B₃ hydrogel exhibited a much lower storage and loss moduli relative to the other hydrogels in the series, which likely occurred because of it not holding onto H₂O as much, which may be largely excluded due to the non-polar aliphatic linkers present in the copolymer's side chains. This early occlusion of H₂O meant that heating would not be expected to increase the extent of host-guest crosslinking compared to the more polar A_{3, P1}+B₃ hydrogels. Moreover, after heating, the C_{1, P1}+B₃ hydrogel became sticky (FIG. 110, left), which may explain the results from the lap-shear tests (Table 3), where oven drying for 24 h of the C_{1, P1}+B₃ mixture in between two pieces of metal yielded the largest shear stress values of the series of hydrogels on glass, metal, and high-density polyethylene (HDPE).

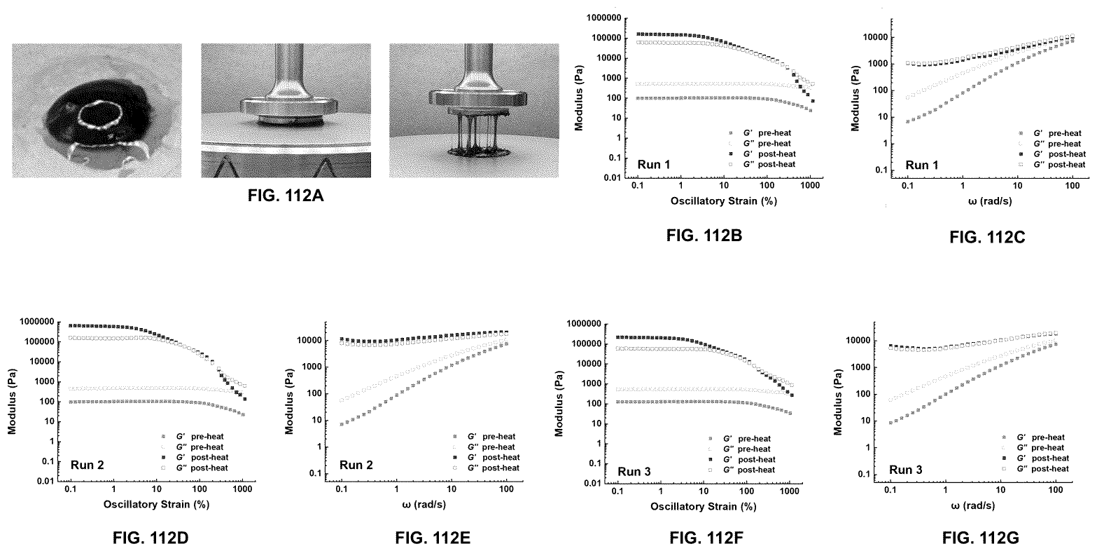

Lastly, the other control hydrogel, C_{2, P1}+B₃, bearing polar TEG linkers between the Ad groups and the PNB backbone was assessed by strain and frequency sweep rheology to determine its mechanical properties pre-/post-heating. Given the similarity of structures and overall polarity, it was not surprising to see this control hydrogel C_{2, P1}+B₃ yield G′ and G″ values comparable to the A_{3, P1}+B₃ hydrogels (Table 2, FIG. 112B, FIG. 112C, FIG. 112D, FIG. 112E, FIG. 112F, FIG. 112G, FIG. 113A, FIG. 113B, FIG. 113C). The post-heating rheological data seems to suggest that even though the C_{2, P1} copolymer has more polar TEG side chains, it still may not absorb as much H₂O as the A_{3, P1} copolymer on account of the viologen subunits' higher polarity and greater propensity to absorb H₂O. This interpretation is based on the relative increase in G′ observed for the A_{3, P1}+B₃ hydrogels vs that which was measured for the C_{2, P1}+B₃ hydrogels (i.e., 5875× vs 2810× increase, respectively). However, it is important to note once again that the process for performing rheological tests on the C_{2, P1} copolymer is it to be kept at 4° C. until mixed with polymer B₃ so the mixture is as homogeneous as possible.

TABLE 3
Lap-shear adhesion testing summary for A_{3, P1} + B₃ hydrogel and
C_{1, P1} + B₃ emulsion in aqueous 100 mM NaCl solutions.

| | Shear Stress (MPa) | | | | | |
|---|---|---|---|---|---|---|
| | A_{3, P1} + B₃ Hydrogel | | | C_{1, P1} + B₃ Emulsion | | |
| Substrate | i^{a} | ii^{a} | iii^{a} | i^{a} | ii^{a} | iii^{a} |
| Glass^{b} | 0.14-0.17 | 0.66 | 1.12 | 0.24 | 1.65 | 1.55 |
| Metal^{c} | 0.23-0.31 | 0.42-0.51 | 2.0-3.3 | 0.43-0.52 | 1.98-3.7 | 4.98-8.5 |
| HDPE^{d} | 0.18-0.24 | 0.84-0.96 | 0.70-0.87 | 0.14-0.20 | 0.59-0.76 | 0.56-0.85 |

^{a}Curing protocol: (i) 24 h air dry, (ii) 12 h air dry followed by 12 h oven dry at 80° C., and (iii) 24 h oven dry at 80° C.
^{b}Microscope slide (VWR brand 25 × 75 × 0.9 mm).
^{c}Stainless steel ruler (28 × 75 × 0.9 mm).
^{d}High density polyethylene (25 × 75 × 1.6 mm)

### Versatile Adhesive Properties of the Viscous Hydrogels

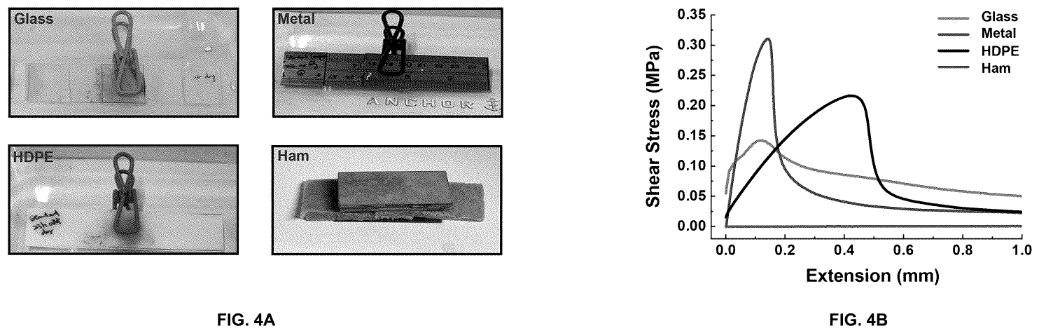

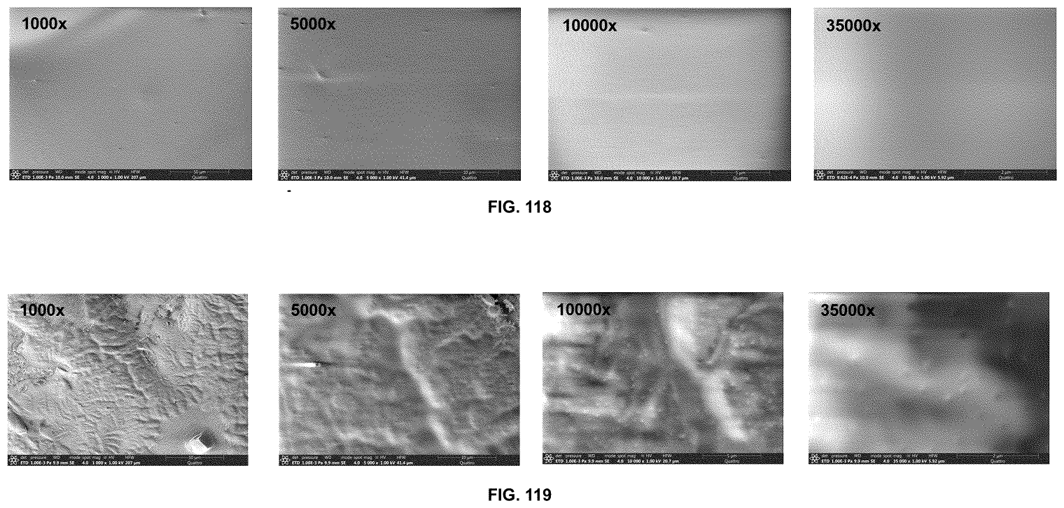

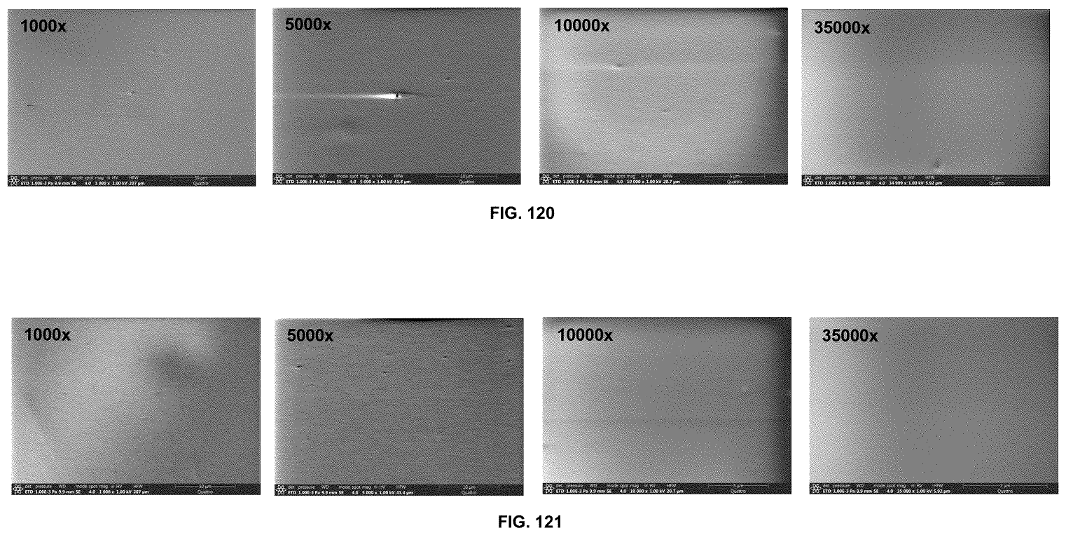

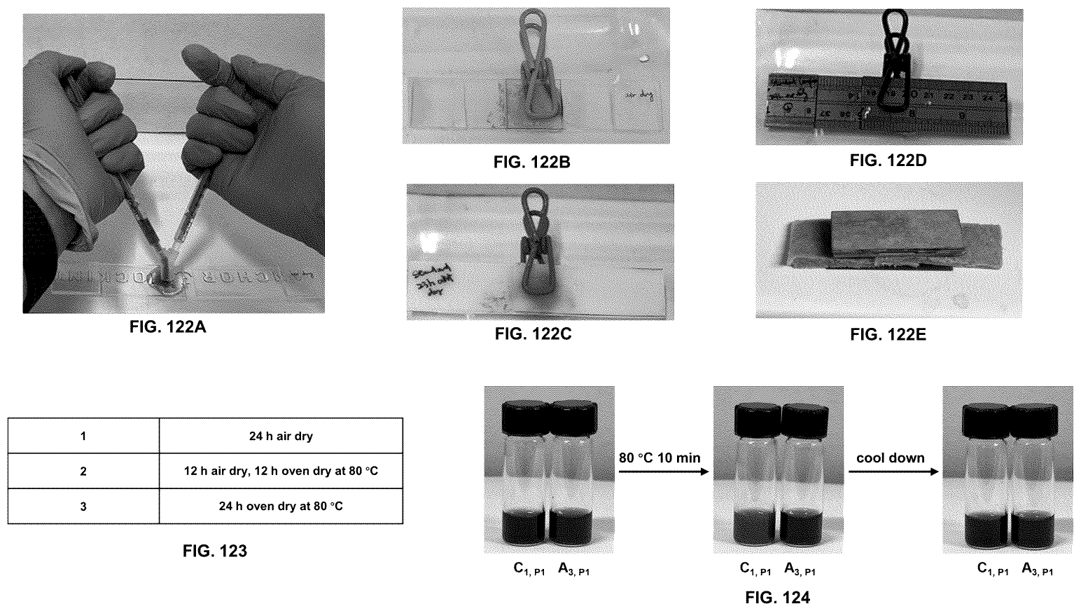

The investigation of the two-part gelation mechanism (i.e., host-guest crosslinking followed by saltwater-induced gelation and kinetic trapping, FIG. 2A, FIG. 2B, FIG. 3A, FIG. 3B, FIG. 3C) revealed the versatile nature of the A_{3, P1}+B₃ hydrogel's affinity for different surfaces, such as on the glass vial, the stainless-steel syringe, and the non-stick Teflon coated stir bar. Motivated by these observations, lap-shear tests were used to evaluate the adhesive properties of the hydrogels on different substrates such as glass slides, a stainless-steel metal ruler, sheets of HDPE, and store-bought ham, the latter of which was chosen to simulate organic tissue. A dual-syringe method (FIG. 122A) was used to apply the polymer samples onto the substrates. One syringe contained 0.5 mL of a 200 mM NaCl solution while the other contained an equimolar mixture of copolymers A_{3, P1} and B₃ (15 mg in total) dissolved in 0.5 mL deionized H₂O. The plunger of each syringe was suppressed simultaneously to mix both solutions and to apply the hydrogels onto the different substrates. Once deposited onto each surface, another identical substrate was placed on top, sandwiching the hydrogel in between (FIG. 4A). Next, the glass, metal, and HDPE samples were clamped using a standard binder clip and left to dry in air for 24 h. For the ham sample, a small weight (122.7 g) was set on top to keep the ham in place during the curing process instead of a binder clip, which cut through the soft substrate. The lap-shear tests were then conducted to measure the adhesive strength of the hydrogels in between each substrate. The shear stress (MPa) vs. extension (mm) plots are shown in FIG. 4B, where three replicates were performed for each substrate but only the median data trace is overlaid for comparison. The A_{3, P1}+B₃ hydrogels adhered to the glass, metal, and HDPE with a maximum stress ranging from 0.15-0.30 MPa, whereas the store-bought ham used to mimic human tissue barely showed any adhesion, an outcome which may be well suited for coatings on medical devices. The latter statement is well supported by SEM data obtained for thin films comprising the A_{3, P1}+B₃ hydrogels, which showed (FIG. 118, FIG. 119, FIG. 120, FIG. 121) cohesive and homogeneous films.

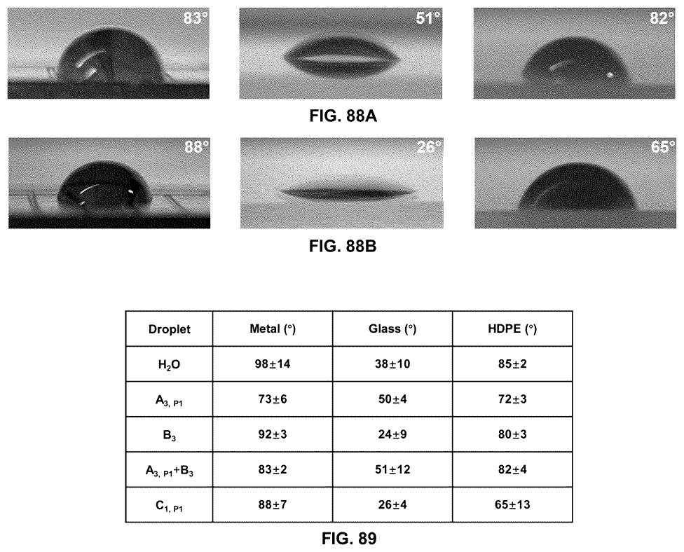

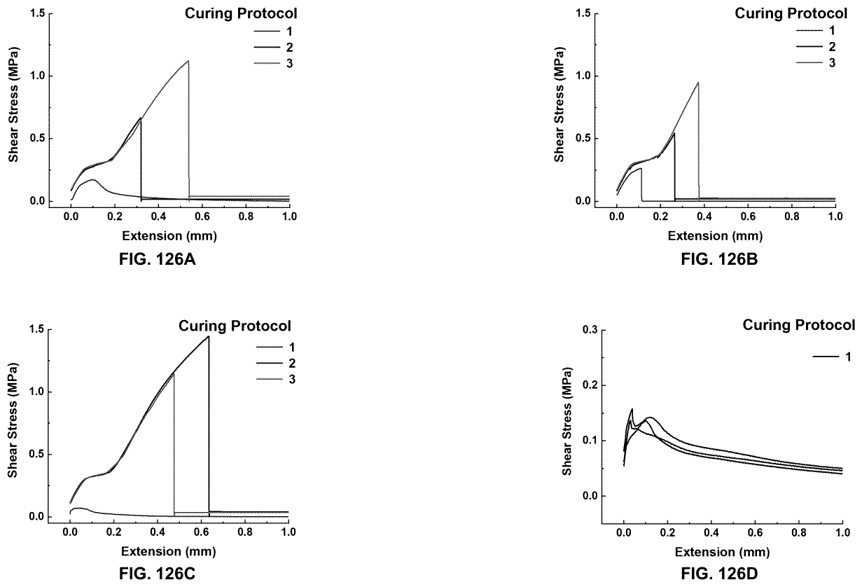

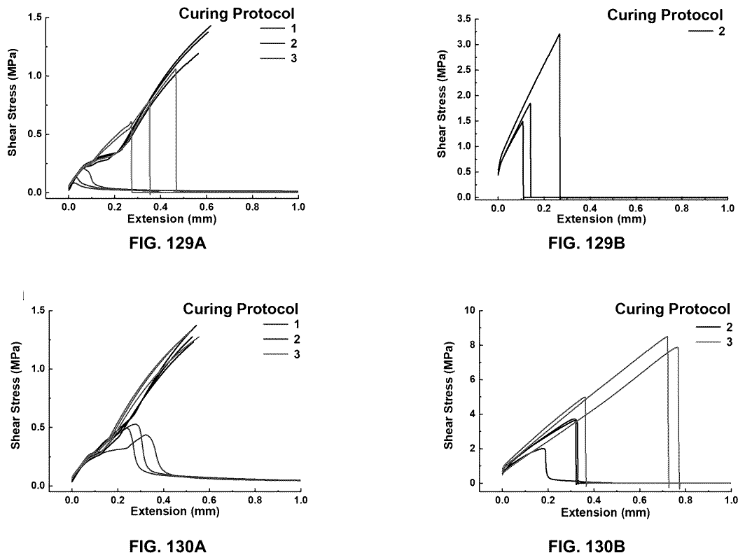

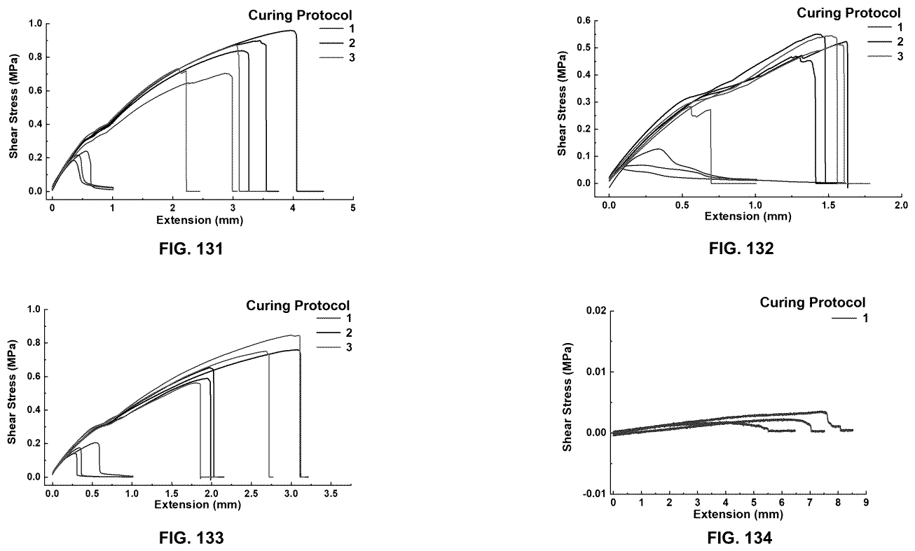

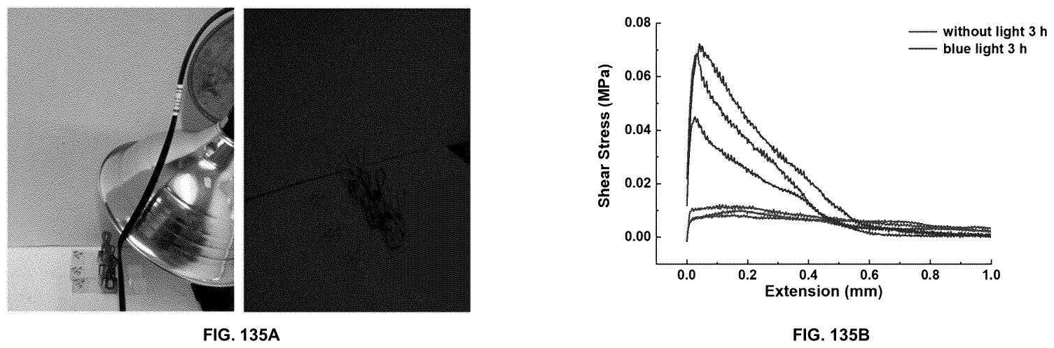

Since the hydrogels behaved differently before and after heating, as evidenced by the rheological data shown in FIG. 3B and FIG. 3C, the adhesive strength of the A_{3, P1}+B₃ hydrogels was then tested on HDPE using the following different curing protocols: (i) 24 h air dry, (ii) 12 h air dry followed by 12 h oven dry at 80° C., and (iii) 24 h oven dry at 80° C. (FIG. 131). The adhesive strength (Table 3) for the 24 h air dried samples (0.18-0.24 MPa) was lower than that which was observed for the samples that were oven dried. However, the 24 h oven dried samples exhibited lower adhesive strength (0.70-0.87 MPa) than the hydrogels that were cured using the 12 h air and 12 h oven dry protocol (0.84-0.96 MPa) (FIG. 131). To rationalize this different behavior, the hydrogels that were oven dried for 24 h underwent nearly complete dehydration, which resulted in the samples becoming more brittle than those which were air and oven dried over a combined 24 h period. This is an important aspect as the copolymers operate through dynamic host-guest inclusion complexes, which may be affected by the lack of solvent present in the hydrogels. Moreover, the underlying HDPE sheets also may have been affected by the oven-based curing protocols, which could have softened the plastic and potentially contributed to a reduction in the observed adhesive strength. The adhesive strength increased 3-4 times for the oven-dried samples relative to those that were only air dried for 24 h. To confirm the ubiquitous nature of these results, A_{3, P1}+B₃ hydrogels were also tested on glass and metal substrates (Table 3, FIG. 126A, FIG. 128A, FIG. 128B). Similar to HDPE, the hydrogels that were heat cured for 24 h demonstrated stronger adhesive properties than those that were air dried (glass: 1.12 vs 0.17 MPa; metal: 2.0-3.3 vs 0.23-0.31 MPa), which is further evidence of the affinity that the viscous hydrogels have for both polar and non-polar surfaces (FIG. 88A, water-contact angle measurements that characterized the polarity of each surface). To put these lap-shear adhesive results into context, positively charged catechol-based polymers reported elsewhere in the literature have been shown to adhere to different surfaces such as glass and aluminum metal to similar effect after drying at 55° C. for 24 h (i.e., 1.5-2.4 MPa vs 1.1-3.3 MPa for A_{3, P1}+B₃). Lastly, attempts to switch the solvent to a 90% MeOH, 10% H₂O mixture (containing 100 mM NaCl) to induce faster evaporation and therefore better crosslinking were ineffective, as it appeared to have affected the formation of the host-guest complexes, which resulted in only partial formation of hydrogels that did not adhere very well to the non-polar HDPE, as well as other surfaces, as the hydrogels that were formed using only saltwater (FIG. 126C, FIG. 129A, FIG. 129B, FIG. 132).

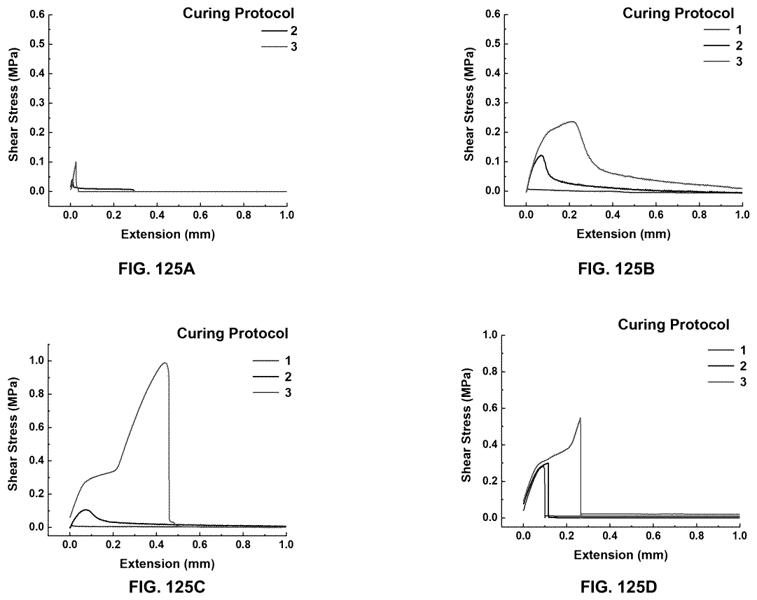

Because copolymers A_{3, P1} and B₃ consisted mostly of oligoethylene glycol side chains and the PNB backbone, each of which may have contributed to the copolymers' overall adhesive properties, two additional PNB-based copolymers were synthesized: poly(TEG₁₂₀-ZnTPP)ₛₜₐₜ (E_{P1}) and poly(Me₁₂₀-ZnTPP)ₛₜₐₜ (F_{P1}). The TEG-based copolymer was first dissolved in either H₂O or an aqueous 100 mM NaCl solution and then deposited via a syringe onto glass surfaces, followed by curing (i.e., 24 h air dried, 12 h air and 12 h oven dried, or 24 h oven dried). Then, lap-shear adhesion tests were performed on the cured samples of copolymer E_{P1}. The sample in deionized H₂O demonstrated (FIG. 125B) minimal adhesion (0.24 MPa) between the two glass surfaces after drying by oven for 24 h, however, the sample prepared in saltwater that was oven dried for 24 h exhibited (FIG. 125C) stronger adhesive properties (1.0 MPa). For the saltwater samples cured by shorter oven drying times, little (0.1 MPa) to no adhesion was observed. Next, the contribution of the PNB backbone was evaluated by dissolving copolymer F_{P1} in CH₂Cl₂ instead of H₂O or saltwater because it was hydrophobic and therefore not soluble in polar solvents, followed by depositing it between two glass slides and curing it using the same protocols as those used for copolymer E_{P1}. It is important to note that the use of a volatile organic solvent made it difficult to obtain consistent deposition of the material as the copolymer solution would run off the slides when pressed together. Some adhesion was observed, the strength of which ranged from 0.28-0.54 MPa.

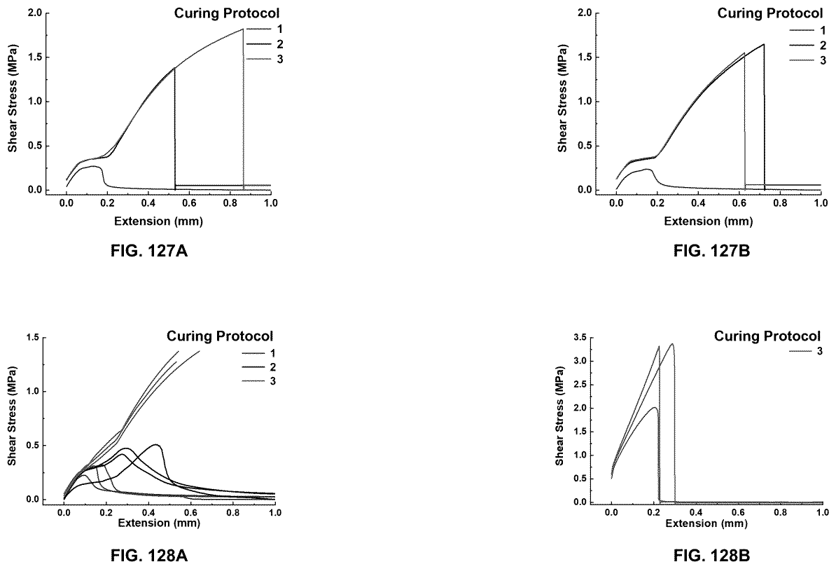

To better understand the role oligoviologen side chains played in adhesion, copolymer C_{1, P1} (bearing no oligoviologen side chains, FIG. 2B) was mixed with copolymer B₃ in saltwater via the dual-syringe method. This mixture did not completely form hydrogels, however, but rather yielded an emulsion. Moreover, when applied to an HDPE substrate, the C_{1, P1}+B₃ emulsion did not adhere as readily as the A_{3, P1}+B₃ hydrogels, which resulted in more material runoff when the second HDPE sheet was added on top prior to clamping. This behavioral difference yielded lap-shear data (Table 3, FIG. 133) that exhibited slightly lower adhesion strength on average for all three curing protocols when compared to the A_{3, P1}+B₃ hydrogels (Table 3, FIG. 131). Even with this difference, the samples that were oven dried yielded adhesive strengths in the range of 0.56-0.85 MPa vs the air-dried samples, which maxed out at 0.14-0.2 MPa. Consistent with earlier experiments, the C_{1, P1}+B₃ emulsions were also evaluated in lap-shear adhesion tests involving the more polar glass and non-polar metal substrates. Some runoff was encountered during the deposition onto these surfaces, however, far less sample was lost when compared to deposition onto the non-polar HDPE substrate. This difference allowed for easier deposition of the C_{1, P1}+B₃ sample, but still not nearly as efficiently as the A_{3, P1}+B₃ hydrogels. Next, the deposited C_{1, P1}+B₃ emulsions were clamped and cured for 24 h in an oven at 80° C. and the corresponding adhesive strengths were measured (Table 3, FIG. 127A, FIG. 127B, FIG. 130A, FIG. 130B; glass: 1.55 MPa; metal: 4.98-8.5 MPa, respectively) and found to be comparable to the A_{3, P1}+B₃ hydrogels. With that said, it is important to reiterate the difficulty associated with depositing the C_{1, P1}+B₃ emulsion onto different substrates (particularly non-polar surfaces) relative to the process involved with depositing the stickier A_{3, P1}+B₃ hydrogels on polar and non-polar surfaces.

### Photoredox-Based Control Over the Mechanical Properties Using Visible Light

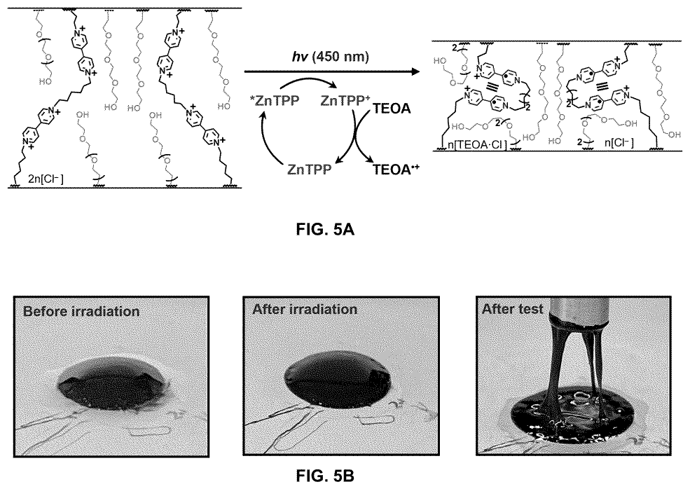

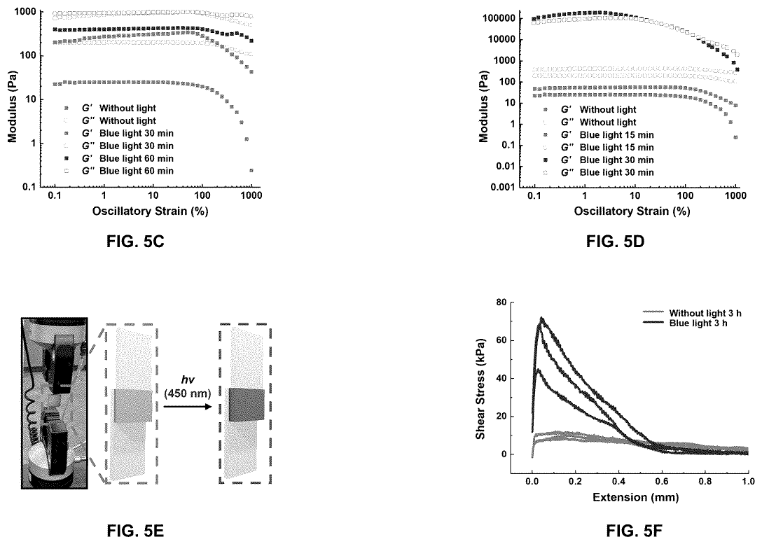

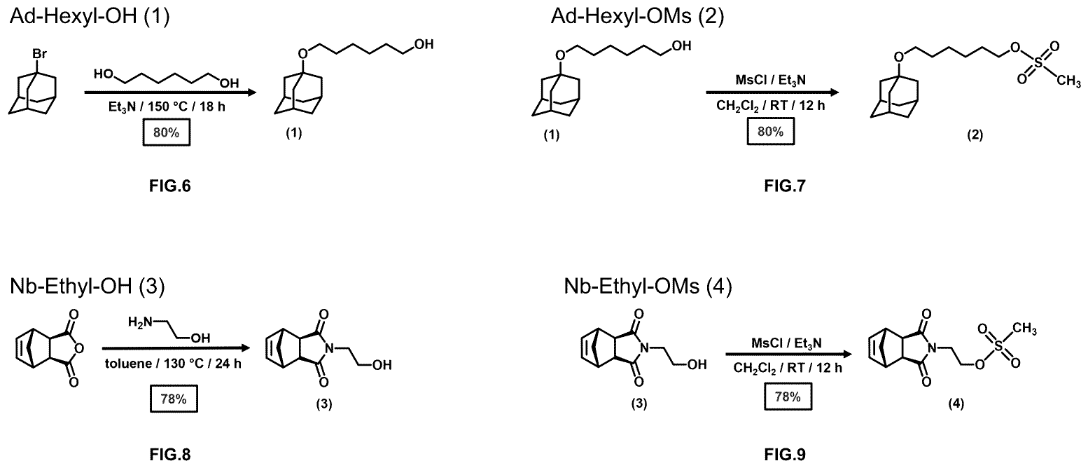

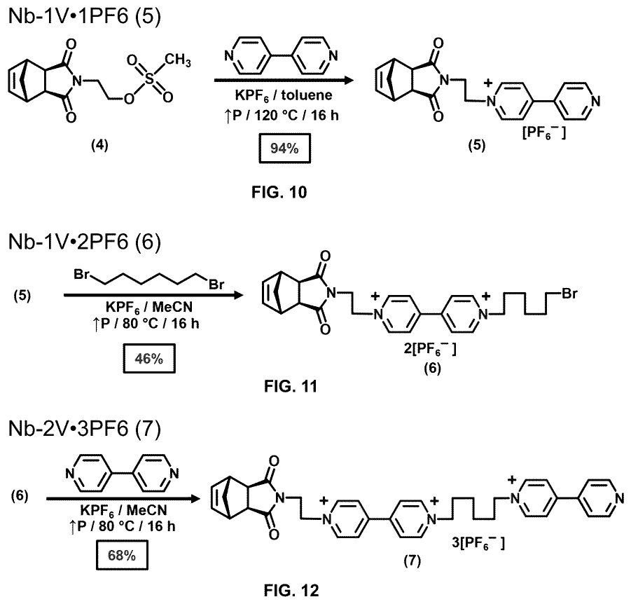

Although the oligoviologen side chains proved critical to the gelation mechanism of the hydrogels (FIG. 2A, FIG. 2B, FIG. 3A), they are also well known to be excellent electron acceptors and are compatible with a wide-range of visible-light-based photoredox catalysts, such as tetraphenyl porphyrins. Therefore, controlling the photoredox-responsive properties and performance of the viscous hydrogels using a PET mechanism was carried out next (FIG. 5A). Accordingly, porphyrin side chains were designed and incorporated into copolymer A_{3, Pn}, where in these experiments n=1. Having the photoredox catalyst (ZnTPP) tethered to the PNB backbone allowed it to be in close proximity to the oligoviologen side chains, meaning fast electron transfer could occur while providing multiple electrons per PNB chain because an excess of sacrificial reductant (triethanolamine, TEOA) was included in the hydrogel solution and used to regenerate the photocatalyst. This PET process allowed multiple oligoviologen side chains to be reduced (i.e., V²⁺ to V·⁺) in response to blue light (450 nm) and for radical-radical-based spin pairing and molecular recognition to occur (V·⁺-V·⁺, FIG. 5A) while also decreasing the overall electrostatic repulsion and halving the number of chloride anions (Cl⁻), the latter of which left as the corresponding TEOA·Cl salt.

The change in mechanical properties that occurred during the visible-light-based photoredox process was quantified (FIG. 5B, FIG. 5C) using oscillatory shear rheology. The A_{3, P1}+B₃ hydrogels were prepared in an aqueous 100 mM NaCl solution containing 3 mM TEOA and were deposited onto the rheometer stage. Next, the storage (G′) and loss (G″) moduli were measured for the A_{3, P1}+B₃ hydrogels in three separate experiments: (i) prior to irradiation (FIG. 5C, lower two spectra), and after 30 min (ii) and 60 min (iii) of blue light irradiation (FIG. 5C, upper four spectra), all while the stage was maintained at 25° C. and the intensity of a single light source was 23.9 W·m⁻² at a distance of 0.2 m. Without irradiation, the hydrogels were softer, where G′ at 1% strain was 25 Pa and G″ was 201 Pa, indicative of viscous-like properties. After the hydrogel sample was irradiated with blue light for 30 min, there was an obvious increase in both moduli (274 and 875 Pa, respectively, at 1% strain), as well as a decrease in tan δ (8.0 to 3.2), meaning the hydrogels became stiffer as a function of the photoreduction process. Raising the irradiation time to 60 min caused the outside layer of the hydrogel to become darker (FIG. 5B) and an increase of G′ to 400 Pa was observed while G″ exhibited only a marginal increase to 952 Pa. Moreover, it is important to note that at higher percent strain (80%), the non-irradiated and 30 min-irradiated hydrogel samples showed (FIG. 5C) a substantial drop in G′, however, the sample irradiated for 60 min maintained a more robust storage modulus, even up to 1000% strain.

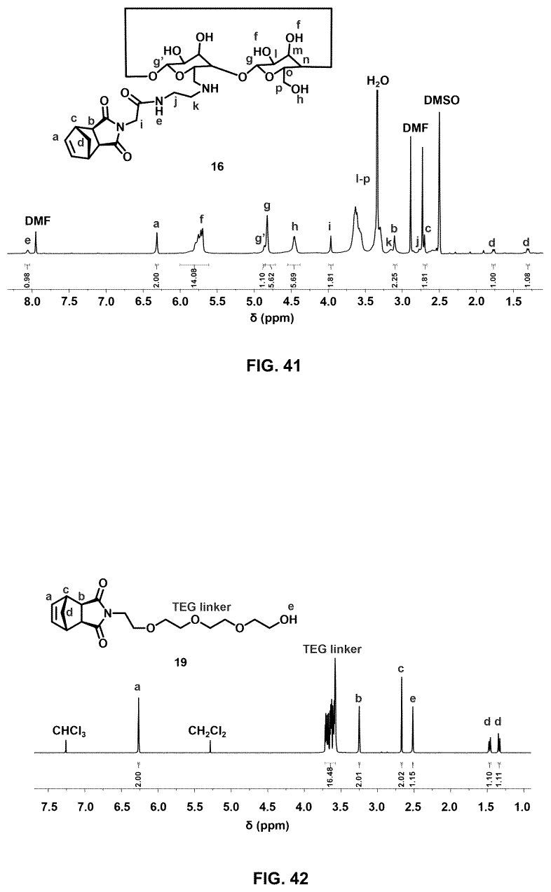

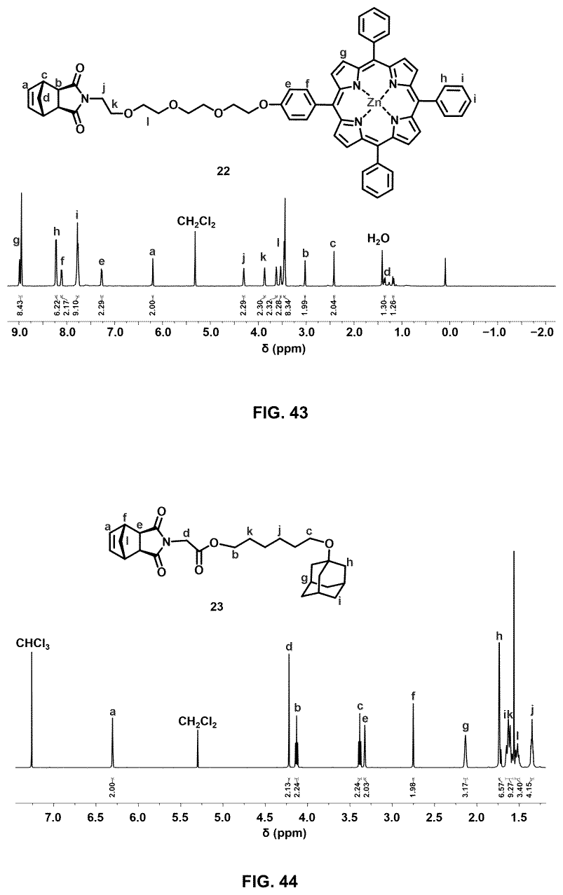

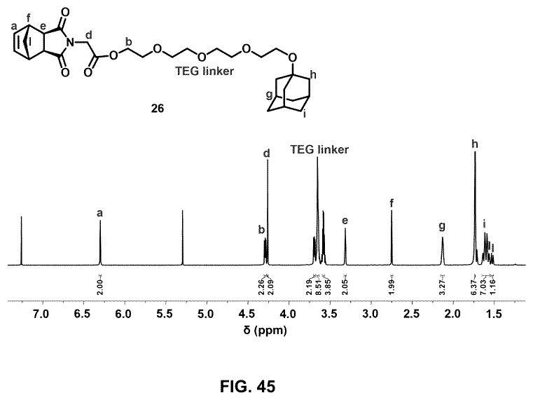

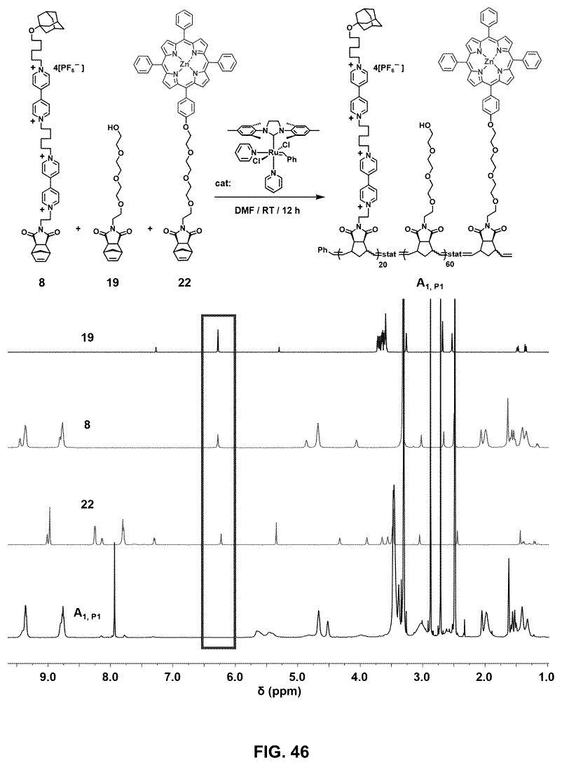

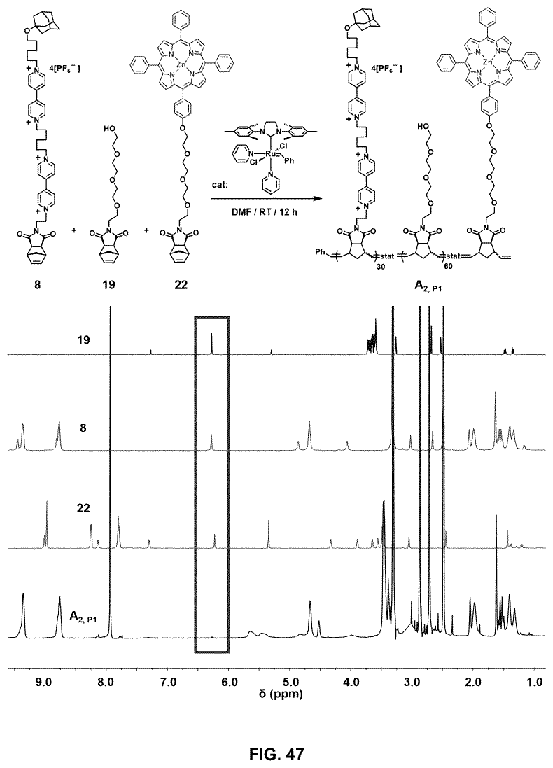

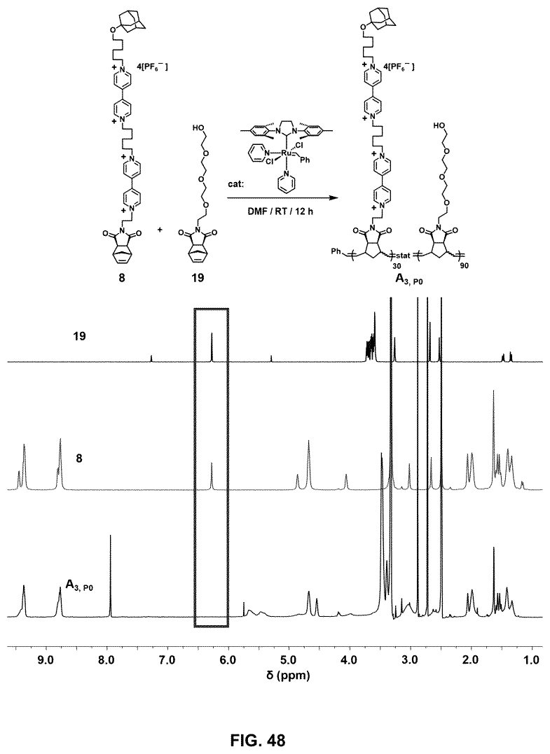

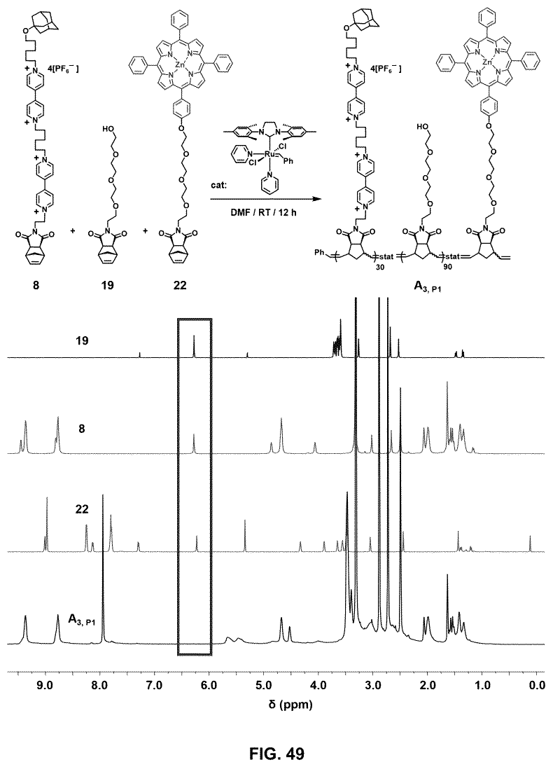

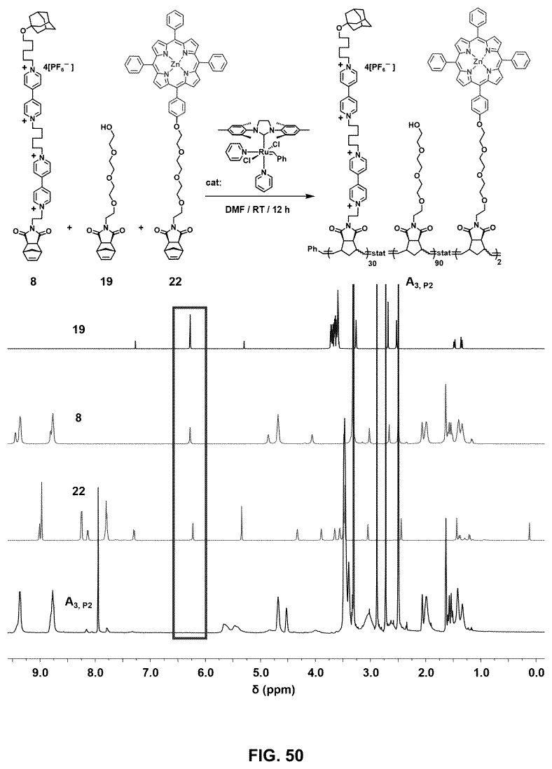

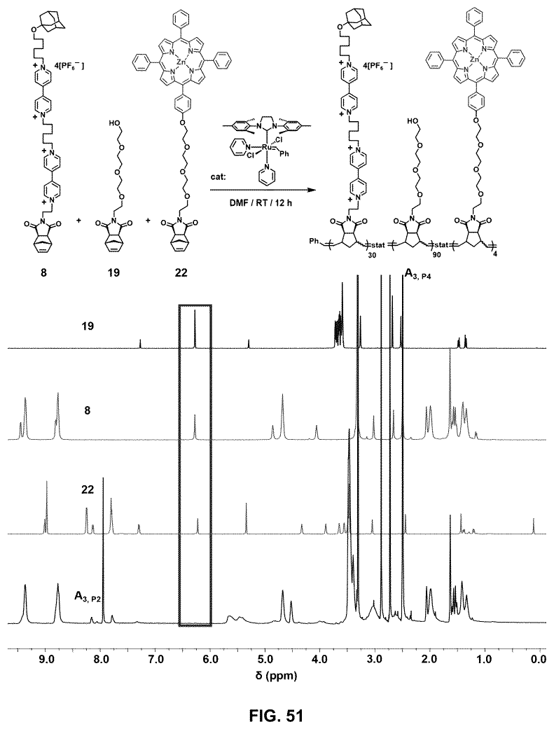

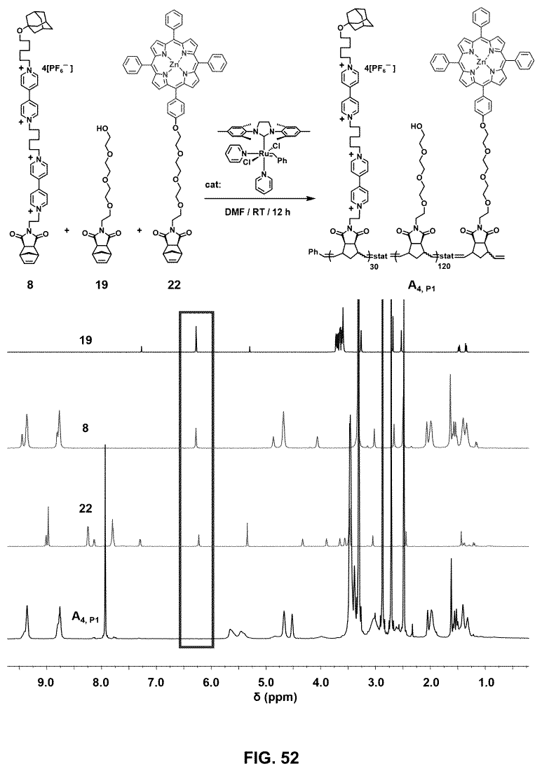

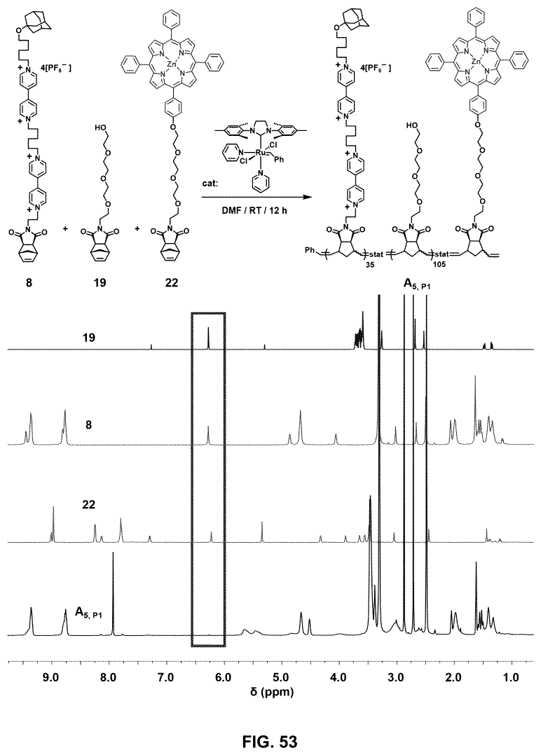

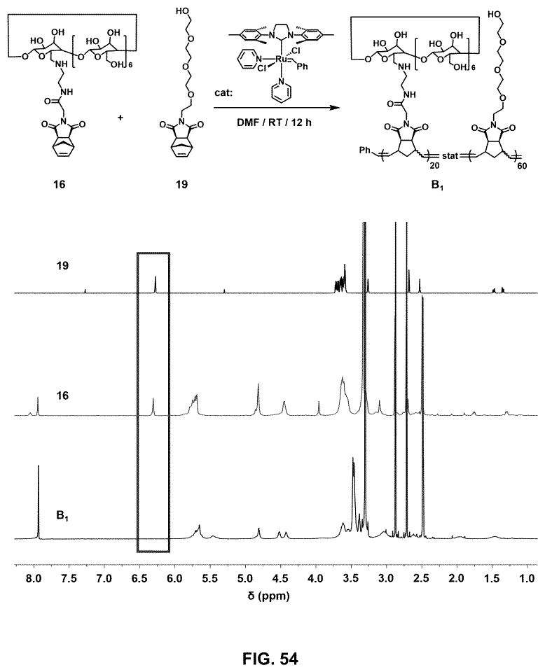

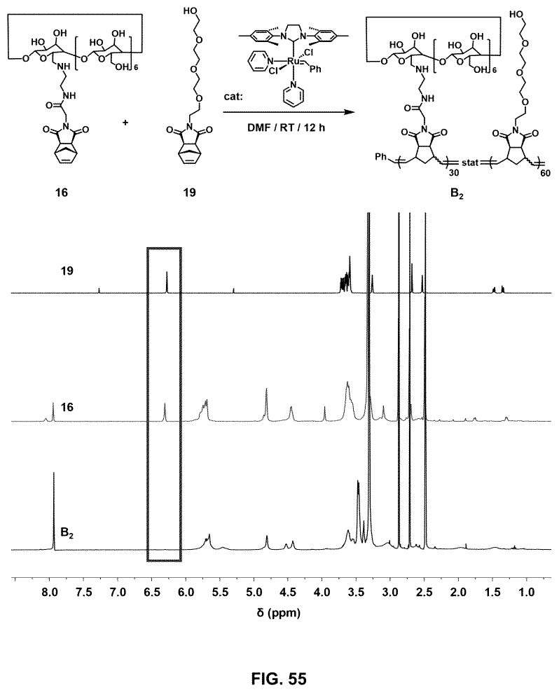

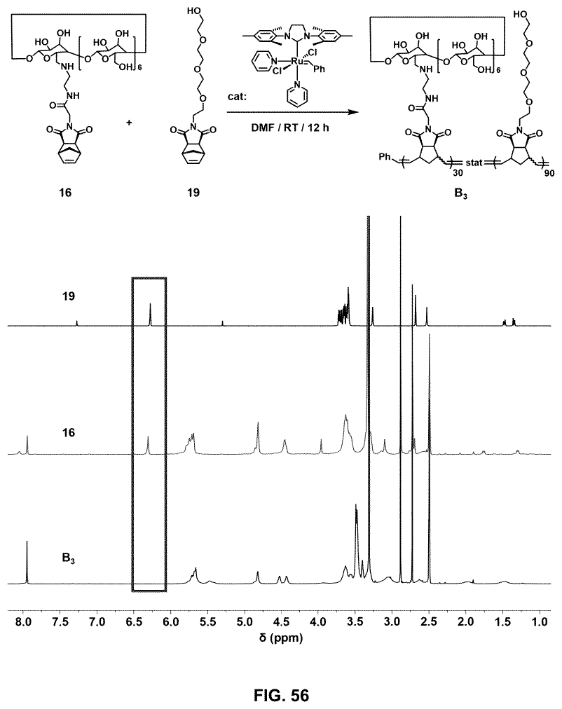

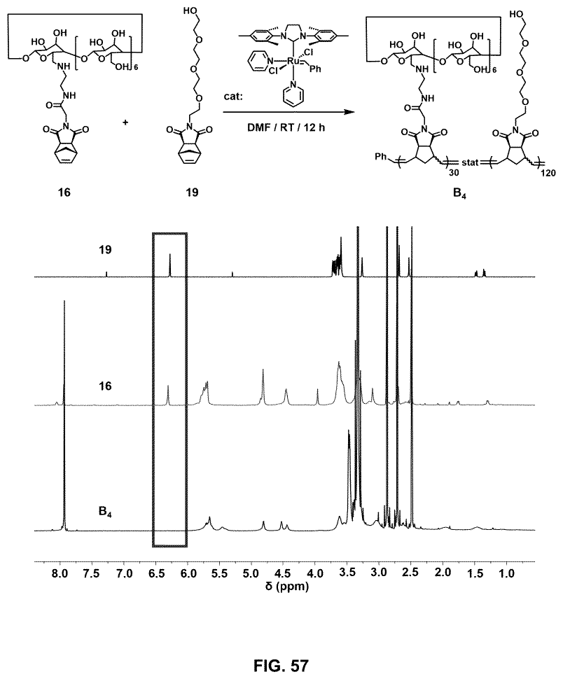

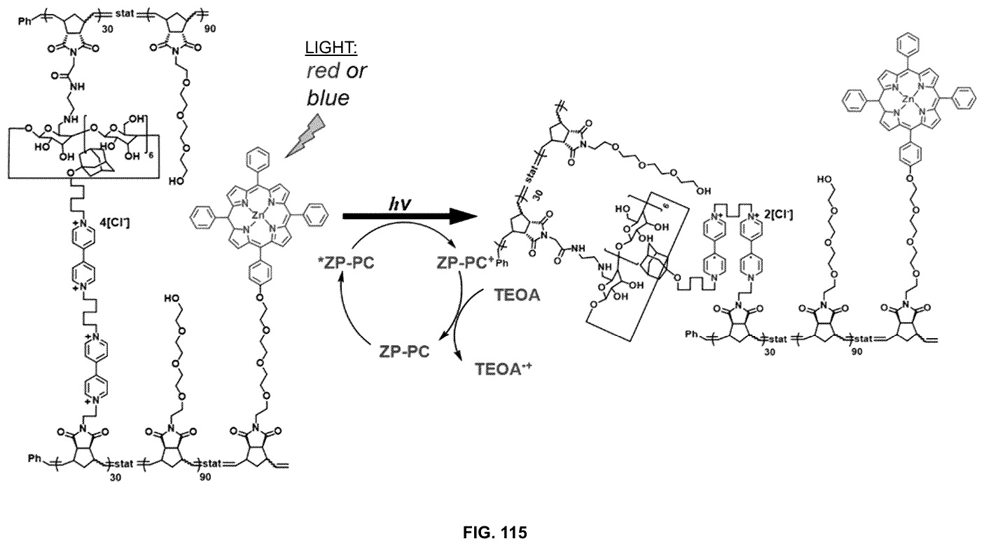

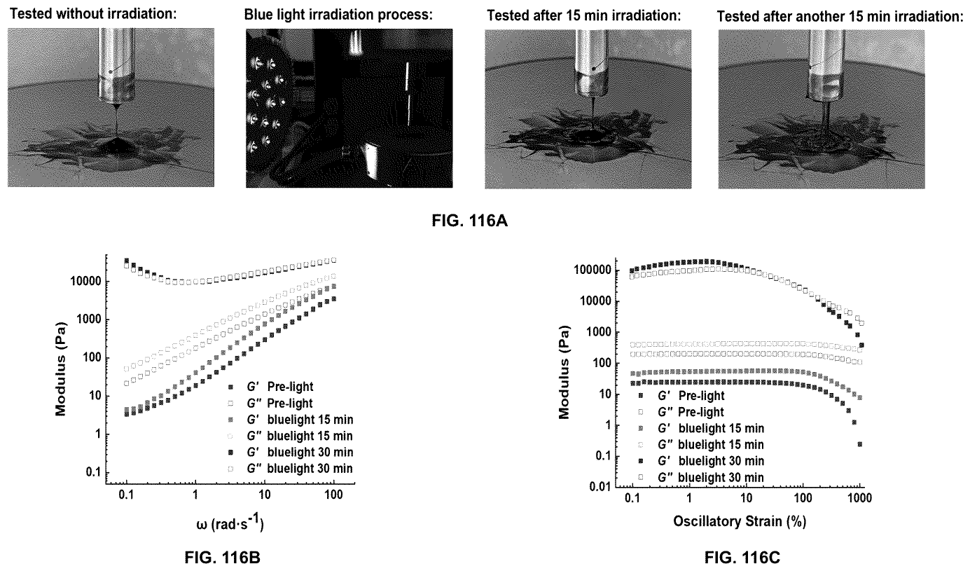

To further confirm the hydrogel's ability to contract and stiffen in response to visible light, another photoredox experiment was conducted (FIG. 5D, FIG. 116A, FIG. 116B, FIG. 116C) using a freshly prepared A_{3, P1}+B₃ hydrogel, which was irradiated with blue light at the same distance (0.2 m) and intensity (23.9 W·m⁻²) for 0, 15, and 30 min. After each irradiation period, the rheometer's geometry was lowered back down to establish complete contact with the hydrogel to measure the change in the storage and loss moduli as a function of photoirradiation times on the same hydrogel. Under these experimental conditions, the hydrogel became stiffer (i.e., G′ increased from 25 to 54 Pa at 1% strain) after 15 min of blue light irradiation. Moreover, the distance between the geometry and the stage was lowered from 1.0 to 0.75 mm because the hydrogel contracted in the Z direction while being irradiated with blue light. Next, the hydrogel was irradiated for an additional 15 min (i.e., 30 min in total at this point) and the geometry was lowered again to 0.5 mm to re-establish complete contact with the hydrogel. This second photoirradiation experiment resulted in a steep increase in G′ (54 to 184,306 Pa at 1% strain) and also showed G′ moving higher than G″. The significant increase in the storage modulus is reminiscent of the heat curing experiments (FIG. 3B) in that irradiation with blue light caused the hydrogels to become stiffer and therefore more viscous. The photo-induced contraction combined with the agitation of the hydrogel by the instrument's geometry resulted in the loss of H₂O through some evaporation as well as loss of a portion of the H₂O:TEOA solution as it was squeezed out of the hydrogel during photoreduction (FIG. 3A). Likewise, heating at 80° C. on the rheometer stage caused direct evaporation of H₂O and stiffening of the hydrogel via loss of H₂O and an increase in the extent of host-guest crosslinking. Moreover, at higher percent strain, the material exhibited shear-thinning properties, as evidenced by the crossover point between G′ and G″, which, again, was also observed for the samples that were heated on the rheometer stage. Essentially, application of either external stimulus resulted in the ‘switching on’ of elastic (G′>G″) and shear-thinning properties via stimuli-induced dehydration mechanisms (FIG. 3A, FIG. 41, FIG. 42).

To evaluate the adhesive performance of the A_{3, P1}+B₃ hydrogels in response to blue light, lap-shear adhesion tests were carried out using glass slides, the latter of which were amenable to maximum light penetration (light source was at 0.25 m distance and 15.3 W·m⁻² intensity). Two sets of three A_{3, P1}+B₃ hydrogels were applied to the glass substrates using the dual-syringe method (FIG. 122A), where the A_{3, P1} and B₃ copolymers were once again dissolved in an H₂O:TEOA solution and mixed with an aqueous saltwater solution containing 3 mM TEOA. One set of hydrogel samples was air dried for 3 h in the dark (i.e., samples were covered with aluminum foil) and the other set of hydrogels was subjected to blue light irradiation for 3 h (FIG. 5E). The results from the lap-shear adhesion tests (FIG. 5F) showed on average a six-fold increase in the shear stress, ranging from 8.3-12.2 kPa for the non-irradiated set of hydrogels and up to 44.2-77.2 kPa for the photoreduced hydrogels. The results from these photoirradiation and lap-shear experiments provide an alternative method to heat-curing protocols for the purpose of increasing the strength of hydrogel-based adhesives.

### Conclusion

The design, synthesis, and visible light-based control over the gelation, mechanical properties, and adhesive performance of a mucomimetic photoredox-responsive hydrogel was described. The hydrogels were prepared by mixing two PNB-based bottlebrush copolymers (A_{x, Pn} and Bₓ), each of which were synthesized through ROMP of functional Nb-based monomers terminated by β-CD and Ad groups, respectively. Formation of host-guest inclusion complexes between the ‘host’ β-CD and ‘guest’ Ad groups in H₂O resulted in soluble polymer networks that only formed a kinetically trapped viscous hydrogel once the copolymer mixture was exposed to a high ionic strength solution. The rapid, saltwater-induced gelation mechanism resulted from copolymer A_{x, Pn} having multiple polar, dicationic viologen subunits whose positive charges were screened in saline environments, effectively ‘salting out’ the A_{x, Pn}+Bₓ copolymer network. This two-part mechanism of network formation followed by rapid gelation is distinct from most injectable and shear-thinning hydrogels in that the host-guest crosslinked network remained soluble in H₂O and could easily be administered by syringe to any surface or location without any concern for clogging the needle or the rate of injection (i.e., injectability). Rheological evaluation of these self-assembled hydrogels revealed viscous behavior (G″>G′) in the post-injected state, but also elastic behavior (G′>G″) and shear-thinning properties that were ‘switched on’ after heating the hydrogels at 80° C. for 10 min. A similar level of control over the hydrogel's mechanical properties was demonstrated in response to blue light through the incorporation of a zinc-based tetraphenyl porphyrin monomer into the backbone of the ‘guest’ copolymer (A_{3, P1}). The incorporated porphyrin functioned as a visible-light-absorbing photocatalyst that could transfer electrons to the oligoviologen side chains. This reduction process converted all viologen subunits to their corresponding radical cations (i.e., V²⁺ to V·⁺) and resulted in contraction and stiffening of the hydrogel as a function of viologen radical-based self-assembly, a decrease in electrostatic repulsion, and a loss of the corresponding charge-screening anions, all of which led to higher crosslinking as H₂O was emitted. The change in the hydrogel's mechanical properties as a function of this photoredox process was monitored by rheology. Both moduli increased as tan δ decreased after irradiation with blue light. Moreover, after repeated rheological tests on the same photo-irradiated sample, both elastic (G′>G″) and shear-thinning properties were ‘switched on’. In addition to understanding the gelation and photoredox-responsive mechanisms, the viscous hydrogel also exhibited broad adhesive properties on polar and non-polar surfaces, such as wood, glass, metal, and HDPE, but not on a tissue mimic such as ham. The corresponding adhesive performance of the hydrogels was tested through lap-shear experiments, where a dramatic increase in adhesive strength was observed in samples that were either heat- or photo-cured. Taken together, these experiments demonstrated how the mechanical properties (storage/loss moduli), physical behavior (shear-thinning), and performance (adhesive strength) of a kinetically trapped mucomimetic hydrogel can be tuned using either heat or a low-energy source of visible light. This dynamic mucomimetic photoredox-responsive hydrogel platform may be useful in biomedical applications, such as in 3D (bio)printing and manufacturing, 4D tissue culture, drug delivery, and regenerative medicine.

### Materials and Methods

### Statistical Analysis

The statistical data preparation and sample size are discussed in the Supporting Information. The statistical data presentation follows the mean±STD type for the rheology experiments of different hydrogels, where n=3 for each hydrogel set. The statistical data presentation overlays the replicates of each set of experiment for lap-shear adhesion tests, as each run has different breaking point in this specific experiment, where n=3 for each set. All statistical analysis for rheology and lap-shear experiments were processed using Origin.

### Materials and Instrumentation

All reagents were purchased from commercial suppliers and used without further purification unless stated otherwise. All reactions were performed under nitrogen (N₂) or argon (Ar) gas unless otherwise stated. Column chromatography was carried out with silica gel (Sorbtech, 0.040-0.063 mm). Polymerization of all polymers was performed under an inert atmosphere of UHP N₂ in a glovebox using a modified Grubbs' 3^{rd} generation catalyst that was prepared. All nuclear magnetic resonance (NMR) spectra were recorded on Varian Inova-500 spectrometer at 25° C., with working frequencies of 500 (¹H) and 125 (¹³C) MHz. Chemical shifts are reported in ppm relative to the signals corresponding to the residual non-deuterated solvents: CDCl₃: δ_{H}=7.26 ppm and δ_{C}=77.16 ppm; (CD₃)₂SO: δ_{H}=2.50 ppm and δ_{C}=39.52 ppm; CD₂Cl₂: δ_{H}=5.32 ppm and δ_{C}=53.84 ppm; D₂O: δ_{H}=4.79 ppm. High-resolution mass spectrometry (HRMS) data was recorded on a Bruker maXis 4G UHR-TOF mass spectrometer. Matrix assisted laser desorption/ionization time-of-flight mass spectrometry (MALDI-TOF-MS) was recorded on a Bruker Solaris 12T FT-MS, samples were prepared using 2,5-dihydroxybenzoic or α-cyano-4-hydroxycinnamic acid matrices. Ultraviolet-visible-near-infrared (UV-vis-NIR) absorbance spectra were recorded on Agilent Cary 5000 spectrophotometer with a PbSmart NIR detector. Isothermal titration calorimetry was performed on a VP-ITC (MicroCalorimeter Malvern Panalytical, Malvern, U.K.) at 25° C. Size exclusion chromatography (SEC) analyses were performed on an Agilent 1260 Infinity setup with three PSS NOVEMA MAX Lux analytical 100 Å columns in tandem and 0.025 M Na₂SO₄ in H₂O mobile phase run at 23° C. with 1.0 mL·min⁻¹ flow rate, or with two Shodex GPC KD-806M columns in sequence and 0.025 M LiBr in DMF mobile phase run at 60° C. at 1.0 mL·min⁻¹. The differential refractive index (dRI) of each compound was monitored using a Wyatt Optilab T-rEX detector and the light scattering (LS) of each compound was monitored using Wyatt Dawn Heleos-II detector. Isothermal titration calorimetry (ITC) was performed on a VP-ITC MicroCalorimeter at 25° C. The related titration parameters are as follows: 25° C., 5.0 μL/injection, 25 injections, 8.5 s injection duration, 300 s delay between injections, and 2 s filter period. All the photochemical reduction experiments of oligoviologen-based hydrogels were accomplished using one Hampton Bay desk lamp with an ABI LED aquarium light bulb (450 nm/12 Watt/740 lumens). The distance between the light bulb and the sample on rheometer stage was 0.2 m, while the light intensity was 23.9 W·m⁻². The distance between the light bulb and the glass slides with hydrogels for lap shear tests was 0.25 m, while the light intensity was 15.3 W·m⁻². Contact angle images were acquired through the use of a Samsung Note 10+ as camera with a Xenvo 15x macro lens attachment. Images were captured at 1 s after dropping 7.5 μL of solution onto the substrate. All images were analyzed in ImageJ and all contact angles (θ_{E}) are reported. Scanning electron microscopy (SEM) was conducted using a Thermofisher Quattro S ESEM apparatus with a high-stability Schottky field emission gun electron source providing electron resolution of 0.7 nm at 30 keV, 1.4 nm at 1 keV.

### Rheology

Rheological data was obtained on a TA HR-20 Rheometer using a 20 mm plain geometry. All samples tested were between 80-100 mg of mixed supramolecular gel smoothed over the stage to cover the geometry. Testing was conducted at a constant gap of 500 μm as a constant axial force could not be maintained in many samples. Strain sweep tests ranged from 0.1-1000% strain, and angular frequency was kept constant at 1 rad·s⁻¹ throughout the test. Frequency sweeps ranged from 0.1-1000 rad·s⁻¹ with a constant strain of 1%. Temperature dependent rheology was performed at a constant strain of 1% and a constant frequency of 1 rad·s⁻¹ ranging from 25-80° C., with a temperature increasing rate at 3° C./min (around 18 min for the entire process). Samples were cured by heating at 80° C. for 10 min, then cooled to 25° C. for 10 min. Strain and frequency sweeps were then repeated after curing. Strain sweeps were performed before frequency sweeps in each run before and after heating unless otherwise stated. Rheological data of photoreduction experiments was obtained on a TA HR-20 Rheometer using an 8 mm plain geometry.

C_{1, P1}+B₃: Rheology tests were performed on C_{1, P1}+B₃ hydrogels at 50 mg·mL⁻¹ in 100 mM NaCl solution. Same procedure was used as described for A+B hydrogels. Each run contained around 100 mg C_{1, P1}+B₃ hydrogels. However, C_{1, P1}+B₃ was not as soft material as A+B hydrogels (FIG. 110, left), and to avoid the axial force being too high, gap was adjusted to fit each sample (1100 μm, 1100 μm and 950 μm for three runs, separately).

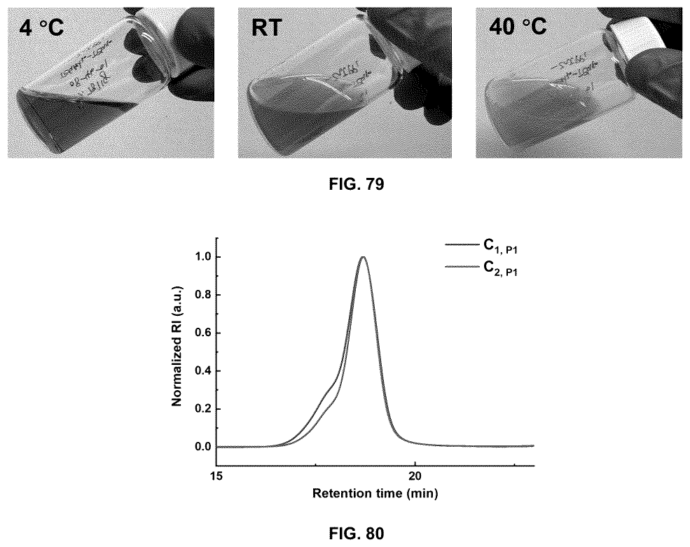

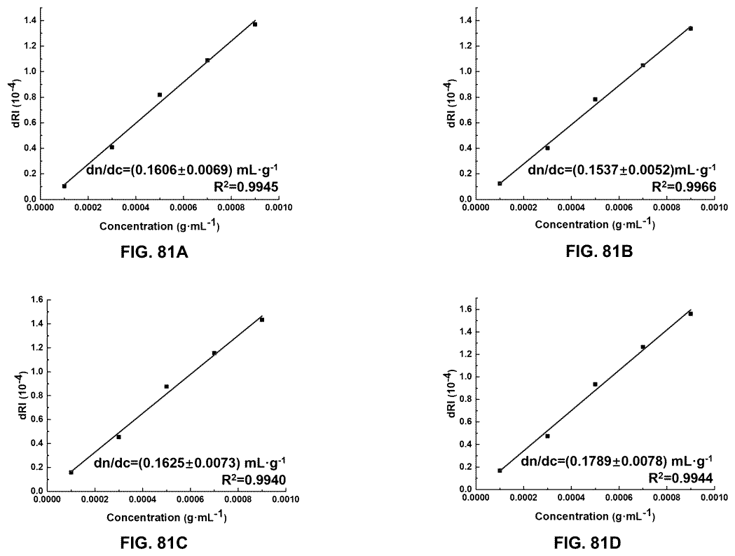

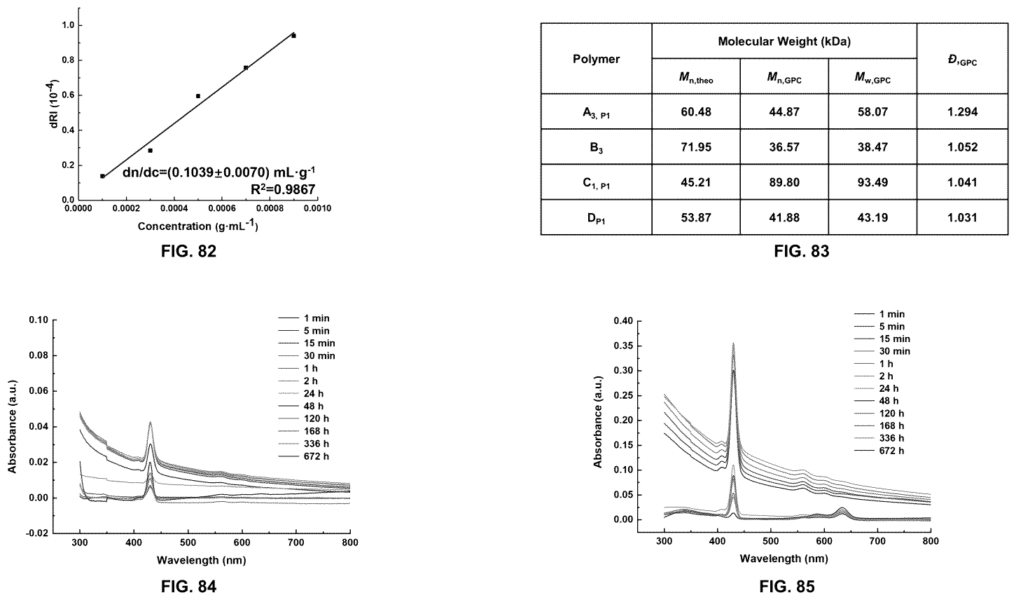

C_{2, P1}+B₃: Rheology tests were performed on C_{2, P1}+B₃ hydrogels at 50 mg·mL⁻¹ in 100 mM NaCl solution. Same procedure was used as described for A+B hydrogels. Each run contained around 100 mg C_{2, P1}+B₃ hydrogels. However, as illustrated in FIG. 79, copolymer C_{2, P1} is not soluble in H₂O at room temperature, so copolymer C_{2, P1} was dissolved in 100 mM NaCl solution at 4° C. and kept at this temperature until mixed with copolymer B₃ (still dissolved in 100 mM NaCl solution at room temperature) to form hydrogels for tests. C_{2, P1}+B₃ hydrogels were soft materials (also sticky) similar as A+B hydrogels, so the gap was able to be maintained at 500 μm for each run. Pictures were taken for the tests and shown in FIG. 112A.

### Lap-Shear

Substrates for lap-shear adhesion tests were constructed from glass microscope slides (VWR brand 25×75×0.9 mm), stainless steel ruler segments (28×75×0.9 mm), and HDPE (25×75×1.6 mm). To align the slides and eliminate any torsion forces on the surface during lap-shear testing, glass slides and steel ruler segments were cut into tabs (25×25×0.9 mm for glass slides and 28×25×0.9 mm for steel ruler) and superglued onto the ends of the substrates. Lap-shear samples on each surface (glass, stainless steel, HDPE, ham) were analyzed using an Instron 68TM-30 Load Frame universal testing apparatus to determine the adhesive strength. Each sample's cross-sectional area of adhesion was measured prior to testing. The HDPE, steel, and glass samples were gripped at 60 psi within the load frame using Instron 2712-041 series pneumatic side action tensile grips with rubber jaw faces and a 1 kN limit. The ham samples were gripped at 15 psi to avoid damage to the tissue. The samples were tested under tension at a rate of 1 mm·min⁻¹. Samples that exceeded 1 kN of force were stopped and retested using 30 kN limit wedge grips.

A 100 mM NaCl solution, statistical copolymer E_{P1}, and statistical copolymer F_{P1} were used to start adhesion tests on glass (FIG. 125A, FIG. 125B, FIG. 125C, FIG. 125D) to show that a single polymer (i.e., not the self-assembled complex, in flowing solution form) could not provide significant adhesion. All the copolymers in the flowing solution form were applied to the substrates via a syringe (15 mg in 1 mL solvent). Next, hydrogels A_{3, P1}+B₃ (FIG. 126A, FIG. 126B, FIG. 126C, FIG. 126D) and C_{1, P1}+B₃ emulsions (FIG. 127A, FIG. 127B) were tested with different solution conditions on glass, involving a majority of organic solvent (CH₃OH) to investigate faster curing times and with and without salt present. The C_{1, P1}+B₃ emulsions were applied to the substrates with a similar dual-syringe method, while B₃ and C_{1, P1} (15 mg for C_{1, P1}+B₃) were dissolved separately in 0.5 mL 100 mM NaCl aqueous solution in each syringe. It should be noted, however, that performing these experiments on glass made it difficult to reproduce each run. This is because the glass would fail under stress at different time points during the lap shear experiments. When the adhesion became stronger, the strain limit relied on the quality of glass slide.

### Contact Angle Measurements

Contact angle measurements were performed on three different substrates: metal (steel ruler), glass, and high-density polyethylene (HDPE). H₂O, copolymer A_{3, P1} in H₂O (45.7 mg·mL⁻¹, 0.023 mol·L⁻¹), copolymer B₃ in H₂O (54.3 mg·mL⁻¹, 0.023 mol·L⁻¹), copolymer C_{1, P1} in H₂O (34.2 mg·mL⁻¹, 0.023 mol·L⁻¹), and copolymer mixture A_{3, P1}+B₃ in H₂O (50 mg·mL⁻¹, 0.023 mol·L⁻¹) were tested. Each solution (7.5 μL) was deposited onto each substrate three separate times to calculate the average. No saltwater solutions were used because a gel would form and give inaccurate contact angle measurements.

### UV-Vis of Degradation Experiment

A pre-mixed solution of 15 mg A_{3, P1}+B₃ in 0.5 mL H₂O and a pre-mixed solution of 15 mg C_{1, P1}+B₃ in 0.5 mL H₂O were added to 100 mM NaCl solution (100 mL) separately. After the full injection of copolymer mixture into the bottle, 1 mL aliquots of the supernatant were taken to test the UV-vis absorbance at different time points. The detection by UV-vis spectroscopy is based on the absorbance of the porphyrin molecule (430 nm) integrated in the copolymer complex.

### General Preparation of A+B Hydrogels

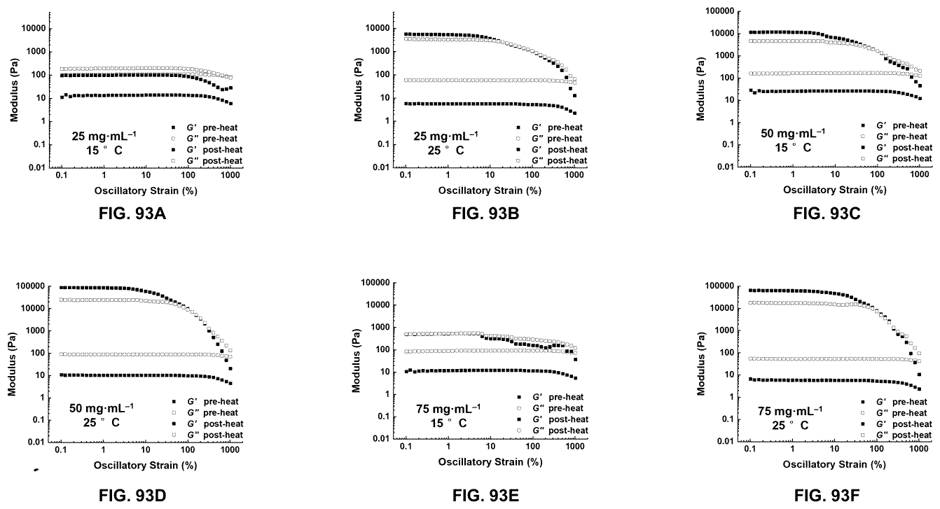

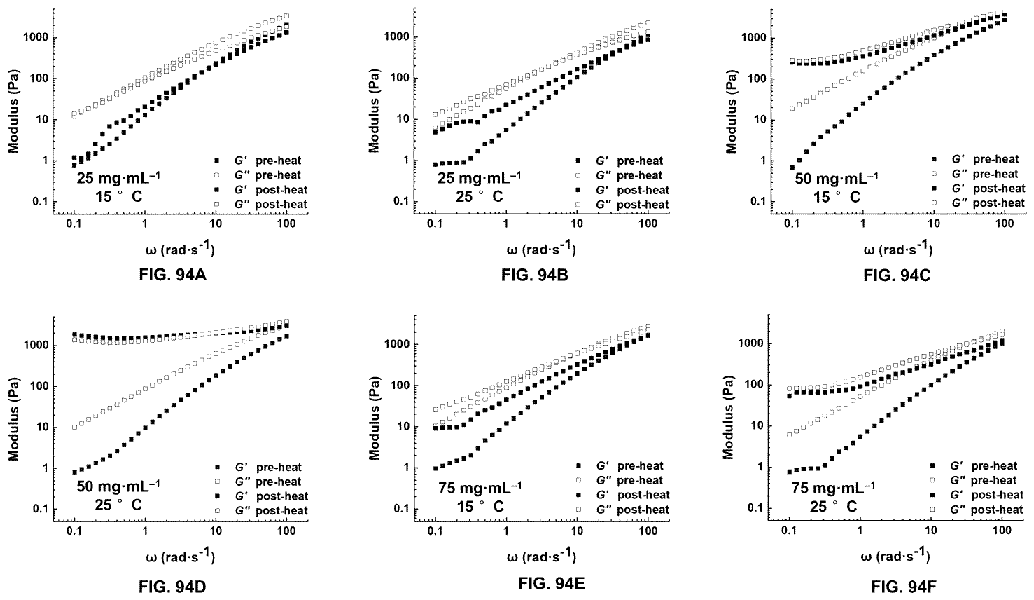

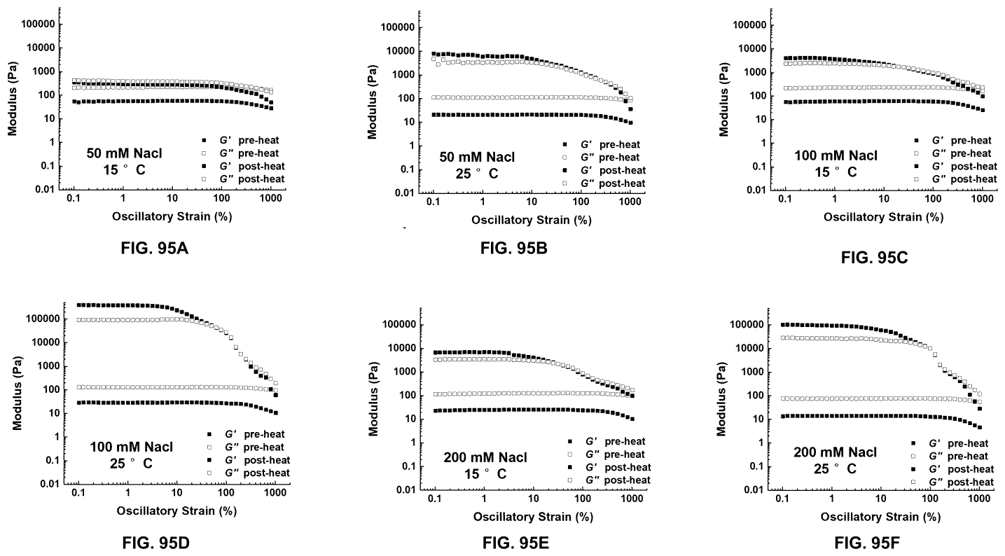

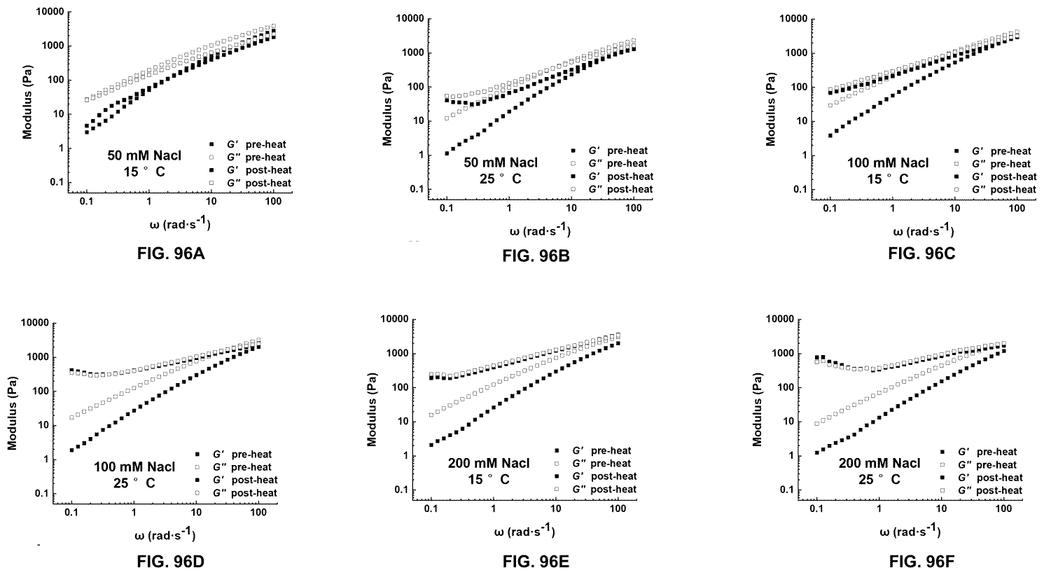

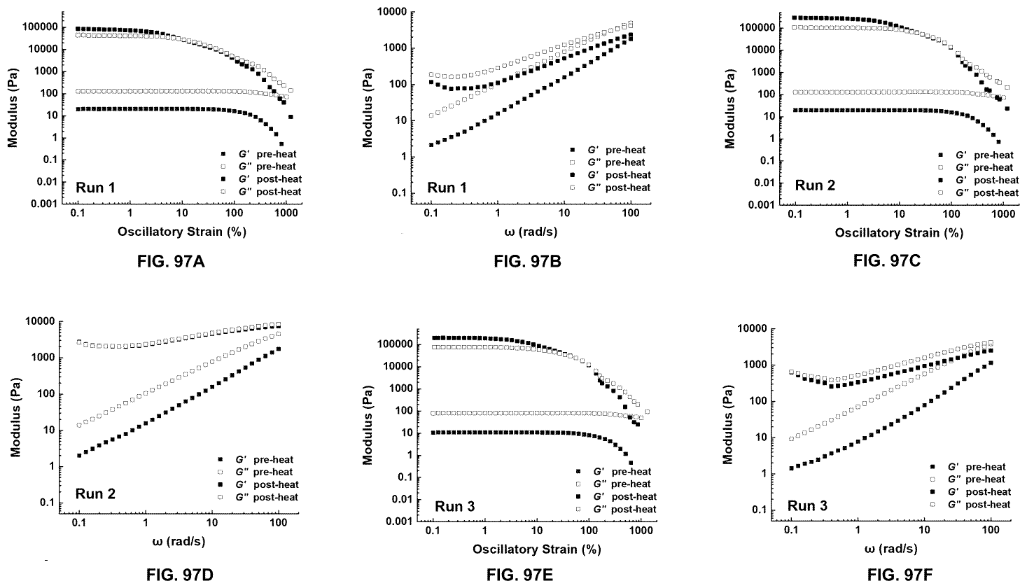

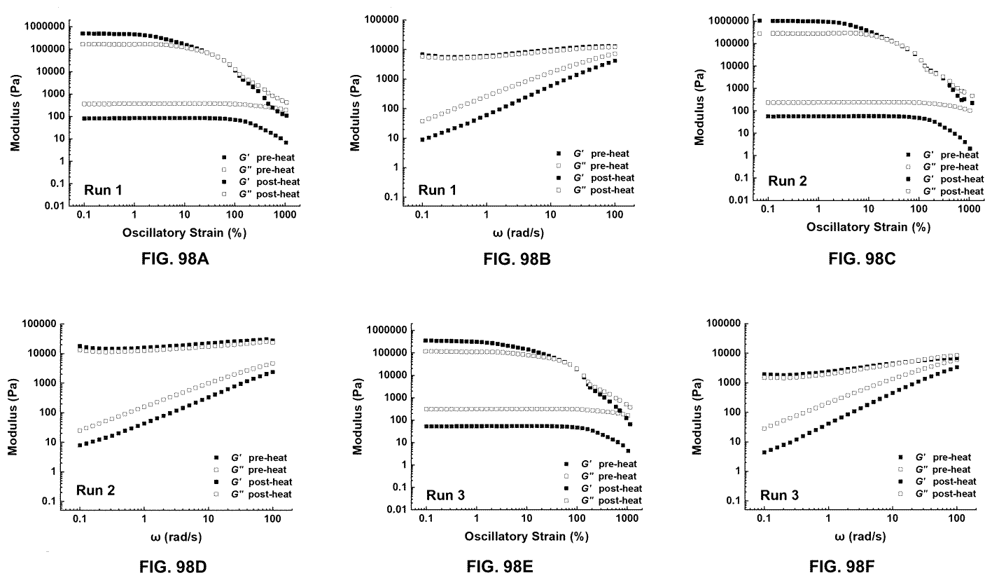

Initial Screening: The guest copolymer A_{3, P1} and host copolymer B₃ were dissolved separately in buffered solutions. The solution of guest copolymer A_{3, P1} was then added into the solution of host copolymer B₃ to form the hydrogel to be tested. The amount of hydrogel was between 80-100 mg (pre-weighed dry mass before dissolving in any buffered solutions) for each run. The hydrogels were first tested at different concentrations in PBS: 25, 50 and 75 mg·mL⁻¹ (FIG. 93A-F, FIG. 94A-F), among which the 50 mg·mL⁻¹ hydrogel concentration was the only one that showed obvious shear-thinning properties (i.e., G′/G″ crossover) for strain sweep tests at both 15° C. and 25° C. after heat curing at 80° C. To simplify the salt solution, the 50 mg·mL⁻¹ gel concentration was selected to do the rheology screening for different NaCl solutions at 50, 100 and 200 mM (FIG. 95A-F, FIG. 96A-F). It is important to note that the 100 mM NaCl solution was chosen as the standard solution for all tests at this point, as shear-thinning properties were evident for strain sweep tests at both 15 and 25° C. after heat curing at 80° C. After these initial screening tests were conducted, all hydrogels moving forward were assessed at 25° C., before and after heat curing at 80° C.

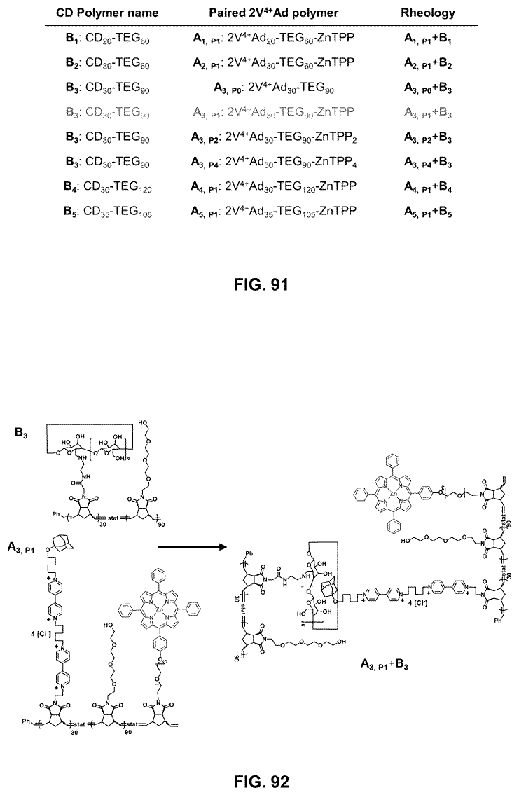

Tests (3 replicates for each) for a series of A+B hydrogels: The best condition of 50 mg·mL⁻¹ in 100 mM NaCl solution was used to do the experiments for different A+B hydrogels (summarized in FIG. 91). All tests were conducted at 25° C. before and after heat curing at 80° C. The same hydrogel test was repeated three times. (Note: all the polymerizations for the copolymers used to form hydrogels and used for rheology went to completion, one exception was copolymer B₅ for which the polymerization was almost complete, 3 replicates were still performed for A_{5, P1}+B₅.)

Photoreduction and Rheology for A_{3, P1}+B₃ Hydrogels

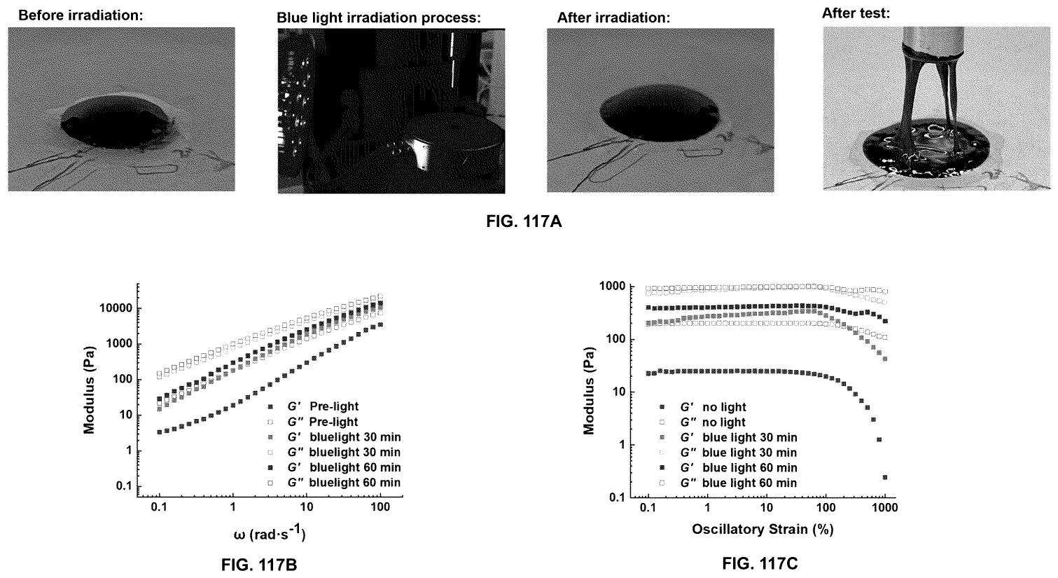

The guest copolymer A_{3, P1} and host copolymer B₃ were dissolved separately in 3 mM TEOA in 100 mM NaCl solution instead of the normal buffered solutions. The solution of guest copolymer A_{3, P1} was then added into the solution of host copolymer B₃ to form the hydrogel with a final concentration of 50 mg·mL⁻¹. Two sets of photoreduction experiments were carried out. The first set involved the same A_{3, P1}+B₃ hydrogel that was tested at different irradiation times (FIG. 116A, FIG. 116B, FIG. 116C). The gap was started at 1000 μm for the test without irradiation, then the gap was adjusted to 750 μm after 15 min irradiation, and then to 500 μm after another 15 min irradiation. The second set involved completely different A_{3, P1}+B₃ hydrogels tested once after different irradiation times (FIG. 117A, FIG. 117B, FIG. 117C). The gap was all at 1000 μm. The stage temperature was maintained at 25° C. during irradiation. All the rheological data of photoreduction experiments was obtained using an 8 mm plain geometry. One Hampton Bay desk lamp with an ABI LED aquarium light bulb (450 nm/12 Watt/740 lumens) was used for the irradiation process. The distance between the light bulb and the sample on rheometer stage was 0.2 m, while the light intensity was 23.9 W·m⁻².

### Scanning Electron Microscopy (SEM) Imaging

Three different samples of A_{3, P1}+B₃ were prepared for SEM: 1) A_{3, P1}+B₃ dissolved in H₂O at 50 mg·mL⁻¹ and dropped onto clean gold wafer by pipette; 2) A_{3, P1} and B₃ were dissolved separately in 100 mM NaCl solution, and A_{3, P1} was dropped onto clean gold wafer using pipette followed by dropping B₃ to form fresh hydrogels with a concentration of 50 mg·mL⁻¹, excess NaCl solution was also on gold wafer; 3) pre-made hydrogels of A_{3, P1}+B₃ with a concentration of 50 mg·mL⁻¹ were attached to the gold wafer using a pipette. All three samples were air dried overnight, and the samples were then loaded into the SEM chamber. The sample chamber was evacuated using the HiVac setting, and images were recorded at 1000×, 5000×, 10000×, and 35000× magnification.

### Example 2—Mitigating Pseudomonas aeruginosa Biofilm Formation Using Self-Assembled Bactericidal Polymer Coating

Bacterial biofilms complicate the treatment of infections by enabling chronic colonization and antibiotic resistance. Infections that arise from contamination of surgical tools, medical implants, and catheters may be mitigated using antibacterial polymer coatings. Disclosed herein is a self-assembled polymer coating that consists of two bottlebrush copolymers which are synthesized through ring-opening metathesis polymerization. The formation of the polymer coating occurs via reversible host-guest interactions between adamantane and β-cyclodextrin and was shown to be stable on surfaces over several days in static salt solutions. Under dynamic flow conditions, the polymer coating efficiently prevented biofilm formation through a delamination process, even after 96 h of exposure. Moreover, bactericidal properties were demonstrated through the slow release of an antibiotic drug combination that was electrostatically loaded onto the positively charged oligoviologen side chains of the polymers. Growth inhibition was observed for up to 48 h under static conditions for the drug-loaded coatings. These results demonstrate a self-assembled polymer coating that was designed to possess both antifouling and bactericidal functionality under dynamic flow conditions, thus representing a platform to mitigate the growth of multi-drug resistant bacteria and biofilm formation on medical devices using nearly any combination of negatively charged antibiotics.

### Introduction

The opportunistic pathogen Pseudomonas aeruginosa (P. aeruginosa) and other gram-negative bacteria are a rising public health threat due to their multi-drug resistance and ability to thrive in a range of environments. P. aeruginosa is a main cause of medical device-associated infections, exacerbating hospital admissions and patient morbidity. These characteristics can be attributed in part to the formation of multicellular bacterial communities called biofilms. Biofilms are aggregates of bacteria encased in an extracellular matrix that is typically comprised of extracellular DNA (eDNA), polysaccharides, and proteins. Biofilm formation allows for stronger adherence to surfaces, less susceptibility to environmental changes, and stronger tolerance toward antibiotics and the human immune system. For example, biofilm bacteria can be up to 1000× more tolerant to antibiotics compared to their planktonic, or free swimming, counterparts. Since targeting P. aeruginosa within the protective biofilm community can be challenging, preventing bacterial attachment and biofilm formation is a desirable therapeutic aim.

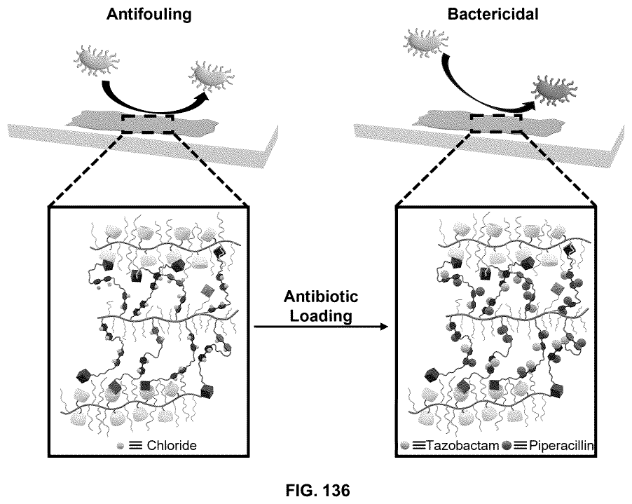

Antibacterial polymer coatings have been widely used to prevent biofilm formation over the years. The general mechanism to mitigate bacterial adhesion can be divided into two main categories of coatings: antifouling or bactericidal (FIG. 136). Antifouling coatings function by inhibiting the bacterial attachment, while bactericidal coatings operate by killing the adhered bacteria. Hydrophilic polymers have been investigated as antifouling polymer coatings, including polyethylene glycol (PEG), zwitterionic polymers, and polysaccharides. The bactericidal coatings are generally designed to function through two different killing mechanisms. The first involves a contact-active strategy, where the bacteria are killed upon direct contact with the coating. The majority of coatings that operate through this mechanism are cationic, such as antimicrobial peptides (AMPs), quaternary ammonium compounds (QACs), and quaternary phosphoniums. The other mechanism involves the release of bactericidal agents, including antibiotics, antiseptics, AMPs, etc. However, these types of coatings are not without limitations. For example, any bacterium that can attach to the antifouling coatings may still proliferate, whereas for bactericidal coatings, the gathering of dead bacteria and debris can lead to opportunities for other bacteria to colonize the surface. Therefore, a combination of antifouling and bactericidal coatings is often used to provide protection against bacterial adhesion and biofilm formation.

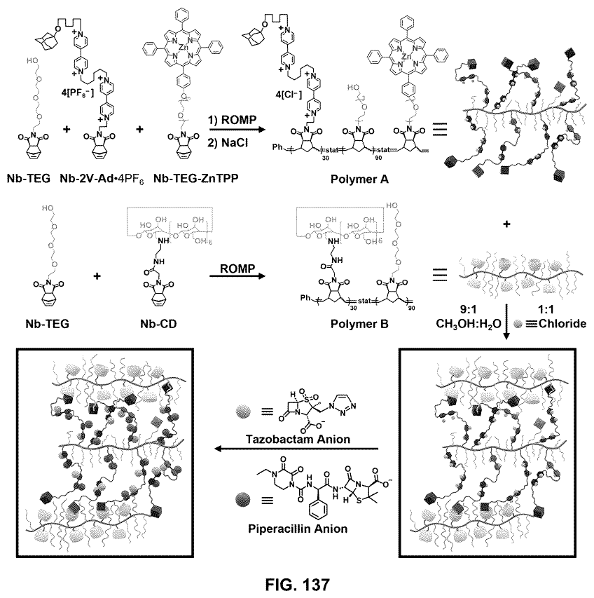

Disclosed herein is a self-assembled polymer coating which prevented P. aeruginosa bacterial cell attachment and biofilm formation on glass over a 96-h period through a unique delamination process that was carried out under dynamic flow conditions (0.167 mL·min⁻¹). The polymer coating consisted of two norbornene (Nb)-based bottlebrush copolymers (A and B) that formed a polymer film through reversible host-guest-based crosslinking between sidechain adamantane (Ad) and β-cyclodextrin (β-CD) functional groups (FIG. 137). Polymer film A+B was fabricated by drop casting the polymer mixture dissolved in 90:10 MeOH:H₂O onto glass slides and letting the solvent evaporate. Upon exposure to a static salt solution (100 mM NaCl), the polymer film displayed excellent stability over several days. However, the dynamic and reversible nature of Ad-CD host-guest complexes resulted in favorable delamination of the A+B film during flow cell experiments, a controlled process that efficiently prevented P. aeruginosa biofilm formation over four days. Furthermore, copolymer A was loaded with tazobactam or piperacillin anions via electrostatic interactions with the constituent oligoviologen sidechains to yield bactericidal copolymers Aₜ and Aₚ, respectively. The antibiotic-loaded polymer film Aₜ+Aₚ+B was then prepared (1:1 Ad:CD), which resulted in P. aeruginosa growth inhibition under static conditions for two days (as confirmed by confocal microscopy images and CFU counts). The rate of release of the antibiotics from the polymer film Aₜ+Aₚ+B was studied indirectly under static conditions using antibiotic release assays, ultimately demonstrating release over a period of five hours. The ease with which the polymer coating was fabricated and loaded electrostatically with an anionic antibiotic drug combination, combined with its unique delamination-based antifouling mechanism under flow, suggests the self-assembled polymer coating platform reported here is an ideal candidate to mitigate the growth of multi-drug-resistant bacteria and biofilm formation on a range of biomedical device surfaces using nearly any combination of negatively charged antibiotics.

### Materials and Methods

### Synthetic Procedures

Polymerization of all polymers was performed under an inert atmosphere of UHP N₂ in a glovebox using a modified Grubbs' 3^{rd} generation catalyst (G3). All the ROMP reactions were performed in anhydrous DMF in the glovebox. The reactions were removed from the glovebox and quenched with excess ethyl vinyl ether after an overnight reaction. The copolymers were then purified by dialysis using regenerated cellulose membranes with a molecular weight cutoff of 1.0 kDa. Each copolymer was characterized by ¹H NMR to confirm full conversion of the monomers and analytical GPC with 0.025 M Na₂SO₄ in H₂O as the mobile phase.

### Flow Cell Experiments

Polymer film (A+B) coated coverslips were prepared for flow cell experiments. The guest copolymer A was dissolved in CH₃OH, and the host copolymer B was dissolved in a mixture of 80% CH₃OH and 20% H₂O. The solution of guest copolymer A was then added into the solution of host copolymer B (1:1 molar ratio of A:B) to form a mixture of A+B at a total concentration of 50 mg·mL⁻¹ in 90% CH₃OH and 10% H₂O. The A+B solution (150 μL) was then added to each coverslip by drop casting and drying the film overnight before flow cell experiments.

PAO1 ΔwspF Tn7 Gm::P(A1/04/03)::GFP was struck out onto Luria Broth (LB) agar plates from frozen glycerol stocks and incubated overnight at 37° C. Tryptic Soy Broth (TSB) media was inoculated with a single colony and grown overnight with shaking at 37° C. Overnight cultures were back-diluted 1/100 in TSB media and grown with shaking at 37° C. to mid-log phase. Mid-log cultures were then diluted in 1% TSB media supplemented with an additional 50 mM NaCl solution (i.e., 20 mL of 5 M NaCl were added to 2 L of media) to a final OD 600 nm of 0.01 in a 1 mL volume. Flow cells without coverslips were autoclaved, and then either glass coverslips without polymer coating (control) or polymer-coated glass coverslip was affixed to the flow cell using silicone sealant. The flow cells were inoculated with ˜300 μL of back-diluted culture using a 1-mL syringe and incubated invertedly at 25° C. for 10 minutes. The flow cell was connected, and the initial rate was set at 40 mL·h⁻¹ for 20 minutes. After 20 minutes, the flow rate was reduced to 10 mL·h⁻¹ and imaged using an upright Nikon confocal laser scanning microscope. The 20× magnification objective was used with an excitation of 488 nm and an emission of 508 nm. After imaging, the flow cell was incubated in a dark room at 25° C. At 48 h and 96 h, the flow cells were imaged again. On each day of imaging, three stills and three z-stack images were taken of the middle portion of the flow cells.

### Static Growth Experiments

Cellvis 8 chambered #1.5 high-performance cover glass wells were utilized for this experiment. Two of the glass wells were coated in a polymer film (A+B) while another two were coated in a polymer film loaded with antibiotics (Aₜ+Aₚ+B). A+B (1:1 molar ratio of A:B) was dissolved in 90% CH₃OH and 10% H₂O at 18.75 mg·mL⁻¹ and 200 μL was dropped into one glass well; Aₜ+Aₚ+B (1:1:2 molar ratio of Aₜ:Aₚ:B) was dissolved in 90% CH₃OH and 10% H₂O with the same molar amount of copolymer B as compared to A+B instead of the same concentration and 200 μL was dropped into one glass well. Then the well plate with two wells loaded with A+B solution (200 μL each) and two wells loaded with Aₜ+Aₚ+B solution (200 μL each) was put on a shaker to dry overnight before further experiments. Prior to inoculating bacteria, the polymer coatings were imaged using an inverted Leica confocal laser scanning microscope. The 20× magnification objective was used with an excitation of 488 nm and an emission of 508 nm. Three z-stacks were taken over the middle portion of the well.

PAO1 ΔwspF Tn7 Gm::P(A1/04/03)::GFP and PAO1 ΔwspF ΔpelA ΔpslBCD ΔalgD Tn7 Gm::P(A1/04/03)::GFP expressing strains were struck out onto LB agar plates from frozen glycerol stocks and incubated overnight at 37° C. TSB media was inoculated with a single colony and grown overnight with shaking at 37° C. Overnight cultures were back diluted 1/100 in 100% TSB media and grown with shaking at 37° C. to an OD of 0.1. Then, 220 μL of back-diluted culture was added to each Cellvis well. The top row was inoculated with PAO1 ΔwspF Tn7 Gm::P(A1/04/03)::GFP culture and the bottom row was inoculated with PAO1 ΔwspF ΔpelA ΔpslBCD ΔalgD Tn7 Gm::P(A1/04/03)::GFP culture. At 0 h, CFUs were collected and plated on LB agar. Using an iPhone camera, a picture from the top of the wells was taken. The chamber was then placed in a covered Pyrex dish containing paper towels wet with deionized water to prevent dehydration, and then incubated in a dark room at 25° C. for 48 h. After 24 h and 48 h, CFUs and pictures of the top of the wells were taken again.

Prior to imaging the bacteria growth at 48 h, the wells were washed out by fully submerging the chamber in buffer (1×PBS, pH 7.4). The wells were tapped out on a paper towel to remove any excess liquid.

As for the CFUs for the well plates, a 200 μL-multichannel pipette was used to place 90 μL of 1×PBS solution into each well of a 96-well plate. 10 μL of the static glass well supernatant was carefully removed and added to the respective first column of the 96-well plate containing 90 μL of PBS. Serial dilutions were performed by transferring 10 μL from the first well to the adjacent well. This process was repeated to obtain a final dilution of 1:10⁸. A 20 μL-multichannel pipette was then used to deposit 5 μL from all eight wells of the respective row onto a room temperature LB agar plate, plated in triplicate. This step was repeated for each row. Drops on the LB agar plate was allowed to dry before being transferred to a 37° C. incubator to grow statically overnight. After 24 h, bacterial colonies were counted, and CFU counts were calculated.

### Antibiotic Release Experiments

The same amount of the antibiotic-loaded polymer film (Aₜ+Aₚ+B) was used to coat each well for these antibiotic release experiments as was used previously in the static growth experiments.

To determine the release rate of antibiotics from the antibiotic-loaded polymer film (Aₜ+Aₚ+B) that coated the glass well, 220 μL of 100% TSB was added to the well. Aliquots were taken at different time points to study the release rate of antibiotics. To remove aliquots, the entire 220 μL solution was removed from the well and added to a sterile 1 mL Eppendorf tube stored at 4° C. Fresh 220 μL of TSB was added back to the well. Between aliquot collection, the wells were stored in a covered Pyrex dish at 25° C. After obtaining all aliquots, 180 μL from the Eppendorf tube solution was added to individual wells of a 96-well plate.

The PAO1 ΔwspF ΔpelA ΔpslBCD ΔalgD Tn7 Gm::P(A1/04/03)::GFP expressing strain was struck out onto LB agar plates from frozen glycerol stocks and incubated overnight at 37° C. TSB media was inoculated with a single colony and grown overnight with shaking at 37° C. Overnight cultures were back diluted 1/100 in TSB media and grown with shaking at 37° C. to an OD of 0.4. Then, 20 μL of the back-diluted culture was added to each 96-well plate well.

A Breathe-Easy Sealing Membrane from Diversified Biotech was used to seal the 96-well plate. The well plate was inserted into the Thermoscientific Varioskan Lux well plate reader. The incubation temperature was set at 37° C. with light shaking at 240 rpm. The plate reader was set to measure the OD 600 nm at 20-minute intervals for a total of 18 h, with a pause of shaking during the readings. After 18 h, the well plates were removed from the reader.

### Materials, General Methods, and Instrumentation

All reagents were purchased from commercial suppliers and used without further purification unless stated otherwise. All reactions were performed under nitrogen (N₂) or argon (Ar) gas unless otherwise stated. Column chromatography was carried out with silica gel (Sorbtech, 0.040-0.063 mm). Polymerization of all polymers was performed under an inert atmosphere of UHP N₂ in a glovebox using a modified Grubbs' 3^{rd} generation catalyst that was prepared. All nuclear magnetic resonance (NMR) spectra were recorded on Varian Inova-500 spectrometer at 25° C., with working frequencies of 500 (¹H) and 125 (¹³C) MHz. Chemical shifts are reported in ppm relative to the signals corresponding to the residual non-deuterated solvents: CDCl₃: δ_{H}=7.26 ppm and δ_{C}=77.16 ppm; (CD₃)₂SO: δ_{H}=2.50 ppm and δ_{C}=39.52 ppm; CD₂Cl₂: δ_{H}=5.32 ppm and δ_{C}=53.84 ppm; D₂O: δ_{H}=4.79 ppm; CD₃OD: δ_{H}=3.31 ppm and δ_{C}=49.00 ppm. High-resolution mass spectrometry (HRMS) data was recorded on a Bruker maXis 4G UHR-TOF mass spectrometer. Matrix assisted laser desorption/ionization time-of-flight mass spectrometry (MALDI-TOF-MS) was recorded on a Bruker Solaris 12T FT-MS, samples were prepared using 2,5-dihydroxybenzoic or α-cyano-4-hydroxycinnamic acid matrices. Size exclusion chromatography (SEC) analyses were performed on an Agilent 1260 Infinity setup with three PSS NOVEMA MAX Lux analytical 100 Å columns in tandem and 0.025 M Na₂SO₄ in H₂O mobile phase run at 23° C. with 1.0 mL·min⁻¹ flow rate. The differential refractive index (dRI) of each compound was monitored using a Wyatt Optilab T-rEX detector and the light scattering (LS) of each compound was monitored using Wyatt Dawn Heleos-II detector. The polymer films were all prepared by drop casting and the thickness of the films was determined by depositing the films on the center of a glass slide, leaving a border of glass on each side, followed by obtaining topographical data from a KLA-Tencor Alpha-Step D-100 Profilometer. Scanning electron microscopy (SEM) was conducted using a Thermofisher Quattro S ESEM apparatus with a high-stability Schottky field emission gun electron source providing electron resolution of 0.7 nm at 30 keV, 1.4 nm at 1 keV.

### Flow Cell Experiments

An upright confocal laser scanning microscope was used. Imaging was conducted using a Nikon AX Upright Laser Scanning Confocal Microscope. This microscope is equipped with a motorized stage and controlled by the Nis Element software. There is a custom stage made to allow for flow cells to be imaged. The microscope is equipped with a CFI Plan Apochromat Lambda 20× dry (NA 0.80) and a 40× oil immersion (NA 1.25). It contains 4 lasers that run from 405 nm to 640 nm. The scan head is a Nikon AX is a 25 mm FOV Galvano scanner that supports bidirectional and line scan imagining. The microscope is stationed on a TMC vibrational control CleanBench laboratory table.

Polymer film (A+B) coated coverslips were prepared for flow cell experiments. The guest copolymer A was dissolved in CH₃OH, and the host copolymer B was dissolved in a mixture of 80% CH₃OH and 20% H₂O. The solution of guest copolymer A was then added into the solution of host copolymer B (1:1 molar ratio of A:B) to form a mixture of A+B at a total concentration of 50 mg·mL⁻¹ in 90% CH₃OH and 10% H₂O. 150 μL of A+B solution was then added to each coverslip by drop casting method and dried overnight before flow cell experiments. Same preparation method of polymer film was used here as described for the profilometry experiments besides the glass coverslips were used instead of normal glass slides.

PAO1 ΔwspF Tn7 Gm::P(A1/04/03)::GFP was struck out onto Luria Broth (LB) agar plates from frozen glycerol stocks and incubated overnight at 37° C. Tryptic Soy Broth (TSB) media was inoculated with a single colony and grown overnight with shaking at 37° C. Overnight cultures were back-diluted 1/100 in TSB media and grown with shaking at 37° C. to mid-log phase. Mid-log cultures were then diluted in 1% TSB media supplemented with an additional 50 mM NaCl solution (i.e., 20 mL of 5 M NaCl were added to 2 L of media) to a final OD 600 nm of 0.01 in a 1 mL volume. Flow cells without coverslips were autoclaved, and then either glass coverslips without polymer coating (control) or polymer-coated glass coverslip was affixed to the flow cell using silicone sealant. The flow cells were inoculated with ˜300 μL of back-diluted culture using a 1-mL syringe and incubated invertedly at 25° C. for 10 minutes. The flow cell was connected, and the initial rate was set at 40 mL·h⁻¹ for 20 minutes. After 20 minutes, the flow rate was reduced to 10 mL·h⁻¹ and imaged using an upright Nikon confocal laser scanning microscope. The 20× magnification objective was used with an excitation of 488 nm and an emission of 508 nm. After imaging, the flow cell was incubated in a dark room at 25° C. At 48 h and 96 h, the flow cells were imaged again. On each day of imaging, three stills and three z-stack images were taken of the middle portion of the flow cells.

The green fluorescence background (shown in greyscale) of images for glass coverslips with polymer coating was first confirmed to not be due to the porphyrin component of copolymer A as illustrated in FIG. 158, where polymer film A₀+B (no porphyrin included) was imaged, and green fluorescence background (shown in greyscale) was also observed.

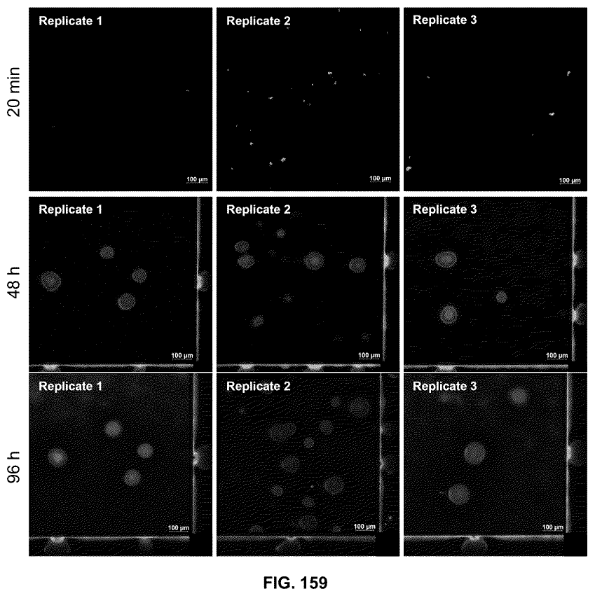

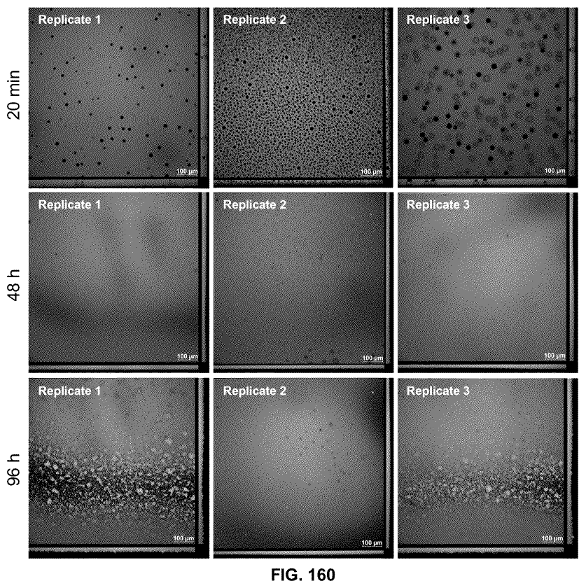

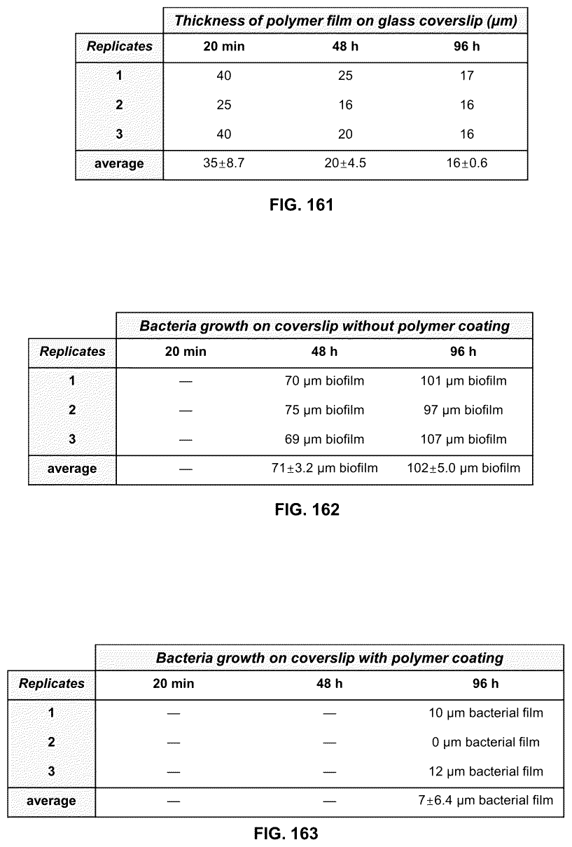

Three replicates were performed for flow cell experiments using either glass coverslips without polymer coating (control) or polymer-coated glass coverslips. One representative z-stack image was chosen for each replicate and the images were shown in FIG. 159 and FIG. 160 for experiments using glass coverslips without and with polymer coating, respectively. The thickness of polymer film on the coverslip at 20 min, 48 h, and 96 h was summarized in FIG. 161, and polymer film delamination was observed in this set of flow cell experiments, probably due to the flow of buffer. The bacterial growth at 20 min, 48 h, and 96 h was summarized in FIG. 162 and FIG. 163 for glass coverslips without and with polymer coating, respectively. The results showed that despite that there was polymer film delamination during the experiment, the polymer film (A+B) still mitigated bacteria growth and biofilm formation.

### Static Growth Experiments

An inverted confocal laser scanning microscope was used. Imaging was conducted using a Leica SP8 Lightning Single Photon Laser Scanning Confocal Microscope. This microscope is equipped with a motorized stage and controlled by the Las X software. There are three piezo-driven adaptor plates that allow for multi-well plates to be imaged. The microscope is equipped with a HC PL APO CS2 10× dry (NA 0.40), 20× multi-immersion (NA 0.75), 40× oil immersion (NA 1.30), and 63× oil immersion (NA 1.40) objectives. It contains 5 lasers that run from 405 nm to 638 nm. Illumination is provided by a Broadband EL6000 mercury halide light source with 3 filter sets for DAPI, FITC, and Rhodamine. The scan head is a SP8 LlAchroics Compact RGB Tandem scanner (8000 Hz resonant scanner+10-1800 Hz galvanometric scanner).

Cellvis 8 chambered #1.5 high performance cover glass wells were utilized for this experiment. Two of the glass wells were coated in a polymer film (A+B) while another two were coated in a polymer film loaded with antibiotics (Aₜ+Aₚ+B). A+B (1:1 molar ratio of A:B) was dissolved in 90% CH₃OH and 10% H₂O at 18.75 mg·mL⁻¹ and 200 μL was dropped into one glass well; Aₜ+Aₚ+B (1:1:2 molar ratio of Aₜ:Aₚ:B) was dissolved in 90% CH₃OH and 10% H₂O with the same molar amount of copolymer B as compared to A+B instead of the same concentration and 200 μL was dropped into one glass well. Then the well plate with 2 wells loaded with A+B solution (200 μL each) and 2 wells loaded with Aₜ+Aₚ+B solution (200 μL each) was put on a shaker to dry overnight before further experiments. Prior to inoculating bacteria, the polymer coatings were imaged using an inverted Leica confocal laser scanning microscope. The 20× magnification objective was used with an excitation of 488 nm and an emission of 508 nm. Three z-stacks were taken over the middle portion of the well.

PAO1 ΔwspF Tn7 Gm::P(A1/04/03)::GFP and PAO1 ΔwspF ΔpelA ΔpslBCD ΔalgD Tn7 Gm::P(A1/04/03)::GFP expressing strains were struck out onto Luria Broth (LB) agar plates from frozen glycerol stocks and incubated overnight at 37° C. Tryptic Soy Broth (TSB) media was inoculated with a single colony and grown overnight with shaking at 37° C. Overnight cultures were back diluted 1/100 in 100% TSB media and grown with shaking at 37° C. to an OD of 0.1. Then, 220 μL of back-diluted culture was added to each Cellvis well. The top row was inoculated with PAO1 ΔwspF Tn7 Gm::P(A1/04/03)::GFP culture and the bottom row was inoculated with PAO1 ΔwspF ΔpelA ΔpslBCD ΔalgD Tn7 Gm::P(A1/04/03)::GFP culture. At 0 h, CFUs were collected and plated on LB agar. Using an iPhone camera, a picture from the top of the wells was taken. The chamber was then placed in a covered Pyrex dish containing paper towels wet with deionized water to prevent dehydration, and then incubated in a dark room at 25° C. for 48 h. After 24 h and 48 h, CFUs and pictures of the top of the wells were taken again.

Prior to imaging the bacteria growth at 48 h, the wells were washed out by fully submerging the chamber in buffer (1×PBS, pH 7.4). The wells were tapped out on a paper towel to remove any excess liquid.

As for the CFUs for the well plates, a 200 μL-multichannel pipette was used to place 90 μL of 1×PBS solution into each 96 plate well. 10 μL of the static glass well supernatant was carefully removed and added to the respective first column of the 96 well plate containing 90 μL of PBS. Serial dilutions were performed by transferring 10 μL from the first well to the adjacent well. This process was repeated to obtain a final dilution of 1:10⁸. A 20 μL-multichannel pipette was then used to deposit 5 μL from all eight wells of the respective row onto a room temperature LB agar plate, plated in triplicate. This step was repeated for each row. Drops on the LB agar plate was allowed to dry before being transferred to a 37° C. incubator to grow statically overnight. After 24 h, bacterial colonies were counted and CFU counts were calculated.

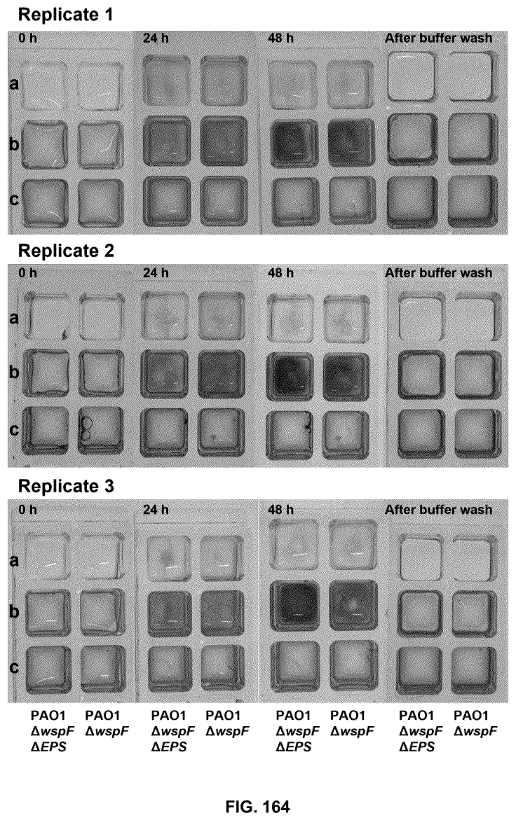

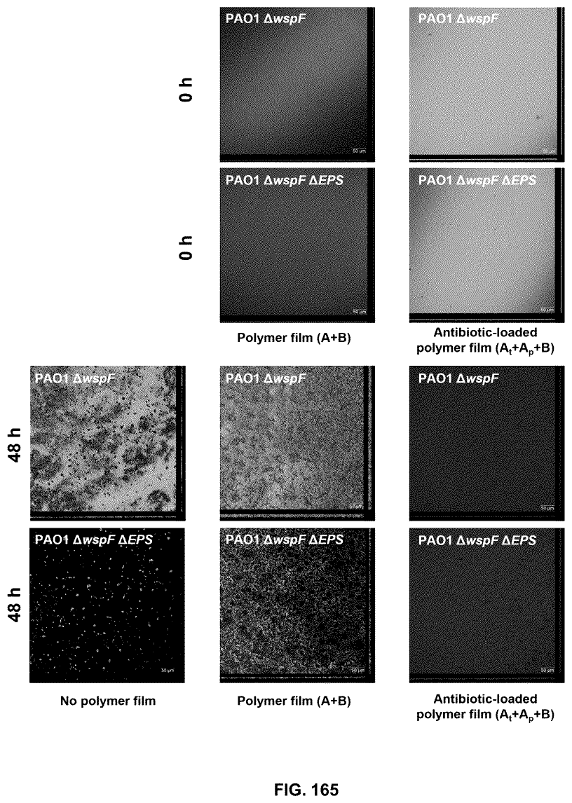

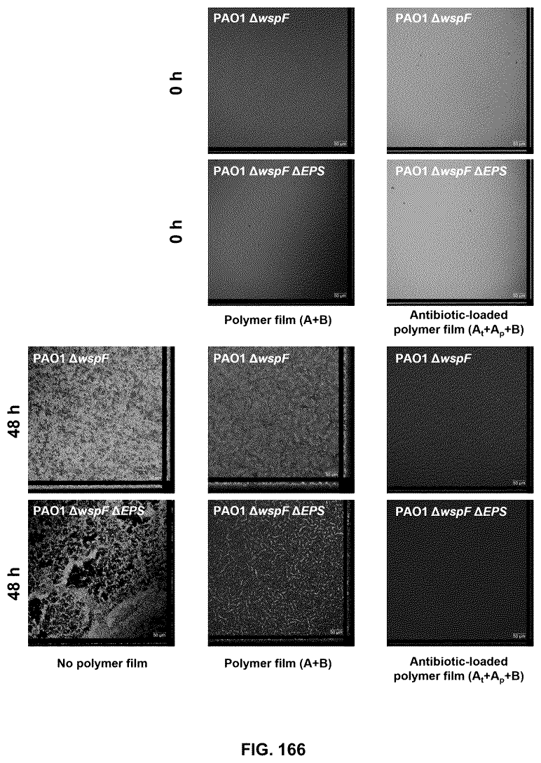

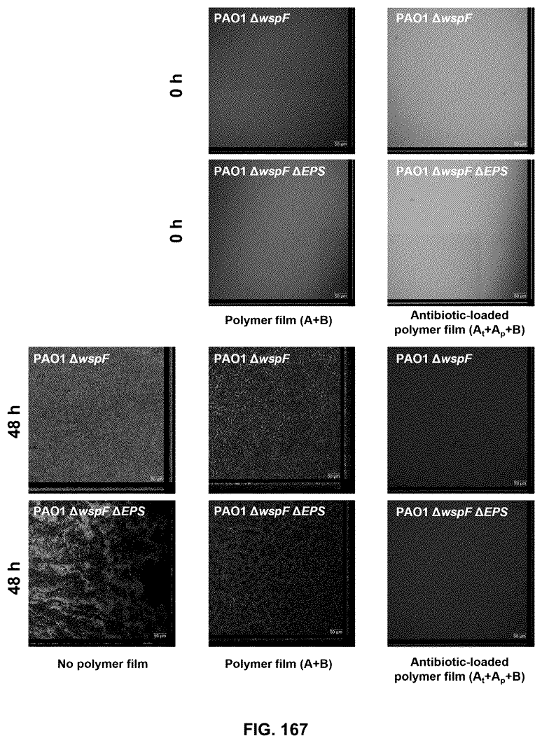

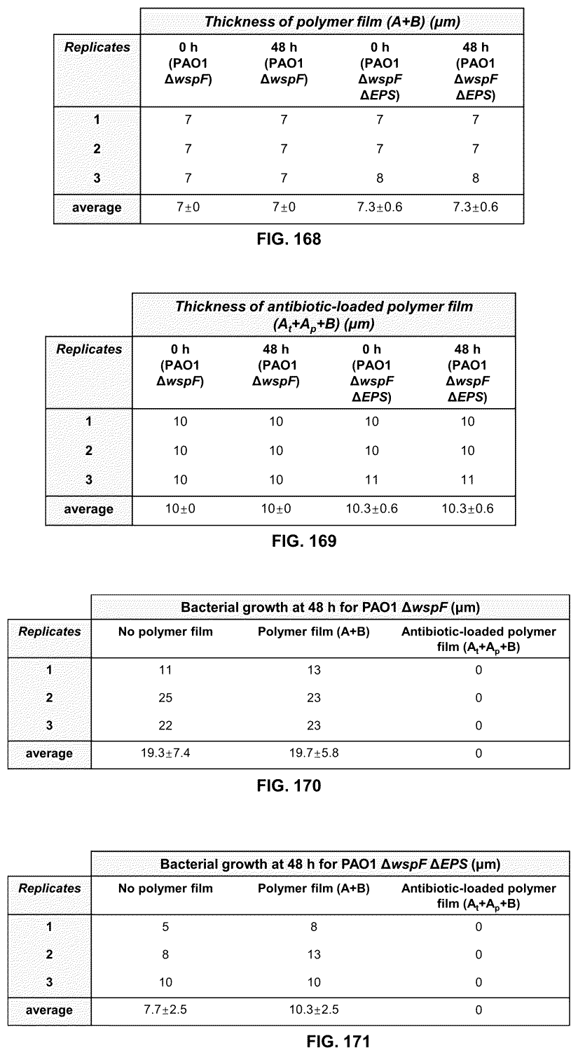

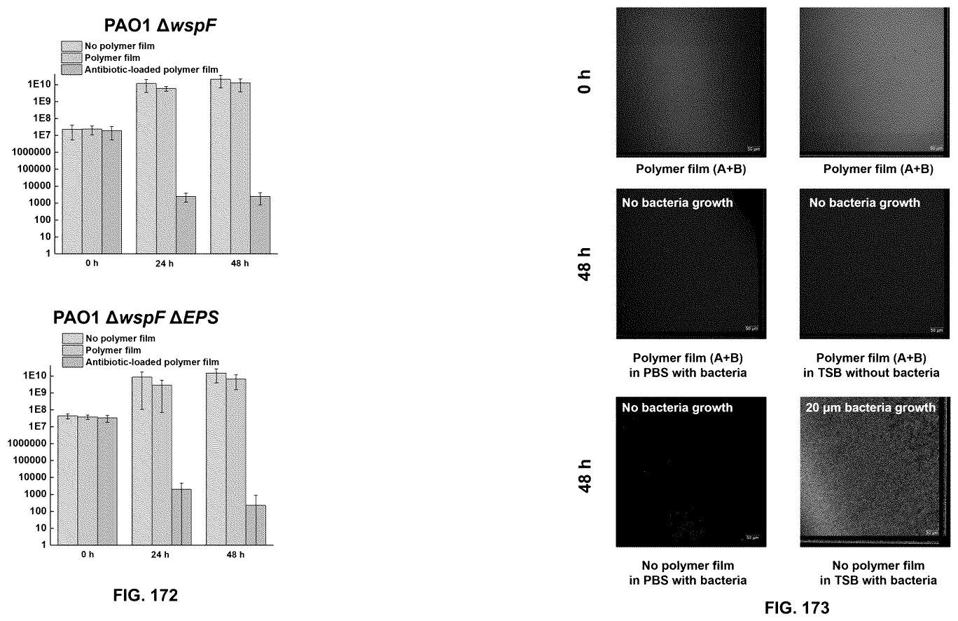

Three replicates were performed for this set of experiments. The images of the top of the wells were summarized in FIG. 164. Confocal microscopy images of three biological replicates were summarized in FIG. 165, FIG. 166, and FIG. 167. Polymer film (A+B) thickness was summarized in FIG. 168, and no delamination observed (under static conditions). Antibiotic-loaded polymer film (Aₜ+Aₚ+B) thickness was summarized in FIG. 169, and no delamination was observed (under static conditions). Bacterial growth was summarized in FIG. 170 and FIG. 171, polymer film (A+B) showed similar results as no polymer film, which means under static conditions, polymer film (A+B) did not mitigate bacteria growth. There was no bacterial growth on the antibiotic-loaded polymer film (Aₜ+Aₚ+B), demonstrating that it successfully served as a bactericidal polymer coating (FIG. 172).

Since bacteria grew in the well coated with polymer film (A+B), an additional set of control experiments was performed (FIG. 173), which supported that the cyclodextrin part in copolymer B did not serve as food for bacteria growth, as no bacteria growth was observed with the polymer film (A+B) in PBS instead of TSB.

### Antibiotic Release Assays

A 96-well plate reader was used. OD 600 nm measurements were taken by a ThermoFisher Scientific Varioskan LUX multimode microplate reader. There is an adaptor fitted for inserting 96 well plates into the machine. Incubation temperature of the machine can be set at a range of 0° C. to 45° C. The microplate reader can be set to shake at light, moderate, heavy force modes to provide 0 to 1200 rpms. A Xenon flash lamp light source is used in connection to a Photomultiplier Tube (PMT) detector capable of reading OD measurements from 200 nm to 1000 nm. The microplate reader is connected to a PC Thermo Scientific Skanlt Software for data collection.

To determine the release rate of antibiotics from the antibiotics loaded polymer film (Aₜ+Aₚ+B) that coated the glass well, 220 μL of 100% TSB was added to the well. Aliquots were taken at different time points to study the release rate of antibiotics. To remove aliquots, the entire 220 μL solution was removed from the well and added to a sterile 1 mL Eppendorf tube stored in a 4° C. refrigerator. Fresh 220 μL of TSB was added back to the well. Between aliquot collection, the wells were stored in a covered Pyrex dish in a 25° C. room. After obtaining all aliquots, 180 μL from the Eppendorf tube solution was added to individual wells on a 96 well plate.

The PAO1 ΔwspF ΔpelA ΔpslBCD ΔalgD Tn7 Gm::P(A1/04/03)::GFP expressing strain was struck out onto LB agar plates from frozen glycerol stocks and incubated overnight at 37° C. TSB media was inoculated with a single colony and grown overnight with shaking at 37° C. Overnight cultures were back diluted 1/100 in TSB media and grown with shaking at 37° C. to an OD of 0.4. Then, 20 μL of the back-diluted culture was added to each 96 well plate well.

A Breathe-Easy Sealing Membrane from Diversified Biotech was used to seal the 96 well plate. The well plate was inserted into the Thermoscientific Varioskan Lux well plate reader. The incubation temperature was set at 37° C. with light shaking at 240 rpm. The plate reader was set to measure the OD 600 nm at 20-minute intervals for a total of 18 h, with a pause of shaking during the readings. After 18 h, the well plates were removed from the reader.

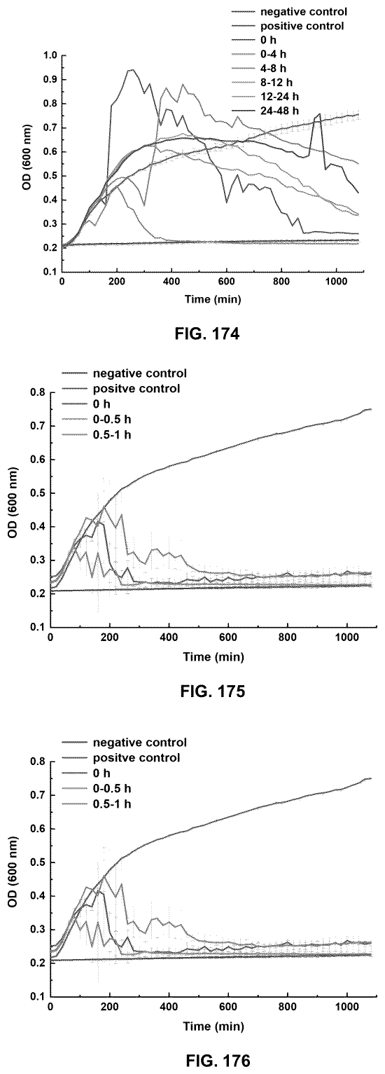

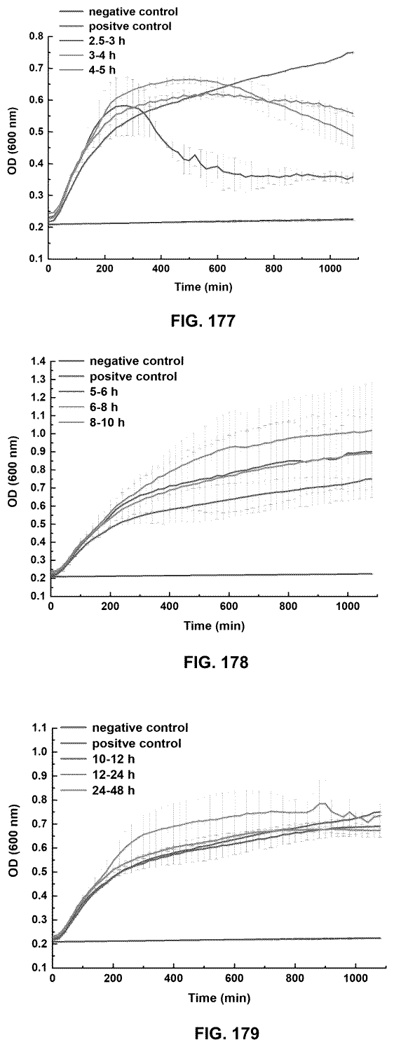

Initially, aliquots were collected at 0 h, 4 h, 8 h, 12 h, 24 h and 48 h. As shown in FIG. 174, the majority of the antibiotics were released within 4 h. Further studies were conducted with additional collection time points. Specifically, aliquots were collected at 30-minute increments from 0 h to 4 h. Then additional aliquots were collected at 5 h, 6 h, 8 h, 10 h, 12 h, 24 h, and 48 h. Three replicates were performed for this experiment. The results were summarized in FIG. 175, FIG. 176, FIG. 177, FIG. 178, and FIG. 179. Large amounts of antibiotics were released in the first hour and continued releasing to 5 h. No more antibiotics were released after 5 h.

Statistical Copolymer A₀: poly(2V⁴⁺Ad₃₀-TEG₉₀)ₛₜₐₜ·120Cl

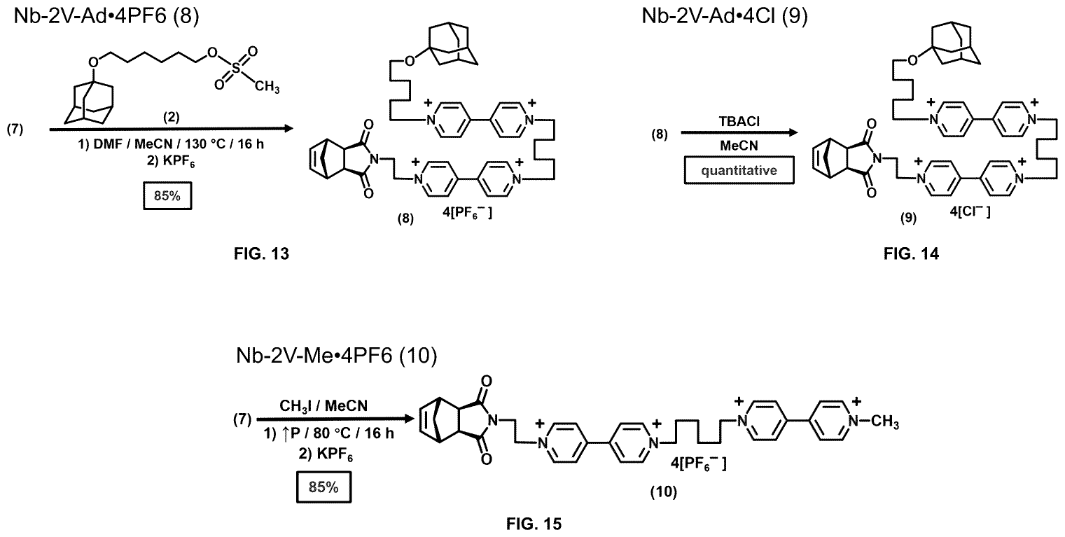

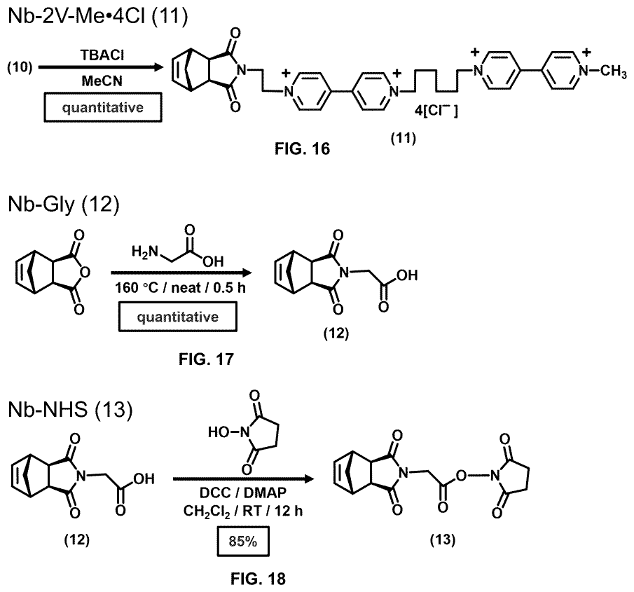

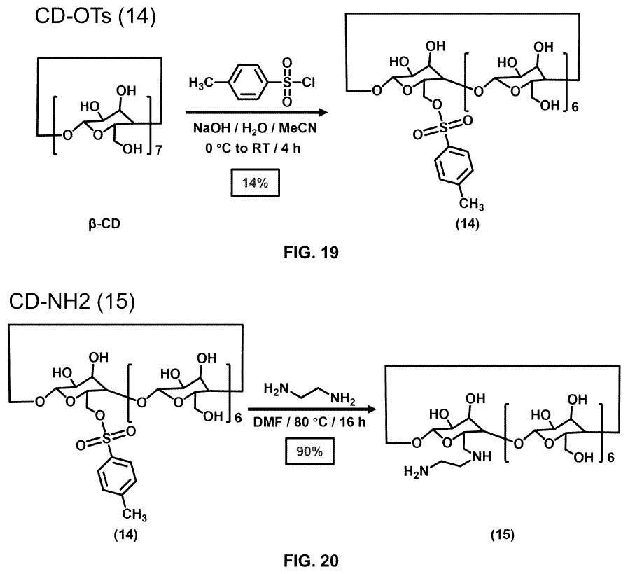

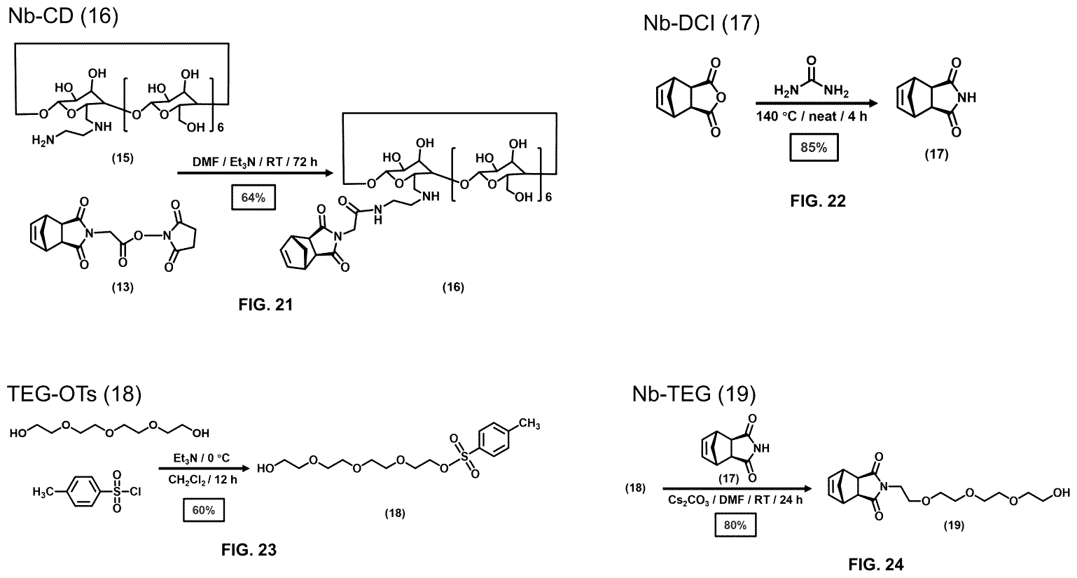

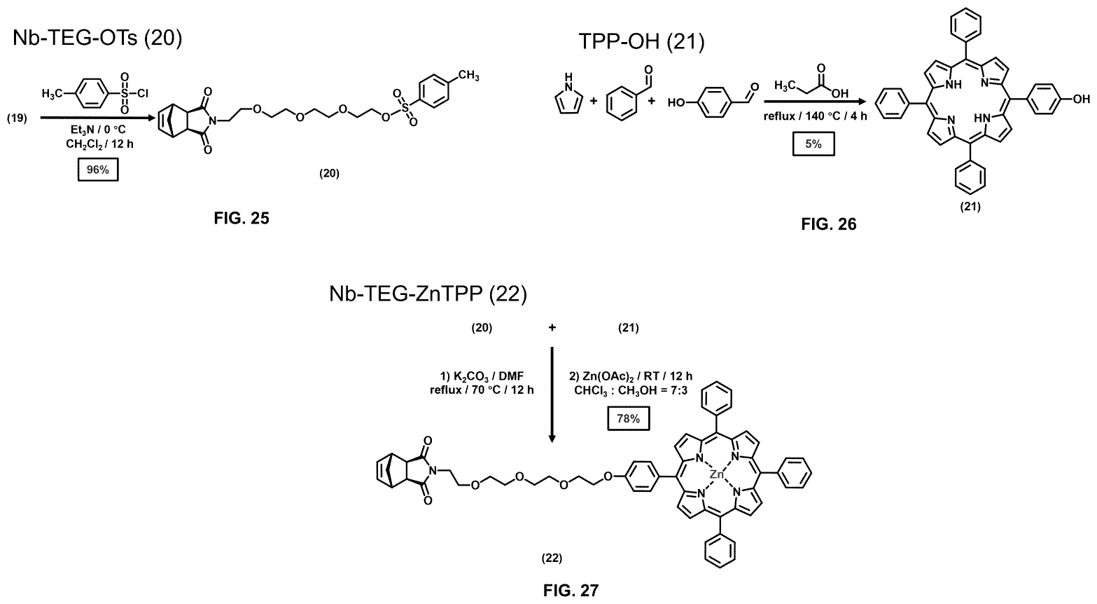

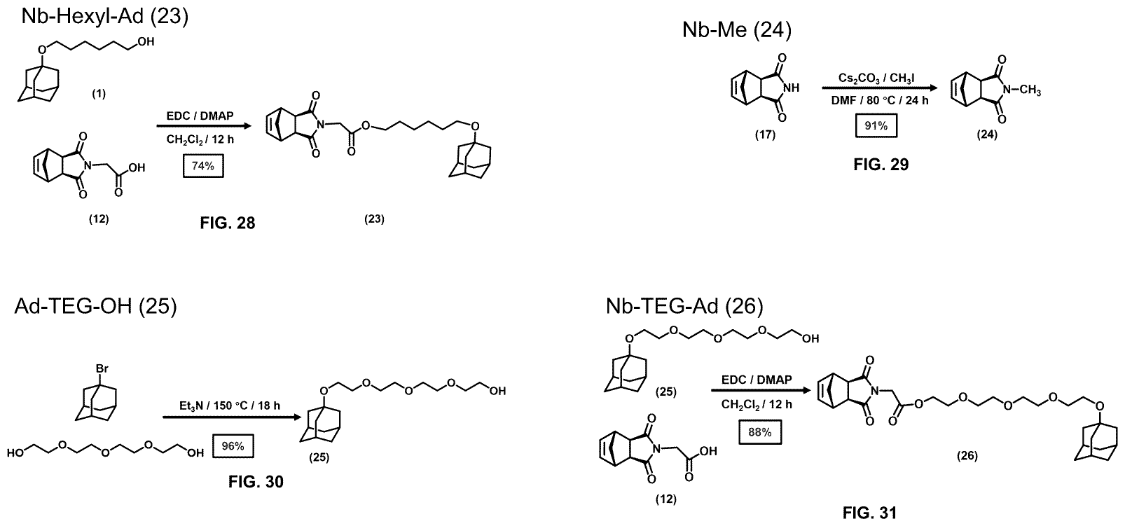

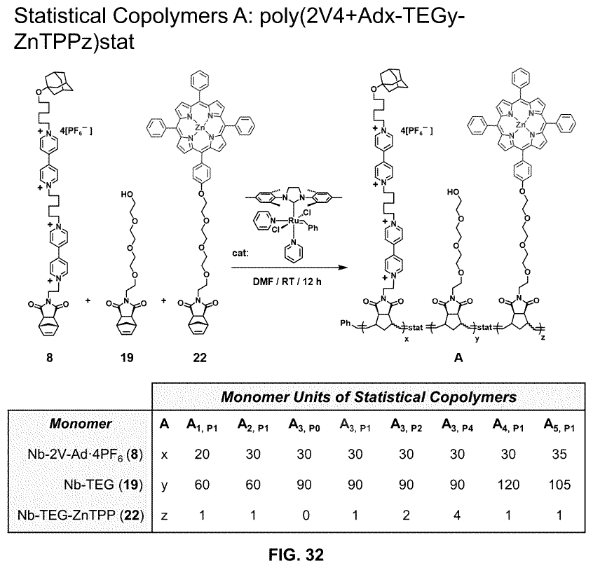

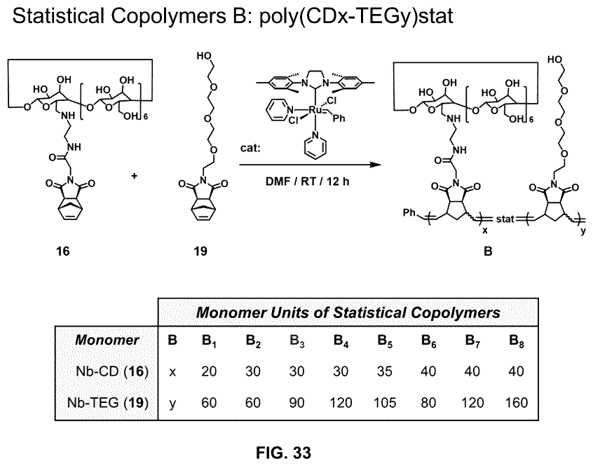

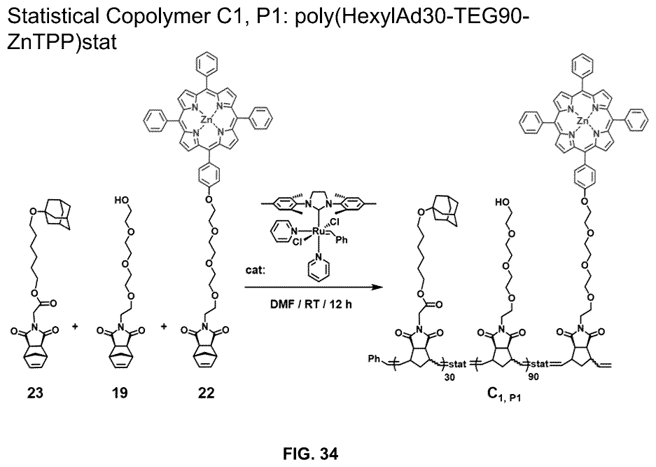

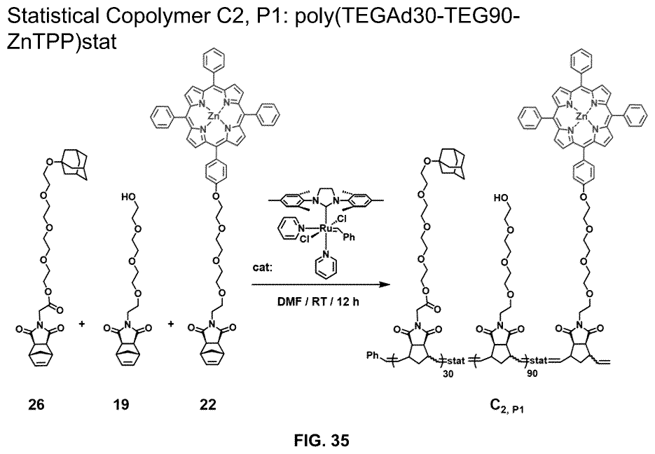

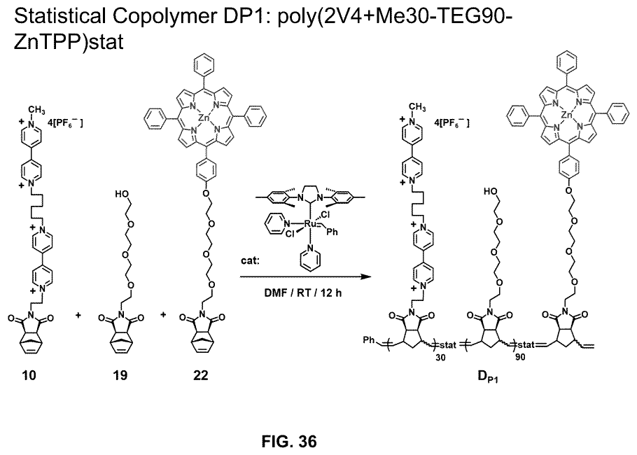

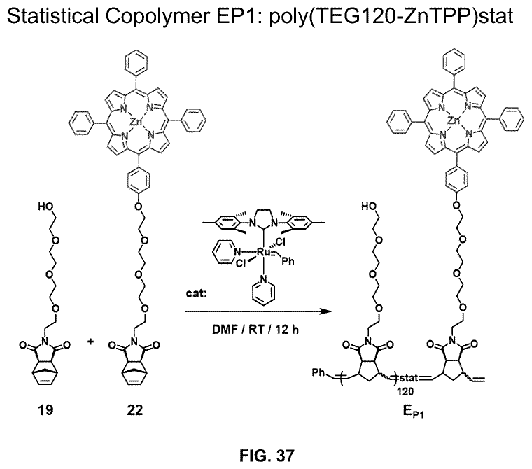

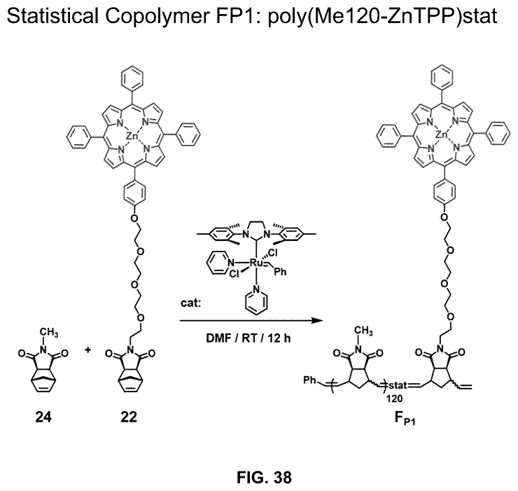

A solution of modified Grubbs 3rd generation catalyst (G3) was freshly prepared in DMF. G3 (0.0581 mL, 0.84 mg, 1.16 μmol, 1 equiv.) was added to a solution of 8 (FIG. 13) (48.9 mg, 34.9 μmol, 30 equiv.), 19 (FIG. 24) (35.5 mg, 104.6 μmol, 90 equiv.) in 1.329 mL DMF to give G3:8 (FIG. 13) ratio of 1:30 and a 0.025 M concentration of 8 (FIG. 13). The resulting solution was stirred for 12 h at room temperature. After the polymerization went to completion, the reaction was quenched by addition of ethyl vinyl ether (EVE). Then, the reaction mixture was transferred to dialysis tubing (RC dialysis tubing, 1 kDa molecular weight cut-off, 38 mm flat-width) and was placed in a beaker with 500 mL H₂O to remove the excess EVE and DMF. The dialysis continued for 12 h with H₂O and was then switched to 500 mL saturated NaCl solution to do counter anion exchange from PF₆⁻ to Cl⁻ for 6 h. After that, the solution in the beaker was switched back to 500 mL H₂O, followed by changing the H₂O every 12 h for a total of two more times. After dialysis, copolymer A₀ was lyophilized for 24 h to yield a dark yellow solid (52.3 mg, 85% yield).

Statistical Copolymer A: poly(2V⁴⁺Ad₃₀-TEG₉₀-ZnTPP)ₛₜₐₜ·120Cl

A solution of modified G3 was freshly prepared in DMF. G3 (0.0595 mL, 0.86 mg, 1.19 μmol, 1 equiv.) was added to a solution of 8 (FIG. 13) (50.1 mg, 35.7 μmol, 30 equiv.), 19 (FIG. 24) (36.4 mg, 107.2 μmol, 90 equiv.), and 22 (FIG. 27) (1.21 mg, 1.19 μmol, 1 equiv.) in 1.370 mL DMF to give G3:8 (FIG. 13) ratio of 1:30 and a 0.025 M concentration of 8 (FIG. 13). The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width) and was placed in a beaker with 500 mL H₂O to remove the excess EVE and DMF. The dialysis continued for 12 h with H₂O and was then switched to 500 mL saturated NaCl solution to do counter anion exchange from PF₆⁻ to Cl⁻ for 6 h. Then, the solution in the beaker was switched back to 500 mL H₂O, followed by changing the H₂O every 12 h for a total of two more times. After dialysis, copolymer A was lyophilized for 24 h to yield a purple solid (62.7 mg, 87% yield).

### Statistical Copolymer Aₜ:

poly(2V⁴⁺Ad₃₀-TEG₉₀-ZnTPP)ₛₜₐₜ·72Tazobactam·48Cl

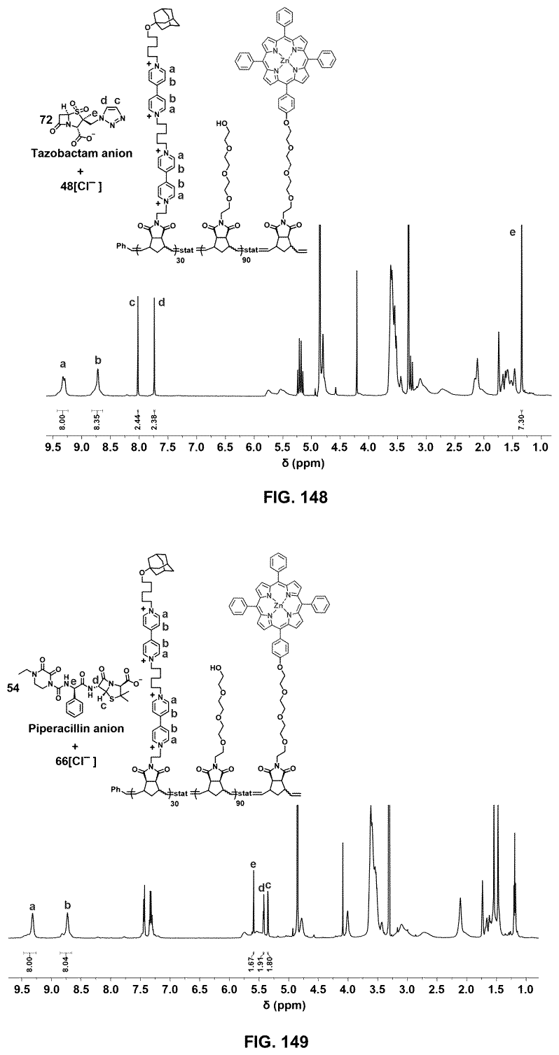

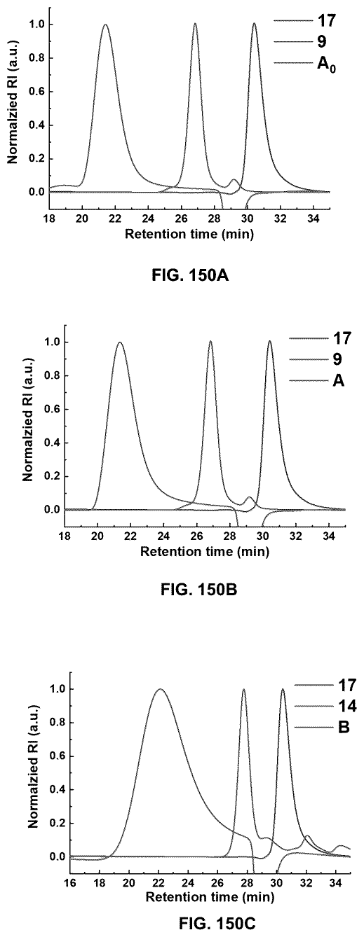

Copolymer A (27.7 mg, 0.0137 mmol, 1 equiv.) was dissolved in 2 mL H₂O, then tazobactam sodium (106 mg, 0.33 mmol, 24 equiv.) dissolved in 5 mL H₂O was added to the copolymer A solution to do counter anion exchange. The combined solution was then transferred to dialysis tubing (RC dialysis tubing, 1 kDa molecular weight cut-off, 38 mm flat-width), and was placed in a beaker with 500 mL H₂O to remove the excess tazobactam sodium. The dialysis continued for 48 h and the H₂O was changed every 12 h. After dialysis, copolymer Aₜ was lyophilized for 24 h to yield a purple solid (33.9 mg, 78% yield). ¹H NMR confirmed that the counter anion exchange was about 60% with tazobactam for copolymer Aₜ(FIG. 148).

Statistical Copolymer Aₚ: poly(2V⁴⁺Ad₃₀-TEG₉₀-ZnTPP)ₛₜₐₜ·54Piperacillin·66Cl

Copolymer A (27.7 mg, 0.0137 mmol, 1 equiv.) was dissolved in 2 mL H₂O, then piperacillin sodium (178 mg, 0.33 mmol, 24 equiv.) dissolved in 5 mL H₂O was added to the copolymer A solution to do counter anion exchange, resulting in a purple solid that precipitated from solution after adding excess piperacillin sodium. The mixture was centrifuged, and the excess solution was poured out. The remaining purple solid was then dissolved in 2 mL CH₃OH and transferred to dialysis tubing (RC dialysis tubing, 1 kDa molecular weight cut-off, 38 mm flat-width), and was placed in a beaker with 500 mL H₂O to remove the excess piperacillin sodium. The dialysis continued for 48 h and the H₂O was changed every 12 h. After dialysis, copolymer Aₚ was lyophilized for 24 h to yield a purple solid (36.2 mg, 65% yield). ¹H NMR confirmed that the counter anion exchange was about 45% with piperacillin for copolymer Aₚ (FIG. 149).

Statistical Copolymer B: poly(CD₃₀-TEG₉₀)ₛₜₐₜ

A solution of modified G3 was freshly prepared in DMF. G3 (0.0479 mL, 0.69 mg, 0.96 μmol, 1 equiv.) was added to a solution of 16 (FIG. 21) (39.7 mg, 28.8 μmol, 30 equiv.) and 19 (FIG. 24) (29.3 mg, 86.3 μmol, 90 equiv.) in 1.103 mL DMF to give G3:16 (FIG. 21) ratio of 1:30 (the concentration of 16 (FIG. 21) in solution was 0.025 M). The resulting solution was stirred for 12 h at room temperature. After the polymerization went to completion, the reaction was quenched by addition of EVE. Then, the reaction mixture was transferred to dialysis tubing (RC dialysis tubing, 1 kDa molecular weight cut-off, 38 mm flat-width), and was placed in a beaker with 500 mL H₂O to remove the excess EVE and DMF. The dialysis continued for 24 h and the H₂O was changed every 12 h. After dialysis, copolymer B was lyophilized for 12 h to yield a pale-yellow solid (51.5 mg, 75% yield).

### Gel Permeation Chromatography (GPC)

All the data was collected using three PSS NOVEMA MAX Lux analytical 100 Å columns in tandem and H₂O mobile phase (0.025 M Na₂SO₄) running at 23° C. with 1.0 mL·min⁻¹ flow rate. (Note: No GPC trace of monomer 22 (FIG. 27) (Nb-TEG-ZnTPP) was overlaid on the graphs below as it is not soluble in H₂O)

### Polymer Film Preparation

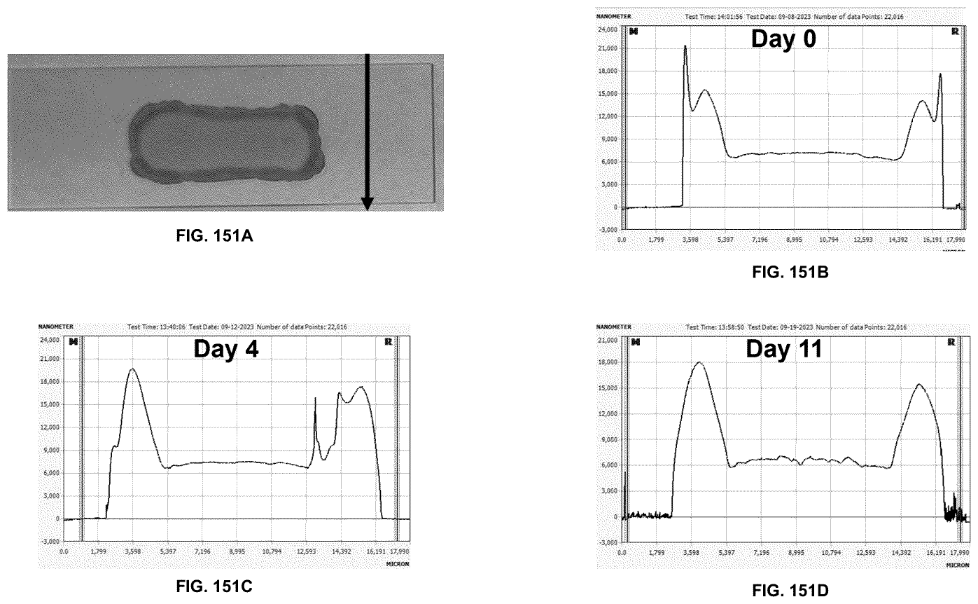

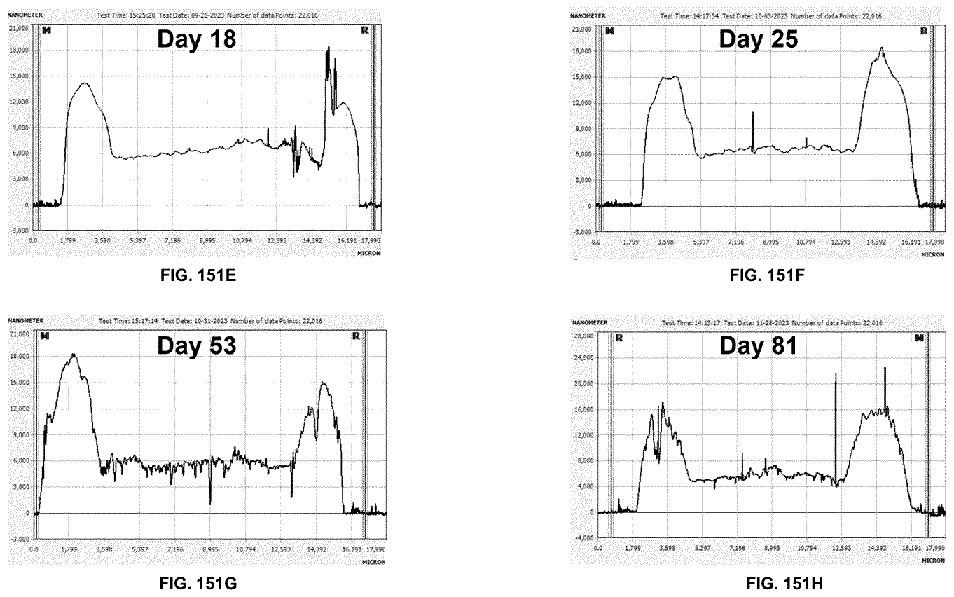

The guest copolymer A was dissolved in CH₃OH, and the host copolymer B was dissolved in a mixture of 80% CH₃OH and 20% H₂O. The solution of guest copolymer A was then added into the solution of host copolymer B (1:1 molar ratio of A:B) to form a mixture of A+B at a total concentration of 50 mg·mL⁻¹ in 90% CH₃OH and 10% H₂O. 150 μL of the A+B solution was then added to a glass slide by drop casting method and dried overnight before profilometry test (FIG. 151A).

### Profilometry

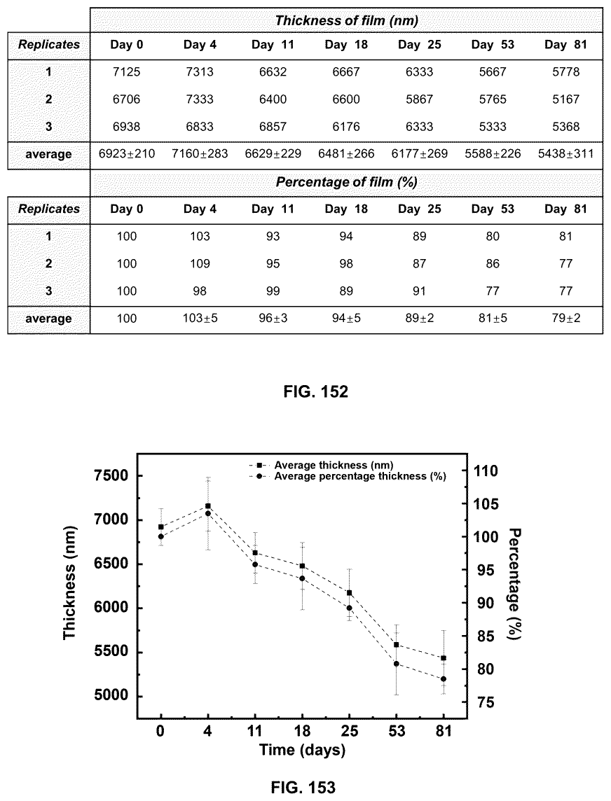

The profilometry experiment was done on the middle part of the film with the direction of the arrow. This initial test was labeled as day 0. After this initial test, the glass slide with polymer film was submerged in 100 mM NaCl solution to continue testing over several days. The labeled days all include one day of drying before testing (e.g., day 4 represents three days in 100 mM NaCl solution and one day drying before being subjected to analysis by profilometry). Three replicates were done for this film degradation study. One set of profilometry figures for one replicate is summarized in FIG. 151B, FIG. 151C, FIG. 151D, FIG. 151E, FIG. 151F, FIG. 151G, and FIG. 151H and all three replicates are summarized in FIG. 152 and plotted in FIG. 153. The results showed that the polymer film was stable in the first week in static salt solutions and that the majority of the polymer film remained attached to the glass slide up to 80 days.

### Scanning Electron Microscopy (SEM) Imaging

Scanning electron microscopy (SEM) experiments were performed to see the differences in morphology between polymer film A+B and the antibiotics-loaded polymer film Aₜ+Aₚ+B. Two samples were prepared for SEM: 1) A+B (1:1 molar ratio of A:B) dissolved in 90% CH₃OH and 10% H₂O at 18.75 mg·mL⁻¹ was dropped onto clean gold wafer by pipette; 2) Aₜ+Aₚ+B (1:1:2 molar ratio of Aₜ:Aₚ:B) dissolved in 90% CH₃OH and 10% H₂O with the same molar amount of copolymer B as compared to A+B instead of the same concentration that was dropped onto a clean gold wafer by pipette. Both samples were air dried overnight, and the samples were then loaded into the SEM chamber. The sample chamber was evacuated using the HiVac setting, and images were recorded at 1000×, 5000×, 10000×, and 35000× magnification.

### Spectroscopic Analysis of Polymer Coating

Polymer films (A+B or A₀+B) were drop cast to coat each well for the following spectroscopic experiments. A+B or A₀+B (1:1 molar ratio of A:B or A₀:B) was dissolved in 90% CH₃OH and 10% H₂O at 18.75 mg·mL⁻¹ and 100 μL was dropped into each well. The well plate was put on a shaker to dry overnight before further analysis. Each polymer film was prepared in triplicate for analysis.

For the fluorescence measurements, polymers were used to coat the wells of black-walled, clear bottom Invitrogen 96-well microplates (Thermo Fisher Scientific, M33089), and PAO1 ΔwspF Tn7 Gm::P(A1/04/03)::GFP and PAO1 ΔwspF were added to separate wells for comparison. Using a Thermoscientific Varioskan Lux well plate reader, the fluorescence emission from 510 nm to 840 nm (1 nm step size) was monitored from the top of the well using an excitation of 488 nm (corresponding to the excitation wavelength used in the confocal microscopy experiments). The results from these experiments are shown in FIG. 156A. For the absorbance measurements, polymers were drop cast to coat the wells of non-treated polystyrene 96-well microplates (Costar, 3370), and using a Thermoscientific Varioskan Lux well plate reader, the absorbance (1 nm step size) was monitored. The results are shown in FIG. 156B.

### Results

### Self-Assembled Polymer Film Design, Preparation, and Properties

The self-assembled polymer film was designed by cross-linking two separate PNB-based statistical copolymers through non-covalent host-guest interactions between Ad and β-CD. Specifically, copolymers A and B were synthesized using ring-opening metathesis polymerization (ROMP) of functional Nb-based monomers (FIG. 137). Copolymer A was designed to incorporate polar, dicationic viologen subunits that tether the Ad functional group to the polymerizable Nb group (Nb-2V-Ad·4PF₆), while copolymer B was designed by linking the β-CD group to the Nb group with an ethylenediamine linker (Nb-CD). A tetraethylene glycol (TEG)-functionalized monomer (Nb-TEG) was polymerized together into each copolymer to promote the completion of the polymerization with bulky Ad or β-CD monomers, as well as increase the solubility of the copolymers in polar solvents. An additional monomer functionalized with a zinc-based tetraphenylporphyrin (Nb-TEG-ZnTPP) was also added to copolymer A for the purpose of helping stabilize the self-assembled coating while also functioning as a dye to aid with visualizing the coating. The ratio of the different monomers in each copolymer was selected based on optimal polymerization efficiency, water solubility, and host-guest-based cross-linking between the two copolymers.

The mechanism associated with the formation of viscous hydrogels prepared from copolymers A and B mixed in a 1:1 molar ratio in saltwater is disclosed herein above. The resultant hydrogel was confirmed to be cohesive and homogenous by SEM images, while exhibiting broad adhesive properties towards a variety of different surfaces. Here, rather than employing saltwater as the solvent to afford the viscous hydrogels, copolymer A and B were dissolved in a 1:1 molar ratio in a combined solvent condition (90% CH₃OH and 10% H₂O). The choice of solvent in this instance better facilitated application to a glass slide using a pipette and a drop casting method to form the polymer film A+B after air drying (FIG. 151A). A stability test of the polymer film A+B under static salt solutions (100 mM NaCl) was carried out over several days. Profilometry was used to determine the film thickness over several weeks (FIG. 151B, FIG. 151C, FIG. 151D, FIG. 151E, FIG. 151F, FIG. 151G, and FIG. 151H). The results from this investigation confirmed that >90% of the polymer film remained after three weeks in static salt solutions and that the majority of the polymer film (>79%) remained attached to the glass slide through 80 days (FIG. 152 and FIG. 153). The effective stability of the A+B film in salt solutions suggested the self-assembled copolymers could serve as an ideal antifouling coating, thus setting the stage for further biological studies of bacterial growth.

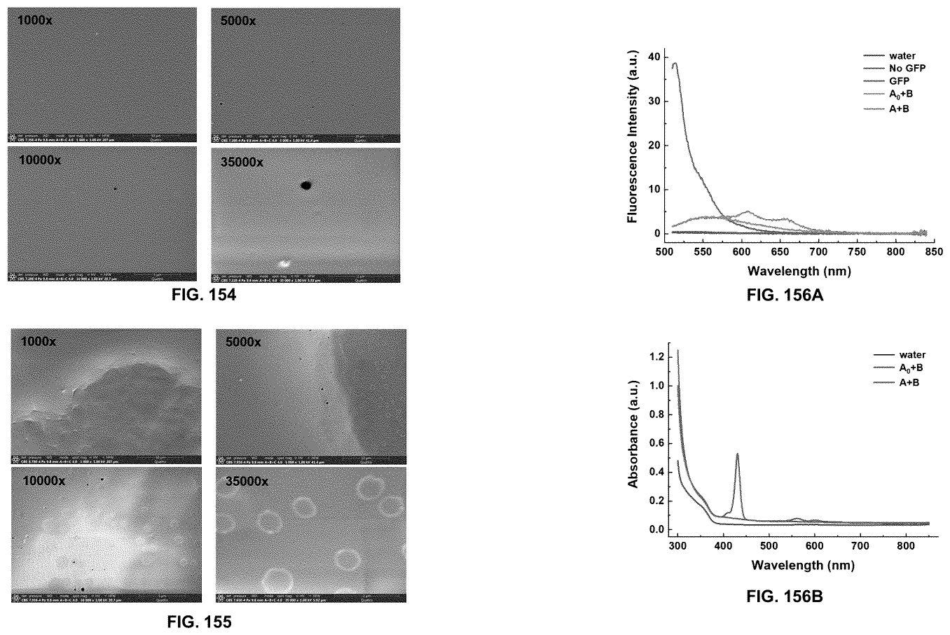

In addition to potentially functioning as an antifouling coating, a bactericidal polymer film was also successfully generated by loading a negatively charged antibiotic drug combination onto copolymer A through the ionic interactions with the positively charged viologen side chains (FIG. 137). Copolymer A (with chloride ions as counter anions) was first converted to copolymers Aₜ and Aₚ by doing counteranion exchange with tazobactam and piperacillin anions, respectively. Proton nuclear magnetic resonance (¹H NMR) revealed copolymer Aₜ was approximately 60% loaded with tazobactam anions (FIG. 148), while copolymer Aₚ was approximately 45% loaded with piperacillin anions (FIG. 149). The loading efficiency was comparable to a loading nalidixic acid anions into a cationic hydrogel also containing oligoviologens (˜60% loaded). The lack of complete loading of these two antibiotics into copolymer A was likely due to the larger size of either tazobactam or piperacillin anion compared to the original chloride ion, which led to some steric effects inside the copolymer chains. Moreover, this partial loading for both copolymers Aₜ and Aₚ was consistent with their relatively low solubilities as copolymer A was converted into the bactericidal polymer film Aₜ+Aₚ+B (1:1:2 molar ratio of Aₜ:Aₚ:B). SEM images for the A+B copolymer film (FIG. 154) exhibited a smooth surface. However, small circles were observed on top of the surface for antibiotic-loaded polymer film Aₜ+Aₚ+B (FIG. 155), which again, indicated that the larger size of the antibiotic anions (either tazobactam or piperacillin) decreased the solubility of the copolymers and thus led to incomplete, yet functionally sufficient, loading of the antibiotics. Consequently, an adequate amount of antibiotics was loaded into the Aₜ+Aₚ+B, polymer film, effectively serving as a bactericidal coating suitable for further biological studies of bacterial growth and establishing a proof-of-concept platform for the facile loading of nearly any negatively charged antibiotic drug combination.

### Flow Cell Experiments

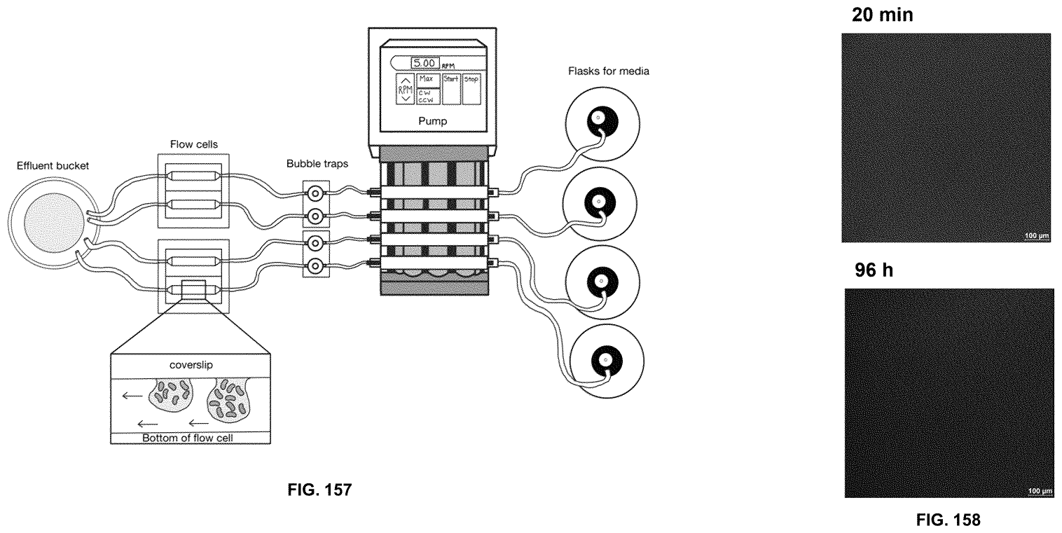

The stability of the polymer film (A+B) over several days in static saline solutions suggested it had the potential to serve as a physical barrier against bacteria growth. To test the polymer film's efficacy towards preventing biofilm formation, biofilms were cultured in microfluidic devices called flow cells, which simulate an active flow environment similar to that which a medical device may experience. As shown in the schematic for the flow cell growth setup (FIG. 157), sterilized media is pumped at a constant rate through tubing, intercepted by a bubble trap, to the inlet port of a flow cell, and then waste passes through the outlet port. Bacteria are inoculated directly into the flow cell, where they attach to the glass coverslip and grow. The live biofilm can then be imaged using an upright confocal microscope.

First, to assess the potential autofluorescence of the polymer film, the flow cell was imaged without inoculation of bacteria. The polymer film (A+B) exhibited autofluorescence across the specified wavelength range (FIG. 156A, FIG. 156B). It was initially believed that the autofluorescence may be due to the porphyrin unit that is incorporated in the polymer film. However, autofluorescence was still observed when a polymer film lacking the porphyrin unit (A₀+B) was used to coat a coverslip (FIG. 158). This result supports another component of the film being responsible for the background autofluorescence, presumably the viologen subunits. In any case, the fluorescence signal from the polymer coating was minimal in comparison to the GFP-expressing bacteria used in this study.

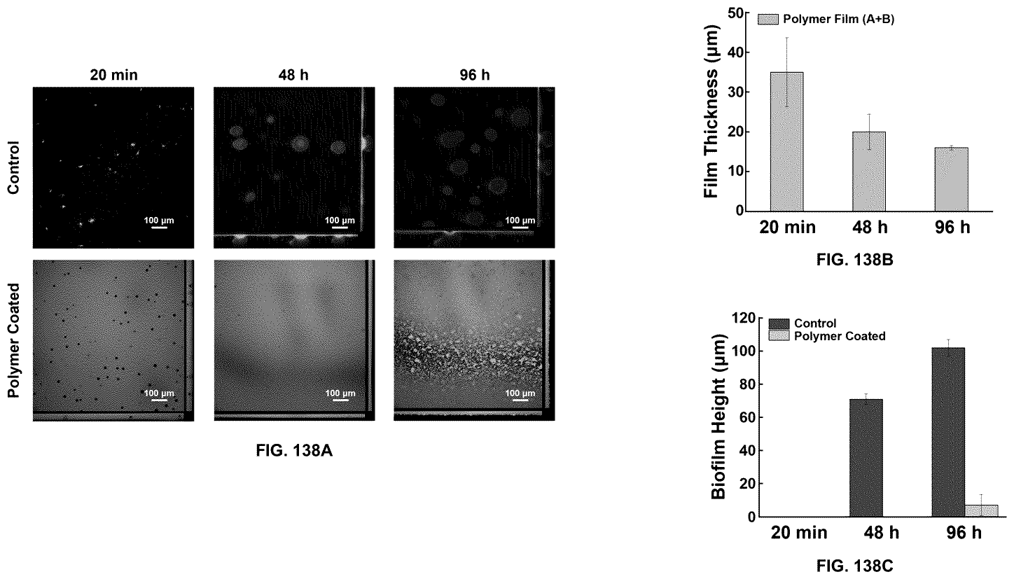

Flow cells in which the coverslips were coated with A+B polymer film (i.e., experimental group) and flow cells without the polymer coating (i.e., control group) were inoculated with a biofilm-overproducing P. aeruginosa strain that was engineered to constitutively express the fluorescent protein GFP, PAO1 ΔwspF Tn7 Gm::P(A1/04/03)::GFP. Growth medium for the flow cell experiments was supplemented with 50 mM NaCl to ensure integrity of the polymer film. Confocal microscopy images of the flow cells were collected at 20 min, 48 h, and 96 h after inoculation. As shown in FIG. 138A, at 20 min, individual bacteria and small bacterial aggregates were attached to the flow cell coverslip without the polymer coating. However, for the case in which the coverslip was coated with A+B polymer film, at 20 min post-inoculation, it was unclear whether bacteria had attached due to the autofluorescence of the polymer. To overcome the issue of autofluorescence, the overall thickness of the polymer film+biofilm was monitored at subsequent timepoints. At 48 h post-inoculation, the flow cell without the polymer coating contained distinct biofilm aggregates with an average biofilm height of 71±3.2 μm (three biological replicates, with three fields of view per replicate, FIG. 138C). In contrast, distinct biofilm aggregates were not observed for flow cells in which the coverslip was coated with the A+B polymer film, and only a thin layer of bacteria was observed on top of the polymer layer. Additionally, the polymer decreased in thickness from 35±8.7 μm at 20 min post-inoculation to 20±4.5 μm at 48 h post-inoculation (FIG. 138B). By 96 h post-inoculation, biofilm aggregates with an average height of 102±5 μm were observed in the flow cells with uncoated coverslips, whereas only small aggregates (7±6.4 μm tall) were observed in the flow cells with polymer-coated coverslips (FIG. 138C). Additionally, by this time point, the polymer film thickness decreased to 16±0.6 μm (FIG. 138B). Overall, it was observed that the A+B polymer film inhibited large biofilm aggregates from forming, supporting the notion that the A+B polymer film can serve as an antifouling coating under dynamic flow conditions (FIG. 136). One possible mechanism contributing to the antifouling properties of the A+B film is through delamination of the constituent copolymers, which is supported by the fact that the thickness of polymer film decreased over the course of the experiment (FIG. 138B). Specifically, any bacteria that attached to the top of the polymer film were removed with the delaminated polymer film under the active flow system.

### Static Growth Experiments

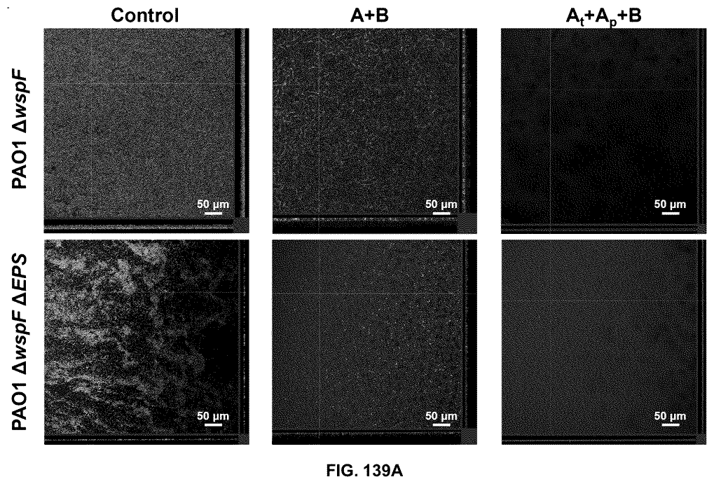

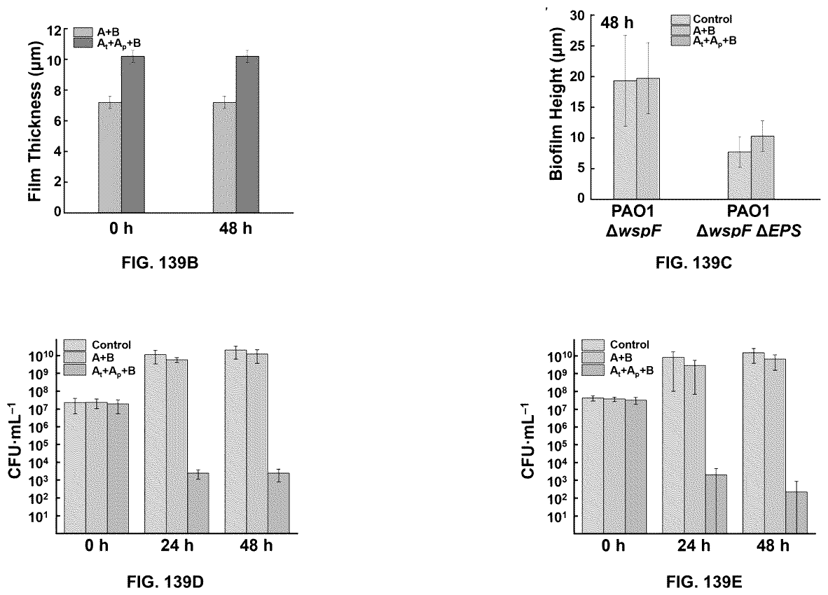

Next, the A+B polymer film was evaluated for antifouling abilities under static growth conditions (i.e., no dynamic flow). Biofilm formation in 8-chambered glass slides was assessed (FIG. 139A), with the bottom of the chambers uncoated, coated with the A+B polymer film, or coated with bactericidal copolymer that was loaded with the anionic, anti-Pseudomonas antibiotics, tazobactam and piperacillin (Aₜ+Aₚ+B). Before inoculating the 8-chambered glass slides with bacteria, the polymer films were imaged by confocal microscopy to determine the initial film thickness (FIG. 139A, FIG. 168, FIG. 169). As shown in FIG. 139B, the thickness of the A+B polymer film was 7.2±0.4 μm, and the Aₜ+Aₚ+B polymer film loaded with antibiotics was slightly thicker at 10.2±0.4 μm. The difference in film thickness was likely due to the larger size of the tazobactam and piperacillin anions relative to chloride. Both polymer coatings were observed to be uniformly distributed on the bottoms of the 8-chambered glass slides. Next, the 8-chambered glass slides were inoculated with the biofilm overproducing strain, PAO1 ΔwspF Tn7 Gm::P(A1/04/03)::GFP, or the isogenic, non-EPS-producing strain, PAO1 ΔwspF ΔpelF Δpsl ΔalgD Tn7 Gm::P(A1/04/03)::GFP, which served as a negative control for biofilm formation. Bacteria were statically cultured for 48 h, without replenishing the media or removing any waste. Then, the non-adherent biomass and spent media were washed out before imaging the adherent biomass by confocal microscopy.

Biofilms with an average thickness of 19.3±7.4 μm formed on the uncoated chambers that were inoculated with the biofilm overproducing strain, PAO1 ΔwspF Tn7 Gm::P(A1/04/03)::GFP (FIG. 139A, FIG. 139C). This strain also formed biofilms in chambers that were coated with polymer film (A+B), having an average thickness of 19.3±5.8 μm (obtained by subtracting the initial thickness of the polymer from the total thickness observed after 48 h). In contrast, the polymer film loaded with antibiotics (Aₜ+Aₚ+B) resulted in complete prevention of biofilm formation (i.e., no increase in thickness was observed relative to the initial polymer thickness). The thickness of both polymer films remained constant over the course of the 48-h experiment, and no delamination was observed under the static conditions (FIG. 139B). This result matched findings from a separate experiment monitoring polymer film degradation (FIG. 153). As expected, the non-EPS producing strain, PAO1 ΔwspF ΔpelF Δpsl ΔalgD Tn7 Gm::P(A1/04/03)::GFP, formed minimal adherent biomass in both uncoated chambers (7.7±2.5 μm) and chambers coated with A+B polymer film (10.3±2.5 μm) (FIG. 139A, FIG. 139C). Again, the Aₜ+Aₚ+B polymer film loaded with antibiotics completely prevented any bacterial attachment.

Overall, the A+B polymer film was not sufficient in preventing biofilm formation under static conditions. Instead, it appears that the A+B polymer film may have provided a surface for bacteria to attach and form biofilms (FIG. 139C). One possible explanation for this result is that copolymer B contains large amounts of β-CD, which is a sugar that P. aeruginosa could use as energy. To test this, a similar experiment was set up in the 8-chambered slides, but instead of TSB media, sterile PBS buffer was used, which provided no carbon source for P. aeruginosa. Typically, P. aeruginosa cannot grow in PBS, but if the copolymer B acts as a carbon source, then P. aeruginosa would be expected to grow. By assessing bacterial growth by confocal microscopy and determining CFUs, it was clear that there was no bacterial growth in PBS alone, thus rejecting the assertion that copolymer B was capable of serving as a carbon source (FIG. 173). Another explanation for biofilm formation on the A+B polymer film is that since the polymer film forms through dynamic host-guest interactions, swelling in the buffer might allow the dynamic non-covalent bonds to move, providing some space for the bacteria to interact with the A+B polymer film under static conditions.

In contrast, the polymer films loaded with antibiotics (Aₜ+Aₚ+B) provided full protection. This protection was predicted to be due to release of the antibiotics from the polymer film to the growth medium in the chamber. To test this, colony-forming units (CFUs) in the liquid of each chamber were determined at 0, 24, and 48 h post-inoculation, providing a measure of the viable number of bacteria (FIG. 139D, FIG. 139E). At 0 h post-inoculation, CFU values were approximately the same regardless of whether the chamber was coated or not, indicating that the same concentration of bacteria was added to each well. CFUs increased over time for liquid collected from both uncoated chambers and chambers coated with the unloaded A+B polymer film. In contrast, for liquid collected from the chambers coated with the Aₜ+Aₚ+B polymer film loaded with antibiotics, there was a significant drop in CFUs by 24 h post-inoculation, with CFUs plateauing to the 48 h timepoint (FIG. 139D, FIG. 139E). This plateau suggested that after 24 h, there was no more antibiotics released from the polymer film. To confirm the latter, additional experiments were performed to determine the release rate of the antibiotics.

### Antibiotic Release Experiments

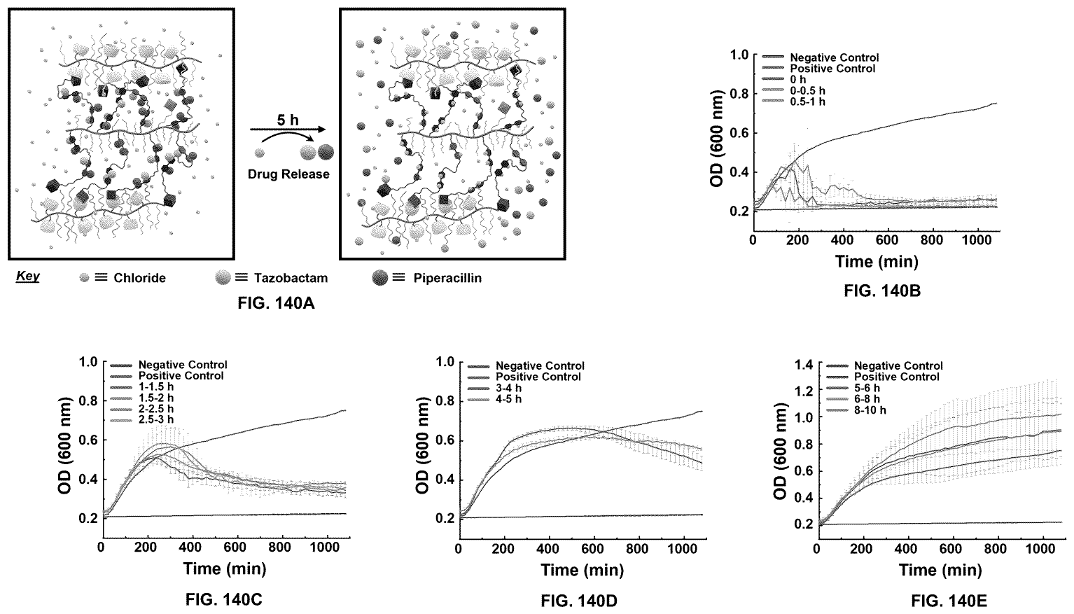

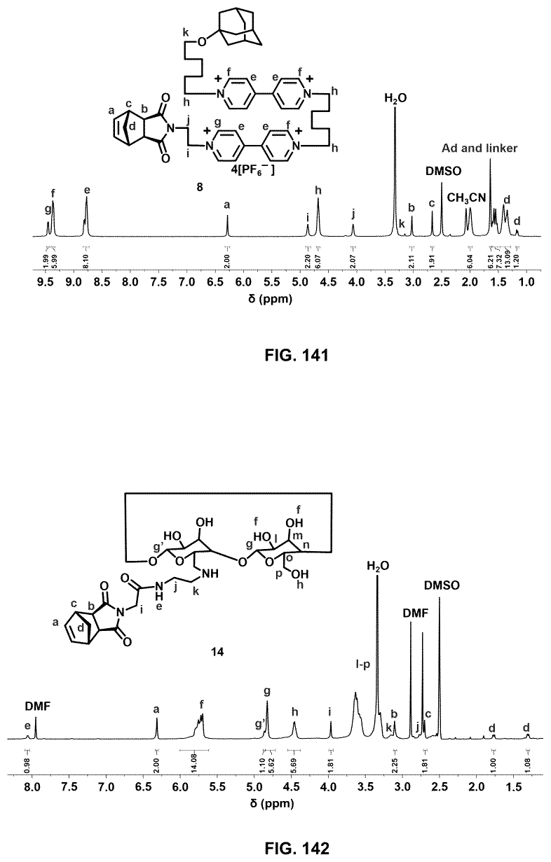

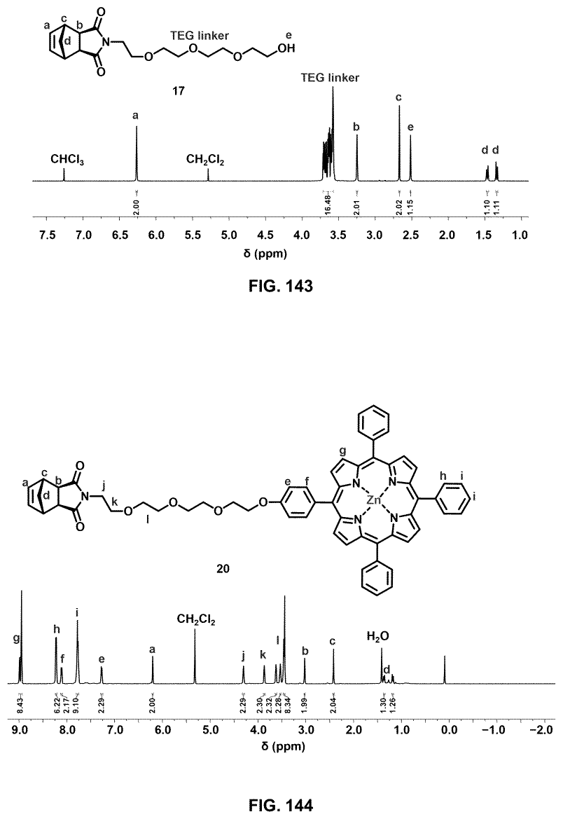

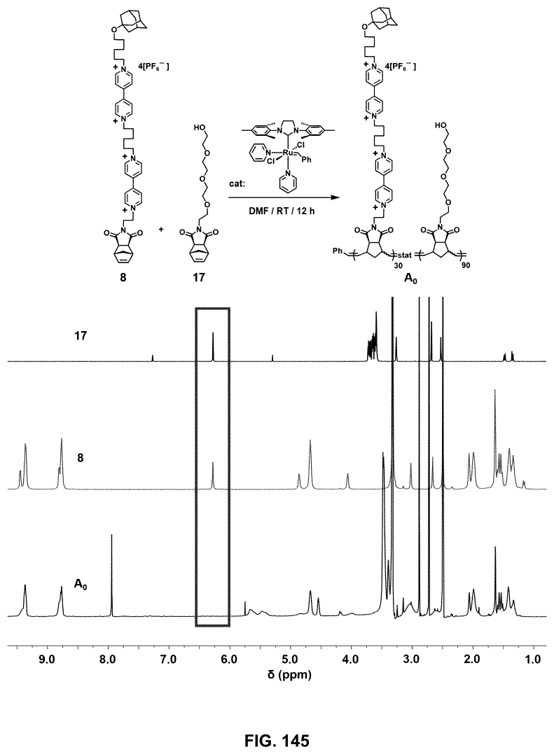

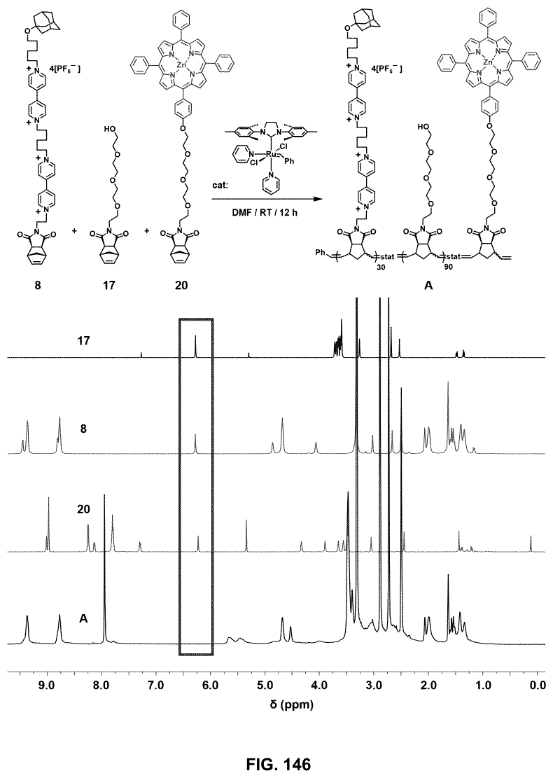

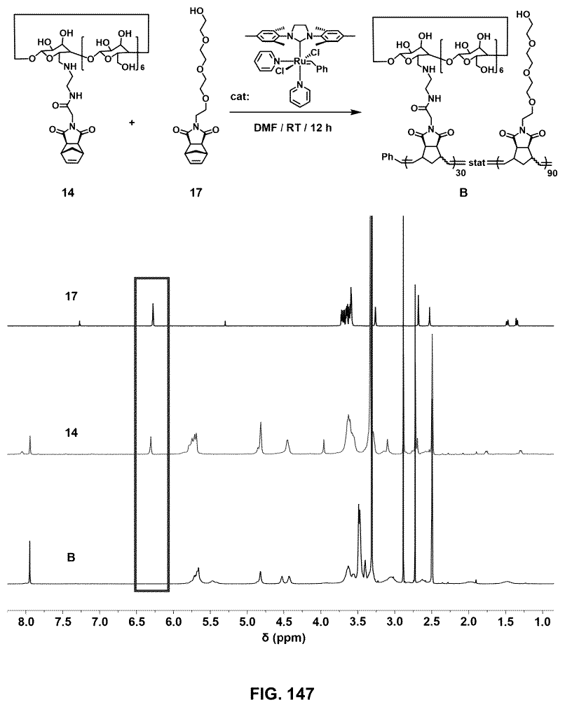

To better understand the rate of release of the loaded antibiotics in the static growth experiments, an antibiotic release assay was performed (FIG. 140A, FIG. 140B, FIG. 140C, FIG. 140D, FIG. 140E). To do this, TSB media was added to 8-chambered slides, with the bottoms coated with Aₜ+Aₚ+B polymer film loaded with antibiotics. Note that for this experiment, the slides were not inoculated with bacteria. At select time points, aliquots were collected by removing the entire media solution within a chamber and replacing it with fresh media. Next, these aliquots were added to a 96-well plate, inoculated with bacteria, and bacterial growth was assessed over 20 h by monitoring the OD at 600 nm. The negative control was TSB media without bacteria, and the positive control was TSB media with bacteria. Only the PAO1 ΔwspF ΔpelF ΔpslA algD Tn7 Gm::P(A1/04/03)::GFP strain was used to reduce aggregates from forming which would cause OD 600 nm values to be skewed.

In the first run of this experiment, it was noted that most of the antibiotics were released between 0 and 4 h (FIG. 174). Subsequently, more time intervals were added within the first 4 h of the total 48 h experiment to determine the specific time range that the antibiotics were released (FIG. 175, FIG. 176, FIG. 177, FIG. 178, FIG. 179). The negative and positive controls were as expected, where the wells without bacteria showed no change in OD 600 nm, and the wells with TSB media and bacteria continuously grew throughout the 18 hours.

Bacterial growth was inhibited in the initial aliquot that was collected at 0 h, immediately after adding media, as well as in the aliquots collected from 0-0.5 h and 0.5-1 h (FIG. 140B). This result suggests that that the tazobactam and piperacillin anions were readily released upon media contact, which is consistent with the SEM image showing that these anions are present on the top layer of the polymer film (FIG. 155). Bacterial growth was inhibited, albeit to a lesser degree, in aliquots collected from 1-1.5, 1.5-2, 2-2.5, and 2.5-3 h, as illustrated in FIG. 140C. By 3 h, there was only minimal inhibition of growth, and no inhibition by 5 h or later (FIG. 140D, FIG. 140E). These results support that antibiotic release from the polymer was rapid, and with media exchanges, occurred within the first 5 h. Moreover, these antibiotic and corresponding bactericidal properties establish a proof-of-concept platform capable of electrostatically loading nearly any combination of negatively charged antibiotic drug combination that can be used to treat a variety of drug-resistant bacteria.

### CONCLUSIONS

The design, synthesis, loading, and release of antibiotics from a self-assembled polymer film/coating on a glass substrate are disclosed. The polymer coating was composed of two bottlebrush copolymers that were synthesized through ROMP, followed by self-assembly 1:1 via host-guest interactions between Ad and β-CD functional groups appended to the sidechains of each Nb-based copolymers, A and B, respectively. The polymer film (A+B) showed prominent prevention against bacterial cell attachment and biofilm formation over several days while under a dynamic environment in a flow cell (0.167 mL·min⁻¹). This disclosure utilized a copolymer delamination mechanism while under flow conditions, where >50% of the polymer film remained after four days (in contrast to the >90% of the polymer film that remained under static conditions). Furthermore, the combination antibiotic-loaded polymer film (Aₜ+Aₚ+B) mitigated bacterial growth under static conditions. The release of the antibiotics from the polymer film was achieved through diffusion-limited counteranion exchange with chloride ions in the buffered solutions, which was indirectly determined using antibiotic release assays to go to completion around 5 h. This hydrogels disclosed can be modified to extend the antibiotic release time period of the polymer coatings to provide even longer protection, as well as have the potential for use of other antibiotic drug combinations in biomedical applications, such as in non-toxic and biodegradable antifouling/bactericidal coatings for medical devices.

What is claimed is:

1. A copolymer complex comprising:
a first polynorbornene (PNB)-based bottlebrush copolymer comprising:
a plurality of oligoethylene glycol sidechains; and
a plurality of β-cyclodextrin (β-CD)-terminated oligoethylene glycol sidechains; and
a second PNB-based bottlebrush copolymer comprising:
a plurality of oligoethylene glycol sidechains; and
a plurality of positively charged adamantane (Ad)-terminated oligoviologen sidechains; and
wherein the copolymer complex is reversibly soluble based on ionic strength, such that:
in a low ionic strength aqueous environment, the copolymer complex is soluble and dissolves to form a soluble copolymer complex, and
in a high ionic strength aqueous environment, the copolymer complex is insoluble and rapidly precipitates out to form a saltwater-stable adhesive hydrogel.

2. The copolymer complex of claim 1, wherein each Ad-terminated oligoviologen sidechain comprises at least one positively charged viologen subunit per oligoviologen sidechain.

3. The copolymer complex of claim 1, wherein the hydrogel is further heat-activated, such that the heat-activated hydrogel comprises increased dynamic CD-Ad crosslinking junctions, increased viscosity, and increased stiffness as compared to the hydrogel prior to heat activation.

4. The copolymer complex of claim 1, wherein at least one negatively charged compound is electrostatically loaded onto the plurality of positively charged Ad-terminated oligoviologen sidechains.

5. The copolymer complex of claim 4, wherein the at least one negatively charged compound comprises an antibiotic selected from tazobactam and piperacillin.

6. The copolymer complex of claim 1, wherein the second PNB-based bottlebrush copolymer further comprises a plurality of porphyrin-terminated sidechains.

7. The copolymer complex of claim 6, wherein the hydrogel is further photo-activated, such that the heat-activated hydrogel comprises increased dynamic CD-Ad crosslinking junctions, increased viscosity, and increased stiffness as compared to the hydrogel prior to photo-activation.

8. The copolymer complex of claim 6, wherein each porphyrin-terminated sidechain comprises a zinc-based tetraphenyl porphyrin monomer.

9. A method of synthesizing a copolymer complex, the method comprising:
exposing a copolymer mixture to an aqueous environment to form the copolymer complex, the copolymer mixture comprising:
a first polynorbornene (PNB)-based bottlebrush copolymer comprising:
a plurality of oligoethylene glycol sidechains; and
a plurality of β-cyclodextrin (β-CD)-terminated oligoethylene glycol sidechains; and
a second PNB-based bottlebrush copolymer comprising:
a plurality of oligoethylene glycol sidechains; and
a plurality of positively charged adamantane (Ad)-terminated oligoviologen sidechains; and
wherein the copolymer complex is reversibly soluble based on ionic strength, such that:
in a low ionic strength aqueous environment, the copolymer complex is soluble and dissolves to form a soluble copolymer complex, and
in a high ionic strength aqueous environment, the copolymer complex is insoluble and rapidly precipitates out to form a saltwater-stable adhesive hydrogel.

10. The method of claim 9, wherein each Ad-terminated oligoviologen sidechain comprises at least one positively charged viologen subunit per oligoviologen sidechain.

11. The method of claim 9, further comprising forming the soluble copolymer complex by lowering an ionic strength of the aqueous environment.

12. The method of claim 9, further comprising forming the saltwater-stable adhesive hydrogel complex by raising an ionic strength of the aqueous environment.

13. A method of coating a surface with an adhesive hydrogel, the method comprising:
applying a copolymer complex to a surface, wherein the copolymer complex comprises:
a first polynorbornene (PNB)-based bottlebrush copolymer comprising:
a plurality of oligoethylene glycol sidechains; and
a plurality of β-cyclodextrin (β-CD)-terminated oligoethylene glycol sidechains; and
a second PNB-based bottlebrush copolymer comprising:
a plurality of oligoethylene glycol sidechains; and
a plurality of positively charged adamantane (Ad)-terminated oligoviologen sidechains;
wherein the copolymer complex is reversibly soluble based on ionic strength, such that:
in a low ionic strength aqueous environment, the copolymer complex is soluble and dissolves to form a soluble copolymer complex, and
in a high ionic strength aqueous environment, the copolymer complex is insoluble and rapidly precipitates out to form a saltwater-stable adhesive hydrogel; and
exposing the surface to a high ionic strength aqueous environment such that the copolymer complex on the surface rapidly precipitates out to form the saltwater-stable adhesive hydrogel and coat the surface.

14. The method of claim 13, wherein applying the copolymer complex to the surface comprises:
dissolving the first PNB-based bottlebrush copolymer and the second PNB-based bottlebrush copolymer in an organic solvent to form a dissolved copolymer complex;
drop casting the dissolved copolymer complex on to the surface; and
evaporating the organic solvent from the surface.

15. The method of claim 13, wherein each Ad-terminated oligoviologen sidechain comprises at least one positively charged viologen subunit per oligoviologen sidechain.

16. The method of claim 13, wherein the surface is selected from high-density polyethylene (HDPE), stainless steel, glass, wood, and platinum.

17. The method of claim 13, wherein the high ionic strength aqueous environment comprises a saline solution.

18. The method of claim 13, wherein the second PNB-based bottlebrush copolymer further comprises a plurality of zinc-based tetraphenyl porphyrin-terminated sidechains.

19. The method of claim 13, further comprising activating the hydrogel by at least one of photo-activation and heat activation.

20. The method of claim 13, wherein at least one negatively charged compound is electrostatically loaded onto the plurality of positively charged Ad-terminated oligoviologen sidechains.

21. The method of claim 20, wherein the at least one negatively charged compound comprises an antibiotic selected from tazobactam and piperacillin.
